(19) United States
(12) Patent Application Publication
(10) Pub. No.: US 2015/0193575 A1
(43) Pub. Date: Jul. 9, 2015

(54) SYSTEMS AND METHODS OF SELECTING COMPOUNDS WITH REDUCED RISK OF CARDIOTOXICITY

(71) Applicant: The Governors of the University of Alberta, Edmonton (CA)

(72) Inventors: Michael Houghton, Edmonton (CA); Jack A. Tuszynski, Edmonton (CA); Khaled Barakat, Edmonton (CA); Anwar Mohamed, Edmonton (CA)

(21) Appl. No.: 14/569,467

(22) Filed: Dec. 12, 2014

Related U.S. Application Data
(60) Provisional application No. 61/916,093, filed on Dec. 13, 2013.
(60) Provisional application No. 62/034,745, filed on Aug. 7, 2014.

(51) Int. Cl. G06F 19/16; G06F 19/00; C40B 30/02

(52) U.S. Cl. CPC G06F 19/16; C40B 30/02; G06F 19/3437

(57) ABSTRACT

Provided herein are systems and methods for selecting compounds that have reduced risk of cardiotoxicity or which are not likely to be cardiotoxic. As an example, a system and method can include a computational dynamic model combined with a high throughput screening in silico that mimics one of the most important ion channels associated with cardiotoxicity, namely the human Ether-a-go-go Related Gene (hERG) channel. Also provided herein are systems and methods for redesigning compounds that are predicted to be cardiotoxic based on the model and the high throughput screening.

### 1. CROSS REFERENCE TO RELATED APPLICATIONS

The present application claims the benefit of priority of U.S. Provisional Application No. 61/916,093, filed Dec. 13, 2013, and U.S. Provisional Application No. 62/034,745, Aug. 7, 2014, the content of each of which is hereby incorporated by reference in its entirety.

### 2. TECHNICAL FIELD

This application relates generally to compounds and cardiotoxicity and more generally to processor-implemented systems and methods for analyzing compounds with respect to cardiotoxicity.

### 3. BACKGROUND

Cardiotoxicity is a leading cause of attrition in clinical studies and post-marketing withdrawal. The human Ether-a-go-go Related Gene 1 (hERG1) K⁺ ion channel is implicated in cardiotoxicity, and the U.S. Food and Drug Administration (FDA) requires that candidate drugs be screened for activity against the hERG1 channel. Recent investigations suggest that non-hERG cardiac ion channels are also implicated in cardiotoxicity. Therefore, screening of candidate drugs for activity against cardiac ion channels, including hERG1, is recommended.

The hERG1 ion channel (also referred to as KCNH2 or Kv11.1) is a key element for the rapid component of the delayed rectified potassium currents (I_{Kr}) in cardiac myocytes, required for the normal repolarization phase of the cardiac action potential (Curran et al., 1995, “A Molecular Basis for Cardiac-Arrhythmia; HERG Mutations Cause Long Qt Syndrome,” Cell, 80, 795-803; Tseng, 2001, “I(Kr): The hERG Channel,” J. Mol. Cell. Cardiol., 33, 835-49; Vandenberg et al., 2001, “HERG Kb Channels: Friend and Foe,” Trends. Pharm. Sci. 22, 240-246). Loss of function mutations in hERG1 cause increased duration of ventricular repolarization, which leads to prolongation of the time interval between Q and T waves of the body surface electrocardiogram (long QT syndrome-LQTS) (Vandenberg et al., 2001; Splawski et al., 2000, “Spectrum of Mutations in Long-QT Syndrome Genes KVLQT1, HERG, SCN5A, KCNE1, and KCNE2,” Circulation, 102, 1178-1185; Witchel et al., 2000, “Familial and Acquired Long QT Syndrome and the Cardiac Rapid Delayed Rectifier Potassium Current, Clin. Exp. Pharmacol. Physiol., 27, 753-766). LQTS leads to serious cardiovascular disorders, such as tachyarrhythmia and sudden cardiac death.

Diverse types of organic compounds used both in common cardiac and noncardiac medications, such as antibiotics, antihistamines, and antibacterial, can reduce the repolarizing current I_{Kr} (i.e., with binding to the central cavity of the pore domain of hERG1) and lead to ventricular arrhythmia (Lees-Miller et al., 2000, “Novel Gain-of-Function Mechanism in K [symbol] Channel-Related Long-QT Syndrome: Altered Gating and Selectivity in the HERG1 N629D Mutant,” Circ. Res., 86, 507-513; Mitcheson et al., 2005, “Structural Determinants for High-affinity Block of hERG Potassium Channels,” Novartis Found. Symp. 266, 136-150; Lees-Miller et al., 2000, “Molecular Determinant of High-Affinity Dofetilide Binding to HERG1 Expressed in Xenopus Oocytes: Involvement of S6 Sites,” Mol. Pharmacol., 57, 367-374). Therefore, several approved drugs (i.e., terfenadine, cisapride, astemizole, and grepafloxin) have been withdrawn from the market, whereas several drugs, such as thioridazine, haloperidol, sertindole, and pimozide, are restricted in their use because of their effects on QT interval prolongation (Du et al., 2009, “Interactions between hERG Potassium Channel and Blockers,” Curr. Top. Med. Chem., 9, 330-338; Sanguinetti et al., 2006, “hERG Potassium Channels and Cardiac Arrhythmia,” Nature, 440, 463-469).

The recommended in vitro drug screening process includes traditional patch clamp techniques, radiolabeled drug binding assays, 86RB-flux assays, and high-throughput cell-based fluorescent dyes and stably transfected hERG1 ion channels from Chinese hamster ovary (CHO) cells (Stork et al., 2007, “State Dependent Dissociation of HERG Channel Inhibitors,” Br. J. Pharmacol., 151, 1368-1376) and HEK 293 cells (also known as 293T cells) (Diaz et al., 2004, “The [³H]Dofetilide Binding Assay is a Predictive Screening Tool for hERG Blockade and Proarrhythmia: Comparison of Intact Cell and Membrane Preparations and Effects of Altering [K⁺]_{O},” J. Pharmacol. Toxicol. Methods., 50(3), 187-199). Although elaborate nonclinical tests display a reasonable sensitivity and establish safety standards for novel therapeutics, the screening of all of potential candidates remains very time-consuming and thus increases the final cost of drug design.

Molecular modeling techniques have provided some guidance in screening drug candidates for their blocking ability to cardiac channel proteins. For example, several receptor-based models of hERG-drug interactions based on molecular docking and molecular dynamics (MD) simulation studies have been published (Stansfeld et al., 2007, “Drug Block of the hERG Potassium Channel: Insight from Modeling,” Proteins: Struct. Funct. Bioinf. 68, 568-580; Masetti et al., 2007, “Modeling the hERG Potassium Channel in a Phospholipid Bilayer: Molecular Dynamics and Drug Docking Studies, J. Comp. Chem., 29(5), 795-808; Zachariae et al., 2009, “Side Chain Flexibilities in the Human Ether-a-go-go Related Gene Potassium Channel (hERG) Together with Matched-Pair Binding Studies Suggest a New Binding Mode for Channel Blockers,” J. Med. Chem., 52, 4266-4276; Boukharta et al., 2011, “Computer Simulations of Structure—Activity Relationships for hERG Channel Blockers,” Biochemistry, 50, 6146-6156; Durdagi et al., 2011, “Combined Receptor and Ligand-Based Approach to the Universal Pharmacophore Model Development for Studies of Drug Blockade to the hERG1 Pore Domain,” J. Chem. Inf. Model., 51, 463-474). However, the MD simulations in these studies are of short duration and do not provide vital information regarding the structural rearrangements that take place during voltage-induced gating transitions as well as the conformational dynamics of the ion channel. Therefore, an accurate atomistic approach to the problem of cardiotoxicity involving cardiac ion channels, including hERG1, is lacking in the art.

### 4. SUMMARY

Provided herein is the first comprehensive computational dynamic model of a membrane-bound ion channel that provides an atomistically detailed sampling of the physiologically relevant conformational states of the channel. In certain embodiments, the model is combined with an atomistically detailed high throughput screening algorithm of test compounds in silica to predict cardiotoxicity or risk of cardiotoxicity and to select for compounds with reduced risk of cardiotoxicity.

In certain embodiments, the model and methods disclosed herein can be used to screen a standardized panel of drugs showing that cardiotoxic compounds are blockers of the membrane-bound ion channels disclosed herein, whereas proven safe drugs do not block these channels. In certain embodiments, the model and methods disclosed herein can be used to screen thousands of new candidate drugs in silico, which greatly accelerates drug development and renders it safer and cheaper rather than having to test all compounds in biological assays.

In certain embodiments, the model and methods disclosed herein can be used to predict compounds that are cardiotoxic or are potentially cardiotoxic, or to identify which chemical moieties of the compounds may be implicated in the toxicity, so that drug developers may avoid using the molecule, or may structurally modify the molecule to address the toxicity concerns.

In certain embodiments, the ion channel used in the computational dynamic model is a tetrameric protein, surrounded by a membrane, ions, solvent or physiological fluid molecules, and optionally, other components of an in vivo system, to simulate the realistic environment of the channel. In certain embodiments, the duration of the computational dynamic model is of sufficient length (e.g., greater than 200 ns) to allow sampling of all physiologically relevant conformational states of the channel, including the open, closed and inactive states.

In certain embodiments, the atomistic detail afforded by the computational dynamic model and high throughput screening algorithm allows a determination of whether a test compound blocks the channel in its preferred binding conformation or conformations. In certain embodiments, a compound that blocks the channel in its preferred binding conformation or conformations is cardiotoxic.

In one aspect, provided herein, is a system and method for selecting a compound with reduced risk of cardiotoxicity. As an example, the system and method can include a computational dynamic model combined with a high throughput screening in silico that mimics ion channels associated with cardiotoxicity, for example, the human Ether-a-go-go Related Gene 1 (hERG1) channel, the hNaᵥ1.5 channel, and the hCaᵥ1.2 channel. Also provided herein are processor-implemented systems and methods for redesigning compounds that are predicted to be cardiotoxic based on the model and the high throughput screening.

As another example, a processor-implemented system and method includes the steps of: a) using structural information describing the structure of a cardiac ion channel protein; b) performing a molecular dynamics (MD) simulation of the protein structure; c) using a clustering algorithm to identify dominant conformations of the protein structure from the MD simulation; d) selecting the dominant conformations of the protein structure identified from the clustering algorithm; e) providing structural information describing conformers of one or more compounds; f) using a docking algorithm to dock the conformers of the one or more compounds of step e) to the dominant conformations of step d); g) identifying a plurality of preferred binding conformations for each of the combinations of protein and compound; h) optimizing the preferred binding conformations using MD; and i) determining if the compound blocks the ion channel of the protein in the preferred binding conformations; wherein one or more of the steps a) through i) are not necessarily executed in the recited order.

In certain embodiments, one or more of the steps a) through i) of the method are performed in the recited order.

In certain embodiments, the structural information of step a) is a three-dimensional (3D) structure. In certain embodiments, the structural information of step a) is an X-ray crystal structure, an NMR solution structure, or a homology model, as disclosed herein.

In certain embodiments, step e) comprises providing the chemical structure of a compound and determining the conformers of the compound. In certain embodiments, the chemical structure of the compound defines the conformers.

In certain embodiments, if the compound does not block the ion channel in the preferred binding conformations, the compound is selected for further development or possible use in humans, or to be used as a compound for further drug design.

In certain embodiments, steps a) through i) of the method are executed on one or more processors.

In certain embodiments, the cardiac ion channel protein is a membrane-bound protein. In certain embodiments, the cardiac ion channel protein is voltage-gated. In certain embodiments, the cardiac ion channel protein is a sodium, calcium, or potassium ion channel protein. In certain embodiments, the cardiac ion channel protein is a potassium ion channel protein. In certain embodiments, the potassium ion channel protein is hERG1. In certain embodiments, the hERG1 channel is formed as a tetramer through the association of four monomer subunits. In certain embodiments, the potassium ion channel protein is flexible. In certain embodiments, the flexible potassium ion channel protein has greater than 100 variable-sized pockets within the monomer subunits or between the interaction sites of the monomers. In certain embodiments, the cardiac ion channel protein is a sodium ion channel protein. In certain embodiments, the sodium ion channel protein is hNaᵥ1.5. In certain embodiments, the cardiac ion channel protein is a calcium ion channel protein. In certain embodiments, the calcium ion channel protein is hCaᵥ1.2.

In certain embodiments, the compound is capable of inhibiting hepatitis C virus (HCV) infection. In certain embodiments, the compound is an inhibitor of HCV NS3/4A protease, an inhibitor of HCV NS5B polymerase, or an inhibitor of HCV NS5a protein.

In certain embodiments, the structural information of step a) is a three-dimensional (3D) structure. In certain embodiments, the structural information of step a) is an X-ray crystal structure, an NMR solution structure, or a homology model.

In certain embodiments, the structural information of step a) is subjected to energy minimization (EM) prior to performing the MD simulation of step b). In certain embodiments, the MD simulation of step b) incorporates implicit or explicit solvent molecules and ion molecules. In certain embodiments, the MD simulation of step b) incorporates a hydrated lipid bilayer with explicit phospholipid, solvent and ion molecules. In certain embodiments, the MD simulation uses an AMBER force field, a CHARMM force field, or a GROMACS force field. In certain embodiments, the duration of the MD simulation of step b) is greater than 200 ns. In certain embodiments, the duration of the MD simulation of step b) is 200 ns.

In certain embodiments, the docking algorithm of step f) is DOCK or AutoDock.

In certain embodiments, the MD of step h) uses NAMD software.

In certain embodiments, the method further comprises the step of calculating binding energies for each of the combinations of protein and compound in the corresponding optimized preferred binding conformations. In certain embodiments, the method further comprises the step of selecting for each of the combinations of protein and compound the lowest calculated binding energy in the optimized preferred binding conformations, and outputting the selected calculated binding energies as the predicted binding energies for each of the combinations of protein and compound.

In another aspect, provided herein, is a method for predicting cardiotoxicity or risk of cardiotoxicity of a compound.

In certain embodiments of the methods disclosed herein, if the compound does not block the ion channel in the preferred binding conformations, the compound is predicted to have reduced risk of cardiotoxicity. In certain embodiments, if the compound is predicted to have reduced risk of cardiotoxicity, the compound is selected for further development or possible use in humans, or to be used as a compound for further drug design.

In certain embodiments of the methods disclosed herein, if the compound blocks the ion channel in the preferred binding conformations, the compound is predicted to be cardiotoxic. In certain embodiments, if the compound is predicted to be cardiotoxic, the compound is not selected for further clinical development or for use in humans.

In another aspect, provided herein is a method for chemically modifying a compound that is predicted to be cardiotoxic.

In certain embodiments of the methods disclosed herein, if the compound blocks the ion channel in one of the preferred binding conformations, the method further comprises the step of using a molecular modeling algorithm to chemically modify or redesign the compound such that it does not block the ion channel in any of the preferred binding conformations. In certain embodiments, the method further comprises repeating steps e) through i) for the modified compound.

In another aspect, provided herein are biological methods for testing the cardiotoxicity of the compound or modified compound in an in vitro biological assay or in vivo in a wild type animal or a transgenic animal model.

In certain embodiments, the method further comprises testing the cardiotoxicity of the compound or modified compound in an in vitro biological assay. In certain embodiments, the in vitro biological assay comprises high throughput screening of ion channel and transporter activities. In certain embodiments, the in vitro biological assay comprises high throughput screening of potassium ion channel and transporter activities. In certain embodiments, the in vitro biological assay is a hERG1 channel inhibition assay. In certain embodiments, the in vitro biological assay is a FluxOR™ potassium ion channel assay. In certain embodiments, the FluxOR™ potassium channel assay is performed on HEK 293 cells stably expressing hERG1 or mouse cardiomyocyte cell line HL-1 cells. In certain embodiments, the in vitro biological assay comprises electrophysiology measurements in single cells. In certain embodiments, the electrophysiology measurements in single cells comprise patch clamp measurements. In certain embodiments, the single cells are Chinese hamster ovary cells stably transfected with hERG1. In certain embodiments, the in vitro biological assay is a Cloe Screen IC₅₀ hERG1 Safety assay.

In certain embodiments, the method further comprises testing the cardiotoxicity of the compound or modified compound in vivo by measuring ECG in a wild type animal, for example a wild type mouse, or a transgenic animal model, for example, a transgenic mouse model expressing human hERG1.

In another aspect, provided herein is a processor-implemented system is provided for designing a compound in order to reduce risk of cardiotoxicity. The system includes one or more computer-readable mediums, a grid computing system, and a data structure. The one or more computer-readable mediums are for storing protein structural information representative of a cardiac ion channel protein and for storing compound structural information describing conformers of the compound. The grid computing system includes a plurality of processor-implemented compute nodes and a processor-implemented central coordinator, said grid computing system receiving the stored protein structural information and the stored compound structural information from the one or more computer-readable mediums. Said grid computing system uses the received protein structural information to perform molecular dynamics simulations for determining configurations of target protein flexibility over a simulation length of greater than 50 ns. The molecular dynamics simulations involve each of the compute nodes determining forces acting on an atom based upon an empirical force field that approximates intramolecular forces, where numerical integration is performed to update positions and velocities of atoms. The central coordinator forms molecular dynamic trajectories based upon the updated positions and velocities of the atoms as determined by each of the compute nodes. Said grid computing system configured to: cluster the molecular dynamic trajectories into dominant conformations of the protein, execute a docking algorithm that uses the compound's structural information in order to dock the compound's conformers to the dominant conformations of the protein, and identify a plurality of preferred binding conformations for each of the combinations of protein and compound based on information related to the docked compound's conformers. The data structure is stored in memory which includes information about the one or more of the identified plurality of preferred binding conformations blocking the ion channel of the protein. Based upon the information about blocking the ion channel, the compound is redesigned in order to reduce risk of cardiotoxicity.

In another aspect, provided herein, is a computer-implemented system for selecting a compound with reduced risk of cardiotoxicity which includes one or more data processors and a computer-readable storage medium encoded with instructions for commanding the one or more data processors to execute certain operations. The operations include: a) using structural information describing the structure of a cardiac ion channel protein; b) performing a molecular dynamics (MD) simulation of the protein structure; c) using a clustering algorithm to identify dominant conformations of the protein structure from the MD simulation; d) selecting the dominant conformations of the protein structure identified from the clustering algorithm; e) providing structural information describing conformers of one or more compounds; f) using a docking algorithm to dock the conformers of the one or more compounds of step e) to the dominant conformations of step d); g) identifying a plurality of preferred binding conformations for each of the combinations of protein and compound; h) optimizing the preferred binding conformations using MD; and i) determining if the compound blocks the ion channel of the protein in the preferred binding conformations. If the compound blocks the ion channel in the preferred binding conformations, the compound is predicted to be cardiotoxic. If the compound does not block the ion channel in the preferred binding conformations, the compound is predicted to have reduced risk of cardiotoxicity. Based on a prediction that the compound has reduced risk of cardiotoxicity, the compound is selected.

In certain embodiments, a computer-implemented system for selecting a compound with reduced risk of cardiotoxicity includes: one or more computer memories and one or more data processors. The one or more computer memories are for storing a single computer database having a database schema that contains and interrelates protein-structural-information fields, compound-structural-information fields, and preferred-binding-conformation fields. The protein-structural-information fields are contained within the database schema and configured to store protein structural information representative of a cardiac ion channel protein. The compound-structural-information fields are contained within the database schema and are configured to store compound structural information describing conformers of one or more compounds. The preferred-binding-conformation fields are contained within the database schema and are configured to store information related to one or more preferred binding conformations for each combination of protein and compound determined based at least in part on information in the protein-structural-information fields and the compound-structural-information fields. The one or more data processors are configured to: process a database query that operates over data related to the protein-structural-information fields, the compound-structural-information fields, and the preferred-binding-conformation fields and determine whether the one or more compounds are cardiotoxic by using information in the preferred-binding-conformation fields.

In certain embodiments, a non-transitory computer-readable storage medium is provided for storing data for access by a compound-selection program which is executed on a data processing system. The storage medium includes a protein-structural-information data structure, a candidate-compound-structural-information data structure, a molecular-dynamics-simulations data structure, a dominant-conformations data structure, and a binding-conformations data structure. The protein-structural-information data structure has access to information stored in a database and includes protein structural information representative of a cardiac ion channel protein. The candidate-compound-structural-information data structure has access to information stored in the database and includes compound structural information describing conformers of one or more compounds. The molecular-dynamics-simulations data structure has access to information stored in the database and includes configuration information of target protein flexibility determined by performing molecular dynamics simulations on the protein structural information. The dominant-conformations data structure has access to information stored in the database and is determined by using a first clustering algorithm based at least in part on the configuration information of target protein flexibility. The binding-conformations data structure has access to information stored in the database and includes information related to one or more combinations of protein and compound determined by using a docking algorithm based at least in part on the compound structural information and the one or more dominant conformations, one or more preferred binding conformations being determined by using a second clustering algorithm based at least in part on the information related to the one or more combinations of protein and compound. A compound is selected if the compound does not block the ion channel in the preferred binding conformations.

### 5. BRIEF DESCRIPTION OF TILE FIGURES

FIGS. 1A and 1B: System block diagrams for selecting a compound that has reduced risk of cardiotoxicity. Processes illustrated in the system block diagrams (1A) and (1B) are: Target Preparation (includes, e.g., combined de novo/homology protein modeling of hERG), Ligand Collection Preparation (includes, e.g., translation of the 2D information of the ligand into a 3D representative structure), Ensemble Generation (includes, e.g., Molecular Dynamics simulations, principal component analysis, and iterative clustering), Docking (includes, e.g., docking and iterative clustering), MD Simulations on Selected Complexes (includes, e.g., Molecular Dynamics simulations and preliminary ranking of docking hits), Rescoring using MM-PBSA (includes, e.g., binding free energy calculation and rescoring of top hits), and Experimental Testing (includes, e.g., hERG1 channel inhibition studies in mammalian cells, Fluxor™ potassium channel assays in mammalian cells, and electrocardiograpy to test anti-arrhythmic activity in wild type mice or transgenic mice expressing hERG). The top hits from the Rescoring step can act as positive controls for the next phase screening. The Ensemble Generation, Docking, MD Simulations on Selected Complexes, and Rescoring using MM-PBSA steps may be performed on a supercomputer, for example, the “IBM Blue Gene/Q” supercomputer system at the Health Sciences Center for Computational Innovation, University of Rochester (e.g., as shown in the block diagram (1B)).

FIG. 2: Representation of hERG1 monomer subunit showing the S1-S6 helices.

FIG. 3: Representation of the α and β-subunits of a complete VGSC.

FIG. 4: A snapshot of the molecular dynamics simulation trajectory showing a model of hERG1 monomer subunit. Shown in the model are the S1-S4 helices that form a voltage sensor domain (VSD) that senses transmembrane potential and is coupled to a central K⁺-selective pore domain. Also shown are the outer helix (S5) and inner helix (S6) that together coordinate the pore helix and selectivity filter that senses transmembrane potential and is coupled to the central pore domain.

FIGS. 5A and 5B: A snapshot of the molecular dynamics simulation trajectory showing a model of hERG1 tetramer; top (5A) and side (5B) views.

FIG. 6: hERG1 tetramer in MD unit cell with phospholipid bilayer, waters of hydration, and ions.

FIG. 7: Plot of Cα RMSD values versus MD simulation time for hERG1.

FIGS. 8A-8C: Example of non-blocker: Aspirin bound to hERG1 tetramer (8A); bound Aspirin (8B) showing only the binding pocket; bound Aspirin (yellow) aligned with bound 1-naphthol (red) (8C) showing that the two compounds overlap in the binding pocket, but do not block the channel.

FIGS. 9A and 9B: Example of a blocker: BMS-986094 bound to hERG1 tetramer (9A); bound BMS-986094 (9B) showing only the binding pocket.

FIG. 10: hERG1 channel inhibition (IC₅₀ determination) in mammalian cells.

FIGS. 11A-11D: Percentage inhibition of hERG activity in CHO cells using patchclamp assay after incubation with test compounds for 5 minutes: (11A) astemizole; (11B) BMS-986094; (11C) 1-naphthol (1-NP); and (11D) 2-amino-6-O-methyl-2′C-methyl guanosine (MG).

FIGS. 12A-12D: FluxOR™ potassium channel assay in mammalian cells: (12A) vehicle; (12B) astemizole; (12C) 1-naphthol (1-NP); and (12D) BMS-986094.

FIG. 13: RMSD of the main MD simulation for the hERG channel.

FIG. 14: Atomic fluctuations of the hERG channel residues. Analysis for the four monomers are shown revealing that the residues that are close to the C-terminal are more rigid (residues 613 to 668) compared to the N-terminal region; whereas the outer portion of the channel (residues 483 to 553) showed higher flexibility for monomer 1 and 4 compared to those in the other monomers. Notably, monomer 4 was more rigid compared to the rest of the monomer for residues 573 to 603.

FIG. 15: Atomic fluctuations of the permeation pore residues. Residues that constitute the permeation pore and the inner cavity showed almost the same behavior.

FIG. 16: Average electron density profiles over the last 300 ns.

FIG. 17: Average electron density profiles over the last 300 ns. The ions' electron densities are extremely small compared to those of the water and lipid systems (see FIG. 15), however the ions' distributions, show in the panel, reveal greater selectivity toward potassium ions compared to chlorine, with a little bulb of potassium within the permeation pore of the channel.

FIGS. 18A-18E: Principal component analysis (PCA)—Eigenvalues focused on half of cavity. The magnitudes of the dominant eigenvectors decay exponentially with the dominant eigenvector and have a significantly higher magnitude compared to the rest of the Eigenvectors.

FIG. 19: Clustering analysis. Clustering analysis was performed on the same residues used for PCA from each monomer. To predict the optimal number of clusters for the whole 500 ns MD trajectory, the average linkage algorithm for different number of clusters ranging from 5 to 300 were used, and two clustering metrics—the DBI and the SSR/SST—were observed. The optimal number is expected when a plateau in SSR/SST coincides with a local minimum for the DBI. This condition was observed at a cluster count of forty-five (45).

FIG. 20: Forty-five (45) dominant conformations for the hERG channel.

FIG. 21: Backbone dynamics of the hERG cavity. The 45 dominant conformations for the hERG channel spanned significant backbone conformational dynamics that was captured using the clustering methodology used.

FIG. 22: Orientations of the side chains of the residues constituting the hERG cavity. Similar to their backbone dynamics, the side chains of the residues forming the hERG cavity explored a significant number of different orientations.

FIG. 23: Docking protocol (stage 1). The first identified preferred ligand binding locations used an ensemble-based blind docking with the 45 dominant conformations involving the whole cavity.

FIG. 24: Docking protocol (stage 2). The top hits of stage 1 guided the selection towards one half of the cavity, where more accurate docking was performed using all hERG structures

FIG. 25: Distance versus energy for twenty-two (22) tested compounds.

FIG. 26: Binding locations of acetaminophen within the hERG cavity.

FIG. 27: Binding modes for acetaminophen. The lowest energy binding mode (˜−19 kcal/mol) is within ˜10 Å of the nearest Thr623 residue.

FIG. 28: Binding modes for astemizole. The lowest binding energy (˜−52 kcal/mol) is within 2 Å of the nearest Thr623 residue.

FIG. 29: Binding modes for BMS-986094. The lowest binding energy (˜−45 kcal/mol) is within 2 Å of the nearest Thr623 residue.

FIGS. 30A-30K: Concentration-response curves of eleven (11) hERG channel blockers using Predictor™ hERG fluorescence polarization assay. Sixteen (16) concentrations of test compounds half-log separated were used as competitors in the Predictor™ hERG binding assay. All data (mean±SEM; n=12) were analyzed using a nonlinear sigmoidal dose-response. Calculated IC₅₀ values for tested compounds are shown above each panel: (30A) astemizole; (30B) pimozide; (30C) cisapride; (30D) haloperidol; (30E) terfenadine; (30F) amiodarone; (30G) E-4031; (30H) quinidine; (30I) celecoxib; (30J) rofecoxib; and (30K) BMS-986094.

FIGS. 31A-31K: hERG electrophysiology patch-clamp concentration-response curves of eleven (11) hERG channel blockers. Stable hERG expressing AC10 cardiomyocytes were patch clamped and potassium-ion currents through hERG were measured for seven (7) concentrations of tested compounds. Data (mean±SEM; n=6) were normalized to the control (0.01% DMSO vehicle) and analyzed using nonlinear sigmoidal dose-response (variable slope). Calculated IC₅₀ values for tested compounds are shown above each panel: (31A) astemizole; (31B) pimozide; (31C) cisapride; (31D) haloperidol; (31E) terfenadine; (31F) amiodarone; (31G) E-4031; (31H) quinidine; (31I) celecoxib; (31J) rofecoxib; and (31K) BMS-986094.

FIGS. 32A-32K: Concentration-response curves of eleven (11) hERG channel non-blockers using Predictor™ hERG fluorescence polarization assay. Sixteen (16) concentrations of test compounds half-log separated were used as competitors in the Predictor™ hERG binding assay: (32A) trimethoprim; (32B) resveratrol; (32C) ranitidine; (32D) aspirin; (32E) naproxen; (32F) ibuprofen; (32G) diclofenac Na; (32H) acetaminophen; (32I) guanosine; (32J) 2-amino-6-O-methyl-2′C-methyl guanosine (MG); and (32K) 1-naphthol (1-NP).

FIGS. 33A-33K: Concentration-response curves of eleven (11) hERG channel non-blockers. Stable hERG expressing AC10 cardiomyocytes were patch clamped and potassium-ion currents through hERG were measured for seven (7) concentrations of tested compound. Data (mean±SEM; n=6) were normalized to the control (0.01% DMSO vehicle). (33A) trimethoprim; (33B) resveratrol; (33C) ranitidine; (33D) aspirin; (33E) naproxen; (33F) ibuprofen; (33G) diclofenac Na; (33H) acetaminophen; (33I) guanosine; (33J) 2-amino-6-O-methyl-2′C-methyl guanosine (MG); and (33K) 1-naphthol (1-NP).

FIGS. 34A and 34B: A 3D structure for the complete hNaᵥ1.5 generated homology model; side (34A) and top (34B) views.

FIG. 35: Top view of a 3D structure of a relaxed MD snapshot for the generated model of Naᵥ1.5, showing a sodium ion trapped within the inner selectivity filter in a region of negative potential.

FIG. 36: Eleven (11) dominant conformations for hNaᵥ1.5.

FIG. 37: Ranolazine binding site in hNaᵥ1.5.

FIG. 38: Example block diagram depicting an environment wherein users can interact with a grid computing environment.

FIG. 39: Example block diagram depicting hardware and software components for the grid computing environment.

FIG. 40: Example schematics of data structures utilized by a compound-selection system.

FIG. 41: Example block diagram depicting a compound-selection system provided on a stand-alone computer for access by a user.

### 6. DETAILED DESCRIPTION

### 6.1 Definitions

As used herein, the term “cardiotoxic” or “cardiotoxicity” refers to having a toxic effect on the heart, for example, by a compound having a deleterious effect on the action of the heart, due to poisoning of the cardiac muscle or of its conducting system. In certain embodiments, long Q-T syndrome or “LQTS” is an aspect of cardiotoxicity.

As used herein, the term “reduced cardiotoxicity” refers to a favorable cardiotoxicity profile with reference to, for example, one or more ion channel proteins disclosed herein. In certain embodiments, a “ligand,” “compound” or “drug,” as defined herein, has reduced cardiotoxicity if it does not inhibit one or more ion channel proteins (e.g., potassium ion channel proteins, such as hERG or hERG1, sodium ion channel proteins, such as hNaᵥ1.5, and calcium ion channel proteins, such as hCaᵥ1.2) disclosed herein. In certain embodiments, a ligand, compound or drug has reduced cardiotoxicity if it does not inhibit “hERG” or “hERG1.” In certain embodiments, a ligand, compound or drug has reduced cardiotoxicity if it does not inhibit “hNaᵥ1.5.” In certain embodiments, a ligand, compound or drug has reduced cardiotoxicity if it does not inhibit “hCaᵥ1.2.” In certain embodiments, a ligand, compound or drug has reduced cardiotoxicity if it does not block, obstruct, or partially obstruct, the channel of one or more ion channel proteins (e.g., potassium ion channel proteins, such as hERG or hERG1, sodium ion channel proteins, such as hNaᵥ1.5, and calcium ion channel proteins, such as hCaᵥ1.2) disclosed herein. In certain embodiments, a ligand, compound or drug has reduced cardiotoxicity if it is not a “blocker,” as defined herein. In certain embodiments, a ligand, compound or drug has reduced cardiotoxicity if it does not block, obstruct, or partially obstruct, the hERG or hERG1 channel, as defined herein. In certain embodiments, a ligand, compound or drug has reduced cardiotoxicity if it does not block, obstruct, or partially obstruct, the hNaᵥ1.5 channel, as defined herein. In certain embodiments, a ligand, compound or drug has reduced cardiotoxicity if it does not block, obstruct, or partially obstruct, the hCaᵥ1.2 channel, as defined herein. In certain embodiments, a ligand, compound or drug has reduced cardiotoxicity if it is not a blocker of hERG or hERG1. In certain embodiments, a ligand, compound or drug has reduced cardiotoxicity if it is not a blocker of hNaᵥ1.5. In certain embodiments, a ligand, compound or drug has reduced cardiotoxicity if it is not a blocker of hCaᵥ1.2.

As used herein, the terms “reducing risk” or “reduced risk” as it applies to cardiotoxicity (e.g., “reduced risk of cardiotoxicity”) refers to observable results which tend to demonstrate an improved cardiotoxicity profile with reference to, for example, one or more ion channel proteins disclosed herein. In certain embodiments, a ligand, compound or drug has a reduced risk of cardiotoxicity if it does not block, obstruct, or partially obstruct, the channel of one or more ion channel proteins disclosed herein. In certain embodiments, a ligand, compound or drug, has a reduced risk of cardiotoxicity if it is not a blocker. In certain embodiments, a ligand, compound or drug has a reduced risk of cardiotoxicity if it does not block, obstruct, or partially obstruct, the hERG or hERG1 channel. In certain embodiments, a ligand, compound or drug has a reduced risk of cardiotoxicity if it is not a blocker of hERG or hERG1. In certain embodiments, a ligand, compound or drug has a reduced risk of cardiotoxicity if it does not block, obstruct, or partially obstruct, the hNaᵥ1.5 channel. In certain embodiments, a ligand, compound or drug has a reduced risk of cardiotoxicity if it is not a blocker of hNaᵥ1.5. In certain embodiments, a ligand, compound or drug has a reduced risk of cardiotoxicity if it does not block, obstruct, or partially obstruct, the hCaᵥ1.2 channel. In certain embodiments, a ligand, compound or drug has a reduced risk of cardiotoxicity if it is not a blocker of hCaᵥ1.2. In certain embodiments, risk is reduced if there is at least about 10%, 20%, 30%, 40%, 50%, 60%, 70%, 80%, 90% or 100% decrease (as measured, e.g., by IC₅₀ data from in vitro biological assays) in the ability of the ligand, compound or drug to inhibit the channel of one or more ion channel proteins disclosed herein. In certain embodiments, a reduction in the risk of cardiotoxicity by at least about 90% indicates that cardiotoxicity has been eliminated with respect to one or more of the ion channel proteins disclosed herein. In certain embodiments, a ligand, compound or drug has a reduced risk of cardiotoxicity if its calculated binding energies, as defined herein, to the one or more ion channel proteins, disclosed herein, compare to physiologically relevant concentrations of greater than or equal to 100 μM. In certain embodiments, a ligand, compound or drug has a reduced risk of cardiotoxicity if its “selectivity index (SI),” as defined herein, is greater than about 100, about 1000 or about 10,000.

As used herein, the term “LQTS” as used herein refers to long Q-T syndrome, a group of disorders that increase the risk for sudden death due to an abnormal heartbeat. The QT of LQTS refers to an interval between two points (Q and T) on the common electrocardiogram (ECG, EKG) used to record the electrical activity of the heart. This electrical activity, in turn, is the result of ions such as sodium and potassium passing through ion channels in the membranes surrounding heart cells. A prolonged QT interval indicates an abnormality in electrical activity that leads to irregularities in heart muscle contraction. One of these irregularities is a specific pattern of very rapid contractions (tachycardia) of the lower chambers of the heart called torsade de pointes, a type of ventricular tachycardia. The rapid contractions, which are not effective in pumping blood to the body, result in a decreased flow of oxygen-rich blood to the brain. This can result in a sudden loss of consciousness (syncope) and death.

As used herein, the term “lipid bilayer” refers to the basic structure of a cell membrane comprising a double layer of phospholipid molecules. Lipid bilayers are particularly impermeable to ions (such as potassium ions, sodium ions, and calcium ions).

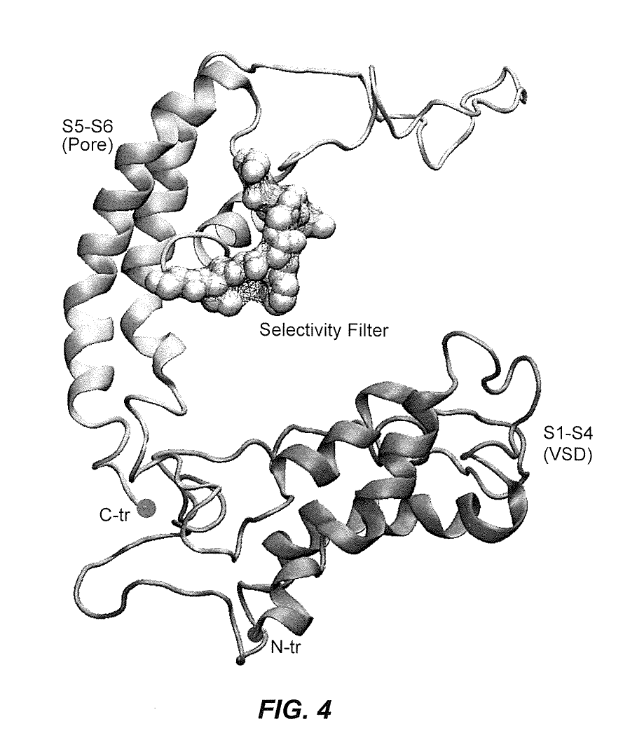

As used herein, the term “hydrated lipid bilayer” refers to a lipid bilayer in the presence of water molecules. As used herein, the term “ion channel” or “ion channel protein,” refers to a membrane bound protein that acts as a pore (e.g., permeation pore) in a cell membrane and permits the selective passage of ions (such as potassium ions, sodium ions, and calcium ions), by means of which electrical current passes in and out of the cell. Such ion channel proteins include, for example, potassium ion channel proteins, such as hERG or hERG1, sodium ion channel proteins, such as hNaᵥ1.5, and calcium ion channel proteins, such as hCaᵥ1.2. In certain embodiments, an ion channel or ion channel protein comprises an inner cavity and a selectivity filter (see, e.g., FIG. 4) through which the ions pass. In certain embodiments, the terms “permeation pore,” “pore” and “channel” are used interchangeably.

One of ordinary skill in the art will understand that there are several possible ways to classify ion channels into groups, as described herein (see, e.g., TABLES 1-4). For instance, (1) by gating, where the conformational change between closed, open and inactivated of the channels is called gating, where (a) voltage-gated ion channels are controlled by the voltage gradient across the membrane (e.g., voltage-gated potassium channels, voltage-gated sodium channels, and voltage-gated calcium channels, etc.), and (b) ligand-gated ion channels are regulated by conformation changes induced by ligands; and (2) by ion, where channels can be categorized by the species of ions passing through those gates (e.g., potassium ion channels, sodium ion channels, and calcium ion channels, etc.)

As used herein, the term “transporter activity,” when used in relation to an “ion channel” or “ion channel protein,” refers to the movement of an ion across a cell membrane.

As used herein, the term “potassium ion channel” or “potassium ion channel protein,” refers to an ion channel that permits the selective passage of potassium ions (K⁺).

As used herein, the term “sodium ion channel” or “sodium ion channel protein,” refers to an ion channel that permits the selective passage of sodium ions (Na⁺).

As used herein, the term “calcium ion channel” or “calcium ion channel protein,” refers to an ion channel that permits the selective passage of calcium ions (Ca⁺²).

As used herein, the term “membrane bound protein” refers to any protein that is bound to a cell membrane under physiological pH and salt concentrations. In certain embodiments, binding of the membrane bound protein can be either by direct binding to the phospholipid bilayer or by binding to a protein, glycoprotein, or other intermediary that is bound to the membrane.

As used herein, the term “voltage-gated channel” or “voltage-gated ion channel” refers to a class of transmembrane ion channels that are activated by changes in electrical potential difference near the channel. In certain embodiments, the voltage-gated ion channel is a voltage-gated potassium channel. In certain embodiments, the voltage-gated ion channel is a voltage-gated sodium channel. In certain embodiments, the voltage-gated ion channel is a voltage-gated calcium channel.

As used herein, the term “voltage-gated potassium channel,” “voltage-gated potassium ion channel” or “voltage-gated potassium ion (K⁺) channel” is a transmembrane channel specific for potassium and sensitive to voltage changes in the cell's membrane potential.

As used herein, the term “voltage-gated sodium channel,” “voltage-gated sodium ion channel” or “voltage-gated sodium ion (Na⁺) channel” is a transmembrane channel specific for sodium and sensitive to voltage changes in the cell's membrane potential.

As used herein, the term “voltage-gated calcium channel,” “voltage-gated calcium ion channel” or “voltage-gated calcium ion (Ca⁺²) channel” is a transmembrane channel specific for calcium and sensitive to voltage changes in the cell's membrane potential.

As used herein, the term “human ERG,” “human ERG1,” “hERG” or “hERG1” refers to the human Ether-a-go-go-Related Gene of chromosome 7q36.1 that codes for a protein known as Kv11.1, the alpha (a) subunit of potassium voltage-gated channel, subfamily H (eag-related), member 2. It will be known to those of ordinary skill in the art that hERG or hERG1 can be also called different names, such as erg1, ERG1, KCNH2, Kv11.1, LQT2, and SQT1. See, for example, “KCNH2 potassium voltage-gated channel, subfamily H (eag-related), member 2 [Homo sapiens (human)],” Gene ID: 3757, updated 3-Nov-2013, http://www.ncbi.nlm.nih.gov/gene/3757. As used herein, the term “hERG” or “hERG1” refers interchangeably to the gene and gene product, Kv11.1. It will further be known to those of ordinary skill in the art the functional hERG1 channel is comprised of a homo-tetramer of four identical monomer α-subunits (e.g., the hERG1 monomer subunits), as disclosed herein.

As used herein, the term “human Naᵥ1.5” or “hNaᵥ1.5” or refers to the sodium ion channel protein that in humans is encoded by the SCN5A gene. It will be known to those of ordinary skill in the art the functional hNaᵥ1.5 channel is comprised of single pore forming α subunit and ancillary β subunits, where the a subunit consists of four structurally homologous transmembrane domains designated DI-DIV, as disclosed herein.

As used herein, the term “human Caᵥ1.2” or “hCaᵥ1.2” refers to the calcium ion channel protein that in humans is encoded by the CACNA1C gene. It will be known to those of ordinary skill in the art the functional hCaᵥ1.2 channel is comprised of α-1, α-2/δ and β subunits in a 1:1:1 ratio, as disclosed herein.

As used herein, the term “protein structure” refers to the three-dimensional structure of a protein. The structure of a protein is characterized in four ways. The primary structure is the order of the different amino acids in a protein chain, whereas the secondary structure consists of the geometry of chain segments in forms such as helices or sheets. The tertiary structure describes how a protein folds in on itself; the quaternary structure of a protein describes how different protein monomers or monomer subunits fold in relation to each other.

As used herein, the term “monomer” or “monomer subunit” refers to one of the proteins making up the quaternary structure of a macromolecule.

As used herein, the term “tetramer” refers to a macromolecule, for example, a protein macromolecule, made up of four monomer subunits. An example of a tetramer is the hERG1 tetramer comprised of four hERG1 monomer subunits. Tetrameric assembly into a quaternary structure is required for the formation of the functional hERG1 channel.

As used herein, the term “structural information” refers to the three dimensional structural coordinates of the atoms within a macromolecule, for example, a protein macromolecule such as hERG1.

As used herein, the term “three-dimensional (3D) structure” refers to the Cartesian coordinates corresponding to an atom's spatial relationship to other atoms in a macromolecule, for example, a protein macromolecule such as hERG1. Structural coordinates may be obtained using NMR techniques, as known in the art, or using x-ray crystallography as is known in the art. Alternatively, structural coordinates can be derived using molecular replacement analysis or homology modeling. Various software programs allow for the graphical representation of a set of structural coordinates to obtain a three dimensional representation of a molecule or molecular complex.

As used herein, the term “dynamics,” when applied to macromolecule and macromolecular structures, refers to the relative motion of one part of the molecular structure with respect to another. Examples include, but are not limited to: vibrations, rotations, stretches, domain motions, hinge motions, sheer motions, torsion, and the like. Dynamics may also include motions such as translations, rotations, collisions with other molecules, and the like.

As used herein, the term “flexible” or “flexibility,” when applied to macromolecule and macromolecular structures defined by structural coordinates, refers to a certain degree of internal motion about these coordinates, e.g., it may allows for bond stretching, rotation, etc.

As used herein, the term “molecular modeling algorithm” refers to computational approaches for structure prediction of macromolecule. For instance, these may comprise comparative protein modeling methods including homology modeling methods or protein threading modeling methods, and may further comprise ab initio or de novo protein modeling methods, or a combination of any such approaches.

As used herein, the term “computational dynamic model” refers to a computer-based model of a system that provides dynamics information of the system. In certain embodiments, when the system is a biological system, for example, a macromolecule or macromolecular structure, the computational dynamic model provides information of the vibrations, rotations, stretches, domain motions, hinge motions, sheer motions, torsion, translations, rotations, collisions with other molecules, and the like, exhibited by the system in the relevant time scale examined by the model.

As used herein, the term “molecular simulation” refers to a computer-based method to predict the functional properties of a system, including, for example, thermodynamic properties, thermochemical properties, spectroscopic properties, mechanical properties, transport properties, and morphological information. In certain embodiments, the molecular simulation is a molecular dynamics (MD) simulation.

As used herein, the term “molecular dynamics simulation” (MD or MD simulation) refers to computer-based molecular simulation methods in which the time evolution of a set of interacting atoms, groups of atoms or molecules, including macromolecules, is followed by integrating their equations of motion. The atoms or molecules are allowed to interact for a period of time, giving a view of the motion of the atoms or molecules. Thus, the MD simulation may be used to sample conformational space over time to predict the lowest energy, most populated, members of a conformational ensemble. Typically, the trajectories of atoms and molecules are determined by numerically solving the Newton's equations of motion for a system of interacting particles, where forces between the particles and potential energy are defined by molecular mechanics force fields. However, MD simulations incorporating principles of quantum mechanics and hybrid classical-quantum mechanics simulations are also available and may be contemplated herein.

As used herein, the term “scalable molecular dynamics” (scalable MD) refers to computational simulation methods which are suitably efficient and practical when applied to large situations (e.g., a large input data set, a large number of outputs or users, or a large number of participating nodes in the case of a distributed system). In certain embodiments, the methods disclosed herein use scalable MD for simulation of the large systems disclosed herein, for example, the hERG1 tetramer in a hydrated lipid bilayer with explicit phospholipid, solvent and ion molecules, free, or bound to ligand.

As used herein, the term “energy minimization” (EM) refers to computational methods for computing stable states of interacting atoms, groups of atoms or molecules, including macromolecules, corresponding to global and local minima on their potential energy surface. Starting from a non-equilibrium molecular geometry, EM employs the mathematical procedure of optimization to move atoms so as to reduce the net forces (the gradients of potential energy) on the atoms until they become negligible.

As used herein, the term “ligand,” “compound” and “drug” are used interchangeably, and refer to any small molecule which is capable of binding to a target receptor, such as an ion channel protein, for example, hERG1. In certain embodiments, the ligand, compound or drug is a “blocker,” as defined herein.

As used herein, the term “dock” or “docking” refers to using a model of a ligand and receptor to simulate association of the ligand-receptor at a proximity sufficient for at least one atom of the ligand to be within bonding distance of at least one atom of the receptor. The term is intended to be consistent with its use in the art pertaining to molecular modeling. A model included in the term can be any of a variety of known representations of a molecule including, for example, a graphical representation of its three-dimensional structure, a set of coordinates, set of distance constraints, set of bond angle constraints or set of other physical or chemical properties or combinations thereof. In certain embodiments, the ligand is a compound, for example a small molecule, and the receptor is a protein macromolecule, for example, hERG1.

As used herein, the term “docking algorithm” refers to computational approaches for predicting the energetically preferred orientation of a ligand to a receptor when bound or docked to each other to form a stable ligand-receptor complex. Knowledge of the preferred orientation in turn may be used to predict the strength of association or binding affinity between ligand and receptor using, for example, scoring functions. In certain embodiments, the ligand is a compound, for example a small molecule, and the receptor is a protein macromolecule, for example, hERG1.

As used herein, the term “drug design” or “rational drug design” refers to methods of processes of discovering new drugs based on the knowledge of a biological target. In certain embodiments of the methods disclosed herein, the biological target is a protein macromolecule, for example, hERG1. Those of ordinary skill in the art will appreciate that drug design that relies on the knowledge of the three-dimensional structure of the biomolecular target is also known as “structure-based drug design.” Those of ordinary skill in the art will also understand that drug design may rely on computer modeling techniques, which type of modeling is often referred to as “computer-aided drug design.” As used herein, the term “binding conformations” refers to the orientation of a ligand to a receptor when bound or docked to each other.

As used herein, the term “dominant conformation” or “dominant conformations” refers to most highly populated orientation(s) of a ligand to a receptor when bound or docked to each other. In certain embodiments, when applied to the trajectories of the MD simulations disclosed herein, a clustering algorithm is used to determine the “dominant conformation” or “dominant conformations.”

As used herein, the term “clustering algorithm,” when applied to a trajectory of the MD simulations disclosed herein, refers to computational approaches for grouping similar conformations in the trajectory into clusters.

As used herein, the term “preferred binding conformation” refers to the energetically preferred orientation of a ligand to a receptor when bound or docked to each other to form a stable ligand-receptor complex.

As used herein, the term “optimized preferred binding conformation” refers to the energetically preferred orientation of a ligand to a receptor when bound or docked to each other to form a stable ligand-receptor complex, following optimizing the preferred binding conformations using MD.

As used herein, the term “binding energies” is understood to mean the “free energy of binding” (ΔG°) of a ligand to a receptor. Under equilibrium conditions, this binding energy is equal to ΔG°=−T ΔS'=−R T Log (K_{eq}), where the symbols have their customary meanings. In certain embodiments, the methods disclosed herein allow calculation of binding energies for various ligand-receptor complexes, for example, various compounds bound to hERG1.

As used herein, the terms “IC₅₀” and “IC₉₀” refer to the concentration of a compound that reduces (e.g., inhibits) the enzyme activity of a target by 50% and 90%, respectively. The term “IC₅₀” generally describes the inhibitory concentration of the compound. Typically, measurements of IC₅₀ and IC₉₀ are made in vitro. In certain embodiments, where the target is a secondary biological target, for example, a membrane-bound ion channel implicated in cardiac cytotoxicity (e.g., hERG1), IC₅₀ is the concentration at which 50% inhibition is observed. IC₅₀'s and IC₉₀'s can be measured according to any method known to one of ordinary skill in the art.

As used herein, the terms “EC₅₀” and “EC₉₀” refer to the plasma concentration/AUC of a compound that reduces (e.g., inhibits) the cellular effect resulting from enzyme activity by 50% and 90%, respectively. The term “EC₅₀” generally describes the effective dose of the compound. In certain embodiments, where the target is a primary biological target, for example, a viral protein (e.g., HCV NS3/4A protease, HCV NS5B polymerase, or HCV NS5a protein), EC₅₀ is the dose of the compound that inhibits viral replication by 50%. EC₅₀'s and EC₉₀'s can be measured according to any method known to one of ordinary skill in the art.

As used herein, the terms “CC₅₀” and “CC₉₀” refer to the concentration of a compound that reduces the number of viable cells (e.g., kills the cells) compared to that for untreated controls, by 50% and 90%, respectively. The term “CC₅₀” generally describes the concentration of the compound that is cytotoxic to cells. In certain embodiments, where the target is a primary biological target, for example, a viral protein (e.g., HCV NS3/4A protease, HCV NS5B polymerase, or HCV NS5a protein), CC₅₀ is the dose of the compound that is cytotoxic to uninfected cells. In certain embodiments, where the target is a secondary biological target, for example, a membrane-bound ion channel implicated in cardiac cytotoxicity (e.g., hERG1), CC₅₀ is the dose of the compound that is cytotoxic to heart cells. In certain embodiments, the methods disclosed herein select for compounds with reduced risk of cardiotoxicity, but which retain strong biological activity to their primary targets. For example, such compounds may have high EC₅₀ values for the secondary biological target (e.g., hERG1), high CC₅₀ values for uninfected cells, but low EC₅₀ values against the primary biological target (e.g., HCV NS3/4A protease, HCV NS5B polymerase, or HCV NS5a protein). CC₅₀'s and CC₉₀'s can be measured according to any method known to one of ordinary skill in the art.

As used herein, the term “selectivity index” (“SI”) refers to the ratio of the CC₅₀ for cardiotoxicity with reference to a secondary biological target (e.g., hERG1) and to uninfected cells compared to the EC₅₀ for effectiveness with reference to a primary biological target (e.g., HCV N53/4A protease, HCV NS5B polymerase, or HCV NS5a protein). In certain embodiments, the methods disclosed herein select for compounds that display SI values greater than about 100. In certain embodiments, the methods disclosed herein select for compounds that display SI values greater than about 1000. In certain embodiments, the methods disclosed herein select for compounds that display SI values greater than about 10,000.

As used herein, the term “blocker” refers to a compound that blocks, obstructs, or partially obstructs, an ion channel, for example, the hERG1 ion channel. In certain embodiments, a blocker is a cardiotoxic compound.

As used herein, the term “non-blocker” refers to a compound that does not block, obstruct, or partially obstruct, an ion channel, for example, the hERG1 ion channel.

As used herein, “high throughput screening” refers to a method that allows a researcher to quickly conduct chemical, genetic or pharmacological tests, the results of which provide starting points for drug design and for understanding the interaction or role of a particular biochemical process in biology. In certain embodiments, the high throughput screening is through virtual in silico screening, for example, using computer-based methods or computer-based models.

As used herein, the terms “processor” and “central processing unit” or “CPU” are used interchangeably and refer to a device that is able to read a program from a computer memory (e.g., ROM or other computer memory) and perform a set of steps according to the program.

As used herein, the terms “computer memory” and “computer memory device” refer to any storage media readable by a computer processor. Examples of computer memory include, but are not limited to, RAM, ROM, computer chips, digital video discs (DVD), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks.

### 6.2 Embodiments

Provided herein is the first comprehensive computational dynamic model of a membrane-bound ion channel that provides an atomistically detailed sampling of the physiologically relevant conformational states of the channel. In certain embodiments, the model is combined with an atomistically detailed high throughput screening algorithm of test compounds in silico to predict cardiotoxicity and to select for compounds with reduced cardiotoxicities.

As an example, these models and algorithms may be used to mimic one of the most important ion channels associated with cardiotoxicity, namely the human Ether-a-go-go Related Gene 1 (hERG1) channel. The hERG1 channel is expressed in the heart as well as in various brain regions, smooth muscle cells, endocrine cells, and a wide range of tumor cell lines. However, its role in the heart is the one that has been well characterized and extensively studied for two main reasons. First, it is directly involved in long QT syndrome (LQTS), a disorder associated with an increased risk of ventricular arrhythmias and ultimately sudden cardiac death. Secondly, the blockade of hERG1 by prescription medications causes drug-induced QT prolongation that shares the same risk of sudden cardiac arrest like LQTS.

The hERG1 channel is formed as a tetramer through the association of four monomer subunits. In the computer-based molecular simulations and molecular models disclosed herein, the tetramer structure is surrounded by a membrane, ions, and water molecules to simulate the realistic environment of the channel. Further, the computer-based molecular simulations disclosed herein are of sufficient length (e.g., greater than 200 ns) to allow sampling of all physiologically relevant conformational states of the hERG1 channel, including the open, closed, inactive states, and any conformation in between these states. This robust molecular simulation of the hERG1 channel allows an atomistically detailed high throughput screening in silico to test compounds and determine if the compounds block the channel, and therefore are likely to exhibit cardiotoxicity. The atomistic detail of the molecular simulation also allows a chemical modification or redesign of those compounds found to block the channel. The redesigned compound may then be re-tested in an iterative fashion using the methods disclosed herein.

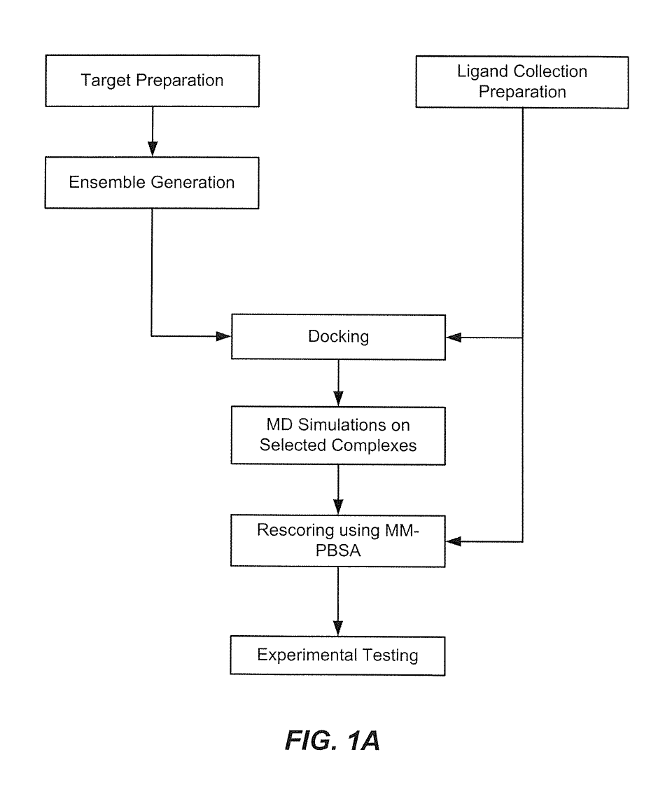

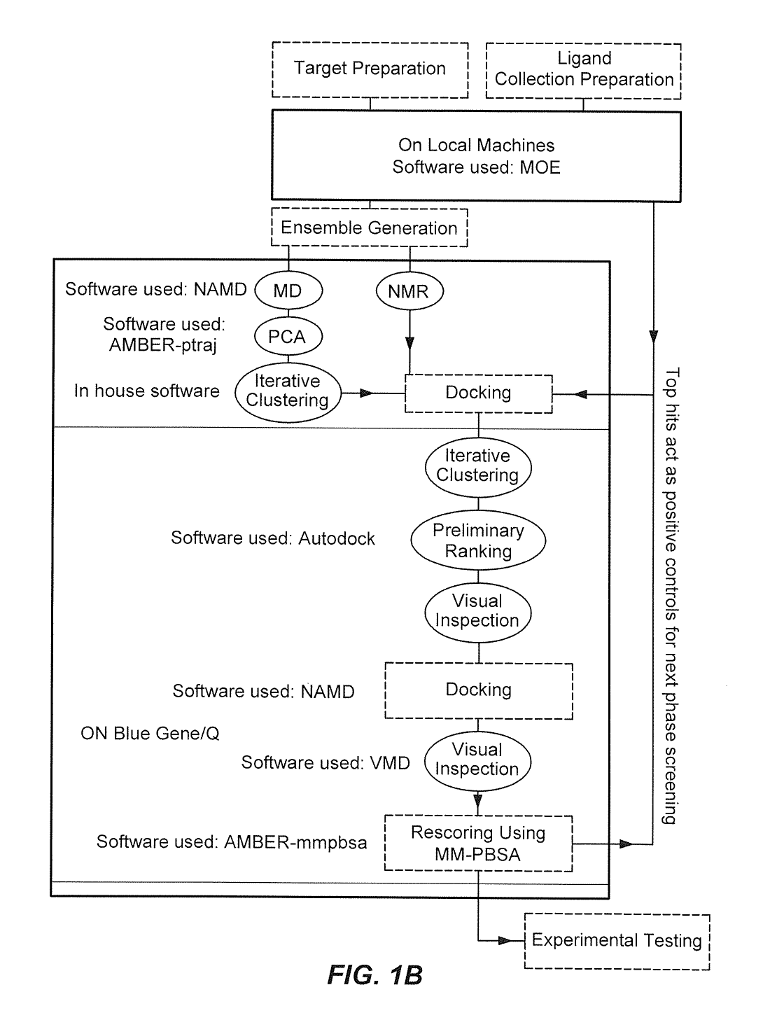

An overview of the methods disclosed herein, including computer-based molecular simulations and molecular models, is provided in FIGS. 1A and 1B. As an example, the methods can include: using structural information describing the structure of a target protein, for example, an ion channel protein; performing a molecular simulation of the protein structure to identify and select the dominant conformations of the protein structure; using a computer algorithm to dock the conformers of the one or more compounds to the dominant conformations of the protein structure; identifying the preferred binding conformations for each of the combinations of protein and compound; and optimizing the preferred binding conformations using molecular simulations to determine if the compound blocks the ion channel in the preferred binding conformations.

In certain embodiments, if the compound blocks the ion channel, the compound is predicted to be cardiotoxic. In certain embodiments, if the compound is predicted to be cardiotoxic, the compound is not selected for further clinical development or for use in humans. In certain embodiments, the compound may be structurally modified or redesigned to address cardiotoxicity.

In certain embodiments, if the compound does not block the ion channel, the compound is predicted to have reduced risk of cardiotoxicity. In certain embodiments, if the compound is predicted to have reduced risk of cardiotoxicity, the compound is selected for further development or possible use in humans, or to be used as a compound for further drug design.

Individual elements and steps of the methods disclosed herein are now described.

6.2.1 Ion Channels

In certain embodiments, the method comprises the step of using structural information describing the structure of a target receptor, for example, an ion channel protein.

In certain embodiments, the target receptor is an ion channel that regulates cardiac function, for example, a cardiac ion channel disclosed herein. In certain embodiments, the cardiac ion channel is a membrane-bound protein. In certain embodiments, the cardiac ion channel is voltage-gated. In certain embodiments, the cardiac ion channel is a sodium, calcium, or potassium ion channel. In certain embodiments, the cardiac ion channel is a potassium ion channel.

Those of ordinary skill in the art will appreciate that ion channels, for example, a cardiac ion channel disclosed herein, may have two fundamental properties, ion permeation and gating. Ion permeation describes the movement through the open channel. The selective permeability of ion channels to specific ions is a basis of classification of ion channels (e.g., Na⁺, K⁺ and Ca²⁺ channels). Gating is the mechanism of opening and closing of ion channels. Voltage-dependent gating is the most common mechanism of gating observed in ion channels.

The following TABLE 1 describes cardiac ion channels, any of which may be associated with cardiotoxicity.

TABLE 1
Cardiac Ion Channels

| | | | | |
|---|---|---|---|---|
| | | Activation | | |
| Current | Description | Mechanism | Clone | Gene |

α-subunit of action potential inward current channels

| | | | | |
|---|---|---|---|---|
| I_{Na} | Sodium | Voltage, | Naᵥ1.5 | SCN5A |
| | current | depolarization | | |
| I_{Ca,L} | Calcium | Voltage, | Caᵥ1.2 | CACNA1C |
| | current, | depolarization | | |
| | L-type | | | |
| I_{Ca,T} | Calcium | Voltage, | Caᵥ3.1/3.2 | CACNA1G |
| | current, | depolarization | | |
| | T-type | | | |

α-subunit of action potential outward (K⁺) current channels

| | | | | |
|---|---|---|---|---|
| I_{to,f} | Transient | Voltage, | KV 4.2/4.3 | KCND2/3 |
| | outward | depolarization | | |
| | current, | | | |
| | fast | | | |
| I_{to,s} | Transient | Voltage, | KV 1.4/1.7/3.4 | KCNA4 |
| | outward | depolarization | | |
| | current, | | | |
| | slow | | | |
| I_{Kur} | Delayed | Voltage, | KV 1.5/3.1 | KCNA5 |
| | rectifier, | depolarization | | |
| | ultrarapid | | | |
| I_{Kr} | Delayed | Voltage, | HERG | KCNH2 |
| | rectifier, | depolarization | | |
| | fast | | | |
| I_{Ks} | Delayed | Voltage, | KVLQT1 | KCNQ1 |
| | rectifier, | depolarization | | |
| | slow | | | |
| I_{Kl} | Inward | Voltage, | Kir 2.1/2.2 | KCNJ2/12 |
| | rectifier | depolarization | | |
| I_{KATP} | ADP activated | [ADP]/[ATP]↑ | Kir 6.2 (SURA) | KCNJ11 |
| | K + current | | | |
| I_{KAch} | Muscarinic- | Acetylcholine | Kir 3.1/3.4 | KCNJ3/5 |
| | gated | | | |
| | K + current | | | |
| I_{KP} | Background | Metabolism, | TWK-1/2 | KCNK1/6 |
| | current | stretch | | |
| I_{FP} | Pacemaker | Voltage, | HCN2/4 | HCN2/4 |
| | current | hyperpolarization | | |

See, e.g., Grant, 2009, “Cardiac Ion Channels,” Circulation: Arrhythmia and Electrophysiology,” 2 (2): 185-194.

Cardiac K⁺ channels fall into three broad categories: voltage-gated (Iₜₒ, I_{Kur}, I_{Kr}, and I_{Ks}), inward rectifier channels (I_{K1}, I_{KAch}, and I_{KATP}), and the background K⁺ currents (TASK-1, TWIK-1/2).

In certain embodiments, the ion channel is selected from any one of the cardiac ion channels of TABLE 1.

In certain embodiments, the ion channel is a potassium ion channel protein selected from TABLE 1.

In certain embodiments, the ion channel is a sodium ion channel protein selected from TABLE 1.

In certain embodiments, the ion channel is a calcium ion channel protein selected from TABLE 1.

In certain embodiments, the ion channel comprises the amino acid sequence selected from group consisting of SEQ ID NO: 2, 4, and 6, as disclosed herein.

The following TABLE 2 describes potassium ion channels, any of which may be associated with cardiotoxicity.

TABLE 2
Potassium Ion Channels

| | | Previous | | |
|---|---|---|---|---|
| Approved | Approved Name | Symbols | Synonyms | Chromosome |
| KCNA1 | potassium voltage-gated | AEMK | Kv1.1, RBK1, | 12p13 |
| | channel, shaker-related | | HUK1, MBK1 | |
| | subfamily, member 1 (episodic | | | |
| | ataxia with myokymia) | | | |
| KCNA2 | potassium voltage-gated | | Kv1.2, HK4 | 1p13 |
| | channel, shaker-related | | | |
| | subfamily, member 2 | | | |
| KCNA3 | potassium voltage-gated | | Kv1.3, MK3, HLK3, | 1p13.3 |
| | channel, shaker-related | | HPCN3 | |
| | subfamily, member 3 | | | |
| KCNA4 | potassium voltage-gated | KCNA4L | Kv1.4, HK1, | 11p14 |
| | channel, shaker-related | | HPCN2 | |
| | subfamily, member 4 | | | |
| KCNA5 | potassium voltage-gated | | Kv1.5, HK2, | 12p13 |
| | channel, shaker-related | | HPCN1 | |
| | subfamily, member 5 | | | |
| KCNA6 | potassium voltage-gated | | Kv1.6, HBK2 | 12p13 |
| | channel, shaker-related | | | |
| | subfamily, member 6 | | | |
| KCNA7 | potassium voltage-gated | | Kv1.7, HAK6 | 19q13.3 |
| | channel, shaker-related | | | |
| | subfamily, member 7 | | | |
| KCNA10 | potassium voltage-gated | | Kv1.8 | 1p13.1 |
| | channel, shaker-related | | | |
| | subfamily, member 10 | | | |
| KCNAB1 | potassium voltage-gated | | AKR6A3, | 3q26.1 |
| | channel, shaker-related | | KCNA1B, | |
| | subfamily, beta member 1 | | hKvBeta3, Kvb1.3, | |
| | | | hKvb3 | |
| KCNAB2 | potassium voltage-gated | | AKR6A5, | 1p36.3 |
| | channel, shaker-related | | KCNA2B, | |
| | subfamily, beta member 2 | | HKvbeta2.1, | |
| | | | HKvbeta2.2 | |
| KCNAB3 | potassium voltage-gated | | AKR6A9, KCNA3B | 17p13.1 |
| | channel, shaker-related | | | |
| | subfamily, beta member 3 | | | |
| KCNB1 | potassium voltage-gated | | Kv2.1 | 20q13.2 |
| | channel, Shab-related | | | |
| | subfamily, member 1 | | | |
| KCNB2 | potassium voltage-gated | | Kv2.2 | 8q13.2 |
| | channel, Shab-related | | | |
| | subfamily, member 2 | | | |
| KCNC1 | potassium voltage-gated | | Kv3.1 | 11p15 |
| | channel, Shaw-related | | | |
| | subfamily, member 1 | | | |
| KCNC2 | potassium voltage-gated | | Kv3.2 | 12q14.1 |
| | channel, Shaw-related | | | |
| | subfamily, member 2 | | | |
| KCNC3 | potassium voltage-gated | SCA13 | Kv3.3 | 19q13.33 |
| | channel, Shaw-related | | | |
| | subfamily, member 3 | | | |
| KCNC4 | potassium voltage-gated | C1orf30 | Kv3.4, HKSHIIIC | 1p21 |
| | channel, Shaw-related | | | |
| | subfamily, member 4 | | | |
| KCND1 | potassium voltage-gated | | Kv4.1 | Xp11.23 |
| | channel, Shal-related | | | |
| | subfamily, member 1 | | | |
| KCND2 | potassium voltage-gated | | Kv4.2, RK5, | 7q31 |
| | channel, Shal-related | | KIAA1044 | |
| | subfamily, member 2 | | | |
| KCND3 | potassium voltage-gated | | Kv4.3, KSHIVB | 1p13.2 |
| | channel, Shal-related | | | |
| | subfamily, member 3 | | | |
| KCNE1 | potassium voltage-gated | | minK, ISK, JLNS2, | 21q22.1-q22.2 |
| | channel, Isk-related family, | | LQT5 | |
| | member 1 | | | |
| KCNE1L | KCNE1-like | | | Xq22.3 |
| KCNE2 | potassium voltage-gated | | MiRP1, LQT6 | 21q22.1 |
| | channel, Isk-related family, | | | |
| | member 2 | | | |
| KCNE3 | potassium voltage-gated | | MiRP2, HOKPP | 11q13.4 |
| | channel, Isk-related family, | | | |
| | member 3 | | | |
| KCNE4 | potassium voltage-gated | | MiRP3 | 2q36.1 |
| | channel, Isk-related family, | | | |
| | member 4 | | | |
| KCNF1 | potassium voltage-gated | KCNF | Kv5.1, kH1, IK8 | 2p25 |
| | channel, subfamily F, | | | |
| | member 1 | | | |
| KCNG1 | potassium voltage-gated | KCNG | Kv6.1, kH2, K13 | 20q13 |
| | channel, subfamily G, | | | |
| | member 1 | | | |
| KCNG2 | potassium voltage-gated | | Kv6.2, KCNF2 | 18q23 |
| | channel, subfamily G, | | | |
| | member 2 | | | |
| KCNG3 | potassium voltage-gated | | Kv6.3 | 2p21 |
| | channel, subfamily G, | | | |
| | member 3 | | | |
| KCNG4 | potassium voltage-gated | | Kv6.4 | 16q24.1 |
| | channel, subfamily G, | | | |
| | member 4 | | | |
| KCNH1 | potassium voltage-gated | | Kv10.1, eag, h-eag, | 1q32.2 |
| | channel, subfamily H (eag- | | eag1 | |
| | related), member 1 | | | |
| KCNH2 | potassium voltage-gated | LQT2 | Kv11.1, BERG, | 7q36.1 |
| | channel, subfamily H (eag- | | erg1 | |
| | related), member 2 | | | |
| KCNH3 | potassium voltage-gated | | Kv12.2, BEC1, elk2 | 12q13 |
| | channel, subfamily H (eag- | | | |
| | related), member 3 | | | |
| KCNH4 | potassium voltage-gated | | Kv12.3, elk1 | 17q21 |
| | channel, subfamily H (eag- | | | |
| | related), member 4 | | | |
| KCNH5 | potassium voltage-gated | | Kv10.2, H-EAG2, | 14q23.1 |
| | channel, subfamily H (eag- | | eag2 | |
| | related), member 5 | | | |
| KCNH6 | potassium voltage-gated | | Kv11.2, erg2, | 17q23.3 |
| | channel, subfamily H (eag- | | HERG2 | |
| | related), member 6 | | | |
| KCNH7 | potassium voltage-gated | | Kv11.3, HERG3, | 2q24.3 |
| | channel, subfamily H (eag- | | erg3 | |
| | related), member 7 | | | |
| KCNH8 | potassium voltage-gated | | Kv12.1, elk3 | 3p24.3 |
| | channel, subfamily H (eag- | | | |
| | related), member 8 | | | |
| KCNJ1 | potassium inwardly-rectifying | | Kir1.1, ROMK1 | 11q24 |
| | channel, subfamily J, member 1 | | | |
| KCNJ2 | potassium inwardly-rectifying | | Kir2.1, IRK1, LQT7 | 17q24.3 |
| | channel, subfamily J, member 2 | | | |
| KCNJ3 | potassium inwardly-rectifying | | Kir3.1, GIRK1, | 2q24.1 |
| | channel, subfamily J, member 3 | | KGA | |
| KCNJ4 | potassium inwardly-rectifying | | Kir2.3, HIR, HRK1, | 22q13.1 |
| | channel, subfamily J, member 4 | | hIRK2, IRK3 | |
| KCNJ5 | potassium inwardly-rectifying | | Kir3.4, CIR, | 11q24 |
| | channel, subfamily J, member 5 | | KATP1, GIRK4, | |
| | | | LQT13 | |
| KCNJ6 | potassium inwardly-rectifying | KCNJ7 | Kir3.2, GIRK2, | 21q22.1 |
| | channel, subfamily J, member 6 | | KATP2, BIR1, | |
| | | | hiGIRK2 | |
| KCNJ8 | potassium inwardly-rectifying | | Kir6.1 | 12p12.1 |
| | channel, subfamily J, member 8 | | | |
| KCNJ9 | potassium inwardly-rectifying | | Kir3.3, GIRK3 | 1q23.2 |
| | channel, subfamily J, member 9 | | | |
| KCNJ10 | potassium inwardly-rectifying | | Kir4.1, Kir1.2 | 1q23.2 |
| | channel, subfamily J, | | | |
| | member 10 | | | |
| KCNJ11 | potassium inwardly-rectifying | | Kir6.2, BIR | 11p15.1 |
| | channel, subfamily J, | | | |
| | member 11 | | | |
| KCNJ12 | potassium inwardly-rectifying | KCNJN1 | Kir2.2, Kir2.2v, | 17p11.1 |
| | channel, subfamily J, | | IRK2, hIRK1 | |
| | member 12 | | | |
| KCNJ13 | potassium inwardly-rectifying | | Kir7.1, Kir1.4 | 2q37 |
| | channel, subfamily J, | | | |
| | member 13 | | | |
| KCNJ14 | potassium inwardly-rectifying | | Kir2.4, IRK4 | 19q13 |
| | channel, subfamily J, | | | |
| | member 14 | | | |
| KCNJ15 | potassium inwardly-rectifying | KCNJN1 | Kir4.2, Kir1.3, | 21q22.2 |
| | channel, subfamily J, | | IRKK | |
| | member 15 | | | |
| KCNJ16 | potassium inwardly-rectifying | | Kir5.1, BIR9 | 17q24.3 |
| | channel, subfamily J, | | | |
| | member 16 | | | |
| KCNJ18 | potassium inwardly-rectifying | | KIR2.6, TTPP2 | 17 |
| | channel, subfamily J, | | | |
| | member 18 | | | |
| KCNK1 | potassium channel, subfamily | | K2p1.1, DPK, | 1q42-q43 |
| | K, member 1 | | TWIK-1 | |
| KCNK2 | potassium channel, subfamily | | K2p2.1, TREK-1 | 1q41 |
| | K, member 2 | | | |
| KCNK3 | potassium channel, subfamily | | K2p3.1, TASK, | 2p23 |
| | K, member 3 | | TASK-1 | |
| KCNK4 | potassium channel, subfamily | | K2p4.1, TRAAK | 11q13 |
| | K, member 4 | | | |
| KCNK5 | potassium channel, subfamily | | K2p5.1, TASK-2 | 6p21 |
| | K, member 5 | | | |
| KCNK6 | potassium channel, subfamily | | K2p6.1, TWIK-2 | 19q13.1 |
| | K, member 6 | | | |
| KCNK7 | potassium channel, subfamily | | K2p7.1 | 11q13 |
| | K, member 7 | | | |
| KCNK9 | potassium channel, subfamily | | K2p9.1, TASK3, | |
| | K, member 9 | | TASK-3 | |
| KCNK10 | potassium channel, subfamily | | K2p10.1, TREK-2, | 14q31 |
| | K, member 10 | | TREK2 | |
| KCNK12 | potassium channel, subfamily | | THIK-2, THIK2, | 2p16.3 |
| | K, member 12 | | K2p12.1 | |
| KCNK13 | potassium channel, subfamily | | K2p13.1, THIK-1, | 14q32.11 |
| | K, member 13 | | THIK1 | |
| KCNK15 | potassium channel, subfamily | | K2p15.1, | 20q13.2 |
| | K, member 15 | | dJ781B1.1, KT3.3, | |
| | | | KIAA0237, | |
| | | | TASK5, TASK-5 | |
| KCNK16 | potassium channel, subfamily | | K2p16.1, TALK-1, | 6p21.2-p21.1 |
| | K, member 16 | | TALK1 | |
| KCNK17 | potassium channel, subfamily | | K2p17.1, TALK-2, | 6p21 |
| | K, member 17 | | TALK2, TASK4, | |
| | | | TASK-4 | |
| KCNK18 | potassium channel, subfamily | | K2p18.1, TRESK-2, | 10q26.11 |
| | K, member 18 | | TRESK2, TRESK, | |
| | | | TRIK | |
| KCNMA1 | potassium large conductance | SLO | KCa1.1, mSLO1 | 10q22 |
| | calcium-activated channel, | | | |
| | subfamily M, alpha member 1 | | | |
| KCNMB1 | potassium large conductance | | hslo-beta | 5q34 |
| | calcium-activated channel, | | | |
| | subfamily M, beta member 1 | | | |
| KCNMB2 | potassium large conductance | | | 3q26.32 |
| | calcium-activated channel, | | | |
| | subfamily M, beta member 2 | | | |
| KCNMB3 | potassium large conductance | KCNMB2, | | 3q26.3-q27 |
| | calcium-activated channel, | KCNMBL | | |
| | subfamily M beta member 3 | | | |
| KCNMB3P1 | potassium large conductance | KCNMB2L, | KCNMB3L1 | 22q11.1 |
| | calcium-activated channel, | KCNMBLP, | | |
| | subfamily M, beta member 3 | KCNMB3L | | |
| | pseudogene 1 | | | |
| KCNMB4 | potassium large conductance | | | 12q15 |
| | calcium-activated channel, | | | |
| | subfamily M, beta member 4 | | | |
| KCNN1 | potassium intermediate/small | | KCa2.1, hSK1 | 19p13.1 |
| | conductance calcium-activated | | | |
| | channel, subfamily N, | | | |
| | member 1 | | | |
| KCNN2 | potassium intermediate/small | | KCa2.2, hSK2 | 11q13.4 |
| | conductance calcium-activated | | | |
| | channel, subfamily N, | | | |
| | member 2 | | | |
| KCNN3 | potassium intermediate/small | | KCa2.3, hSK3, | 1q21.3 |
| | conductance calcium-activated | | SKCA3 | |
| | channel, subfamily N, | | | |
| | member 3 | | | |
| KCNN4 | potassium intermediate/small | | KCa3.1, hSK4, | 19q13.2 |
| | conductance calcium-activated | | hKCa4, hIKCa1 | |
| | channel, subfamily N, | | | |
| | member 4 | | | |
| KCNQ1 | potassium voltage-gated | LQT, | Kv7.1, KCNA8, | 11p15.5 |
| | channel, KQT-like subfamily, | KCNA9 | KVLQT1, JLNS1, | |
| | member 1 | | LQT1 | |
| KCNQ2 | potassium voltage-gated | EBN, EBN1 | Kv7.2, ENB1, | 20q13.33 |
| | channel, KQT-like subfamily, | | BFNC, KCNA11, | |
| | member 2 | | HNSPC | |
| KCNQ3 | potassium voltage-gated | EBN2 | Kv7.3 | 8q24 |
| | channel, KQT-like subfamily, | | | |
| | member 3 | | | |
| KCNQ4 | potassium voltage-gated | DFNA2 | Kv7.4 | 1p34 |
| | channel, KQT-like subfamily, | | | |
| | member 4 | | | |
| KCNQ5 | potassium voltage-gated | | Kv7.5 | 6q14 |
| | channel, KQT-like subfamily, | | | |
| | member 5 | | | |
| KCNS1 | potassium voltage-gated | | Kv9.1 | 20q12 |
| | channel, delayed-rectifier, | | | |
| | subfamily S, member 1 | | | |
| KCNS2 | potassium voltage-gated | | Kv9.2 | 8q22 |
| | channel, delayed-rectifier, | | | |
| | subfamily S, member 2 | | | |
| KCNS3 | potassium voltage-gated | | Kv9.3 | 2p24 |
| | channel, delayed-rectifier, | | | |
| | subfamily S, member 3 | | | |
| KCNT1 | potassium channel, subfamily | | KCa4.1, KIAA1422 | 9q34.3 |
| | T, member 1 | | | |
| KCNT2 | potassium channel, subfamily | | KCa4.2, SLICK, | 1q31.3 |
| | T, member 2 | | SLO2.1 | |
| KCNU1 | potassium channel, subfamily | | KCa5.1, Slo3, | 8p11.2 |
| | U, member 1 | | KCNMC1, Kcnma3 | |
| KCNV1 | potassium channel, subfamily | | Kv8.1 | 8q23.2 |
| | V, member 1 | | | |
| KCNV2 | potassium channel, subfamily | | Kv8.2 | 9p24.2 |
| | V, member 2 | | | |

See, e.g., Potassium channels | HUGO Gene Nomenclature Committee, www.genenames.org/genefamilies/KCN, last visited Nov. 17, 2013.

In certain embodiments, the ion channel is selected from any one of the potassium ion channels of TABLE 2.

In certain embodiments, the ion channel is selected from any one of the members 1-8 of the potassium voltage-gated channel, subfamily H (eag-related), of TABLE 2.

In certain embodiments, the ion channel comprises the amino acid sequence selected from group consisting of SEQ ID NO: 2, 7, 8, 9, 10, 11, 12, and 13, as disclosed herein.

In certain embodiments, the ion channel is the Human Ether-a-go-go Related Gene 1 (hERG1) Channel, as described below.

In certain embodiments, the ion channel is the hNaᵥ1.5 voltage gated sodium channel, as described below.

In certain embodiments, the ion channel is the hCaᵥ1.2 voltage gated calcium channel, as described below.

6.2.2 Human Ether-a-go-go Related Gene 1 (hERG1) Channel

The hERG1 ion channel (also referred to as KCNH2 or Kv11.1) is an important element for the rapid component of the delayed rectified potassium currents (I_{Kr}) in cardiac myocytes, for the normal repolarization phase of the cardiac action potential (Curran et al., 1995, “A Molecular Basis for Cardiac-Arrhythmia; HERG Mutations Cause Long Qt Syndrome,” Cell, 80, 795-803; Tseng, 2001, “I(Kr): The hERG Channel,” J. Mol. Cell. Cardiol., 33, 835-49; Vandenberg et al., 2001, “HERG K [symbol] Channels: Friend and Foe,” Trends. Pharm. Sci. 22, 240-246). Loss of function mutations in hERG1 cause increased duration of ventricular repolarization, which leads to prolongation of the time interval between Q and T waves of the body surface electrocardiogram (long QT syndrome-LQTS) (Vandenberg et al., 2001; Splawski et al., 2000, “Spectrum of Mutations in Long-QT Syndrome Genes KVLQT1, HERG, SCN5A, KCNE1, and KCNE2,” Circulation, 102, 1178-1185; Witchel et al., 2000, “Familial and Acquired Long QT Syndrome and the Cardiac Rapid Delayed Rectifier Potassium Current, Clin. Exp. Pharmacol. Physiol., 27, 753-766). LQTS leads to serious cardiovascular disorders, such as tachyarrhythmia and sudden cardiac death.

The DNA and amino acid sequences for hERG are provided as SEQ ID NO: 1 and SEQ ID NO: 2, respectively.

A detailed atomic structure of the hERG1 gene product based on X-ray crystallography or NMR spectroscopy is not yet available, so structural details for hERG1 are based on analogy with other ion channels, computer homology models, pharmacology, and mutagenesis studies. For example, as described in EXAMPLE 1 below, the structure of hERG1 is based on combined de novo and homology protein modeling, as previously described (Durdagi et al., 2012, “Modeling of Open, Closed, and Open-Inactivated States of the HERG1 Channel: Structural Mechanisms of the State-Dependent Drug Binding,” J. Chem. Inf. Model., 52, 2760-2774). The structural information useful for the methods described herein is provided, for example, as a homology model, including wherein the homology model is represented by coordinates for a potassium ion channel protein (e.g., hERG1), as in Table A (see, e.g., EXAMPLE 1).

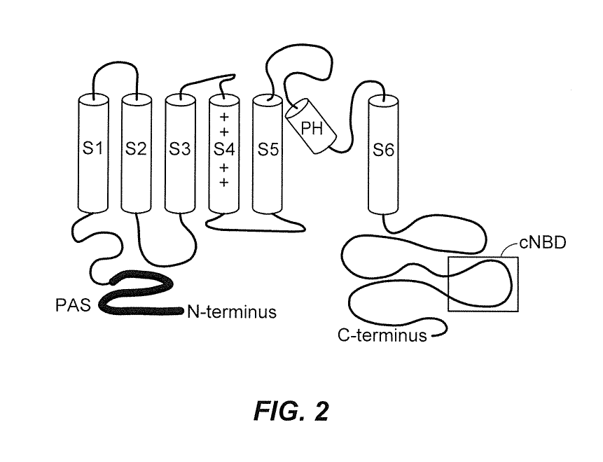

In homology models, the hERG1 gene product comprises a tetramer, with each monomer subunit containing six transmembrane helices (see FIG. 2). hERG1 is formed by coassembly of four monomer α-subunits, each of which has six transmembrane spanning α-helical segments (S1-S6). Within each hERG1subunit, the S1-S4 helices form a voltage sensor domain (VSD) that senses transmembrane potential and is coupled to a central K⁺-selective pore domain. Each pore domain is comprised of an outer helix (S5) and inner helix (S6) that together coordinate the pore helix and selectivity filter. The carboxy end of the pore helix and selectivity filter contain the highly conserved K channel signature sequence, which in hERG1 is Thr-Ser-Val-Gly-Phe-Gly. This sequence forms a narrow conduction pathway at the extracellular end of the pore in which K ions are coordinated by the backbone carbonyl oxygen atoms of the signature sequence residues.

Movements of the voltage-sensor domain enable the pore domain to open and close in response to changes in membrane potential. The drug binding site is contained within the central pore cavity of the pore domain, located below the selectivity filter and flanked by the four S6 helices (see FIG. 2) of the tetrameric channel.

Without being limited by any theory, in one aspect of the disclosure, the blocking of the central pore cavity or channel of hERG by a drug is a predictor of the cardiotoxicity of the drug. Undesired drug blockade of K⁺ ion flux in hERG1 can lead to long QT syndrome, eventually inducing fibrillation and arrhythmia. hERG1 blockade is a significant problem experienced during the course of many drug discovery programs.

6.2.3 Human Naᵥ1.5 Voltage Gated Sodium Channel

The Naᵥ1.5 voltage gated sodium channel (VGSC) is responsible for initiating the myocardial action potential and blocking Naᵥ1.5 through either mutations or its interactions with small molecule drugs or toxins have been associated with a wide range of cardiac diseases. These diseases include long QT syndrome 3 (LQT3), Brugada syndrome 1 (BRGDA1) and sudden infant death syndrome (SIDS).

The DNA and amino acid sequences for hNaᵥ1.5 are provided as SEQ ID NO: 3 and SEQ ID NO: 4, respectively.

A detailed atomic structure of the hNaᵥ1.5 gene product based on X-ray crystallography or NMR spectroscopy is not yet available, so structural details for hNaᵥ1.5 are based on analogy with other ion channels, computer homology models, pharmacology, and mutagenesis studies. The structural information useful for the methods described herein is provided, for example, as a homology model, including wherein the homology model is represented by coordinates for a sodium ion channel protein (e.g., hNaᵥ1.5), as in Table B (see, e.g., EXAMPLE 16).

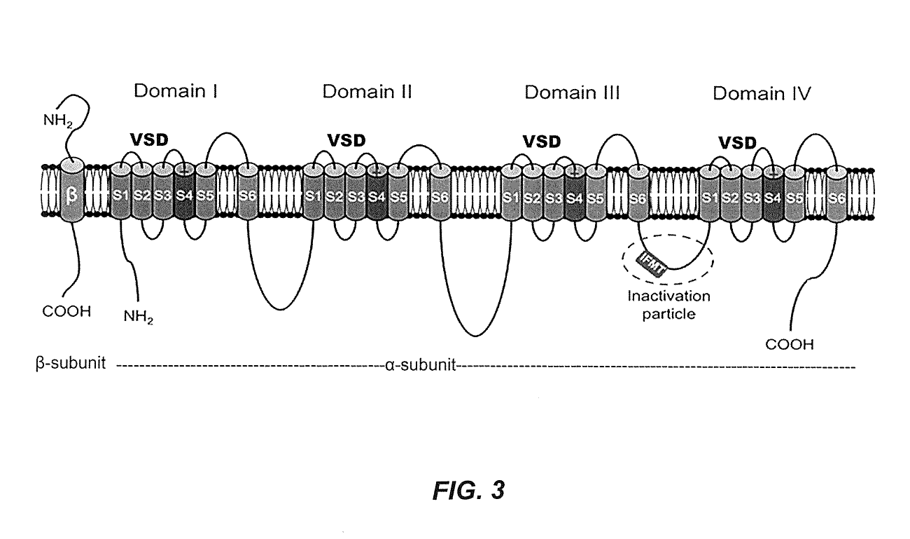

Eukaryotic VGSCs are hetero-tetramers in which the four domains (DI-IV; see FIG. 3) are different. DI comprises CYT1 (N-terminus) and TRM1, DII comprises TRM2, DIII comprises TRM3 and CYT4 (the inactivation gate), and DIV comprises TRM4 and CYT5 (C-terminus). The selectivity filter region as well as the selectivity specific residue in each TRM sub-domain are oriented inward toward the channel. Each TRM sub-domain is composed of six long helical segments (S1-S6). The first four segments (S1-S4) are grouped together in one side and are named as the voltage-sensing domain (VSD). The S4 segment is a 3₁₀ helix and is characterized by a highly conserved amino acid propensity of positively charged residues (Lys and Arg), usually called the “gating charges.” Some of these positively charged residues on S4 are held stabilized in the trans-membrane region through the formation of salt bridges with the negatively charged residues of S1-S3 (Asp and Glu) (Tiwari-Woodruff et al., 2000, “Voltage-Dependent Structural Interactions in the Shaker K(+) Channel,” J Gen Physiol 115: 123-138).

VGSCs generally share a common activation mechanism. A change in the membrane potential results in a conformational change and an outward movement of S4, allowing the activation of the channel and the passage of the captions through the channel's pore (Catterall, 2014, “Structure and Function of Voltage-Gated Sodium Channels at Atomic Resolution,” Exp Physiol 99: 35-51″). The last two helical segments from each domain (S5-S6) are usually referred to as the pore forming segments. The S5 helical segment is a long segment that extends horizontally from S4, through a linker, and then vertically through the trans-membrane region. A loop then connects S5 to two short helices named as the pore helices (P1 and P2). The S6 segment is connected to P2 through a short turn and extends vertically toward the intracellular part of the channel. A short turn connecting P1 and P2 contains the selectivity specific residues, which is uniquely conserved among VGSCs with the following arrangement (DEKA) splayed across the four domains and is known as the selectivity filter (D372, E898, K1419 and A1711). This DEKA selectivity filter is responsible for introducing the sodium selectivity over other mono/di-valent cations as has been shown previously by several experimental and computational mutational analyses (Lipkind et al., 2008, “Voltage-Gated Na Channel Selectivity: The Role of the Conserved Domain III Lysine Residue,” J Gen Physiol 131: 523-529). It has been shown that mutating the selectivity filter's residues not only affect the selectivity of the channel, but also the gating kinetics of the as well (Hilber, et al., 2005, “Selectivity Filter Residues Contribute Unequally to Pore Stabilization in Voltage-Gated Sodium Channels,” Biochemistry 44: 13874-13882).

Without being limited by any theory, in one aspect of the disclosure, the blocking of the central pore cavity or channel of hNaᵥ1.5 by a drug is a predictor of the cardiotoxicity of the drug. Undesired drug blockade of Na ion flux in hNaᵥ1.5 can lead to long QT syndrome, eventually inducing fibrillation and arrhythmia. Blockage of hNaᵥ1.5 is a significant problem experienced during the course of many drug discovery programs.

6.2.4 Human Caᵥ1.2 Voltage Gated Calcium Channel

The Caᵥ1.2 voltage gated calcium channel is also responsible for mediating the entry of calcium ions into excitable cells and blocking Caᵥ1.2 through either mutations or its interactions with small molecule drugs or toxins have been associated with a wide range of cardiac diseases. These diseases include long QT syndrome 3 (LQT3) and Brugada syndrome 1 (BRGDA1).

The DNA and amino acid sequences for hCaᵥ1.2 are provided as SEQ ID NO: 5 and SEQ ID NO: 6, respectively.

A detailed atomic structure of the hCaᵥ1.2 gene product based on X-ray crystallography or NMR spectroscopy is not yet available, so structural details for hCaᵥ1.2 are based on analogy with other ion channels, computer homology models, pharmacology, and mutagenesis studies. The structural information useful for the methods described herein is provided, for example, as a homology model, including wherein the homology model is represented by coordinates for a calcium ion channel protein (e.g., hCaᵥ1.2), as in Table C.

The global architecture of Caᵥs is composed of four basic components. The α1 subunit is located in the cell membrane and calcium ions can pass through. The auxiliary β, CaM and α2δ subunits bind with high affinity to the loops of domain I and II. Caᵥ α2δ is a single pass transmembrane subunit which is formed by two disulfide-linked proteins (Van Petegem et al., 2006, “The Structural Biology of Voltage-Gated Calcium Channel Function and Regulation,” Biochem Soc Trans 34(Pt 5): 887-93).

The transmembrane Caᵥ consists of four homologous repeats membranespanning domains (DI-IV). Each repeat is formed by six segments (S1-S6). The first 4 segments (S1-S4) are the voltage-segment domain and the last 2 segments (S5-S6) form the calcium-selective pore domain. The S4 segment contains positively charged residues and acts as a voltage sensors controlling gating. Channel activation is considered to be triggered by a conformational change in the voltage sensors leading to channel opening.

Without being limited by any theory, in one aspect of the disclosure, the blocking of the central pore cavity or channel of hCaᵥ1.2 by a drug is a predictor of the cardiotoxicity of the drug. Undesired drug blockade of Ca⁺² ion flux in hCaᵥ1.2 can lead to long QT syndrome, eventually inducing fibrillation and arrhythmia. Blockage of hCaᵥ1.2 is a significant problem experienced during the course of many drug discovery programs.

6.2.5 Computational Aspects

In certain aspects, provided herein are computational methods for selecting a compound that is not likely to be cardiotoxic.

In certain embodiments, the computational methods comprise a computational dynamic model. In certain embodiments, the computational dynamic model comprises a molecular simulation that samples conformational space over time. In certain embodiments, the molecular simulation is a molecular dynamics (MD) simulation.

In certain embodiments, the method comprising the steps of: a) using structural information describing the structure of an ion channel protein; b) performing a molecular dynamics (MD) simulation of the protein structure; c) using a clustering algorithm to identify dominant conformations of the protein structure from the MD simulation; d) selecting the dominant conformations of the protein structure identified from the clustering algorithm; e) providing structural information describing conformers of one or more compounds; f) using a docking algorithm to dock the conformers of the one or more compounds of step e) to the dominant conformations of step d); g) identifying a plurality of preferred binding conformations for each of the combinations of protein and compound; h) optimizing the preferred binding conformations using scalable MD; and i) determining if the compound blocks the ion channel of the protein in the preferred binding conformations; wherein one or more of the steps a) through i) are not necessarily executed in the recited order. In certain embodiments, the ion channel protein is a potassium ion channel protein.

In certain embodiments, the structural information of step a) is a three-dimensional (3D) structure. In certain embodiments, the structural information of step a) is an X-ray crystal structure, an NMR solution structure, or a homology model, as disclosed herein.

In certain embodiments, step e) comprises providing the chemical structure of a compound and determining the conformers of the compound. In certain embodiments, the chemical structure of the compound defines the conformers.

In certain embodiments, steps e) through i) comprise a high-throughput screening of the compounds to determine if they are “blockers” or “non-blockers.”

In certain embodiments, one or more of the steps a) through i) of the method are performed in the recited order.

In certain embodiments, steps a) through i) of the method are executed on one or more processors.

6.2.5.1 Structural Information of the Ion Channel Protein

In certain embodiments, the method comprises the step of using structural information describing the structure of an ion channel protein. In certain embodiments, the ion channel protein is also referred to as a “receptor” or “target” and the terms “protein,” “receptor” and “target” are used interchangeably.

In certain embodiments, the structural information describing the structure of the ion channel protein is from a homology model.

In certain embodiments, the structural information describing the structure of the ion channel protein is from an NMR solution structure. Multidimensional heteronuclear NMR techniques for determination of the structure and dynamics of macromolecules are known to those of ordinary skill in the art (see, e.g., Rance et al., 2007, “Protein NMR Spectroscopy: Principles and Practice,” 2nd ed., Boston: Academic Press).

In certain embodiments, the structural information describing the structure of the ion channel protein is from an X-ray crystal structure. X-ray crystallographic techniques for determination of the structure of macromolecules are also known to those of ordinary skill in the art (see, e.g., Drenth et al., 2007, “Principles of Protein X-Ray Crystallography,” 3rd ed., Springer Science).

The following TABLE 3 describes structures of cardiac ion channels, any of which may be used in the methods disclosed herein.

TABLE 3
Structures of Cardiac ion Channels

| | | | | | Structure | | | |
|---|---|---|---|---|---|---|---|---|
| | | Activation | | | X-ray | | Homology structures | |
| Current | Description | mechanism | Clone | Gene | Human | Others | References | Models |
| Ina | Sodium | Voltage, | Nav1.5 | SCN5A | 2KBI, 2L53, | x | 1, 2, 3 | x |
| | current | depolarization | | | 4DCK, 4DJC | | | |
| ICa,L | Calcium | Voltage, | Cav1.2 | CACNA1C | 2BE6, 2F3Z, | 2F3Y, 4DEY | 4, 5, 6, 7, 8, | x |
| | current, | depolarization | | | 2LQC, | | 9, a | |
| | L-type | | | | 2V01,2V02, | | | |
| | | | | | 2W73,2WEL,2X0 | | | |
| | | | | | G,2Y4V, | | | |
| | | | | | 3G43, 3OXQ | | | |
| ICa,T | Calcium | Voltage, | Cav3.1 | CACNA1G | x | x | 10, 11 | A |
| | current, | depolarization | | | | | | |
| | T-type | | | | | | | |
| ICa,T | Calcium | Voltage, | Cav3.2 | CACNAIG | x | x | 12 | B |
| | current, | depolarization | | | | | | |
| | T-type | | | | | | | |
| Ito,f | Transient | Voltage, | Kv4.2 | KCND2 | x | 1NN7, 1S6C | 13, 14, 15, 16 | C |
| | outward | depolarization | | | | | | |
| | current, fast | | | | | | | |
| Ito,s | Transient | Voltage, | Kv4.3 | KCND3 | ISIG, 2NZ0 | 2I2R | 17 | x |
| | outward | depolarization | | | | | | |
| | current, fast | | | | | | | |
| Ito,s | Transient | Voltage, | Kvl.4 | KCNA4 | 1ZTO | IKN7 | 18, 19, 20, 21 | D |
| | outward | depolarization | | | | | | |
| | current, slow | | | | | | | |
| Ito,s | Transient | Voltage, | Kv1.7 | KCNA4 | x | x | 22, 23, 24 | F |
| | outward | depolarization | | | | | | |
| | current, slow | | | | | | | |
| Ito,s | Transient | Voltage, | Kv3.4 | KCNA4 | 1B4G, 1B4I, 1ZTN | x | b | G |
| | outward | depolarization | | | | | | |
| | current, slow | | | | | | | |
| IKur | Delayed | Voltage, | Kvl.5 | KCNA5 | x | x | 25-36, c | H |
| | rectifier, | depolarization | | | | | | |
| | ultrarapid | | | | | | | |
| IKur | Delayed | Voltage, | Kv3.1 | KCNA5 | x | 3KVT | 37, 38 | I |
| | rectifier, | depolarization | | | | | | |
| | ultrarapid | | | | | | | |
| Ikr | Delayed | Voltage, | HERG | KCNH2 | 2L4R, 4HQA, | x | 39-67 | J, K |
| | rectifier, fast | depolarization | | | 1UJL, 2L0W, | | | |
| | | | | | 2LE7, 2L1M, | | | |
| | | | | | 4HP9 | | | |
| Iks | Delayed | Voltage, | KVLQT1 | KCNQ1 | 3BJ4, 3HFC, | x | 68-79 | L |
| | rectifier, slow | depolarization | | | 3HFE | | | |
| IK1 | Inward | Voltage, | Kir2.1 | KCNJ2 | x | 1U4F, 2GIX, | 80-92 | M |
| | rectifier | depolarization | | | | 2XKY | | |
| IK1 | Inward | Voltage, | Kir2.2 | KCNJ12 | x | 3JYC, 3SPC, | 93 | N |
| | rectifier | depolarization | | | | 3SPG, 3SPH, | | |
| | | | | | | 3SPI, 3SPJ | | |
| IKATP | ADP | [ADP]/[ATP] | Kir6.2 | KCNJ11 | x | x | 94-100 | O |
| | activated K+ | ↑ | (SURA) | | | | | |
| | current | | | | | | | |
| IKAch | Muscarinic | Acetylcholine | Kir3.1 | KCNJ3 | x | 2QKS, 1U4F, | 89, 101 | P |
| | gated K+ | | | | | 1N9P, 1U4E, | | |
| | current | | | | | 3K6N, 2XKY | | |
| IKAch | Muscarinic | Acetylcholine | Kir3.4 | KCNJ5 | x | x | 102, d, e | Q |
| | gated K+ | | | | | | | |
| | current | | | | | | | |
| IKP | Background | Metabolism, | TWK-1 | KCNK1 | 3UKM | x | 103, f | R |
| | current | stretch | | | | | | |
| IKP | Background | Metabolism, | TWK-2 | KCNK6 | x | x | g | S |
| | current | stretch | | | | | | |
| IFP | Pacemaker | Voltage, | HCN2 | HCN2 | 3U10 | 1Q43, 3FFQ, | 104, 105, 106 | T |
| | current | hyper- | | | | 2Q0A, 1Q5O, | | |
| | | polarization | | | | 3ETQ, 1Q3E, | | |
| | | | | | | 4EQF, 3BPZ | | |
| IFP | Pacemaker | Voltage, | HCN4 | HCN4 | 3OTF, 3U11, | x | 107 | U |
| | current | hyper- | | | 4HBN | | | |
| | | polarization | | | | | | |

References:
a) http://othes.univie.ac.at/21370/1/2012-05-24_0648516.pdf Suwattanasophon, “Molecular modeling of voltage-gated calcium channels,” Doctoral Dissertation, Department of Physics, University of Vienna (2012).
b) http://www.signaling-gateway.org/molecule/query;jsessionid=19da8b8664247e4bal5f71e85572ca0e39c55d31063b87412bce1773ec279ec6?afcsid=A001364&type=orthologs&adv=latest
c)http://www.asaabstracts.com/strands/asaabstracts/abstract.htm;jsessionid=85D4A676BAC78E6BABBDACF1893CC865?year=2011&index=2&absnum=5761
d) http://www-brs.ub.ruhr-uni-bochum.de/netahtml/HSS/Diss/MintertJanckeElisa/diss.pdf Mintert-Janke, “The role of Kir3.1 and Kir3.4 subunits in the regulation of cardiac GIRK channels in atrial myocytes,” Doctoral Dissertation, International Graduate School of Biosciences, Ruhr-University Bochum, Institute of Physiology, Department of Cellular Physiology (2010). Yu, F. H. & Catterall, W. A. The VGL-chanome: a protein superfamily specialized for electrical signaling and ionic homeostasis. Sci. STKE 2004, re15,
doi:10.1126/stke.2532004rel5 (2004).
e) http://stke.sciencemag.org/cgikontent-nw/full/sigtrans;2003/194/pe32
f) http://www2.sci.u-szeged.hu/ABS/2012/Acta%2011Pb/5693.pdf Szuts, V. et al. What have we learned from two-pore potassium channels: Their molecular configuration and function in the human heart. Acta Biologica Szegediensis 56, 93-107 (2012).
g) http://www.sciencedirect.com/science/article/pii/S0165614705001264 Buckingham, S. D., Kidd, J. F., Law, R. J., Franks, C. J. & Sattelle, D. B. Structure and function of two-pore-domain K+channels: contributions from genetic model organisms. Trends Pharmacol. Sci. 26, 361-367, doi:10.1016/j.tips.2005.05.003 (2005).
1. O’Reilly AO, Eberhardt E, Weidner C, Alzheimer C, Wallace BA, Lampert A. Bisphenol A binds to the local anesthetic receptor site to block the human cardiac sodium channel. Bondarenko VE, ed. PLoS One. 2012;7(7):e41667. Available at: http://dx.plos.org/10.1371/journal.pone.0041667. Accessed November 5, 2013.
2. Sarhan MF, Tung C-C, Van Petegem F, Ahern CA. Crystallographic basis for calcium regulation of sodium channels. Proc. Natl. Acad. Sci. U. S. A. 2012;109(9):3558-63. Available at: http://www.pubmedcentral.nih.gov/articlerenderfcgi?artid=3295267&tool=pmcentrez&rendertype=abstract. Accessed November 6, 2013.
3. Cormier JW, Rivolta I, Tateyama M, Yang A-S, Kass RS. Secondary structure of the human cardiac Na+channel C terminus: evidence for a role of helical structures in modulation of channel inactivation. J. Biol. Chem. 2002;277(11):9233-41. Available at: http://www.jbc.org/content/277/11/9233.abstract. Accessed November 6, 2013.
4. Stary A, Shafrir Y, Hering S, Wolschann P, Guy HR. Structural Model of the Ca V 1.2 Pore. Channels. 2008;2(3):210-215. Available at: https://www.landesbioscience.com/journals/channels/article/6158/?nocache
5. Tikhonov DB, Zhorov BS. Possible roles of exceptionally conserved residues around the selectivity filters of sodium and calcium channels. J. Biol. Chem. 2011;286(4):2998-3006. Available at: http://www.pubmedcentral.nih.gov/articlerenderfcgi?artid=3024794&tool=pmcentrez&rendertype=abstract. Accessed November 6, 2013.
6. Beguin P. Ng YJA, Krause C, Mahalakshmi RN, Ng MY, Hunziker W. RGK small GTP-binding proteins interact with the nucleotide kinase domain of Ca2+30- channel beta-subunits via an uncommon effector binding domain. J. Biol. Chem. 2007;282(15):11509-20. Available at: http://www.ncbi.nlm.nih.gov/pubmed/17303572. Accessed November 6, 2013.
7. Depil K, Beyl S. Stary-Weinzinger A, Hohaus A, Timin E, Hering S. Timothy mutation disrupts the link between activation and inactivation in Ca(V)1.2 protein. J. Biol. Chem. 2011;286(36):31557-64. Available at: http://www.jbc.org/content/286/36/31557.short. Accessed November 6, 2013.
8. Kudrnac M, Beyl S. Hohaus A, et al. Coupled and independent contributions of residues in IS6 and IIS6 to activation gating of CaV1.2../. BioL Chem. 2009;284(18):12276-84. Available at: http://www.jbc.org/content/284/18/12276.short. Accessed November 6, 2013.
9. Zhorov BS, Folkman E V, Ananthanarayanan VS. Homology model of dihydropyridine receptor: implications for L-type Ca(2+30) channel modulation by agonists and antagonists. Arch. Biochem. Biophys. 2001;393(1):22-41. Available at: http://www.ncbi.nlm.nih.gov/pubmec1/11516158. Accessed November 6, 2013.
10. Karmazinova M, Beyl S, Stary-Weinzinger A, et al. Cysteines in the loop between IS5 and the pore helix of Ca(V)3.1 are essential for channel gating. Pflugers Arch. 2010;460(6):1015-28. Available at: http://www.ncbi.nlm.nih.gov/pubmecV20827487. Accessed November 6, 2013.
11. Lipkind GM. Molecular Modeling of Interactions of Dihydropyridines and Phenylalkylamines with the Inner Pore of the L-Type Ca2+Channel. Mol. Pharmacol. 2003;63(3):499-511. Available at: http://molpharm.aspetjournals.orgkontent/63/3/499.full. Accessed November 6, 2013.
12. Demers-Giroux P-0, Bourdin B, Sauve R, Parent L. Cooperative Activation of the T-type CaV3.2 Channel: INTERACTION BETWEEN DOMAINS H AND HI. J. BioL Chem. 2013;288(41):29281-93. Available at: http://www.ncbi.nlm.nih.gov/pubmed/23970551. Accessed November 6, 2013.
13. Heler R, Bell JK, Boland LM. Homology model and targeted mutagenesis identify critical residues for arachidonic acid inhibition of Kv4 channels. Channels (Austin). 7(2):74-84. Available at: http://www.pubmedcentral.nih.gov/articlerendericgi?artid=3667888&tool=pmcentrez&rendertype=abstract. Accessed November 6, 2013.
14. Barghaan J, Baring R. Dynamic coupling of voltage sensor and gate involved in closed-state inactivation of kv4.2 channels. J. Gen. PhysioL 2009;133(2):205-24. Available at: http://jgp.rupress.orgkontent/133/2/205.full. Accessed November 6, 2013.
15. Zhou W, Qian Y, Kunjilwar K, Pfaffinger PJ, Choe S. Structural insights into the functional interaction of KChIP1 with Shal-type K(+30) channels. Neuron. 2004;41(4):573-86. Available at: http://www.ncbi.nlm.nih.gov/pubmed/14980206. Accessed November 6, 2013.
16. Strop P, Bankovich AJ, Hansen KC, Garcia KC, Brunger AT. Structure of a human A-type potassium channel interacting protein DPPX, a member of the dipeptidyl aminopeptidase family. J. MoL BioL 2004;343(4):1055-65. Available at: http://www.ncbi.nlm.nih.gov/pubmed/15476821. Accessed November 6, 2013.
17. Pioletti M, Findeisen F, Hura GL, Minor DL. Three-dimensional structure of the KChIP1-Kv4.3 T1 complex reveals a cross-shaped octamer. Nat. Struct. MoL Biol. 2006;13(11):987-95. Available at: http://dx.doi.org/10.1038/nsmb1164. Accessed November 6, 2013.
18. Liu H-L, Lin J-C. A set of homology models of pore loop domain of six eukaryotic voltage-gated potassium channels Kv1.1-Kv1.6. Proteins. 2004;55(3):558-67. Available at: http://www.ncbi.nlm.nih.gov/pubmed/15103620. Accessed November 6, 2013.
19. Lee J-H, Lee B-H, Choi S-H, et al. Ginsenoside Rg3 inhibits human Kv1.4 channel currents by interacting with the Lys531 residue. Mol. Pharmacol. 2008;73(3):619-26. Available at: http://molpharm.aspetjournals.org/content/73/3/619.full. Accessed November 6, 2013.
20. Jiang X, Bett GCL, Li X, Bondarenko VE, Rasmusson RL. C-type inactivation involves a significant decrease in the intracellular aqueous pore volume of Kv1.4 K+channels expressed in Xenopus oocytes. J. Physiol. 2003;549(Pt 3):683-95. Available at: http://jp.physoc.org/content/549/3/683.full. Accessed November 6, 2013.
21. Liu H-L, Chen C-W, Lin J-C. Homology models of the tetramerization domain of six eukaryotic voltage-gated potassium channels Kv1.1-Kv1.6. J. BiomoL Struct. Dyn. 2005;22(4):387-98. Available at: http://www.ncbi.nlm.nih.gov/pubmed/15588103. Accessed November 6, 2013.
22. Kashuba VI, Kvasha SM, Protopopov Al, et al. Initial isolation and analysis of the human Kv1.7 (KCNA7) gene, a member of the voltage-gated potassium channel gene family. Gene. 2001;268(1-2):115-22. Available at: http://www.ncbi.nlm.nih.gov/pubmed/11368907. Accessed November 6, 2013.
23. Shamgar L, Haitin Y, Yisharel I, et al. KCNEI constrains the voltage sensor of Kv7.I K+channels. Jenkins A, ed. PLoS One. 2008;3(4):e1943. Available at: http://dx.plos.org/10.1371/journal.pone.0001943. Accessed November 6, 2013.
24. Ranatunga KM, Law RJ, Smith GR, Sansom MSP. Electrostatics studies and molecular dynamics simulations of a homology model of the Shaker K +channel pore. Eur. Biophys. J. 2001;30(4):295-303. Available at: http://link.springer.com/10.1007/s002490100134. Accessed November 6, 2013.
25. Ander M, Luzhkov VB, Aqvist J. Ligand Binding to the Voltage-Gated KvI.5 Potassium Channel in the Open State-Docking and Computer Simulations of a Homology Model. Biophys. J. 2008;94(3):820-831. Available at: http://www.sciencedirect.com/science/article/pii/S0006349508706817. Accessed November 6, 2013.
26. Olson TM, Alekseev AE, Liu XK, et al. Kv1.5 channelopathy due to KCNA5 loss-of-function mutation causes human atrial fibrillation. Hum. Mol. Genet. 2006;15( 14):2185-91. Available at: http://hmg.oxfordjournals.org/content/I5/14/2185.full. Accessed November 6, 2013.
27. Decher N, Kumar P, Gonzalez T, Pirard B, Sanguinetti MC. Binding site of a novel KvI.5 blocker: a “foot in the door” against atrial fibrillation. Mol. Pharmacol. 2006;70(4):1204-1I. Available at: http://molpharm.aspetjournals.org/content/70/4/1204.full. Accessed November 6, 2013.
28. Decher N, Pirard B, Bundis F, et al. Molecular basis for Kv1.5 channel block: conservation of drug binding sites among voltage-gated K+channels. J. Biol. Chem. 2004;279(1):394-400. Available at: http://www.jbc.org/content/279/1/394.full. Accessed November 6, 2013.
29. Pietra F. Binding of ciguatera toxins to the voltage-gated Kvl .5 potassium channel in the open state. Docking of gambierol and molecular dynamics simulations of a homology model. J. Phys. Org. Chem. 2008;21(11):997-1001. Available at: http://doi.wiley.com/10.1002/poc.1413. Accessed November 6, 2013.
30. Pirard B, Brendel J, Peukert S. The discovery of Kv1.5 blockers as a case study for the application of virtual screening approaches. J. Chem. Inf. Model. 2005;45(2):477-85. Available at: http://dx.doi.org/10.1021ki0400011. Accessed November 6, 2013.
31. Eldstrom J, Fedida D. Modeling of high-affinity binding of the novel atrial anti-arrhythmic agent, vernakalant, to Kv1.5 channels. J. Mol. Graph. Model. 2009;28(3):226-235. Available at: http://www.sciencedirect.com/science/article/pii/S1093326309000825. Accessed November 6, 2013.
32. Yang Q, Du L, Wang X, Li M, You Q. Modeling the binding modes of Kvl .5 potassium channel and blockers. J. Mol. Graph. Model. 2008;27(2):178-187. Available at: http://www.sciencedirect.com/science/article/pii/S1093326308000508. Accessed November 6, 2013.
33. Pietra F. COMPUTER SIMULATIONS OF THE INTERACTION OF CIGUATOXIN 3C, BREVENAL AND ent-BREVENAL LADDER POLYETHERS WITH A HOMOLOGY MODEL OF THE VOLTAGE-GATED Kv1.5 POTASSIUM CHANNEL. 2011. Available at: http://www.worldscientific.com/doi/abs/10.1142/s021963360900526x. Accessed November 6, 2013.
34. Nuilez L, Vaquero M, Gomez R, et al. Nitric oxide blocks hKv1.5 channels by S-nitrosylation and by a cyclic GMP-dependent mechanism. Cardiovasc. Res. 2006;72(1):80-9. Available at: http://cardiovascres.oxfordjoumals.org/content/72/1/80.M. Accessed November 6, 2013.
35. Moreno I, Caballero R, Gonzalez T, et al. Effects of irbesartan on cloned potassium channels involved in human cardiac repolarization. J. Pharmacol. Exp. Ther. 2003;304(2):862-73. Available at: http://jpet.aspetjournals.orgkontent/304/2/862A11. Accessed November 6, 2013.
36. Luzhkov VB, Nilsson J, Arhem P, Aqvist J. Computational modelling of the open-state Kvl .5 ion channel block by bupivacaine. Biochim. Biophys. Acta - Proteins Proteomics. 2003;1652(1):35-5 I. Available at: http://www.sciencedirect.com/science/article/pii/S1570963903002681. Accessed November 6, 2013.
37. Herrera D, Mamarbachi A, Simoes M, et al. A single residue in the S6 transmembrane domain governs the differential flecainide sensitivity of voltage-gated potassium channels. Mol. Pharmacol. 2005;68(2):305-16. Available at: http://www.ncbi.nlm.nih.gov/pubmed/15883204. Accessed November 6, 2013.
38. Kopljar I, Labro AJ, Cuypers E, et al. A polyether biotoxin binding site on the lipid-exposed face of the pore domain of Kv channels revealed by the marine toxin gambierol. Proc. Nail. Acad. Sci. U. S. A. 2009;106(24):9896-901. Available at: http://www.pnas.org/content/106/24/9896.1ong. Accessed November 6, 2013.
39. Pearlstein RA, Vaz RJ, Kang J, et al. Characterization of HERG potassium channel inhibition using CoMSiA 3D QSAR and homology modeling approaches. Bioorg. Med. Chem. Lett. 2003;13(10):1829-1835. Available at: http://www.sciencedirect.com/science/article/pii/S0960894X03001963. Accessed November 5, 2013.
40. Rajamani R, Tounge BA, Li .1, Reynolds CH. A two-state homology model of the hERG K+channel: application to ligand binding. Bioorg. Med. Chem. Lett. 2005;15(6):1737-1741. Available at: http://www.sciencedirect.com/science/article/pii/S0960894X05000466. Accessed November 5, 2013.
41. Osterberg F, Aqvist J. Exploring blocker binding to a homology model of the open hERG K+channel using docking and molecular dynamics methods. FEBS Lett. 2005;579(13):2939-2944. Available at: http://www.sciencedirect.com/science/article/pii/S0014579305005144. Accessed November 5, 2013.
42. Coi A, Bianucci AM. Combining structure- and ligand-based approaches for studies of interactions between different conformations of the hERG K+channel pore and known ligands. J. Mol. Graph. Model. 2013;46:93-104. Available at: http://www.sciencedirect.com/science/article/pii/S1093326313001770. Accessed November 5, 2013.
43. Mitcheson JS, Chen J, Lin M, Culberson C, Sanguinetti MC. A structural basis for drug-induced long QT syndrome. Proc. Natl. Acad Sci. U. S. A. 2000;97(22):12329-33. Available at: http://www.pnas.org/content/97/22/12329.full. Accessed November 5, 2013.
44. Colenso CK, Sessions RB, Zhang YH, Hancox JC, Dempsey CE. Interactions between voltage sensor and pore domains in a hERG K+channel model from molecular simulations and the effects of a voltage sensor mutation. J. Chem. Inf. Model. 2013;53(6):1358-70. Available at: http://www.ncbi.nlm.nih.gov/pubmed/23672495. Accessed November 5, 2013.
45. Ceccarini L, Masetti M, Cavalli A, Recanatini M. Ion conduction through the hERG potassium channel. PLoS One. 2012;7(11):e49017. Available at: http://www.pubmedcentral.nih.gov/articlerender.fcgi?artid=3487835&tool=pmcentrez&rendertype=abstract. Accessed November 5, 2013.
46. Durdagi S, Deshpande S, Duff 113, Noskov SY. Modeling of open, closed, and open-inactivated states of the hERG1 channel: structural mechanisms of the state- dependent drug binding. J. Chem. Inf. Model. 2012;52(10):2760-74. Available at: http://www.ncbi.nlm.nih.gov/pubmed/22989185. Accessed November 5, 2013.
47. El Harchi A, Zhang YH, Hussein L, Dempsey CE, Hancox JC. Molecular determinants of hERG potassium channel inhibition by disopyramide. J. Mol. Cell. Cardiol. 2012;52(1):185-95. Available at: http://www.ncbi.nlm.nih.gov/pubmed/21989164. Accessed November 5, 2013.
48. Cheng H, Zhang Y, Du C, Dempsey CE, Hancox JC. High potency inhibition of hERG potassium channels by the sodium-calcium exchange inhibitor KB-R7943. Br. J. Pharmacol. 2012;165(7):2260-73. Available at: http://www.pubmedcentralnih.gov/articlerenderfcgi?artid=3413861&tool=pmcentrez&rendertype=abstract. Accessed November 5, 2013.
49. Du-Cuny L, Chen L, Zhang S. A critical assessment of combined ligand- and structure-based approaches to HERG channel blocker modeling. J. Chem. Inf. Model. 2011;51(11):2948-60. Available at: http://www.ncbi.nlm.nih.gov/pubmed/21902220. Accessed November 5, 2013.
50. Stary A, Wacker SJ, Boukharta L, et al. Toward a consensus model of the HERG potassium channel. ChemMedChem. 2010;5(3):455-67. Available at: http://www.ncbi.nlm.nih.gov/pubmed/20104563. Accessed November 5, 2013.
51. Shultz MD, Cao X, Chen CH, et al. Optimization of the in vitro cardiac safety of hydroxamate-based histone deacetylase inhibitors. J. Med. Chem. 2011;54(13):4752-72. Available at: http://www.ncbi.nlm.nih.gov/pubmec1/21650221. Accessed November 5, 2013.
52. Lees-Miller JP, Subbotina JO, Guo J, Yarov-Yarovoy V, Noskov SY, Duff HJ. Interactions of H562 in the S5 helix with T618 and S621 in the pore helix are important determinants of hERG1 potassium channel structure and function. Biophys. J. 2009;96(9):3600-10. Available at: http://www.pubmedcentral.nih.gov/articlerender.fcgi?artid=2711401&tool=pmcentrez&rendertype=abstract. Accessed October 31, 2013.
53. Patel SD, Habeski WM, Cheng AC, de la Cruz E, Loh C, Kablaoui NM. Quinazolin-4-piperidin-4-methyl sulfamide PC-1 inhibitors: alleviating hERG interactions through structure based design. Bioorg. Med. Chem. Lett. 2009;19(12):3339-43. Available at:http://www.ncbi.nlm.nih.gov/pubmed/19435660. Accessed November 5, 2013.
54. Imai YN, Ryu S, Oiki S. Docking model of drug binding to the human ether-a-go-go potassium channel guided by tandem dimer mutant patch-clamp data: a synergic approach. J. Med. Chem. 2009;52(6):1630-8. Available at: http://dx.doi.org/10.1021/jm801236n. Accessed November 5, 2013.
55. Du L, Li M, You Q, Xia L. A novel structure-based virtual screening model for the hERG channel blockers. Biochem. Biophys. Res. Commun. 2007;355(4):889-94. Available at: http://www.ncbi.nlm.nih.gov/pubmed/17331468. Accessed November 4, 2013.
56. Tseng G-N, Sonawane KD, Korolkova Y V. et al. Probing the outer mouth structure of the HERG channel with peptide toxin footprinting and molecular modeling. Biophys. J. 2007;92(10):3524-40. Available at: http://www.pubmedcentral.nih.gov/articlerenderfcgi?artid=1853143&tool=pmcentrez&rendertype=abstract. Accessed November 5, 2013.
57. Morais Cabral JI-1, Lee A, Cohen SL, Chait BT, Li M, Mackinnon R. Crystal structure and functional analysis of the HERG potassium channel N terminus: a eukaryotic PAS domain. Cell. 1998;95(5):649-55. Available at: http://www.ncbi.nlm.nih.gov/pubmed/9845367. Accessed November 5, 2013.
58. Tseng GN. I(Kr): the hERG channel. J. Mol. Cell. Cardiol. 2001;33(5):835-49. Available at: http://www.ncbi.nlm.nih.gov/pubmed/11343409. Accessed November 5, 2013.
59. Ishii K, Kondo K, Takahashi M, Kimura M, Endoh M. An amino acid residue whose change by mutation affects drug binding to the HERG channel. FEBS Len. 2001;506(3):191-5. Available at: http://www.ncbi.nlm.nih.gov/pubmed/11602243. Accessed November 5, 2013.
60. Witchel HJ, Dempsey CE, Sessions RB, et al. The low-potency, voltage-dependent HERG blocker propafenone--molecular determinants and drug trapping. Mol. Pharmacol. 2004;66(5):1201-12. Available at: http://www.ncbi.nlm.nih.gov/pubmed/15308760. Accessed November 5, 2013.
61. Piper DR, Hinz WA, Tallurri CK, Sanguinetti MC, Tristani-Firouzi M. Regional specificity of human ether-a'-go-go-related gene channel activation and inactivation gating. J. Biol. Chem. 2005;280(8):7206-17. Available at: http://www.ncbi.nlm.nih.gov/pubmed/15528201. Accessed November 5, 2013.
62. Farid R, Day T, Friesner RA, Pearlstein RA. New insights about HERG blockade obtained from protein modeling, potential energy mapping, and docking studies. Bioorg. Med. Chem. 2006;14(9):3160-73. Available at: http://www.ncbi.nlm.nih.gov/pubmed/16413785. Accessed November 5, 2013.
63. Kutteh R, Vandenberg JI, Kuyucak S. Molecular dynamics and continuum electrostatics studies of inactivation in the HERG potassium channel. J. Phys. Chem. B. 2007; 1 1 1 (5):1090-8. Available at: http://www.ncbi.nlm.nih.gov/pubmed/17266262. Accessed November 5, 2013.
64. Yoshida K, Niwa T. Quantitative structure-activity relationship studies on inhibition of HERG potassium channels. J. Chem. Inf. Model. 46(3):1371-8. Available
at: http://www.ncbi.nlm.nih.gov/pubmed/16711756. Accessed November 5, 2013.
65. Vandenberg JI, Walker BD, Campbell TJ. HERG K+channels: friend and foe. Trends PharmacoL Sci. 2001;22(5):240-246. Available at: http://www.sciencedirect.corn/science/article/pii/S016561470001662X. Accessed November 6, 2013.
66. Al-Owais M, Bracey K, Wray D. Role of intracellular domains in the function of the herg potassium channel. Eur. Biophys. J. 2009;38(5):569-76. Available at: http://www.ncbi.nlm.nih.gov/pubmed/19172259. Accessed November 5, 2013.
67. Stansfeld PJ, Gedeck P, Gosling M, Cox B, Mitcheson JS, Sutcliffe MJ. Drug block of the hERG potassium channel: insight from modeling. Proteins. 2007;68(2):568-80. Available at: http://www.ncbi.nlm.nih.gov/pubmed/17444521. Accessed November 5, 2013.
68. Du L-P, Li M-Y, Tsai K-C, You Q-D, Xia L. Characterization of binding site of closed-state KCNQ1 potassium channel by homology modeling, molecular docking, and pharmacophore identification. Biochem. Biophys. Res. Commun. 2005;332(3):677-687. Available at: http://www.sciencedirect.com/science/article/pii/S0006291X05009538. Accessed November 6, 2013.
69. Lerche C, Bruhova I, Lerche H, et al. Chromanol 293B binding in KCNQI (Kv7.1) channels involves electrostatic interactions with a potassium ion in the selectivity filter. Mol. Pharmacol. 2007;71(6):1503-11. Available at: http://www.ncbi.nlm.nih.gov/pubmed/17347319. Accessed November 6, 2013.
70. Melman YF, Um SY, Krumerman A, Kagan A, McDonald T V. KCNE1 Binds to the KCNQI Pore to Regulate Potassium Channel Activity. Neuron. _ 2004;42(6):927-937. Available at: http://www.sciencedirect.com/science/article/pii/S0896627304003307. Accessed November 6, 2013.
71. Seebohm G, Chen J, Strutz N, Culberson C, Lerche C, Sanguinetti MC. Molecular determinants of KCNQI channel block by a benzodiazepine. Mol. PharmacoL 2003;64(1):70-7. Available at: http://molpharm.aspetjournals.org/content/64/1/70.full. Accessed November 6, 2013.
72. Seebohm G, Pusch M, Chen J, Sanguinetti MC. Pharmacological activation of normal and arrhythmia-associated mutant KCNQI potassium channels. Circ. Res. 2003;93(10):941-7. Available at: http://circres.ahajournals.org/content/93/10/941.full. Accessed November 6, 2013.
73. Seebohm G, Sanguinetti MC, Pusch M. Tight coupling of rubidium conductance and inactivation in human KCNQI potassium channels. J. Physiol. 2003;552(2):369-378. Available at: http://doi.wiley.com/10.1111/j.1469-7793.2003.00369.x. Accessed November 6, 2013.
74. Seebohm G, Strutz-Seebohm N, Ureche ON, et al. Differential Roles of S6 Domain Hinges in the Gating of KCNQ Potassium Channels. Biophys. J. 2006;90(6):2235-2244. Available at: http://www.sciencedirect.com/science/article/pii/S0006349506724080. Accessed November 6, 2013.
75. Smith JA, Vanoye CG, George AL, Meiler .1, Sanders CR. Structural models for the KCNQ I voltage-gated potassium channel. Biochemistry. 2007;46(49):14141-52. Available at: http://dx.doi.org/10.1021/bi701597s. Accessed November 6, 2013.
76. Tapper AR, George AL. Location and orientation of minK within the I(Ks) potassium channel complex. J. Biol. Chem. 2001;276(41):38249-54. Available at: http://www.ncbi.nlm.nih.gov/pubmecV11479291. Accessed November 6, 2013.
77. Lange W, Geissendorfer J, Schenzer A, et al. Refinement of the binding site and mode of action of the anticonvulsant Retigabine on KCNQ K+ channels. Mol. PharmacoL 2009;75(2):272-80. Available at: http://molpharm.aspetjournals.org/content/75/2/272.short. Accessed November 6, 2013.
78. Panaghie G, Abbott GW. The role of S4 charges in voltage-dependent and voltage-independent KCNQI potassium channel complexes. J. Gen. Physiol. 2007;129(2):121-33. Available at: http://jgp.rupress.org/content/129/2/121.full. Accessed November 6, 2013.
79. Strutz-Seebohm N, Pusch M, Wolf S, et al. Structural basis of slow activation gating in the cardiac I Ks channel complex. Cell. PhysioL Biochem. 2011;27(5):443-52. Available at: http://www.karger.com/ArticlefFullText/329965. Accessed November 6, 2013.
80. Durell S, Guy HR. A family of putative Kir potassium channels in prokaryotes. BMC EvoL Biol. 2001;1(1):14. Available at: http://www.biomedcentral.com/1471-2148/1/14. Accessed November 6, 2013.
81. Epshtein Y, Chopra AP, Rosenhouse-Dantsker A, Kowalsky GB, Logothetis DE, Levitan I. Identification of a C-terminus domain critical for the sensitivity of Kir2.1 to cholesterol. Proc. Natl. Acad. Sci. U. S. A. 2009;106(19):8055-60. Available at: http://www.pnas.org/content/106/19/8055.short. Accessed November 6, 2013.
82. Giorgetti A, Carloni P. Molecular modeling of ion channels: structural predictions. Curr. Opin. Chem. Biol. 2003;7(1):150-156. Available at: http://www.sciencedirect.comiscience/article/pii/S1367593102000121. Accessed November 6, 2013.
83. Leyland ML, Dart C, Spencer PJ, Sutcliffe Mi, Stanfield PR. The possible role of a disulphide bond in forming functional Kir2.1 potassium channels. Pflfigers Arch. 1999;438(6):778-781. Available at: http://link.springer.com/article/10.1007/s004249900153. Accessed November 6, 2013.
84. Thompson GA, Leyland ML, Ashmole I, Sutcliffe KT, Stanfield PR. Residues beyond the selectivity filter of the K+channel Kir2.1 regulate permeation and block by external Rb+and Cs
85. Chang H-K, Lee J-R, Liu T-A, Suen C-S, Arreola J, Shieh R-C. The extracellular K+ concentration dependence of outward currents through Kir2.1 channels is regulated by extracellular Na+ and Ca2 2013.
86. Chatelain FC, Alagem N, Xu Q, Pancaroglu R, Reuveny E, Minor DL. The pore helix dipole has a minor role in inward rectifier channel function. Neuron. 2005;47(6):833-43. Available at: http://www.pubmedcentral.nih.gov/articlerenderfcgi?artid=3017504&tool=pmcentrez&rendertype=abstract. Accessed November 6, 2013.
87. Dart C, Leyland ML, Spencer PJ, Stanfield PR, Sutcliffe MJ. The selectivity filter of a potassium channel, murine kir2.1, investigated using scanning cysteine mutagenesis. J. Physiol. 1998;511 ( Pt 1:25-32. Available at: http//www.pubmedcentral.nih.gov/articlerendericgi?artid=2231101&tool=pmcentrez&rendertype=abstract. Accessed November 6, 2013.
88. D'Avanzo N, Lee S-J, Cheng WWL, Nichols CG. Energetics and location of phosphoinositide binding in human Kir2.1 channels. J. Biol. Chem. 2013;288(23):16726-37. Available at: http://www.ncbi.nlm.nih.gov/pubmed/23564459. Accessed November 6, 2013.
89. Robertson JL, Palmer LG, Roux B. Long-pore electrostatics in inward-rectifier potassium channels. J. Gen. Physiol. 2008;132(6):613-32. Available at: http://jgp.rupress.org/content/132/6/613.full. Accessed November 6, 2013.
90. Stanfield PR, Sutcliffe MJ. Spermine is fit to block inward rectifier (Kir) channels. J. Gen. Physiol. 2003;122(5):481-4. Available at: http://www.pubmedcentral.nih.gov/articlerender.fcgi?artid=2229586&tool=pmcentrez&rendertype=abstract. Accessed November 6, 2013.
91. Yeh S-H, Chang H-K, Shieh R-C. Electrostatics in the cytoplasmic pore produce intrinsic inward rectification in kir2.1 channels. J. Gen. Physiol. 2005;126(6):551-62. Available at: http://jgp.rupress.org/content/126/6/551.figures-only. Accessed November 6, 2013.
92. Xiao J, Zhen X, Yang J. Localization of PIP2 activation gate in inward rectifier K+channels. Nat. Neurosci. 2003;6(8):811-8. Available at: http://dx.doi.org/10.1038/nn1090. Accessed November 6, 2013.
93. Hassinen M, Paajanen V, Haverinen J, Eronen H, Vornanen M. Cloning and expression of cardiac Kir2.1 and Kir2.2 channels in thermally acclimated rainbow trout. Am. J. Physiol. ReguL Integr. Comp. Physiol. 2007;292(6):R2328-39. Available at: http://ajpregu.physiology.org/content/292/6/R2328. Accessed November 6, 2013.
94. Antcliff JF, Haider S, Proks P. Sansom MSP, Ashcroft FM. Functional analysis of a structural model of the ATP-binding site of the KATP channel Kir6.2 subunit. EMBO J. 2005;24(2):229-39. Available at: http://dx.doi.org/10.1038/sj.emboj.7600487. Accessed November 6, 2013.
95. Coventry A, Bull-Otterson LM, Liu X, et al. Deep resequencing reveals excess rare recent variants consistent with explosive population growth. Nat. Commun. 2010;1:131. Available at: http://dx.doi.org/10.1038/nconuns1130. Accessed November 6, 2013.
96. Gloyn AL, Reimann F, Girard C, et al. Relapsing diabetes can result from moderately activating mutations in KCNJ11. Hum. Mot. Genet. 2005;14(7):925-34. Available at: http://hmg.oxfordjournals.org/content/14M925.full. Accessed November 6, 2013.
97. Haider S, Tarasov Al, Craig TJ, Sansom MSP, Ashcroft FM. Identification of the PIP2-binding site on Kir6.2 by molecular modelling and functional analysis. EMBO J. 2007;26(16):3749-59. Available at: http://dx.doi.org/10.1038/sj.emboj.7601809. Accessed November 6, 2013.
98. Lin Y-W, Bushman JD, Yan F-F, et al. Destabilization of ATP-sensitive potassium channel activity by novel KCNJI 1 mutations identified in congenital hyperinsulinism. J. Biol. Chem. 2008;283(14):9146-56. Available at: http://www.jbc.org/content/283/14/9146.full. Accessed November 6, 2013.
99. Lu T, Hong M-P, Lee H-C. Molecular determinants of cardiac K(ATP) channel activation by epoxyeicosatrienoic acids. J. BioL Chem. 2005;280(19):19097-104. Available at: http://www.jbc.org/content/280/19/19097.full. Accessed November 6, 2013.
100. Bryan J, Munoz A, Zhang X, et al. ABCC8 and ABCC9: ABC transporters that regulate K+channels. Pflugers Arch. 2007;453(5):703-18. Available at: http://www.ncbi.nlm.nih.gov/pubmec1/16897043. Accessed November 6, 2013.
101. Logothetis DE, Lupyan D, Rosenhouse-Dantsker A. Diverse Kir modulators act in close proximity to residues implicated in phosphoinositide binding. J. Physiol. 2007;582(Pt 3):953-65. Available at: http://www.pubmedcentral.nih.gov/articlerenderfcgi?artid=2075264&tool=pmcentrez&rendertype=abstract. Accessed November 6, 2013.
102. Rosenhouse-Dantsker A, Sui JL, Zhao Q, et al. A sodium-mediated structural switch that controls the sensitivity of Kir channels to Ptdlns(4,5)P(2). Nat. Chem. BioL 2008;4(10):624-31. Available at: http://dx.doi.org/10.1038/nchembio.112. Accessed November 6, 2013.
103. Chatelain FC, Bichet D, Douguet D, et al. TWIK1, a unique background channel with variable ion selectivity. Proc. NatL Acad. Sci. U. S. A. 2012;109(14):5499-504. Available at: http://www.pubmedcentral.nih.gov/articlerenderfcgi?artid=3325654&tool=pmcentrez&rendertype=abstract. Accessed November 6, 2013.
104. Cheng L, Kinard K, Rajamani R, Sanguinetti MC. Molecular mapping of the binding site for a blocker of hyperpolarization-activated, cyclic nucleotide- modulated pacemaker channels. J. Pharmacol. Exp. Ther. 2007;322(3):931-9. Available at: http://www.ncbi.nlm.nih.gov/pubmed/17578902. Accessed November 6, 2013.
105. Giorgetti A, Carloni P, Mistrik P, Torre V. A homology model of the pore region of HCN channels. Biophys. J. 2005;89(2):932-44. Available at: http://www.pubmedcentral.nih.gov/articlerenderfcgi?artid=1366642&tool=pmcentrez&rendertype=abstract. Accessed November 6, 2013.
106. WernhOner K, Silbernagel N, Marzian S. et al. A leucine zipper motif essential for gating of hyperpolarization-activated channels. J. BioL Chem. 2012;287(48):40150-60. Available at: http://www.ncbi.nlm.nih.gov/pubmed/23048023. Accessed November 6, 2013.
107. Bucchi A, Baruscotti M, Nardini M, et al. Identification of the molecular site of ivabradine binding to HCN4 channels. PLoS One. 2013;8(1):e53132. Available at: http://www.pubmedcentral.nih.gov/articlerender.fcgi?artid=3537762&tool=pmcentrez&rendertype=abstract. Accessed November 6, 2013.
Models:
(sources: http://swissmodel.expasy.org/repository/, http://modbase.compbio.ucsfedu/modbase-cgi/index.cgi)
A) http://swissmodel.expasy.org/repositoryfipid=srnr03&query_l_input=043497&zid=async
B) http://swissmodel.expasy.org/repository/?pid=smr03&query_l_input=095180&zid=async
C) http://swissmodel.expasy.org/repository/?pid=snu03&query_l_input=Q9NZV8&zid=async
D) http://swissmodel.expasy.org/repository/?pid=snu03&query_1 _input=P22459&zid=async
F) http://swissmodel.expasy.org/repository/?pid=snu03&query_l jnput=Q96RP8&zid=async
G) http://swissmodel.expasy.org/repository/?pid=smr03&query_l_input=Q03721&zid=async
H) http://swissmodel.expasy.org/repositoly/?pid=smr03&query_l_input=P22460&zid=async
I) http://swissmodel.expasy.org/repository/?pid=smr03&query_l jnput=P48547&zid=async
J) http://swissmodel .expasy.org/repository/?pid=smr03&query_1_input=Q12809&zid=async
K) http://modbase.compbio.ucsf. edu/modbase-cgi/model_details.cgi?queryfile=1384719244_2759&searchmode=default&displaymode=moddetail&seq jd=9609015e801c7f9d197f8911003adb27MPVRDPGS
L) http://swissmodel.expasy.org/repository/?pid=smr03&query_l_input=P51787&zid=async
M) http://modbase.compbio.ucsf.edu/modbase-cgi/model_details.cgi?queryfile=1384719426_1825&searchmode=default&displaymode=moddetail&seq_id=clec697d8bdbb72003b332d22ceea5a7MDFLDEGS
N) http://swissmodel.expasy.org/repository/?pid=smr03&query_l_input=Q14500&zid=async
O) http://swissmodel.expasy.org/repository/?pid=smr03&query_l_input=Q14654&zid=async
P) http://swissmodel.expasy.org/repository/?pid=smr03&query_l_input=P48549&zid=async
Q) http://swissmodel.expasy.org/repository/?pid=smr03&query_l_input=P48544&zid=async
R) http://swissmodel.expasy.org/repository/?pid=smr03&query_l_input=000180&zid=async
S) http://swissmodel.expasy.org/repository/?pid=smr03&query_l_input=Q9Y257&zid=async
T) http://modbase.compbio.ucsf. edu/modbase-cgi/model_details.cgi?queryfile=1384719931_2572&searchmode=default&displaymode=moddetail&seq_id=19163822d53ef06530f0730234fde9a6MDARSSNL
U) http://modbase.compbio.ucsf. edu/modbase-cgi/model_detail s.cgi?queryfile=1384719969_8641&searchmode=default&displaymode=moddetail &seq_id=751e84311ef9684d3ef944f626613alfMDICLPSNL

In certain embodiments, the structural information describing the structure of the ion channel protein is selected from any one of the structures of TABLE 3.

The following TABLE 4 describes structures of potassium ion channels, any of which may be used in the methods disclosed herein.

TABLE 4
Structures of Potassium Ion Channels

| | | | | | Homology structures | |
|---|---|---|---|---|---|---|
| | | | X-ray/NMR | | (human only) | |
| Activation Mechanism | Clone | Gene | Human | Others | References | Models |
| potassium voltage-gated | Kv1.1 | KCNA1 | x | x | 1, 2, 7 | A |
| channel, shaker-related | | | | | | |
| subfamily, member 1 | | | | | | |
| (episodic ataxia with | | | | | | |
| myokymia) | | | | | | |
| potassium voltage-gated | Kv1.2 | KCNA2 | x | 3LUT, | 3, 4 | B |
| channel, shaker-related | | | | 2A79, | | |
| subfamily, member 2 | | | | 4JTC, | | |
| | | | | 2A79 | | |
| potassium voltage-gated | Kv1.3 | KCNA3 | 4BGC | x | 5, 6, 7, 8, | C, D |
| channel, shaker-related | | | | | 9, 10, 11, | |
| subfamily, member 3 | | | | | 12 | |
| potassium voltage-gated | Kv1.6 | KCNA6 | x | x | 1, 13, 14 | E |
| channel, shaker-related | | | | | | |
| subfamily, member 6 | | | | | | |
| potassium voltage-gated | Kv1.8 | KCNA10 | x | x | x | N3 |
| channel, shaker-related | | | | | | |
| subfamily, member 10 | | | | | | |
| potassium voltage-gated | Kvb1.3 | KCNAB1 | x | x | 15, a, b | F, G |
| channel, shaker-related | | | | | | |
| subfamily, beta member 1 | | | | | | |
| potassium voltage-gated | HKvbeta2.1 | KCNAB2 | 1ZSX | x | x | x |
| channel, shaker-related | | | | | | |
| subfamily, beta member 2 | | | | | | |
| potassium voltage-gated | KCNA3B | KCNAB3 | x | x | x | H |
| channel, shaker-related | | | | | | |
| subfamily, beta member 3 | | | | | | |
| potassium voltage-gated | Kv2.1 | KCNB1 | x | 4JTA, | 16, 17, 18, | I |
| channel, Shab-related | | | | 4JTC, | 19, 20 | |
| subfamily, member 1 | | | | 4JTD, | | |
| | | | | 3LNM, | | |
| | | | | 2R9R | | |
| potassium voltage-gated | Kv2.2 | KCNB2 | x | x | x | J |
| channel, Shab-related | | | | | | |
| subfamily, member 2 | | | | | | |
| potassium voltage-gated | Kv3.1 | KCNC1 | x | 3KVT | 21, 22 | K |
| channel, Shaw-related | | | | | | |
| subfamily, member 1 | | | | | | |
| potassium voltage-gated | Kv3.2 | KCNC2 | x | x | 23, c | L |
| channel, Shaw-related | | | | | | |
| subfamily, member 2 | | | | | | |
| potassium voltage-gated | Kv3.3 | KCNC3 | x | x | 24 | M |
| channel, Shaw-related | | | | | | |
| subfamily, member 3 | | | | | | |
| potassium voltage-gated | Kv3.4 | KCNC4 | 1B4G, | x | x | N |
| channel, Shaw-related | | | 1B4I, | | | |
| subfamily, member 4 | | | 1ZTN | | | |
| potassium voltage-gated | Kv4.1 | KCND1 | x | x | 25 | O |
| channel, Shal-related | | | | | | |
| subfamily, member 1 | | | | | | |
| potassium voltage-gated | minK | KCNE1 | 2K21 | x | x | x |
| channel, Isk-related | | | | | | |
| family, member 1 | | | | | | |
| KCNE1-like | | KCNE1L | x | x | x | P |
| potassium voltage-gated | MiRP1 | KCNE2 | x | x | x | Q |
| channel, Isk-related | | | | | | |
| family, member 2 | | | | | | |
| potassium voltage-gated | MiRP2 | KCNE3 | x | x | 26 | R |
| channel, Isk-related | | | | | | |
| family, member 3 | | | | | | |
| potassium voltage-gated | MiRP3 | KCNE4 | x | x | x | x |
| channel, Isk-related | | | | | | |
| family, member 4 | | | | | | |
| potassium voltage-gated | Kv5.1 | KCNF1 | x | x | x | S |
| channel, subfamily F, | | | | | | |
| member 1 | | | | | | |
| potassium voltage-gated | Kv6.1 | KCNG1 | x | x | x | T |
| channel, subfamily G, | | | | | | |
| member 1 | | | | | | |
| potassium voltage-gated | Kv6.2 | KCNG2 | x | x | x | U |
| channel, subfamily G, | | | | | | |
| member 2 | | | | | | |
| potassium voltage-gated | Kv6.3 | KCNG3 | x | x | x | V, W |
| channel, subfamily G, | | | | | | |
| member 3 | | | | | | |
| potassium voltage-gated | Kv6.4 | KCNG4 | x | x | x | X, Y |
| channel, subfamily G, | | | | | | |
| member 4 | | | | | | |
| potassium voltage-gated | Kv10.1 | KCNH1 | x | 4F8A, | 27 | Z, A1 |
| channel, subfamily H | | | | 4HOI, | | |
| (eag-related), member 1 | | | | 4LLO | | |
| potassium voltage-gated | Kv12.2 | KCNH3 | x | x | x | B1 |
| channel, subfamily H | | | | | | |
| (eag-related), member 3 | | | | | | |
| potassium voltage-gated | Kv12.3 | KCNH4 | x | x | x | C1 |
| channel, subfamily H | | | | | | |
| (eag-related), member 4 | | | | | | |
| potassium voltage-gated | Kv10.2 | KCNH5 | x | x | 28, 29, 30 | D1 |
| channel, subfamily H | | | | | | |
| (eag-related), member 5 | | | | | | |
| potassium voltage-gated | Kv11.2 | KCNH6 | x | x | x | E1 |
| channel, subfamily H | | | | | | |
| (eag-related), member 6 | | | | | | |
| potassium voltage-gated | Kv11.3 | KCNH7 | x | x | x | F1 |
| channel, subfamily H | | | | | | |
| (eag-related), member 7 | | | | | | |
| potassium voltage-gated | Kv12.1 | KCNH8 | x | x | 29 | G1 |
| channel, subfamily H | | | | | | |
| (eag-related), member 8 | | | | | | |
| potassium inwardly- | Kir.1.1 | KCNJ1 | x | x | 31, 32, 33 | H1 |
| rectifying channel, | | | | | | |
| subfamily J, member 1 | | | | | | |
| potassium inwardly- | Kir2.3 | KCNJ4 | 3GJ9 | x | 34 | I1 |
| rectifying channel, | | | | | | |
| subfamily J, member 4 | | | | | | |
| potassium inwardly- | Kir3.2 | KCNJ6 | 4KFM | x | x | x |
| rectifying channel, | | | | | | |
| subfamily J, member 6 | | | | | | |
| potassium inwardly- | Kir6.1 | KCNJ8 | x | x | 35 | J1, K1 |
| rectifying channel, | | | | | | |
| subfamily J, member 8 | | | | | | |
| potassium inwardly- | Kir3.3 | KCNJ9 | x | x | x | L1, M1 |
| rectifying channel, | | | | | | |
| subfamily J, member 9 | | | | | | |
| potassium inwardly- | Kir4.1 | KCNJ10 | x | x | 36, 37, 38, | N1, O1 |
| rectifying channel, | | | | | 39, 43, 44, | |
| subfamily J, member 10 | | | | | d | |
| potassium inwardly- | Kir7.1 | KCNJ13 | x | x | 40, 41, 42 | P1 |
| rectifying channel, | | | | | | |
| subfamily J, member 13 | | | | | | |
| potassium inwardly- | Kir2.4 | KCNJ14 | x | x | x | Q1, R1 |
| rectifying channel, | | | | | | |
| subfamily J, member 14 | | | | | | |
| potassium inwardly- | Kir4.2 | KCNJ15 | x | x | x | S1 |
| rectifying channel, | | | | | | |
| subfamily J, member 15 | | | | | | |
| potassium inwardly- | Kir5.1 | KCNJ16 | x | x | 38, 44 | T1 |
| rectifying channel, | | | | | | |
| subfamily J, member 16 | | | | | | |
| potassium inwardly- | Kir2.6 | KCNJ18 | x | x | x | x |
| rectifying channel, | | | | | | |
| subfamily J, member 18 | | | | | | |
| potassium channel, | K2p2.1 | KCNK2 | x | x | 45 | V1 |
| subfamily K, | | | | | | |
| member 2 | | | | | | |
| potassium channel, | K2p3.1 | KCNK3 | x | x | 46 | W1 |
| subfamily K, | | | | | | |
| member 3 | | | | | | |
| potassium channel, | K2p4.1 | KCNK4 | 3UM7, | x | x | x |
| subfamily K, | | | 4I9W | | | |
| member 4 | | | | | | |
| potassium channel, | K2p5.1 | KCNK5 | x | x | 47, e | X1 |
| subfamily K, | | | | | | |
| member 5 | | | | | | |
| potassium channel, | K2p7.1 | KCNK7 | x | x | x | Y1, Z1 |
| subfamily K, | | | | | | |
| member 7 | | | | | | |
| potassium channel, | K2p9.1 | KCNK9 | x | x | 48, 49, 50 | A2, B2 |
| subfamily K, | | | | | | |
| member 9 | | | | | | |
| potassium channel, | K2p10.1 | KCNK10 | 4BW5 | x | x | x |
| subfamily K, | | | | | | |
| member 10 | | | | | | |
| potassium channel, | K2p12.1 | KCNK12 | x | x | 51 | C2, D2 |
| subfamily K, | | | | | | |
| member 12 | | | | | | |
| potassium channel, | K2p13.1 | KCNK13 | x | x | x | E2, F2 |
| subfamily K, | | | | | | |
| member 13 | | | | | | |
| potassium channel, | K2p15.1 | KCNK15 | x | x | x | G2, H2 |
| subfamily K, | | | | | | |
| member 15 | | | | | | |
| potassium channel, | K2p16.1 | KCNK16 | x | x | x | I2, J2 |
| subfamily K, | | | | | | |
| member 16 | | | | | | |
| potassium channel, | K2p17.1 | KCNK17 | x | x | x | K2, L2 |
| subfamily K, | | | | | | |
| member 17 | | | | | | |
| potassium channel, | K2p18.1 | KCNK18 | x | x | 52, 53, 54 | M2 |
| subfamily K, | | | | | | |
| member 18 | | | | | | |
| potassium large | KCa1.1 | KCNMA1 | 3MT5, | x | x | x |
| conductance calcium- | | | 3NAF | | | |
| activated | | | | | | |
| channel, subfamily M, | | | | | | |
| alpha member 1 | | | | | | |
| potassium large | hslo-beta | KCNMB1 | x | x | x | N2 |
| conductance calcium- | | | | | | |
| activated channel, | | | | | | |
| subfamily M, beta | | | | | | |
| member 1 | | | | | | |
| potassium large | | KCNMB2 | 1JO6 | x | x | O2 |
| conductance calcium- | | | | | | |
| activated channel, | | | | | | |
| subfamily M, beta | | | | | | |
| member 2 | | | | | | |
| potassium large | | KCNMB3 | x | x | x | P2 |
| conductance calcium- | | | | | | |
| activated channel, | | | | | | |
| subfamily M, beta | | | | | | |
| member 3 | | | | | | |
| potassium large | KCNMB3 | KCNMB3 | x | x | x | x |
| conductance calcium- | L1 | P1 | | | | |
| activated channel, | | | | | | |
| subfamily M, beta | | | | | | |
| member 3, pseudogene 1 | | | | | | |
| potassium large | | KCNMB4 | x | x | x | Q2 |
| conductance calcium- | | | | | | |
| activated channel, | | | | | | |
| subfamily M, beta | | | | | | |
| member 4 | | | | | | |
| potassium | KCa2.1 | KCNN1 | x | x | x | R2 |
| intermediate/small | | | | | | |
| conductance calcium- | | | | | | |
| activated channel, | | | | | | |
| subfamily N, member 1 | | | | | | |
| potassium | KCa2.2 | KCNN2 | x | 3SJQ | 55 | S2, T2 |
| intermediate/small | | | | | | |
| conductance calcium- | | | | | | |
| activated channel, | | | | | | |
| subfamily N, member 2 | | | | | | |
| potassium | KCa2.3 | KCNN3 | x | x | x | U2, V2, |
| intermediate/small | | | | | | W2. X2 |
| conductance calcium- | | | | | | |
| activated channel, | | | | | | |
| subfamily N, member 3 | | | | | | |
| potassium | KCa3.1 | KCNN4 | x | x | 56-63 | Y2 |
| intermediate/small | | | | | | |
| conductance calcium- | | | | | | |
| activated channel, | | | | | | |
| subfamily N, member 4 | | | | | | |
| potassium voltage-gated | Kv7.2 | KCNO2 | x | x | 64-70 | Z2 |
| channel, KQT-like | | | | | | |
| subfamily, member 2 | | | | | | |
| potassium voltage-gated | Kv7.3 | KCNO3 | x | x | 64, 65 | A3 |
| channel, KQT-like | | | | | | |
| subfamily, member 3 | | | | | | |
| potassium voltage-gated | Kv7.4 | KCNO4 | 2OVC, | x | 71 | B3 |
| channel, KQT-like | | | 4GOW | | | |
| subfamily, member 4 | | | | | | |
| potassium voltage-gated | Kv7.5 | KCNO5 | x | x | x | C3, D3 |
| channel, KQT-like | | | | | | |
| subfamily, member 5 | | | | | | |
| potassium voltage-gated | Kv9.1 | KCNS1 | x | x | x | E3, F3 |
| channel, delayed-rectifier, | | | | | | |
| subfamily S, member 1 | | | | | | |
| potassium voltage-gated | Kv9.2 | KCNS2 | x | x | x | G3 |
| channel, delayed-rectifier, | | | | | | |
| subfamily S, member 2 | | | | | | |
| potassium voltage-gated | Kv9.3 | KCNS3 | x | x | x | H3 |
| channel, delayed-rectifier, | | | | | | |
| subfamily S, member 3 | | | | | | |
| potassium channel, | KCa4.1 | KCNT1 | x | x | x | I3 |
| subfamily T, member 1 | | | | | | |
| potassium channel, | KCa4.2 | KCNT2 | x | x | x | J3 |
| subfamily T, member 2 | | | | | | |
| potassium channel, | KCa5.1 | KCNU1 | 4HPF | x | x | K3 |
| subfamily U, member 1 | | | | | | |
| potassium channel, | Kv8.1 | KCNV1 | x | x | x | L3 |
| subfamily V, member 1 | | | | | | |
| potassium channel, | Kv8.2 | KCNV2 | x | x | x | M3 |
| subfamily V, member 2 | | | | | | |

```
References:
a) http://www.proteinmodelportal.org/?pid=modelDetail&provider=SWISSMODEL&template=3eauA&pmpuid=1000000555961&range_from=1&range_to=419&ref_ac=Q14722&zid=async
b) http://www.proteinmodelportal.org/?pid=modelDetail&provider=MODBASE&template=3eauA&pmpuid=1000016941680&range_from=1&range_to=419&ref_ac=Q14722&zidsync
c) http://swissmodel.expasy.org/repository/?pid=smr03&mid=md8253724a3907c2e8717209b372bd4a3_s385_e499_t3o7x&query_1_input=Q14B80
d) http://www.physoc.org/proceedings/abstract/J%20Physiol%20567PPC145 Proceedings of The Physiological Society, poster abstract.
e) http://accelrys.com/resource-center/case-studies/pdf/electrostatics_task2.pdf Tools and methods used in Discovery Studio ® for the visualization, characterization and analysis of the electrostatic effects on the alkali-activatedK+ channel, TASK-2. Application guide from accelrys.
  1. Liu H-L, Lin J-C. A set of homology models of pore loop domain of six eukaryotic voltage-gated potassium channels Kv1.1-Kv1.6. Proteins. 2004; 55(3):558-67. Available at: http://www.ncbi.nlm.nih.gov/pubmed/15103620. Accessed Nov. 6, 2013.
  2. Perry M D, Wong S, Ng C A, Vandenberg J I. Hydrophobic interactions between the voltage sensor and pore mediate inactivation in Kv11.1 channels. J. Gen. Physiol. 2013; 142(3):275-88. Available at: http://www.ncbi.nlm.nih.gov/pubmed/23980196. Accessed Nov. 14, 2013.
  3. Sand R, Sharmin N, Morgan C, Gallin W J. Fine-tuning of voltage sensitivity of the Kv1.2 potassium channel by interhelix loop dynamics. J. Biol. Chem. 2013; 288(14):9686-95. Available at: http://www.jbc.org/content/288/14/9686.long. Accessed Nov. 14, 2013.
  4. Jogini V, Roux B. Dynamics of the Kv1.2 voltage-gated K+ channel in a membrane environment. Biophys. J. 2007; 93(9):3070-82. Available at: http://www.pubmedcentral.nih.gov/articlerender.fcgi?artid=2025645&tool=pmcentrez&rendertype=abstract. Accessed Nov. 14, 2013.
  5. Chen R, Robinson A, Gordon D, Chung S-H. Modeling the binding of three toxins to the voltage-gated potassium channel (Kv1.3). Biophys. J. 2011; 101(11):2652-60. Available at: http://www.pubmedcentral.nih.gov/articlerender.fcgi?artid=3297799&tool=pmcentrez&rendertype=abstract. Accessed Nov. 14, 2013.
  6. Hamer M, Green B, Gao Y-D, et al. Binding of Correolide to the K v 1.3 Potassium Channel: Characterization of the Binding Domain by Site-Directed Mutagenesis †. Biochemistry. 2001; 40(39):11687-11697. Available at: http://dx.doi.org/10.1021/bi0111698. Accessed Nov. 14, 2013.
  7. Rashid M H, Kuyucak S. Affinity and Selectivity of ShK Toxin for the Kv1 Potassium Channels from Free Energy Simulations. J. Phys. Chem. B. 2012. Available at: http://www.ncbi.nlm.nih.gov/pubmed/22480371. Accessed Nov. 14, 2013.
  8. Pegoraro S, Lang M, Dreker T, et al. Inhibitors of potassium channels KV1.3 and IK-1 as immunosuppressants. Bioorg. Med. Chem. Lett. 2009; 19(8):2299-2304. Available at: http://www.sciencedirect.com/science/article/pii/S0960894X09002315. Accessed Nov. 14, 2013.
  9. Rossokhin A, Dreker T, Grissmer S, Zhorov B S. Why does the inner-helix mutation A413C double the stoichiometry of Kv1.3 channel block by emopamil but not by verapamil? Mol. Pharmacol. 2011; 79(4):681-91. Available at: http://www.ncbi.nlm.nih.gov/pubmed/21220411. Accessed Nov. 14, 2013.
10. Yu K, Fu W, Liu H, et al. Computational simulations of interactions of scorpion toxins with the voltage-gated potassium ion channel. Biophys. J. 2004; 86(6):3542-55. Available at: http://www.pubmedcentral.nih.gov/articlerender.fcgi?artid=1304258&tool=pmcentrez&rendertype=abstract. Accessed Nov. 14, 2013.
11. Rauer H. Structure-guided Transformation of Charybdotoxin Yields an Analog That Selectively Targets Ca2+-activated over Voltage-gated K+ Channels. J. Biol. Chem. 2000; 275(2):1201-1208. Available at: http://www.jbc.org/content/275/2/1201.short. Accessed Nov. 14, 2013.
12. Zimin P I, Garic B, Bodendiek S B, Mahieux C, Wulff H, Zhorov B S. Potassium channel block by a tripartite complex of two cationophilic ligands and a potassium ion. Mol. Pharmacol. 2010; 78(4):588-99. Available at: http://molpharm.aspetjournals.org/content/78/4/588.full. Accessed Nov. 14, 2013.
13. Liu H-L, Chen C-W, Lin J-C. Homology models of the tetramerization domain of six eukaryotic voltage-gated potassium channels Kv1.1-Kv1.6. J. Biomol. Struct. Dyn. 2005; 22(4):387-98. Available at: http://www.ncbi.nlm.nih.gov/pubmed/15588103. Accessed Nov. 6, 2013.
14. Mondal S, Babu R M, Bhavna R, Ramakumar S. In silico detection of binding mode of J-superfamily conotoxin pl14a with Kv1.6 channel. In Silico Biol. 2007; 7(2):175-86. Available at: http://www.ncbi.nlm.nih.gov/pubmed/17688443. Accessed Nov. 14, 2013.
15. Ravens U, Wettwer E. Ultra-rapid delayed rectifier channels: molecular basis and therapeutic implications. Cardiovasc. Res. 2011; 89(4):776-85. Available at: http://www.ncbi.nlm.nih.gov/pubmed/21159668. Accessed Nov. 14, 2013.
16. Chen R, Robinson A, Chung S-H. Binding of hanatoxin to the voltage sensor of Kv2.1. Toxins (Basel). 2012; 4(12):1552-64. Available at: http://www.pubmedcentral.nih.gov/articlerender.fcgi?artid=3528262&tool=pmcentrez&rendertype=abstract. Accessed Nov. 14, 2013.
17. Ju M, Stevens L, Leadbitter E, Wray D. The Roles of N- and C-terminal determinants in the activation of the Kv2.1 potassium channel. J. Biol. Chem. 2003; 278(15):12769-78. Available at: http://www.jbc.org/content/278/15/12769.full. Accessed Nov. 14, 2013.
18. Madeja M, Steffen W, Mesic I, Garic B, Zhorov B S. Overlapping binding sites of structurally different antiarrhythmics flecainide and propafenone in the subunit interface of potassium channel Kv2.1. J. Biol. Chem. 2010; 285(44):33898-905. Available at: http://www.pubmedcentral.nih.gov/articlerender.fcgi?artid=2962489&tool=pmcentrez&rendertype=abstract. Accessed Nov. 14, 2013.
19. Nilsson J, Madeja M, Arhem P. Local anesthetic block of Kv channels: role of the S6 helix and the S5-S6 linker for bupivacaine action. Mol. Pharmacol. 2003; 63(6):1417-29. Available at: http://molpharm.aspetjournals.org/content/63/6/1417.long. Accessed Nov. 14, 2013.
20. Shiau Y-S, Huang P-T, Liou H-H, Liaw Y-C, Shiau Y-Y, Lou K-L. Structural basis of binding and inhibition of novel tarantula toxins in mammalian voltage-dependent potassium channels. Chem. Res. Toxicol. 2003; 16(10):1217-25. Available at: http://dx.doi.org/10.1021/tx0341097. Accessed Nov. 14, 2013.
21. Herrera D, Mamarbachi A, Simoes M, et al. A single residue in the S6 transmembrane domain governs the differential flecainide sensitivity of voltage-gated potassium channels. Mol. Pharmacol. 2005; 68(2):305-16. Available at: http://www.ncbi.nlm.nih.gov/pubmed/15883204. Accessed Nov. 6, 2013.
22. Kopljar I, Labro A J, Cuypers E, et al. A polyether biotoxin binding site on the lipid-exposed face of the pore domain of Kv channels revealed by the marine toxin gambierol. Proc. Natl. Acad. Sci. U.S.A. 2009; 106(24):9896-901. Available at: http://www.pnas.org/content/106/24/9896.long. Accessed Nov. 6, 2013.
23. Klassen T L, Spencer A N, Gallin W J. A naturally occurring omega current in a Kv3 family potassium channel from a platyhelminth. BMC Neurosci. 2008; 9(1):52. Available at: http://www.biomedcentral.com/1471-2202/9/52. Accessed Nov. 14, 2013.
24. Sand R M, Atherton D M, Spencer A N, Gallin W J. jShawl, a low-threshold, fast-activating K(v)3 from the hydrozoan jellyfish Polyorchis penicillatus. J. Exp. Biol. 2011; 214(Pt 18):3124-37. Available at: http://www.ncbi.nlm.nih.gov/pubmed/21865525. Accessed Nov. 14, 2013.
25. DeSimone C V, Zarayskiy V V, Bondarenko V E, Morales M J. Heteropoda toxin 2 interaction with Kv4.3 and Kv4.1 reveals differences in gating modification. Mol. Pharmacol. 2011; 80(2):345-55. Available at: http://www.ncbi.nlm.nih.gov/pubmed/21540294. Accessed Nov. 14, 2013.
26. Choi E, Abbott G W. A shared mechanism for lipid- and beta-subunit-coordinated stabilization of the activated K+ channel voltage sensor. FASEB J. 2010; 24(5):1518-24. Available at: http://www.pubmedcentral.nih.gov/articlerender.fcgi?artid=2879946&tool=pmcentrez&rendertype=abstract. Accessed Nov. 15, 2013.
27. Garg V, Stary-Weinzinger A, Sanguinetti M C. ICA-105574 interacts with a common binding site to elicit opposite effects on inactivation gating of EAG and ERG potassium channels. Mol. Pharmacol. 2013; 83(4):805-13. Available at: http://molpharm.aspetjournals.org/content/83/4/805.full. Accessed Nov. 15, 2013.
28. Sokolova O S, Shaitan K V, Grizel' A V, Popinako A V. Karlova M G, Kirpichnikov M P. [Three-dimensional structure of human Kv10.2 ion channel studied by single particle electron microscopy and molecular modeling]. Bioorg. Khim. 38(2):177-84. Available at: http://www.ncbi.nlm.nih.gov/pubmed/22792721. Accessed Nov. 15, 2013.
29. Zhang X, Bursulaya B, Lee C C, Chen B, Pivaroff K. Jegla T. Divalent cations slow activation of EAG family K+ channels through direct binding to S4. Biophys. J. 2009; 97(1):110-20. Available at: http://www.pubmedcentral.nih.gov/articlerender.fcgi?artid=2711382&tool=pmcentrez&rendertype=abstract. Accessed Nov. 15, 2013.
30. Yang Y, Vasylyev D V, Dib-Hajj F, et al. Multistate Structural Modeling and Voltage-Clamp Analysis of Epilepsy/Autism Mutation Kv10.2-R327H Demonstrate the Role of This Residue in Stabilizing the Channel Closed State. J. Neurosci. 2013; 33(42):16586-93. Available at: http://www.jneurosci.org/content/33/42/16586.short. Accessed Nov. 15, 2013.
31. Sackin H, Nanazashvili M, Palmer L G, Krambis M, Walters D E. Structural locus of the pH gate in the Kir1.1 inward rectifier channel. Biophys. J. 2005; 88(4):2597-606. Available at: http://www.pubmedcentral.nih.gov/articlerender.fcgi?artid=1305356&tool=pmcentrez&rendertype=abstract. Accessed Nov. 15, 2013.
32. Rapedius M, Haider S, Browne K F, et al. Structural and functional analysis of the putative pH sensor in the Kir1.1 (ROMK) potassium channel. EMBO Rep. 2006; 7(6):611-6. Available at: http://www.pubmedcentral.nih.gov/articlerender.fcgi?artid=1479598&tool=pmcentrez&rendertype=abstract. Accessed Nov. 15, 2013.
33. Sackin H, Nanazashvili M, Li H, Palmer L G, Walters D E. An Intersubunit Salt Bridge near the Selectivity Filter Stabilizes the Active State of Kir1.1. Biophys. J. 2009; 97(4):1058-1066. Available at: http://www.sciencedirect.com/science/article/pii/S0006349509011503. Accessed Nov. 15, 2013.
34. Ureche O N, Baltaev R, Ureche L, Strutz-Seebohm N, Lang F, Seebohm G. Novel insights into the structural basis of pH-sensitivity in inward rectifier K+ channels Kir2.3. Cell. Physiol. Biochem. 2008; 21(5-6):347-56. Available at: http://www.karger.com/Article/FullText/129629. Accessed Nov. 15, 2013.
35. Li A, Knutsen R H, Zhang H, et al. Hypotension due to Kir6.1 gain-of-function in vascular smooth muscle. J. Am. Heart Assoc. 2013; 2(4):e000365. Available at: http://jaha.ahajournals.org/content/2/4/e000365.full. Accessed Nov. 15, 2013.
36. Furutani K, Ohno Y, Inanobe A, Hibino H, Kurachi Y. Mutational and in silico analyses for antidepressant block of astroglial inward-rectifier Kir4.1 channel. Mol. Pharmacol. 2009; 75(6):1287-95. Available at: http://molpharm.aspetjournals.org/content/75/6/1287.full. Accessed Nov. 15, 2013.
37. Rapedius M, Paynter J J, Fowler P W, et al. Control of pH and PIP2 gating in heteromeric Kir4.1/Kir5.1 channels by H-Bonding at the helix-bundle crossing. Channels (Austin). 1(5):327-30. Available at: http://www.ncbi.nlm.nih.gov/pubmed/18690035. Accessed Nov. 15, 2013.
38. Shang L, Tucker S J. Non-equivalent role of TM2 gating hinges in heteromeric Kir4.1/Kir5.1 potassium channels. Eur. Biophys. J. 2008; 37(2):165-71. Available at: http://www.pubmedcentral.nih.gov/articlerender.fcgi?artid=2190780&tool=pmcentrez&rendertype=abstract. Accessed Nov. 15, 2013.
39. Williams D M, Lopes C M B, Rosenhouse-Dantsker A, et al. Molecular basis of decreased Kir4.1 function in SeSAME/EAST syndrome. J. Am. Soc. Nephrol. 2010; 21(12):2117-29. Available at: http://www.pubmedcentral.nih.gov/articlerender.fcgi?artid=3014025&tool=pmcentrez&rendertype=abstract. Accessed Nov. 15, 2013.
40. Hejtmancik J F, Jiao X, Li A, et al. Mutations in KCNJ13 Cause Autosomal-Dominant Snowflake Vitreoretinal Degeneration. Am. J. Hum. Genet. 2008; 82(1):174-180. Available at: http://www.sciencedirect.com/science/article/pii/50002929707000031. Accessed Nov. 15, 2013.
41. Iwashita M, Watanabe M, Ishii M, et al. Pigment Pattern in jaguar/obelix Zebrafish Is Caused by a Kir7.1 Mutation: Implications for the Regulation of Melanosome Movement. Barsh G, ed. PLoS Genet. 2006; 2(11):e197. Available at: http://dx.plos.org/10.1371/journal.pgen.0020197. Accessed Nov. 9, 2013.
42. Pattnaik B R, Tokarz 5, Asuma M P, et al. Snowflake vitreoretinal degeneration (SVD) mutation R162W provides new insights into Kir7.1 ion channel structure and function. PLoS One. 2013; 8(8):e71744. Available at: http://www.pubmedcentral.nih.gov/articlerender.fcgi?artid=3747230&tool=pmcentrez&rendertype=abstract. Accessed Nov. 15, 2013.
43. Chu C T, Sicca F, Imbrici P, et al. Autism with Seizures and Intellectual Disability: Possible Causative Role of Gain-of-function of the Inwardly-Rectifying K+ Channel Kir4.1. Neurobiol. Dis. 2011; 43(1):239-247. Available at: http://www.sciencedirect.com/science/article/pii/S0969996111000982. Accessed Nov. 15, 2013.
44. Shang L, Lucchese C J, Haider S, Tucker S J. Functional characterisation of missense variations in the Kir4.1 potassium channel (KCNJ10) associated with seizure susceptibility. Mol. Brain Res. 2005; 139(1):178-183. Available at: http://www.sciencedirect.com/science/article/pii/S0169328X05002044. Accessed Nov. 15, 2013.
45. Kollewe A, Lau A Y, Sullivan A, Roux B, Goldstein S A N. A structural model for K2P potassium channels based on 23 pairs of interacting sites and continuum electrostatics. J. Gen. Physiol. 2009; 134(1):53-68. Available at: http://jgp.rupress.org/content/134/1/53.full. Accessed Nov. 15, 2013.
46. Streit A K, Netter M F, Kempf F, et al. A specific two-pore domain potassium channel blocker defines the structure of the TASK-1 open pore. J. Biol. Chem. 2011; 286(16):13977-84. Available at: http://www.pubmedcentral.nih.gov/articlerender.fcgi?artid=3077598&tool=pmcentrez&rendertype=abstract. Accessed Nov. 15, 2013.
47. Niemeyer M I, González-Nilo F D, Zúñiga L, González W, Cid L P, Sepúlveda F V. Neutralization of a single arginine residue gates open a two-pore domain, alkali-activated K+ channel. Proc. Natl. Acad. Sci. U.S.A. 2007; 104(2):666-71. Available at: http://www.pnas.org/content/104/2/666.full. Accessed Nov. 15, 2013.
48. Ashmole I, Vavoulis D V, Stansfeld P J, et al. The response of the tandem pore potassium channel TASK-3 (K(2P)9.1) to voltage: gating at the cytoplasmic mouth. J. Physiol. 2009; 587(Pt 20):4769-83. Available at: http://www.pubmedcentral.nih.gov/articlerender.fcgi?artid=2770146&tool=pmcentrez&rendertypetbstract. Accessed Nov. 15, 2013.
49. González W, Zúñiga L, Cid L P, Arévalo B, Niemeyer M I, Sepúlveda F V. An extracellular ion pathway plays a central role in the cooperative gating of a K(2P) K+ channel by extracellular pH. J. Biol. Chem. 2013; 288(8):5984-91. Available at: http://www.ncbi.nlm.nih.gov/pubmed/23319597. Accessed Nov. 15, 2013.
50. Mathie A, Al-Moubarak E, Veale E L. Gating of two pore domain potassium channels. J. Physiol. 2010; 588(Pt 17):3149-56. Available at: http://www.pubmedcentral.nih.gov/articlerender.fcgi?artid=2976010&tool=pmcentrez&rendertype=abstract. Accessed Nov. 8, 2013.
51. Chatelain F C, Bichet D, Feliciangeli S, et al. THIK2 potassium channel silencing relies on combined intracellular retention and low intrinsic activity at the plasma membrane. J. Biol. Chem. 2013: M113.503318-. Available at: http://www.jbc.org/content/early/2013/10/25/jbc.M113.503318.abstract. Accessed Nov. 15, 2013.
52. Andres-Enguix I, Shang L, Stansfeld P J, et al. Functional analysis of missense variants in the TRESK (KCNK18) K channel. Sci. Rep. 2012; 2:237. Available at: http://www.nature.com/srep/2012/120127/srep00237/full/srep00237.html?WT.ec_id=SREP-631-20120201. Accessed Nov. 15, 2013.
53. Kim S, Lee Y, Tak H-M, et al. Identification of blocker binding site in mouse TRESK by molecular modeling and mutational studies. Biochim. Biophys. Acta. 2013; 1828(3):1131-42. Available at: http://www.ncbi.nlm.nih.gov/pubmed/23200789. Accessed Nov. 15, 2013.
54. Pain: New Insights for the Healthcare Professional: 2013 Edition (Google eBook). ScholarlyEditions; 2013:647. Available at: http://books.google.com/books?id=RViI916bD-IC&pgis=1. Accessed Nov. 15, 2013.
55. Goodchild S J, Lamy C, Seutin V, Marrion N V. Inhibition of K(Ca)2.2 and K(Ca)2.3 channel currents by protonation of outer pore histidine residues. J. Gen. Physiol. 2009; 134(4):295-308. Available at: http://jgp.rupress.org/content/134/4/295.full. Accessed Nov. 15, 2013.
56. Bailey M A, Grabe M, Devor D C. Characterization of the PCMBS-dependent modification of KCa3.1 channel gating. J. Gen. Physiol. 2010; 136(4):367-87. Available at: http://jgp.rupress.org/content/136/4/367.full. Accessed Nov. 15, 2013.
57. Banderali U, Klein H, Garneau L, Simoes M, Parent L, Sauvé R. New insights on the voltage dependence of the KCa3.1 channel block by internal TBA. J. Gen. Physiol. 2004; 124(4):333-48. Available at: http://www.pubmedcentral.nih.gov/articlerender.fcgi?artid=2233899&tool=pmcentrez&rendertype=abstract. Accessed Nov. 15, 2013.
58. Chen R, Chung S-H. Molecular Dynamics Simulations of Scorpion Toxin Recognition by the Ca(2+)-Activated Potassium Channel KCa3.1. Biophys. J. 2013; 105(8):1829-37. Available at: http://www.cell.com/biophysj/fulltext/S0006-3495(13)01018-7. Accessed Nov. 15, 2013.
59. Garneau L, Klein H, Banderali U, Longpré-Lauzon A, Parent L, Sauvé R. Hydrophobic interactions as key determinants to the KCa3.1 channel closed configuration. An analysis of KCa3.1 mutants constitutively active in zero Ca2+. J. Biol. Chem. 2009; 284(1):389-403. Available at: http://www.jbc.org/content/284/1/389.long. Accessed Nov. 15, 2013.
60. Hoffman P N. Tau -rings and Wreath Product Representations. Springer; 1979:148. Available at: http://books.google.com/books?id=rfAb_DTS7vwC&pgis=1. Accessed Nov. 15, 2013.
61. Morales P, Gameau L, Klein H, Lavoie M-F, Parent L, Sauvé R. Contribution of the KCa3.1 channel-calmodulin interactions to the regulation of the KCa3.1 gating process. J. Gen. Physiol. 2013; 142(1):37-
60. Available at: http://www.ncbi.nlm.nih.gov/pubmed/23797421. Accessed Nov. 15, 2013.
62. Newell GF. Signal Transduction in the Cardiovascular System in Health and Disease (Google eBook). Springer; 2008:442. Available at: http://books.google.com/books?id=R5T6XEY9Y5EC&pgis=1. Accessed Nov. 15, 2013.
63. Srivastava A K, Anand-Srivastava M B, eds. Signal Transduction in the Cardiovascular System in Health and Disease. Boston, MA: Springer US; 2008. Available at: http://www.springerlink.com/index/10.1007/978-0-387-09552-3. Accessed Nov. 15, 2013.
64. Füll Y, Seebohm G, Lerche H, Maljevic S. A conserved threonine in the S1-S2 loop of KV7.2 and KV7.3 channels regulates voltage-dependent activation. Pflugers Arch. 2013; 465(6):797-804. Available at: http://www.ncbi.nlm.nih.gov/pubmed/23271449. Accessed Nov. 15, 2013.
65. Hernandez C C, Zaika O, Shapiro M S. A carboxy-terminal inter-helix linker as the site of phosphatidylinositol 4,5-bisphosphate action on Kv7 (M-type) K+ channels. J. Gen. Physiol. 2008; 132(3):361-81. Available at: http://www.pubmedcentral.nih.gov/articlerender.fcgi?artid=2518730&tool=pmcentrez&rendertype=abstract. Accessed Nov. 15, 2013.
66. Miceli F, Soldovieri M V, Iannotti F A, et al. The Voltage-Sensing Domain of K(v)7.2 Channels as a Molecular Target for Epilepsy-Causing Mutations and Anticonvulsants. Front. Pharinacol. 2011; 2:2. Available at: http://www.pubmedcentral.nih.gov/articlerender.fcgi?artid=3108560&tool=pmcentrez&rendertype=abstract. Accessed Nov. 15, 2013.
67. Miceli F, Soldovieri M V, Ambrosino P, et al. Genotype-phenotype correlations in neonatal epilepsies caused by mutations in the voltage sensor of K(v)7.2 potassium channel subunits. Proc. Natl. Acad. Sci. U.S.A. 2013; 110(11):4386-91. Available at: http://www.pubmedcentral.nih.gov/articlerender.fcgi?artid=3600471&tool=pmcentrez&rendertype=abstract. Accessed Nov. 15, 2013.
68. Peretz A, Pell L, Gofman Y, et al. Targeting the voltage sensor of Kv7.2 voltage-gated K+ channels with a new gating-modifier. Proc. Natl. Acad. Sci. U.S.A. 2010; 107(35):15637-42. Available at: http://www.pnas.org/content/107/35/15637.full. Accessed Nov. 15, 2013.
69. Wuttke T V, Seebohm G, Bail S, Maljevic S, Lerche H. The new anticonvulsant retigabine favors voltage-dependent opening of the Kv7.2 (KCNQ2) channel by binding to its activation gate. Mol. Pharmacol. 2005; 67(4):1009-17. Available at: http://www.ncbi.nlm.nih.gov/pubmed/15662042. Accessed Nov. 15, 2013.
70. Wuttke T V, Penzien J, Fauler M, et al. Neutralization of a negative charge in the S1-S2 region of the KV7.2 (KCNQ2) channel affects voltage-dependent activation in neonatal epilepsy. J. Physiol. 2008; 586(2):545-55. Available at: http://www.pubmedcentral.nih.gov/articlerender.fcgi?artid=2375582&tool=pmcentrez&rendertype=abstract. Accessed Nov. 15, 2013.
71. Miceli F, Vargas E, Bezanilla F, Taglialatela M. Gating currents from Kv7 channels carrying neuronal hyperexcitability mutations in the voltage-sensing domain. Biophys. J. 2012; 102(6):1372-82. Available at: http://www.pubmedcentral.nih.gov/articlerender.fcgi?artid=3309409&tool=pmcentrez&rendertype=abstract. Accessed Nov. 15, 2013.
Models:
(sources: http://swissmodel.expasy.org/repository/, http://modbase.compbio.ucsf.edu/modbase-cgi/index.cgi)
A) http://swissmodel.expasy.org/repository/?pid=smr03&query_1_input=Q09470&zid=async
B) http://swissmodel.expasy.org/repository/?pid=smr03&query_1_input=P16389&zid=async
C) http://modbase.compbio.ucsf.edu/modbase-cgi/model_details.cgi?queryfile=1384565596_7269&searchmode=default&displaymode=moddetail&seq_id=a8e3ea70b4e009bdef6948755d5c327aMTVVFTDV
D) http://swissmodel.expasy.org/repository/?pid=smr03&query_1_input=P22001&zid=async
E) http://swissmodel.expasy.org/repository/?pid=smr03&query_1_input=P17658&zid=async
F) http://swissmodel.expasy.org/repository/?pid=smr03&query_1_input=Q5MJQ3&zid=async
G) http://swissmodel.expasy.org/repository/?pid=smr03&query_1_input=Q14722&zid=async
H) http://swissmodel.expasy.org/repository/?pid=smr03&query_1_input=O43448&zid=async
I) http://swissmodel.expasy.org/repository/?pid=smr03&query_1_input=Q14721&zid=async
J) http://swissmodel .expasy.org/repository/?pid=smr03&query_1_input=Q92953&zid=async
K) http://swissmodel.expasy.org/repository/?pid=smr03&query_1_input=P48547&zid=async
L) http://swissmodel.expasy.org/repository/?pid=smr03&query_1_input=Q96PRl&zid=async
M) http://swissmodel.expasy.org/repository/?pid=smr03&query_1_input=Q14003&zid=async
N) http://swissmodel.expasy.org/repository/?pid=smr03 &query_1_input=Q03721&zid=async
O) http://swissmodel.expasy.org/repository/?pid=smr03&query_1_input=Q9NSA2&zid=async
P) http://modbase.compbio.ucsf.edu/modbase-cgi/model_details.cgi?queryfile=1384567151_7525&searchmode=default&displaymode=moddetail&seq_id=a36ecdb42d9c87b885bd99604960010dMNCSAERV
Q) http://modbase.compbio.ucsf.edu/modbase-cgi/model_details.cgi?queryfile=1384567213_1354&searchmode=default&displaymode=moddetail&seq_id=b601aea988df78e26c0654a4d34eeed9MSTLKMSP
R) http://modbase.compbio.ucsf.edu/modbase-cgi/model_details.cgi?queryfile=1384567294_9606&searchmode=default&displaymode=moddetail&seq_id=a3c0482c15355abfa32f6c58877f8057METTVSMI
S) http://swissmodel.expasy.org/repository/?pid=smr03&query_1_input=Q9H3M0&zid=async
T) http://swissmodel.expasy.org/repository/?pid=smr03&query_1_input=Q9UIX4&zid=async
U) http://swissmodel.expasy.org/repository/?pid=smr03&query_1_input=Q9UJ96&zid=async
V) http://swissmodel.expasy.org/repository/?pid=smr03&query_1_input=Q547S7&zid=async
W) http://swissmodel.expasy.org/repository/?pid=smr03&query_1_input=Q8TAE7&zid=async
X) http://modbase.compbio.ucsf.edu/modbase-cgi/query_results.cgi?queryfile=1384567916_8804&searchmode=default &displaymode=overseqview&referer=yes&
Y) http://swissmodel.expasy.org/repository/?pid=smr03&query_1_input=Q71ME5&zid=async
Z) http://swissmodel.expasy.org/repository/?pid=smr03&query_1_input=Q8TAE7&zid=async
A1) http://modbase.compbio.ucsf.edu/modbase-cgi/model_details.cgi?queryfile=1384567998_8594&searchmode=default&displaymode=moddetail&seq_id=4c4911c8ca1747c6d2a5c78941e55206MTMAFGAS
B1) http://swissmodel.expasy.org/repository/?pid=smr03&query_1_input=Q9ULD8&zid=async
C1) http://swissmodel.expasy.org/repository/?pid=smr03&query_1_input=Q9UQ05&zid=async
D1) http://swissmodel.expasy.org/repository/?pid=smr03&query_1_input=Q8NCM2&zid=async
E1) http://swissmodel.expasy.org/repository/?pid=smr03&query_1_input=Q9H252&zid=async
F1) http://swissmodel.expasy.org/repository/?pid=smr03&query_1_input=Q9NS40&zid=async
G1) http://swissmodel.expasy.org/repository/?pid=smr03&query_1_input=Q96L42&zid=async
H1) http://swissmodel.expasy.org/repository/?pid=smr03&query_1_input=P48048&zid=async
I1) http://swissmodel.expasy.org/repository/?pid=smr03& query_1_input=P48050&zid=async
J1) http://swissmodel.expasy.org/repository/?pid=smr03&query_1_input=Q15842&zid=async
K1) http://modbase.compbio.ucsf.edu/modbase-cgi/model_details.cgi?queryfile=1384568700_9407&searchmode=default&displaymode=moddetail&seq_id=55ee0abb20c7d744d677fdeld147529cMLARTSES
L1) http://swissmodel.expasy.org/repository/?pid=smr03&query_1_input=Q92806&zid=async
M1) http://modbase.compbio.ucsf.edu/modbase-cgi/model_details.cgi?queryfile=1384568807_5677&searchmode=default&displaymode=moddetail&seq_id=ddb18c50ed3945d84ad617e3b722b466MAQEESKV
N1) http://swiss model.expasy.org/repository/?pid=smr03&query_1_input=P78508&zid=async
O1) http://modbase.compbio.ucsfedu/modbase-cgi/model_details.cgi?queryfile=1384568899_3338&searchmode=default&displaymode=moddetail&seq_id=67611afa27e8cc1cd8ea6744b48fde64MTSVISNV
P1) http://swissmodel.expasy.org/repository/?pid=smr03&query_1_input=O60928&zid=async
Q1) http://swissmodel.expasy.org/repository/?pid=smr03&query_1_input=Q9UNX9&zid=async
R1) http://modbase.compbio.ucsf.edu/modbase-cgi/model_details.cgi?queryfile=1384569104_5858&searchmode=default&displaymode=moddetail&seq_id=afdb260037b6f98c3a93518108533d95MGLATLPP
S1) http://swissmodel.expasy.org/repository/?pid=smr03&query_1_input=Q99712&zid=async
T1) http://swissmodel.expasy.org/repository/?pid=smr03&query_1_input=Q9NPI9&zid=async
V1) http://modbase.compbio.ucsf.edu/modbase-cgi/model_details.cgi?queryfile=1384569353_4909&searchmode=default&displaymode=moddetail&seq_id=9af5bc61ad5145d910b7d3814a72688bMLPSENIK
W1) http://swissmodel.expasy.org/repository/?pid=smr03&query_1_input=O14649&zid=async
X1) http://swissmodel.expasy.org/repository/?pid=smr03&query_1_input=O95279&zid=async
Y1) http://modbase.compbio.ucsf.edu/modbase-cgi/model_details.cgi?queryfile=1384569593_7302&searchmode=default&displaymode=moddetail&seq_id=36aaef5df5ce07529d58961ba2108236MGGLAWEG
Z1) http://swissmodel.expasy.org/repository/?pid=smr03&query_1_input=Q9Y2U2&zid=async
A2) http://swissmodel.expasy.org/repository/?pid=smr03&query_1_input=Q9NPC2&zid=async
B2) http://modbase.compbio.ucsf.edu/modbase-cgi/model_details.cgi?queryfile=1384569730_2795&searchmode=default&displaymode=moddetail&seq_id=00766f825a6cc1d6e495297082a45f9bMKRQRKSV
C2) http://swissmodel.expasy.org/repository/?pid=smr03&query_1_input=Q9HB15&zid=async
D2) http://modbase.compbio.ucsf.edu/modbase-cgi/model_details.cgi?queryfile=1384569894_1346&searchmode=default&displaymode=moddetail&seq_id=e0852094bb445efccfea59f02d9103c6MSSRSASR
E2) http://swissmodel.expasy.org/repository/?pid=smr03&query_1_input=Q9HB14&zid=async
F2) http://modbase.compbio.ucsf.edu/modbase-cgi/model_details.cgi?queryfile=1384569956_8332&searchmode=default&displaymode=moddetail&seq_id=dcc3a551fc5a5ee6222cbfeffcf8369aMAGRSGDR
G2) http://swissmodel.expasy.org/repository/?pid=smr03&query_1_input=Q9H427&zid=async
H2) http://modbase.compbio.ucsf.edu/modbase-cgi/model_details.cgi?queryfile=1384570007_9325&searchmode=default&displaymode=moddetail&seq_id=b9699314b6c9bfe9c9c2f50588d38d43MRRF'WKSI
I2) http://swissmodel.expasy.org/repository/?pid=smr03&query_1_input=Q96T55&zid=async
J2) http://modbase.compbio.ucsf.edu/modbase-cgi/model_details.cgi?queryfile=1384570100_6288&searchmode=default&displaymode=moddetail&seq_id=2efb50d3588dfb87e918a3dee229c572MPSAGLGS
K2) http://swissmodel.expasy.org/repository/?pid=smr03&query_1_input=B2RCT9&zid=async
L2) http://modbase.compbio.ucsf.edu/modbase-cgi/model_details.cgi?queryfile=1384570158_4780&searchmode=default&displaymode=moddetail&seq_id=a2fae60f8ea8f8070e429d06705facd4MYRPGKDS
M2) http://swissmodel.expasy.org/repository/?pid=smr03&query_1_input=Q7Z418&zid=async
N2) http://modbase.compbio.ucsf.edu/modbase-cgi/model_details.cgi?queryfile=1384570351_2393&searchmode=default&displaymode=moddetail&seq _id=2306f9a9908b9670c6431018abec44f4MVKKAAQK
O2) http://swissmodel.expasy.org/repository/?pid=smr03&query_1_input=Q9Y691&zid=async
P2) http://modbase.compbio.ucsf.edu/modbase-cgi/model_details.cgi?queryfile=1384570548_9650&searchmode=default&displaymode=moddetail&seq_id=8fc994e9b9f84f3f403b73029bc1e03bMDFSAEKS
Q2) http://modbase.compbio.ucsf.edu/modbase-cgi/model_details.cgi?queryfile=1384570685_6684&searchmode=default&displaymode=moddetail&seq_id=d7c9a6db96c1f26901cf4c3f3788bef5MAKLRKFS
R2) http://swissmodel.expasy.org/repository/?pid=smr03&query_1_input=Q92952&zid=async
S2) http://swissmodel.expasy.org/repository/?pid=smr03&query_1_input=Q9H2S1&zid=async
T2) http://modbase.compbio.ucsf.edu/modbase-cgi/model_details.cgi?queryfile=1384570897_5065&searchmode=default&displaymode=moddetail&seq_id=d5739a1a33b4b7f99a72e4376b647813MWLISESS
U2) http://swissmodel.expasy.org/repository/?pid=smr03&query_1_input=Q9UGI6&zid=async
V2) http://modbase.compbio.ucsf.edu/modbase-cgi/model_details.cgi?queryfile=1384571051_9314&searchmode=default&displaymode=moddetail&seq_id=8d0676a58971474fb15f0c3700c02b5eMFSLSSSC
W2) http://modbase.compbio.ucsf.edu/modbase-cgi/model_details.cgi?queryfile=1384571051_9314&searchmode=default&displaymode=moddetail&seq_id=93dfa4a8ea6cb95311d7a2150fd9fa06MDTSSSSC
X2) http://modbase.compbio.ucsf.edu/modbase-cgi/model_details.cgi?queryfile=1384571051_9314&searchmode=default&displaymode=moddetail&seq_id=fdef7bb0a037f1962870cb8509bc44fbMERPSSSC
Y2) http://swissmodel.expasy.org/repository/?pid=smr03&query_1_input=O15554&zid=async
Z2) http://swissmodel.expasy.org/repository/?pid=smr03&query_1_input=O43526&zid=async
A3) http://swissmodel.expasy.org/repository/?pid=smr03&query_1_input=O43525&zid=async
B3) http://swissmodel.expasy.org/repository/?pid=smr03&query_1_input=P56696&zid=async
C3) http://swissmodel.expasy.org/repository/?pid=smr03&query_1_input=Q9NR82&zid=async
D3) http://modbase.compbio.ucsf.edu/modbase-cgi/model_details.cgi?queryfile=1384571494_2304&searchmode=default&displaymode=moddetail&seq_id=be5350a1aed4ad218e0e1839210f8655MPRHVKLK
E3) http://swissmodel.expasy.org/repository/?pid=smr03&query_1_input=Q96KK3&zid=async
F3) http://modbase.compbio.ucsf.edu/modbase-cgi/model_details.cgi?queryfile=1384571575_7232&searchmode=default&displaymode=moddetail&seq_id=83c3de6a79aed9e095cbd10c843a41f4MLMLPQMY
G3) http://swissmodel.expasy.org/repository/?pid=smr03&query_1_input=Q9ULS6&zid=async
H3) http://swissmodel.expasy.org/repository/?pid=smr03&query_1_input=Q9BQ31&zid=async
I3) http://swissmodel.expasy.org/repository/?pid=smr03&query_1_input=Q5JUK3&zid=async
J3) http://swissmodel.expasy.org/repository/?pid=smr03&query_1_input=Q6UVM3&zid=async
K3) http://swissmodel.expasy.org/repository/?pid=smr03&query_1_input=A8MYU2&zid=async
L3) http://swissmodel.expasy.org/repository/?pid=smr03&query_1_input=Q6PIU1&zid=async
M3) http://swissmodel.expasy.org/repository/?pid=smr03&query_1_input=Q8TDN2&zid=async
N3) http://swissmodel.expasy.org/repository/?pid=smr03&query_1_input=Q16322&z id=async
```

In certain embodiments, the structural information describing the structure of the ion channel protein is selected from any one of the structures of TABLE 4.

In certain embodiments, for example, wherein the ion channel is the potassium ion channel protein hERG1, a detailed atomic structure based on X-ray crystallography or NMR spectroscopy is not yet available. Accordingly, structural details are based on analogy with other ion channels, computer homology models, pharmacology, and mutagenesis studies.

The hERG1 homology model may comprise comparative protein modeling methods including homology modeling methods (see, e.g., Marti-Renom et al., 2000, Annu. Rev. Biophys. Biomol. Struct. 29, 291-325) performable without limitation using the “Modeller” computer program (Fiser and Sali, 2003, Methods Enzymol. 374, 461-91) or the “Swiss-Model” application (Arnold et al., 2006, Bioinformatics 22, 195-201); or protein threading modeling methods (see, e.g., Bowie et al., 1991, Science 253, 164-170; Jones et al., 1992, Nature 358, 86-89) performable without limitation using the “Hhsearch” program (Soding, 2005, Bioinformatics 21, 951-960), the “Phyre” application (Kelley and Sternberg, 2009, Nature Protocols 4, 363-371) or the “Raptor” program (Xu et al., 2003, J. Bioinform. Comput. Biol. 1, 95-117); may further comprise ab initio or de novo protein modeling methods using various algorithms, performable without limitation using the publically distributed “ROSETTA” platform (Simons et al., 1999, Genetics 37, 171-176; Baker 2000, Nature 405, 39-42; Bradley et al., 2003, Proteins 53, 457-468; Rohl 2004, Methods Enzymol. 383, 66-93), the “1-TASSER” application (Wu et al., 2007, BMC Biol. 5, 17), or using physics-based prediction (see, e.g., Duan and Kollman 1998, Science 282, 740-744; Oldziej et al., 2005, Proc. Natl. Acad. Sci. USA 102, 7547-7552); or a combination of any such approaches. Computational approaches applicable herein for structure prediction of biomolecules are evaluated annually within the Critical Assessment of Techniques for Protein Structure (CASP) experiment as published in the CASP Proceedings (http://predictioncenter.org/). Advantageously, data holding information about computationally predicted conformations and structures of many biomolecules such as peptides, polypeptides and proteins are available through respective publically available repositories (see, e.g., Kopp and Schwede, 2004, Nucleic Acids Research 32, D230-D234).

In certain embodiments, the methods disclosed herein work best with complex membrane-bound systems that are not susceptible to structure determination by X-ray crystallographic or NMR spectroscopic methods.

6.2.5.2 Structural Information of the Compound (Ligand)

In certain embodiments, the method comprises providing structural information describing conformers of one or more compounds or ligands. As used herein, the terms “compound” and “ligand” are interchangeable.

One of ordinary skill in the art will understand that a chemical compound can adopt differing three-dimensional (3-D) shapes or “conformers” due to rotation of atoms about a bond. Conformers can thus interconvert by rotation around a single bond without breaking. A particular conformer of a ligand may provide a complimentary geometry to the pore (e.g., permeation pore) of an ion channel protein, and promote binding.

In certain embodiments, the structural information of describing conformers of one or more compounds or ligands is obtained from the chemical structure of a compound or ligand.

In certain embodiments, the structural information of the compound is based upon a viral compound being studied or developed by universities, pharmaceutical companies, or individual inventors. Typically, the compound will be a small organic molecule having a molecular weight under 900 atomic mass units. Structural information of the compound may be provided in 2D or 3D, using ChemDraw or simple structural depictions, or by entry of the compound's chemical name. Computer-based modeling of the compound may be used to translate the chemical name or 2D information of the compound into a 3D representative structure.

The software LigPrep from the Schrödinger package (Schrödinger Release 2013-2: LigPrep, version 2.7, Schrödinger, LLC, New York, N.Y., 2013) may be used to translate the 2D information of the compound (ligand) into a 3D representative structure which provides the structural information. LigPrep may also be used to generate variants of the same compound (ligand) with different tautomeric, stereochemical, and ionization properties. All generated structures may be conformationally relaxed using energy minimization protocols included in LigPrep.

In certain embodiments, the compound is selected from a list of compounds that have failed in clinical trials, or were halted in clinical trials due to cardiotoxicity.

In certain embodiments, the compound is selected from TABLE 5, below:

TABLE 5
Cardiac Hazardous Drugs

| Category of Drug | Drug |
|---|---|
| Calcium channel blockers | Prenylamine (TdP reported; withdrawn) |
| | Bepridil (TdP reported; withdrawn) |
| | Terodiline (TdP reported; withdrawn) |
| Psychiatric drugs | Thioridazine (TdP reported) |
| | Chlorpromazine (TdP reported) |
| | Haloperidol (TdP reported) |
| | Droperidol (TdP reported) |
| | Amitriptyline |
| | Nortriptyline |
| | Imipramine (TdP reported) |
| | Desipramine (TdP reported) |
| | Clomapramine |
| | Maprotiline (TdP reported) |
| | Doxepin (TdP reported) |
| | Lithium (TdP reported) |
| | Chloral hydrate |
| | Sertindole (TdP reported; withdrawn |
| | in the UK) |
| | Pimozide (TdP reported) |
| | Ziprasidone |
| Antihistamines | Terfenadine (TdP reported; withdrawn |
| | in the USA) |
| | Astemizole (TdP reported) |
| | Diphenhydramine (TdP reported) |
| | Hydroxyzine |
| | Ebastine |
| | Loratadine |
| | Mizolastine |
| Antimicrobial and | Erythromycin (TdP reported) |
| antimalarial drugs | Clarithromycin (TdP reported) |
| | Ketoconazole |
| | Pentamidine (TdP reported) |
| | Quinine |
| | Chloroquine (TdP reported) |
| | Halofantrine (TdP reported) |
| | Amantadine (TdP reported) |
| | Sparfloxacin |
| | Grepafloxacin (TdP reported; withdrawn) |
| | Pentavalent antimonial meglumine |
| Serotonin agonists/ | Ketanserin (TdP reported) |
| antagonists | Cisapride (TdP reported; withdrawn) |
| Immunosuppressant | Tacrolimus (TdP reported) |
| Antidiuretic hormone | Vasopressin (TdP reported) |
| Other agents | Adenosine |
| | Organophosphates |
| | Probucol (TdP reported) |
| | Papaverine (TdP reported) |
| | Cocaine |

In certain embodiments, the compound is an anticancer agent, such as anthracyclines, mitoxantrone, cyclophosphamide, fluorouracil, capecitabine and trastuzumab. In certain embodiments, the compound is an immunomodulating drug, such as interferon-alpha-2, interleukin-2, infliximab and etanercept. In certain embodiments, the compound is an antidiabetic drug, such as rosiglitazone, pioglitazone and troglitazone. In certain embodiments, the compound is an antimigraine drug, such as ergotamine and methysergide. In certain embodiments, the compound is an appetite suppressant, such as fenfulramine, dexfenfluramine and phentermine. In certain embodiments, the compound is a tricyclic antidepressants. In certain embodiments, the compound is an antipsychotic drug, such as clozapine. In certain embodiments, the compound is an antiparkinsonian drug, such as pergolide and cabergoline. In certain embodiments, the compound is an glucocorticoid. In certain embodiments, the compound is an antifungal drugs such as itraconazole and amphotericin B. In certain embodiments, the compound is an NSAID, including selective cyclo-oxygenase (COX)-2 inhibitors.

In certain embodiments, the compound is an active ingredient in a natural product. In certain embodiments, the compound is a toxin or environmental pollutant.

In certain embodiments, the compound is an antiviral agent.

In certain embodiments, the compound is selected from the group consisting of a protease inhibitor, an integrase inhibitor, a chemokine inhibitor, a nucleoside or nucleotide reverse transcriptase inhibitor, a non-nucleoside reverse transcriptase inhibitor, and an entry inhibitor.

In certain embodiments, the compound is capable of inhibiting hepatitis C virus (HCV) infection.

In certain embodiments, the compound is an inhibitor of HCV NS3/4A serine protease.

In certain embodiments, the compound is an inhibitor of HCV NS5B RNA dependent RNA polymerase.

In certain embodiments, the compound is an inhibitor of HCV NS5A monomer protein.

In certain embodiments, the compound is a compound disclosed in one of the following three applications: U.S. Provisional Patent Application No. 61/780,505, filed Mar. 13, 2013, entitled “Hepatitis C Virus NS5B Polymerase Inhibitors and Methods of Use”; U.S. Provisional Patent Application No. 61/784,584, filed Mar. 14, 2013, entitled “Hepatitis C Virus NS5B Polymerase Inhibitors and Methods of Use”; and U.S. Provisional Patent Application No. 61/786,116, filed Mar. 14, 2013, entitled “Hepatitis C Virus NS5A Monomer Inhibitors and Methods of Use.” The contents of each of these provisional applications are incorporated by reference in their entireties.

In certain embodiments, the compounds is selected from the group consisting of Abacavir, Aciclovir, Acyclovir, Adefovir, Amantadine, Amprenavir, Ampligen, Arbidol, Atazanavir, Balavir, Boceprevirertet, Cidofovir, Darunavir, Delavirdine, Didanosine. Docosanol, Edoxudine, Efavirenz, Emtricitabine, Enfuvirtide, Entecavir, Famciclovir, Fomivirsen, Fosamprenavir, Foscarnet, Fosfonet, Ganciclovir, Ibacitabine, Imunovir, Idoxuridine, Imiquimod, Indinavir, Inosine, Interferon type III, Interferon type II, Interferon type I, Interferon, Lamivudine, Lopinavir, Loviride, Maraviroc, Moroxydine, Methisazone, Nelfinavir, Nevirapine, Nexavir, Oseltamivir (Tamiflu), Peginterferon alfa-2a, Penciclovir, Peramivir, Pleconaril, Podophyllotoxin, Raltegravir, Ribavirin, Rimantadine, Ritonavir, Pyramidine, Saquinavir, Sofosbuvir, Stavudine, Telaprevir, Tenofovir, Tenofovir disoproxil, Tipranavir, Trifluridine, Trizivir, Tromantadine, Truvada, Valaciclovir (Valtrex), Valganciclovir, Vicriviroc, Vidarabine, Viramidine, Zalcitabine, Zanamivir (Relenza), and Zidovudine.

In certain embodiments, the compound is Daclatasvir (BMS-790052), for which the chemical name is “Methyl [(2S)-1{(2S)-2-[5-(4′-{2-[(2S)-1{(2S)-2-[(methoxycarbonyl)amino]-3-methylbutanoyl}2-pyrrolidinyl]-1H-imidazol-5-yl}4-biphenylyl)-1H-imidazol-2-yl]-1-pyrrolidinyl}3-methyl-1-oxo-2-butanyl]carbamate.” The structure of Daclastavir is provided below:

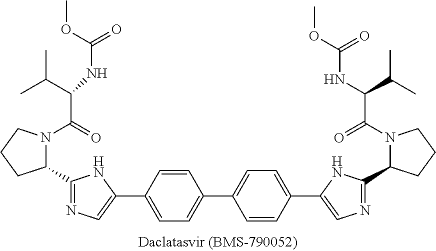 [SMILES: COC(=O)N[C@H](C(=O)N1CCC[C@H]1c1ncc(-c2ccc(-c3ccc(-c4cnc([C@@H]5CCCN5C(=O)[C@@H](NC(=O)OC)C(C)C)[nH]4)cc3)cc2)[nH]1)C(C)C]

In certain embodiments, the compound is BMS-986094, for which the chemical name is “(2R)-neopentyl 2-(((a2R,3R,4R)-5-(2-amino-6-methoxy-9H-purin-9-yl)-3,4-dihydroxy-4-methyltetrahydrofuran-2-yl)methoxy)(naphthalen-1-yloxy)phosphoryl)amino)propanoate.” The structure of BMS-986094 is illustrated below:

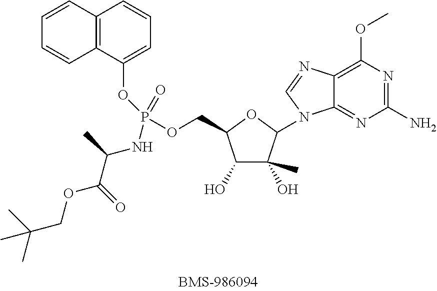 [SMILES: COc1nc(N)nc2c1ncn2C1O[C@H](COP(=O)(N[C@H](C)C(=O)OCC(C)(C)C)Oc2cccc3ccccc23)[C@@H](O)[C@@]1(C)O]

6.2.5.3 Energy Minimization

In certain embodiments, the X-ray crystal structure, NMR solution structures, homology models, molecular models, or generated structures disclosed herein are subjected to energy minimization (EM) prior to performing an MD simulation.

The goal of EM is to find a local energy minimum for a potential energy function. A potential energy function is a mathematical equation that allows the potential energy of a molecular system to be calculated from its three-dimensional structure. Examples of energy minimization algorithms include, but are not limited to, steepest descent, conjugated gradients, Newton-Raphson, and Adopted Basis Newton-Raphson (Molecular Modeling: Principles and Applications, Author A. R. Leach, Pearson Education Limited/Prentice Hall (Essex, England), 2^{nd} Edition (2001) pages: 253-302). It is possible to use several methods interchangeably.

6.2.5.4 Molecular Simulations

In certain embodiments, the method comprises the step of performing a molecular simulation of the structure of the ion channel protein.

Accordingly, provided herein are molecular simulations that sample conformational space of the ion channel protein according to the methods described herein. In certain embodiments, the molecular simulation is a molecular dynamics (MD) simulation.

Molecular simulations can be used to monitor time-dependent processes of the macromolecules and macromolecular complexes disclosed herein, in order to study their structural, dynamic, and thermodynamic properties by solving the equation of motion according to the laws of physics, e.g., the chemical bonds within proteins may be allowed to flex, rotate, bend, or vibrate as allowed by the laws of chemistry and physics. This equation of motion provides information about the time dependence and magnitude of fluctuations in both positions and velocities of the given molecule. Interactions such as electrostatic forces, hydrophobic forces, van der Waals interactions, interactions with solvent and others may also be modeled in MD simulations. The direct output of a MD simulation is a set of “snapshots” (coordinates and velocities) taken at equal time intervals, or sampling intervals. Depending on the desired level of accuracy, the equation of motion to be solved may be the classical (Newtonian) equation of motion, a stochastic equation of motion, a Brownian equation of motion, or even a combination (Becker et al., eds. Computational Biochemistry and Biophysics. New York 2001).

One of ordinary skill in the art will understand that direct output of a MD simulation, that is, the “snapshots” taken at sampling intervals of the MD simulation, will incorporate thermal fluctuations, for example, random deviations of a system from its average state, that occur in a system at equilibrium.

In certain embodiments, the molecular simulation is conducted using the CHARMM (Chemistry at Harvard for Macromolecular Modeling) simulation package (Brooks et al., 2009, “CHARMM: The Biomolecular Simulation Program,” J. Comput. Chem., 30(10):1545-614). In certain embodiments, the molecular simulation is conducted using the NAMD (Not (just) Another Molecular Dynamics program) simulation package (Phillips et al., 2005, “Scalable Molecular Dynamics with NAMD,” J. Comput. Chem., 26, 1781-1802; Kalé et al., 1999, “NAMD2: Greater Scalability for Parallel Molecular Dynamics,” J. Comp. Phys. 151, 283-312). One of skill in the art will understand that multiple packages may be used in combination. Any of the numerous methodologies known in the art to conduct MD simulations may be used in accordance with the methods disclosed herein. The following publications, which are incorporated herein by reference, describe multiple methodologies which may be employed: AMBER (Assisted Model Building with Energy Refinement) (Case et al., 2005, “The Amber Biomolecular Simulation Programs,” J. Comput. Chem. 26, 1668-1688; amber.scripps.edu); CHARMM (Brooks et al., 2009, J. Comput. Chem., 30(10):1545-614; charmm.org); GROMACS (GROningen MAchine for Chemical Simulations) (Van Der Spoel et al., 2005, “GROMACS: Fast, Flexible, and Free,” J. Comput. Chem., 26(16), 1701-18; gromacs.org); GROMOS (GROningen MOlecular Simulation) (Schuler et al., 2001, J. Comput. Chem., 22(11), 1205-1218; igc.ethz.ch/GROMOS/index); LAMMPS (Large-scale Atomic/Molecular Massively Parallel Simulator) (Plimpton et al., 1995, “Fast Parallel Algorithms for Short-Range Molecular Dynamics,” J. Comput. Chem., 117, 1-19; lammps.sandia.gov); and NAMD (Phillips et al., 2005, J. Comput. Chem., 26, 1781-1802; Kale et al., 1999, J. Comp. Phys. 151, 283-312).

Wherein the methods call for a MD simulation, the simulation may be carried out using a simulation package chosen from the group comprising or consisting of AMBER, CHARMM, GROMACS, GROMOS, LAMMPS, and NAMD. In certain embodiments, the simulation package is the CHARMM simulation package. In certain embodiments, the simulation package is the NAMD simulation package.

Wherein the methods call for a MD simulation, the simulation may be of any duration. In certain embodiments, the duration of the MD simulation is greater than 200 ns. In certain embodiments, the duration of the MD simulation is greater than 150 ns. In certain embodiments, the duration of the MD simulation is greater than 100 ns. In certain embodiments, the duration of the MD simulation is greater than 50 ns. In certain embodiments, the duration of the MD simulation of step is about 50, 60, 70, 80, 90, 100, 110, 120, 130, 140, 150, 160, 170, 180, 190, 200, 210, 220, 230, 240, 250, or 250 ns.

In certain embodiments, the molecular simulation incorporates solvent molecules. In certain embodiments, the molecular simulation incorporates implicit or explicit solvent molecules. One of ordinary skill in the art will understand that implicit solvation (also known as continuum solvation) is a method of representing solvent as a continuous medium instead of individual “explicit” solvent molecules most often used in MD simulations and in other applications of molecular mechanics. In certain embodiments, the molecular simulation incorporates water molecules. In certain embodiments, the molecular simulation incorporates implicit or explicit water molecules. In certain embodiments, the molecular simulation incorporates explicit ion molecules. In certain embodiments, the molecular simulation incorporates a lipid bilayer. In certain embodiments, the lipid bilayer incorporates explicit lipid molecules. In certain embodiments, the lipid bilayer incorporates explicit phospholipid molecules. In certain embodiments, the lipid bilayer incorporates a solvated lipid bilayer. In certain embodiments, the lipid bilayer incorporates a hydrated lipid bilayer. In certain embodiments, the hydrated lipid bilayer incorporates explicit phospholipid molecules and explicit water molecules.

6.2.5.5 Principal Component Analysis

In certain embodiments, the method optionally comprises the step of principal component analysis (PCA) of the MD trajectory. In certain embodiments, PCA is performed prior to identification of dominant conformations of the ion channel protein using clustering algorithms (see below). In certain embodiments, PCA is performed using the software AMBER-ptraj (Case et al., 2012, AMBER 12, University of California, San Francisco; Salomon-Ferrer et al., 2013, “An Overview of the Amber Biomolecular Simulation Package,” WIREs Comput. Mol. Sci. 3, 198-210; Amber Home Page. Assisted Model Building with Energy Refinement. Available at: http://ambermd.org, accessed Oct. 26, 2013). PCA reduces the system dimensionality toward a finite set of independent principal components covering the essential dynamics of the system.

6.2.5.6 Calculation of RMSDs

In certain embodiments, the method optionally comprises the step of calculating the root mean square deviation (RMSD) of Cα atoms relative to a reference structure of the ion channel protein. In certain embodiments, calculation of RMSD is performed to observe the overall behavior of the MD trajectory, prior to identification of dominant conformations of the ion channel protein using clustering algorithms (see below).

6.2.5.7 Clustering Algorithms

In certain embodiments, the method comprises the steps of using a clustering algorithm to identify dominant conformations of the ion channel protein from the MD simulation, and selecting the dominant conformations of the protein structure identified from the clustering algorithm.

Clustering algorithms are well known by one of ordinary skill in the art (see, e.g., Shao et al., 2007, “Clustering Molecular Dynamics Trajectories: 1. Characterizing the Performance of Different Clustering Algorithms,” J. Chem. Theory & Computation. 3, 231).

In certain embodiments, 50 or more dominant conformations are selected. In certain embodiments, 100 or more dominant conformations are selected. In certain embodiments, 150 or more dominant conformations are selected. In certain embodiments, 200 or more dominant conformations are selected. In certain embodiments, 250 or more dominant conformations are selected. In certain embodiments, 300 or more dominant conformations are selected.

6.2.5.8 Docking Algorithms

In certain embodiments, the method comprises the step of using a docking algorithm to dock the conformers of the one or more compounds to the dominant conformations of the structure of the ion channel protein determined from the molecular simulations.

Various docking algorithms are well known to one of ordinary skill in the art. Examples of such algorithms that are readily available include: GLIDE (Friesner et al., 2004 “Glide: A New Approach for Rapid, Accurate Docking and Scoring. 1. Method and Assessment of Docking Accuracy,” J. Med. Chem. 47(7), 1739-49), GOLD (Jones et al., 1995, “Molecular Recognition of Receptor Sites using a Genetic Algorithm with a Description of Desolvation,” J. Mol. Biol., 245, 43), FRED (McGann et al., 2012, “FRED and HYBRID Docking Performance on Standardized Datasets,” Comp. Aid. Mol. Design, 26, 897-906), FlexX (Rarey et al., 1996, “A Fast Flexible Docking Method using an Incremental Construction Algorithm,” J. Mol. Biol., 261, 470), DOCK (Ewing et al., 1997, “Critical Evaluation of Search Algorithms for Automated Molecular Docking and Database Screening,” J. Comput. Chem., 18, 1175-1189), AutoDock (Morris et al., 2009, “Autodock4 and AutoDockTools4: Automated Docking with Selective Receptor Flexiblity,” J. Computational Chemistry, 16, 2785-91), IFREDA (Cavasotto et al., 2004, “Protein Flexibility in Ligand Docking and Virtual Screening to Protein Kinases,” J. Mol. Biol., 337(1), 209-225), and ICM (Abagyan et al., 1994, “ICM—A New Method for Protein Modeling and Design: Application to Docking and Structure Prediction from the Distorted Native Conformation,” J. Comput. Chem., 15, 488-506), among many others.

In certain embodiments, the docking algorithm is DOCK or AutoDock.

6.2.5.9 Identification of Preferred Binding Conformations

In certain embodiments, the method comprises the step of identifying a plurality of preferred binding conformations for each of the combinations compound (ligand) and ion channel protein (receptor).

In certain embodiments, a clustering algorithm, as described above, is used to identify the preferred binding conformations for each of the combinations of compound and protein. In certain embodiments, the preferred binding conformations are those which have the largest cluster population and the lowest binding energy. In certain embodiments, the preferred binding conformations are the energetically preferred orientation of the compound (ligand) docked to the protein (receptor) to form a stable complex. In certain embodiments, there is only one preferrend binding conformation for the docked compound.

In certain embodiments, a compound that blocks the channel in one of its preferred binding conformations is predicted to be cardiotoxic. In certain embodiments, a compound that does not block the channel in any of its preferred binding conformations is predited to not be cardiotoxic.

In certain embodiments, a compound that blocks the channel in one of its preferred binding conformations is cardiotoxic. In certain embodiments, a compound that does not block the channel in any of its preferred binding conformations has reduced risk of cardiotoxicity.

6.2.5.10 Optimizing Preferred Binding Conformations

In certain embodiments, the method comprises the step of optimizing the preferred binding conformations using MD, as described above.

In certain embodiments, the MD is scalable MD.

In certain embodiments, the MD uses NAMD software.

6.2.5.11 Calculation of Binding Energies, ΔG_{calc}

In certain embodiments, the method comprises the step of calculating binding energies, ΔG_{calc}, for each of the combinations of compound (ligand) and protein (receptor) in the corresponding optimized preferred binding conformations.

Calculation of binding energies using a combination of molecular mechanics and solvation models are well known by one of ordinary skill in the art (see, e.g., Kollman et al., 2000, “Calculating Structures and Free Energies of Complex Molecules: Combining Molecular Mechanics and Continuum Models,” Acc. Chem. Res. 3B, 889-897).

In certain embodiments, the method further comprises outputting the selected calculated binding energies, ΔG_{calc}, and comparing them to physiologically relevant concentrations for each of the combinations of protein and compound. In this regard, the IC₅₀ (concentration at which 50% inhibition is observed) values measured from, for example, in vitro biological assays can be converted to the observed free energy change of binding, ΔG_{obs} (cal mol⁻¹) using the relation: ΔG_{calc}=RT ln Kᵢ, where R is the gas constant, R=1.987 cal K⁻¹ mol⁻¹, T is the absolute temperature, and Kᵢ is approximated to be the IC₅₀ measured for a particular compound, i. Accordingly, ΔG_{calc} may be compared to ΔG_{obs}, and physiologically relevant concentrations (IC₅₀) for each of the combinations of protein and compound.

6.2.5.12 Prediction of Cardiotoxicity and Selection of Compound

In certain embodiments, the method comprises prediction of cardiotoxicity and selection of a compound based on (i) classification of the compound as “blocker” versus “nonblocker”; and/or (ii) calculated binding energies.

### (i) Classification of Compound as “Blocker” Versus “Nonblocker”:

In certain embodiments, where the compound does not block the ion channel in any of its preferred binding conformations, the compound is identified as a “non-blocker.” Under such circumstances, the “non-blocking” compound is predicted to have reduced risk of cardiotoxicity, and the compound is selected for further development or possible use in humans, or to be used as a compound for further drug design. In certain embodiments, further clinical development may comprise further testing for cardiotoxicity with other ion channels using the methods disclosed herein.

In certain embodiments, wherein the compound blocks the ion channel in one of its preferred binding conformations, the compound is identified as a “blocker.” Under such circumstances, the compound is predicted to be cardiotoxic, and the compound is not selected for further clinical development or for use in humans. However, under such circumstances, the method may further comprise the step of using a molecular modeling algorithm to chemically modify or redesign the compound such that it does not block the ion channel in its preferred binding conformations and retains biological activity to its primary biological target, as described in Sections 5.2.3.13 and 5.2.3.14 below, respectively. As a possible alternative to modification/redesign of the compound, a new compound may also be selected from the collections of a chemical or compound library, for example, a library of new drug candidates generated by organic or medicinal chemists as part of a drug discovery program, as described in Section 5.2.3.15 below.

### (ii) Calculated Binding Energies:

In certain embodiments, where the calculated binding energies, ΔG_{calc}, for the preferred binding conformations compare to physiologically relevant compound concentrations of greater than or equal to 100 μM, binding affinity is predicted to be weak. Under such circumstances, the compound is predicted to have reduced risk of cardiotoxicity at therapeutically relevant concentrations. The compound may be selected for further development or possible use in humans, or to be used as a compound for further drug design. In certain embodiments, further clinical development may comprise further testing for cardiotoxicity with other ion channels using the methods disclosed herein.

In certain embodiments, where the calculated binding energies, ΔG_{calc}, for the preferred binding conformations compare to physiologically relevant compound concentrations of less than or equal to 1 μM, binding affinity is predicted to be moderate to strong. The compound is predicted to be cardiotoxic at therapeutically relevant concentrations, and the compound is not selected for further clinical development or for use in humans. However, under such circumstances, as described above, the method may further comprise the step of using a molecular modeling algorithm to chemically modify or redesign the compound, or as a possible alternative, selecting a new compound from the collections of a chemical or compound library, as described in the sections below.

6.2.5.13 Modification/Redesign of Compounds

In certain embodiments, the method further comprises the step of using a molecular modeling algorithm to chemically modify or design the compound such that it does not block the ion channel in any of its preferred binding conformations.

In certain embodiments, the method comprises repeating steps e) through i) for the modified or redesigned compound.

For example, if a chemical moiety of a compound identified as a “blocker” is found to be responsible for blocking, obstructing, or partially obstructing the ion channel, that chemical moiety may be modified in silico using any one of the molecular modeling algorithms disclosed herein or known to one of ordinary skill in the art. The modified compound may then be retested by repeating steps e) through i) of the methods disclosed herein.

Following re-testing, if the modified compound does not block, obstruct, or partially obstruct the ion channel in any of its preferred binding conformations, the modified compound may now be identified as a “non-blocker.” The modified compound may now be characterized as having reduced risk of cardiotoxicity, and selected for further development or possible use in humans, or to be used as a compound for further drug design. By such modification/redesign, potentially cardiotoxic compounds at risk for QT interval prolongation may be salvaged for further clinical development.

In certain embodiments, the modified or redesigned compound does not block the ion channel in its preferred binding conformations, but retains selective binding to a desired biological target, as described in Section 5.2.3.14 below.

6.2.5.14 Modification/Redesign of Compounds for Selective Binding to Primary Biological Target

In certain embodiments, the modified or redesigned compound retains or even increases selective binding to a primary biological target. In certain embodiments, binding of the compound or modified/redesigned compound to the primary biological target blocks hepatitis C virus (HCV) production. In certain embodiments, the primary biological target is HCV NS3/4A serine protease, HCV NS5B RNA dependent RNA polymerase, or HCV NS5A monomer protein.

In certain embodiments, the modified or redesigned compound is tested in an in vitro biological assay for selective binding to its biological target.

In certain embodiments, the modified or redesigned compound is tested for binding to its biological target in silico using any of the computational models or screening algorithms disclosed herein.

In certain embodiments, the modified or redesigned compound binds with high affinity to its biological target and/or retains biological activity. In certain embodiments, where the primary biological target is HCV NS3/4A serine protease, HCV NS5B RNA dependent RNA polymerase, or HCV NS5A monomer protein, the modified or redesigned compound retains antiviral activity.

In certain embodiments, the computational models or screening algorithms disclosed herein for selecting compounds that have reduced risk of cardiotoxicity may be combined with any computational models or screening algorithms known to those of ordinary skill in the art for modeling the binding of the compound or modified/redesigned compound to its primary biological target.

6.2.5.15 Selection of New Compound from a Chemical Library

As an alternative to modification/redesign of the compound, a new compound may also be selected from the collections of a chemical or compound library, for example, new drug candidates generated by organic or medicinal chemists as part of a drug discovery program.

For example, once the methods disclosed herein identify a chemical moiety of a original tested compound as a “blocker” that is responsible for blocking, obstructing, or partially obstructing the ion channel, a new compound from a chemical library may be selected wherein, for example, the new compound does not comprise the moiety found to be responsible for the blocking, obstructing, or partially obstructing of the ion channel.

The new compound may then be retested for cardiotoxicity by repeating steps e) through i) of the methods disclosed herein.

Following re-testing, if the new compound does not block, obstruct, or partially obstruct the ion channel in any of its preferred binding conformations, the new compound may be identified as a “non-blocker.” The new compound may be characterized as having reduced risk of cardiotoxicity, and selected for further development or possible use in humans, or to be used as a compound for further drug design. By such selection of a new compound from a chemical library, an entire drug discovery program with potentially cardiotoxic compounds at risk for QT interval prolongation may be salvaged by redirecting the program to safer lead compounds for further clinical development.

The new compound selected from the chemical library may also be tested for selective binding to a desired biological target, for example, a primary biological target, as described above in Section 5.2.3.14 above, for the modified/redesigned compound.

6.2.6 Biological Aspects

Optionally, the methods disclosed herein include checking in silico predicted cardiotoxicities with the results of an in vitro biological assay, or in vivo in an animal model. The methods disclosed herein may also include validating or confirming the in silico predicted cardiotoxicities with the results of an in vitro biological assay, or with the results of an in vivo study in an animal model.

Accordingly, in certain aspects, provided herein are biological methods for testing, checking, validating or confirming predicted cardiotoxicities.

In certain embodiments, the method comprises testing, checking, validating or confirming the predicted cardiotoxicity of the compound or modified compound using standard assaying techniques which are known to those of ordinary skill in the art.

In certain embodiments, the method comprises testing, checking, validating or confirming the predicted cardiotoxicity of the compound or modified compound in an in vitro biological assay.

In certain embodiments, the in vitro biological assay comprises high throughput screening of ion channel and transporter activities.

In certain embodiments, the in vitro biological assay is a hERG1 channel inhibition assay, for example, a FluxOR™ potassium ion channel assay, or electrophysiology measurements in single cells, as explained below.

In certain embodiments, the method comprises testing the cardiotoxicity of the compound or modified compound in vivo in an animal model.

In certain embodiments, the cardiotoxicity of the compound or modified compound is tested in vivo by measuring ECG in a wild type mouse or a transgenic mouse model expressing human hERG, as explained below.

6.2.6.1 FluxOR™ Potassium Ion Channel Assay

In certain embodiments, the in vitro biological assay is a FluxOR™ potassium ion channel assay (see, e.g. Beacham et al., 2010, “Cell-Based Potassium Ion Channel Screening Using FluxOR™ Assay,” J. Biomol. Screen., 15(4), 441-446), which allows high throughput screening of potassium ion channel and transporter activities.

The FluxOR™ assay monitors the permeability of potassium channels to thallium (Tl⁺) ions. When thallium is added to the extracellular solution with a stimulus to open channels, thallium flows down its concentration gradient into the cells, and channel or transporter activity is detected with a proprietary indicator dye that increases in cytosolic fluorescence. Accordingly, the fluorescence reported in the FluxOR™ system is an indicator of any ion channel activity or transport process that allows thallium into cells.

In certain embodiments, the FluxOR™ potassium channel assay is performed on HEK 293 cells stably expressing hERG1 or mouse cardiomyocyte cell line HL-1 cells.

In certain embodiments, the FluxOR™ potassium channel assay is performed on a human adult cardiomyocyte cell line expressing hERG1

6.2.6.2 Electrophysiology Measurements in Single Cells

In certain embodiments, the in vitro biological assay comprises electrophysiology measurements, for example, patch clamp electrophysiology measurements, which use a high throughput single cell planar patch clamp approach (see, e.g., Schroeder et al., 2003, “Ionworks HT: A New High-Throughput Electrophysiology Measurement Platform,” J. Biomol. Screen. 8 (1), 50-64).

In certain embodiments, electrophysiology measurements are in single cells. In certain embodiments, the single cells are Chinese hamster ovary (CHO) cells stably transfected with hERG1(CHO-hERG). In certain embodiments, the single cells are from a human adult cardiomyocyte cell line expressing hERG1.

The cells are dispensed into the PatchPlate. Amphotericin is used as a perforating agent to gain electrical access to the cells. The hERG tail current is measured prior to the addition of the test compound by perforated patch clamping. Following addition of the test compound (typically 0.008, 0.04, 0.2, 1, 5, and 25 μM, n=4 cells per concentration, final DMSO concentration=0.25%), a second recording of the hERG current is performed.

Post-compound hERG currents are usually expressed as a percentage of pre-compound hERG currents (% control current) and plotted against concentration for each compound. Where concentration dependent inhibition is observed the Hill equation is used to fit a sigmoidal line to the data and an IC₅₀ (concentration at which 50% inhibition is observed) is determined.

6.2.6.3 Cloe Screen IC₅₀ hERG Safety Assay

In certain embodiments, the in vitro biological assay is a Cloe Screen IC₅₀ hERG Safety assay, for example, as provided by the company CYPROTEX (see, e.g., http://www.cyprotex.com/toxicology/cardiotoxicity/hergsafety/).

In certain embodiments, the Cloe Screen IC₅₀ hERG Safety assay is performed using an Ionworks™ HT platform (Molecular Devices using a CHO hERG cell line) which measures whole-cell current from multiple cells simultaneously using an automated patch clamp system.

Typically, hERG Safety assay uses a high throughput single cell planar patch clamp approach. CHO-hERG cells are dispensed into a PatchPlate. Amphotericin is used as a perforating agent to gain electrical access to the cells. The hERG tail current is measured prior to the addition of the test compound by perforated patch clamping. Following addition of the test compound (typically 0.008, 0.04, 0.2, 1, 5, and 25 μM, n=4 cells per concentration, final DMSO concentration=0.25%), a second recording of the hERG current is performed. Post-compound hERG currents are expressed as a percentage of pre-compound hERG currents (% control current) and plotted against concentration for each compound. Where concentration dependent inhibition is observed the Hill equation is used to fit a sigmoidal line to the data and an IC₅₀ (concentration at which 50% inhibition is observed) is determined.

In certain embodiments, the hERG safety assay using the Ionworks™ HT system generates data comparable with traditional single cell patch clamp measurements.

6.2.6.4 Electrocardiography Studies in Transgenic Mouse Models

In certain embodiments, the method comprises testing the cardiotoxicity of the compound or modified compound in vivo by measuring ECG in a transgenic mouse model expressing human hERG1.

Electrocardiograpy to test anti-arrhythmic activity, in particular, QT prolongation, in transgenic mice expressing hERG specifically in the heart may performed using previously published protocols (Royer et al., 2005, “Expression of Human ERG K+Channels in the Mouse Heart Exerts Anti-Arrhythmic Activity,” Cardiovascular Res. 65, 128-137).

Alternatively, or in addition, electrocardiograpy to test anti-arrhythmic activity, in particular, QT prolongation, in wild type mice may be performed.

The following examples are included to demonstrate preferred embodiments of the disclosure. It should be appreciated by those of ordinary skill in the art that the techniques disclosed in the examples which follow represent techniques discovered by the inventor to function well in the practice of the disclosure, and thus can be considered to constitute preferred modes for its practice. However, those of ordinary skill in the art should, in light of the present disclosure, appreciate that many changes can be made in the specific embodiments which are disclosed and still obtain a like or similar result without departing from the spirit and scope of the disclosure.

### 7. EXAMPLES

FIGS. 1A and 1B depict system block diagrams for selecting a compound that has reduced risk of cardiotoxicity. Processes illustrated in the system block diagrams (1A) and (1B) are: Target Preparation (includes, e.g., combined de novo/homology protein modeling of hERG, as exemplified in EXAMPLE 1, below), Ligand Collection Preparation (as exemplified in EXAMPLE 2, below), Ensemble Generation (includes, e.g., Molecular Dynamics simulations, principal component analysis, and iterative clustering, as exemplified in EXAMPLES 3-5, below), Docking (includes, e.g., docking and iterative clustering, as exemplified in EXAMPLE 6, below), MD Simulations on Selected Complexes (includes, e.g., Molecular Dynamics simulations and preliminary ranking of docking hits, as exemplified in EXAMPLES 7 and 8, below), Rescoring using MM-PBSA (includes, e.g., binding free energy calculation and rescoring of top hits, as exemplified in EXAMPLES 9 and 10, below), and Experimental Testing (includes, e.g., hERG channel inhibition studies in mammalian cells, Fluxor™ potassium channel assays in mammalian cells, and electrocardiograpy to test anti-arrhythmic activity in transgenic mice expressing hERG, as exemplified in EXAMPLES 10-12, below). The top hits from the Rescoring step can act as positive controls for the next phase screening. In certain embodiments, as shown in the block diagram (1B), the Ensemble Generation, Docking, MD Simulations on Selected Complexes, and Rescoring using MM-PBSA steps may be performed on a supercomputer, for example, the “IBM Blue Gene/Q” supercomputer system at the Health Sciences Center for Computational Innovation, University of Rochester, or the equivalent thereof. The Target Preparation and Ligand Collection Preparation steps may be performed on local machines (e.g., in a Molecular Operating Environment (MOE)).

In certain embodiments, the MD simulations disclosed herein comprise simulations of at least 200,000 atoms and their coordinates (protein, membrane, water and ions). In certain embodiments, the equilibration process of at least 200 ns is equivalent to taking 100 billion steps (10¹¹ steps) updating the position coordinates and velocities of each atom in the system in each of these steps. In certain embodiments, the MD simulations using a current state-of-the art supercomputer, for example, the “IBM Blue Gene/Q” supercomputer system, require an equivalent of 10 million CPU hours which scales approximately linearly with the size of the computational hardware available.

### 7.1 Example 1

### Combined De Novo/Homology Protein Modeling

The methods disclosed herein as applied to potassium ion channels may be performed as described in Examples 1-15.

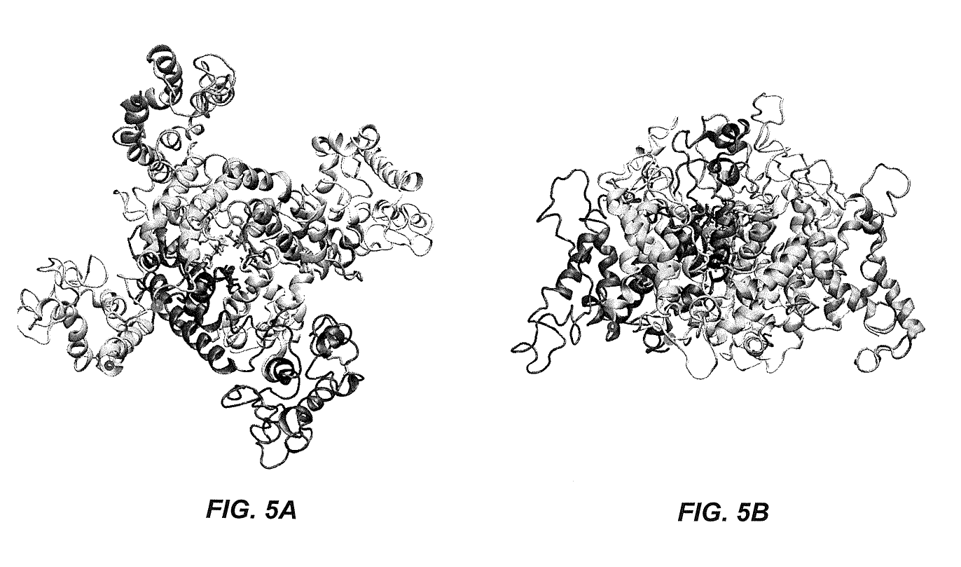

Combined de novo and homology protein modeling of the hERG1 channel protein was performed as previously described (Durdagi et al., 2012, “Modeling of Open, Closed, and Open-Inactivated States of the HERG1 Channel: Structural Mechanisms of the State-Dependent Drug Binding,” J. Chem. Inf. Model., 52, 2760-2774). FIGS. 4 and 5A-5B present molecular models of the hERG1 monomer subunit and the hERG1 tetramer, respectively.

In brief, homology modeling for parts of the hERG1structure conserved among K⁺ channels with known crystal structures used target-template sequence alignment performed by the ClustalW algorithm (Thompson et al., 1994, “Improving the Sensitivity of Progressive Multiple Sequence Alignment Through Sequence Weighting, Position-Specific Gap Penalties and Weight Matrix Choice,” Nucleic Acids Res. 22 (22), 4673-4680). Homology models were produced by the Comparative Modeling module in ROSETTA (Raman et al., 2009, “Structure Prediction for CASP8 with All-Atom Refinement using Rosetta,” Proteins, 77, 89-99; Chivian et al., 2006, “Homology Modeling using Parametric Alignment Ensemble Generation with Consensus and Energy-Based Model Selection,” Nucleic Acids Res. 34 (17), el 12) to produce reasonably good models with ˜3-4 Å backbone Cα RMSD. Since the pore domain (PD) contains an unusually long S5-Pore linker or turret which forms a 8-12-residue helix above the selectivity filter, de novo modeling of the linker and missing parts in the model was performed by Loop Modeling (Wang et al. 2007, “Protein-Protein Docking with Backbone Flexibility,” J. Mol. Biol., 373 (2), 503-519; Canutescu et al., 2003, “Cyclic Coordinate Descent: A Robotics Algorithm for Protein Loop Closure,” Protein Sci., 12 (5), 963-972) in ROSETTA. Five steps were used in the protein modeling: (i) sequence alignment for generation of alignment based on one or more template structures, (ii) threading for generation of initial models based on template structure by copying coordinates over the aligned regions, (iii) loop modeling for rebuilding the missing parts using de novo modeling, (iv) selection of models based on reported experimental data from biochemical, biophysical, and electrophysiological studies, and (v) refinement using all-atom molecular dynamics (MD) simulations with reported constraints for the interatomic distances of the salt-bridge interaction pair obtained from electrophysiology and mutagenesis experiments performed on hERG1 channels.

The previously published sequence alignment was used (Subbotina et al., 2010, “Structural Refinement of the HERG1 Pore and Voltage-Sensing Domains with ROSETTA-Membrane and Molecular Dynamics Simulations,” Proteins, 78 (14), 2922-2934) for modeling the hERG1 channel in open, closed, and inactivated states. Open and closed state S1-S6 TM models were modeled based on the refined Kv1.2 model which was derived from the Kv1.2 crystal structure (PDB ID 2A79) and the Kv1.2 closed state protein model, respectively (Chivian et al., 2006, Nucleic Acids Res. 34 (17), e112; Long et al., 2005, “Crystal Structure of a Mammalian Voltage-Dependent Shaker Family K+ Channel,” Science, 309 (5736), 897-903). Open state Kv1.2, closed state Kv1.2,15 and open-inactivated KcsA PD (PDB ID 3F5W) from Mus musculus were used as template structures. Intracellular (IC) and extracellular (EC) domains such as antibody light and heavy chains from the available PDB coordinate files were trimmed off for generating initial incomplete models of hERG1 in S1-S6 open and closed states and S5S6 in the openinactivated state.

For optimal loop prediction in hERG1, fragment-based loop modeling of ROSETTA was implemented (Wang et al., 2007, J. Mol. Biol., 373 (2), 503-519; Canutescu et al., 2003, Protein Sci., 12 (5), 963-972). Fragment-based conformational searching using cyclic coordinate descent (CCD) and kinematic loop closure (KLC) algorithms for inserting 3- and 9-residue-long fragments of protein structures from the PDB fragment library was performed, and secondary structure prediction was generated by PSIPRED (McGuffin et al., 2000, “The PSIPRED Protein Structure Prediction Server,” Bioinformatics, 16 (4), 404-405). Over 20,000 models for open, closed, and open-inactivated states were generated using loop modeling. Models with a 8-12-residue helix located in the outer mouth of the selectivity filter were selected for further analysis with the Molsoft ICM program (Abagyan et al., 1994, “ICM—A New Method for Protein Modeling and Design—Applications to Docking and Structure Prediction from the Distorted Native Conformation,” J. Comput. Chem., 15 (5), 488-506). The stable models complying with published experimental constraints were used for subsequent all-atom MD simulations.

The coordinates for hERG1 generated from the homology modeling described in EXAMPLE 1, above, are provided in the attached Table A. These coordinates were used as input for the MD simulations, described in EXAMPLE 3 below.

### 7.2 Example 2

### Compound (Ligand) Preparation

The software MOE (Molecular Operating Environment) from Chemical Computing Group (CCG) (http://www.chemcomp.com/press_releases/2010-11-30.htm) was used to translate the 2D information of a compound (ligand) into a 3D representative structure. MOE also generated variants of the same ligand with different tautomeric, stereochemical, and ionization properties. All generated structures were conformationally relaxed using energy minimization protocols included in MOE.

Alternative, or in addition, the software LigPrep from the Schrödinger package (Schrödinger Release 2013-2: LigPrep, version 2.7, Schrödinger, LLC, New York, N.Y., 2013) may be used to translate the 2D information of a compound (ligand) into a 3D representative structure. LigPrep may also be used to generate variants of the same ligand with different tautomeric, stereochemical, and ionization properties. All generated structures may be conformationally relaxed using energy minimization protocols included in LigPrep.

### 7.3 Example 3

### Molecular Dynamics Simulations

All-atom MD simulations were carried out for the selected models using NAMD (Not (just) Another Molecular Dynamics program) (Phillips et al., 2005, “Scalable Molecular Dynamics with NAMD,” J. Comput. Chem., 26, 1781-1802; Kale et al., 1999, “NAMD2: Greater Scalability for Parallel Molecular Dynamics,” J. Comp. Phys. 151, 283-312) in a Molecular Operating Environment (MOE).

MD simulations were carried out at 300 K, and physiological pH (pH 7) and 1 atm using the all-hydrogen AMBER99SB force field for the protein (Hornak et al., 2006, “Comparison of Multiple Amber Force Fields and Development of Improved Protein Backbone Parameters,” Proteins 65, 712-725) and the generalized AMBER force field (GAFF) for the ligands (Wang et al., 2004, “Development and Testing of a General Amber Force Field,” J. Comput. Chem. 25, 1157-1174).

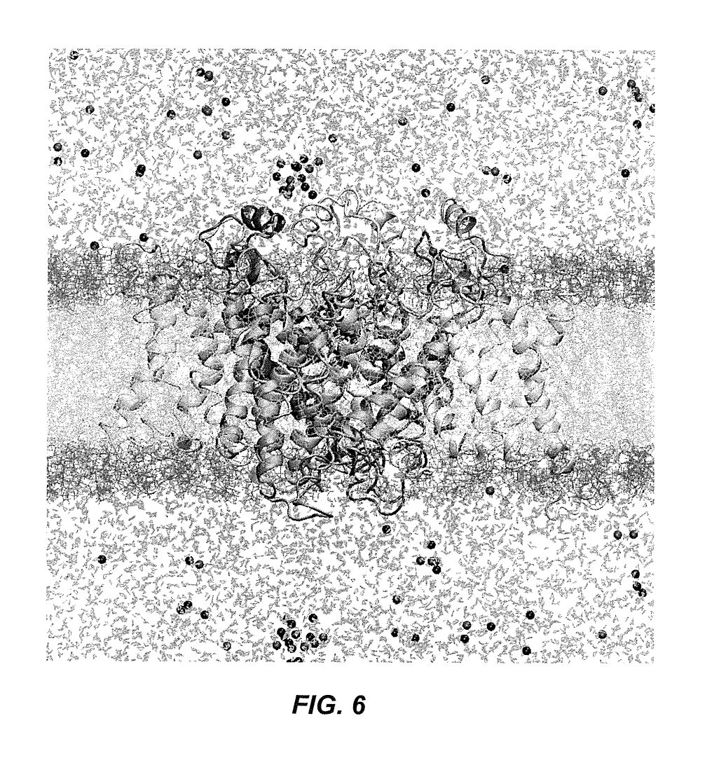

Similar to previous MD simulations (Chivian et al. 2006, “Homology modeling using parametric alignment ensemble generation with consensus and energy-based model selection.” Nucleic Acids Res., 34, 17) of K channels, the particle mesh Ewald (PME) algorithm was used for electrostatic interactions. K ions at the selectivity filter were used as the occupation of ions at the S0:S2:S4 positions according to the previous studies (Chivian et al., 2006). The protein model was embedded into the 1-palmitoyl-2-oleoyl-sn-glycero-3-phosphocholine (POPC) membrane bilayer using the CHARMM-GUI membrane builder protocol (Kumar et al., 2007, “CHARMM-GUI: A Graphical User Interface for the CHARMM users,” Abstr. Pap. Am. Chem. Soc. 233, 273-273; Jo et al., 2008, “Software news and updates—CHARMM-GUI: A Web-Based Graphical User Interface for CHARM,” J. Comput. Chem. 29 (11), 1859-1865). The simulation box contained 1 protein, 416 POPC molecules, 3 K⁺ ions, pore water molecules in the intracellular cavity, solvated by 0.15 M KCl aqueous salt solution. Total atoms in the simulation systems were approximately 176716 atoms. FIG. 6 presents a snapshot of the simulation system showing the hERG1tetramer in the unit cell with phospholipid bilayer, waters of hydration, and ions.

Structures were minimized for 200,000 steps, heated for 2 ns, then equilibrated for 20 ns. During minimization and heating, backbone atoms were heavily restrained from motion, while during equilibration those restraints were strongly reduced (i.e., heating and minimization were carried out with 100.0 kcal mol⁻¹ Å⁻² for backbone, and gradually reduced to 10 kcal mol⁻¹ Å⁻² during equilibration). The system was then subjected to a 200 ns production run with no restraints.

Atomic coordinates were saved to the trajectory every 10 ps, producing 20,000 snapshots. Atomic fluctuation (B-factors) and root mean deviations from the reference structures (RMSD) were then calculated, as explained below.

### 7.4 Example 4

### RMSD Calculation

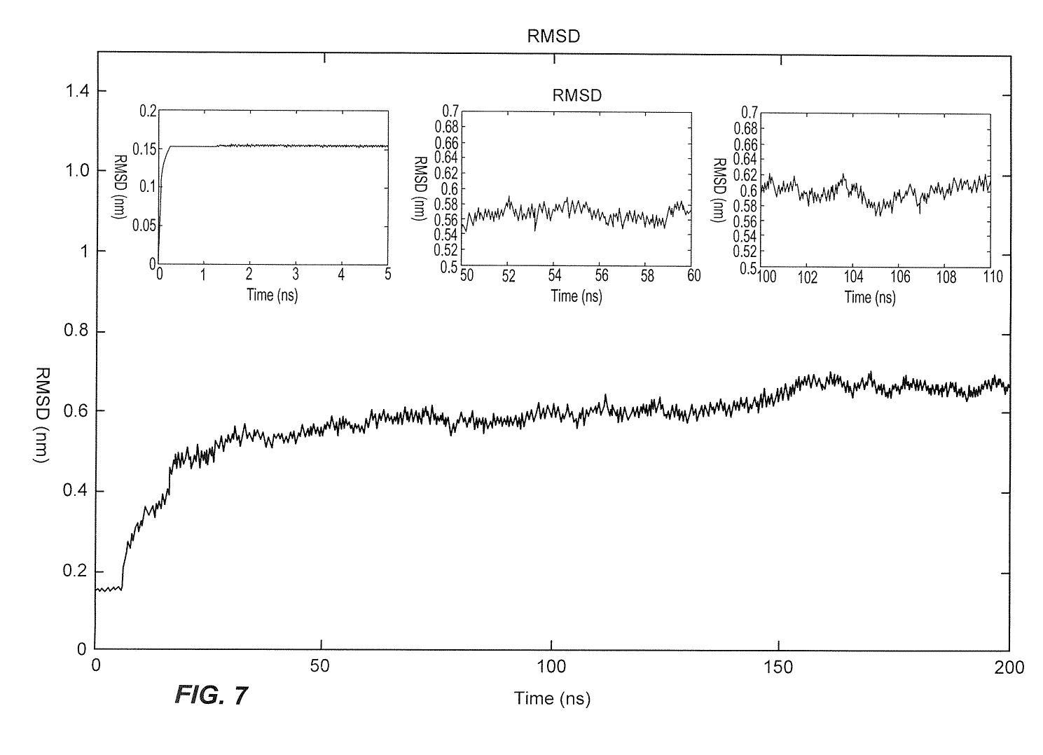

The root mean square deviation (RMSD) of Cα atoms relative to a reference structure were calculated as follows:

$$RMSD ( t ) = {[ \frac{1}{{N}^{2}} {\sum }_{i , j}^{ } {\vert {r}_{ij} ( t ) - {r}_{ij}^{ref} \vert}^{2} ]}^{1 / 2} ; \qquad ( 1 )$$

where N is the number of atoms, and r^{ref} is a reference structure, and is presented in FIG. 7. Each point in this graph represents a different set of coordinates for the hERG structure. The separation between two points in the y-axis represents a deviation between the corresponding protein structures. As shown in the figure, the hERG channel reached equilibrium almost after 25 ns of simulation where the RMSD points fluctuated around 5.5 Å The upper panels in FIG. 7 provide a close up on the RMSD at different durations of the MD simulations. These panels illustrates the effects of restraining the backbone atoms at the beginning of the MD simulation as well as demonstrating the conformational transitions spanned by the hERG structures after removing these restraints and allowing the system to move freely. By observing the overall behavior of the hERG trajectory one can notice the tremendous amount of dynamical transitions of the channel, which can be attributed to the rearrangements of the flexible loops within the protein structure. This allowed the hERG structure to explore a wide conformational space, allowing for introducing protein flexibility within the docking procedure as described below.

### 7.5 Example 5

### Iterative Clustering

Iterative clustering of the MD trajectory was then performed to extract dominant conformations of hERG1. The clustering procedure has been previously described (Barakat et al., 2010, “Ensemble-Based Virtual Screening Reveals Dual-Inhibitors for the P53-MDM2/MDMX Interactions,” J. Mal. Graph. & Model. 28, 555-568; Barakat et al., 2011, “Relaxed Complex Scheme Suggests Novel Inhibitors for the Lyase Activity Of DNA Polymerase Beta,” J. Mol. Graph. & Model. 29, 702-716). An average-linkage algorithm was used to group similar conformations in the 200 ns trajectory into clusters. The optimal number of clusters was estimated by observing the values of the Davies-Bouldin index (DBI) (see, e.g., Davies et al., 1979, “A Cluster Separation Measure,” IEEE Trans. Pattern Anal. Intelligence 1, 224) and the percentage of data explained by the data (SSR/SST) (see, e.g., Shao et al., 2007, “Clustering Molecular Dynamics Trajectories: 1. Characterizing the Performance of Different Clustering Algorithms,” J. Chem. Theory & Computation. 3, 231) for different cluster counts ranging from 5 to 600. At the optimal number of clusters, a plateau in the SSR/SST is expected to match a local minimum in the DBI (Shan et al., 2007). Using this methodology, three-hundred (300) distinct conformations for the intracellular hERG channel were identified.

### 7.6 Example 6

### Docking

Docking:

All docking simulations employed the software AutoDock, version 4.0 (Morris et al., 2009, “Autodock4 and AutoDockTools4: Automated docking with selective receptor flexibility,” J. Computational Chemistry, 16, 2785-91). The docking method and parameters were similar to ones previously used (Barakat et al., 2009, “Characterization of an Inhibitory Dynamic Pharmacophore for the ERCC1-XPA Interaction Using a Combined Molecular Dynamics and Virtual Screening Approach,” J. Mol. Graph. Model 28, 113-130). The screening method adopted the relaxed complex scheme (RCS) (Lin et al., 2002, “Computational Drug Design Accommodating Receptor Flexibility: The Relaxed Complex Scheme,” J. Am. Chem. Soc. 124, 5632-33) through docking of the tested compounds to the 300 hERG structures generated from the above-mentioned clustering methodology. All docking simulations employed the using the Lamarckian Genetic Algorithm (LGA), the docking parameters included an initial population of 400 random individuals; a maximum number of 10,000,000 energy evaluations; 100 trials; 40,0000 maximum generations and the requirement that only one individual can survive into the next generation. The rest of the parameters were set to the default values.

Iterative Clustering:

Clustering of the docking results followed the same adaptive procedure as one previously employed (Barakat et al., 2009). In brief, for each docking simulation a modified version of the PTRAJ module of AMBER (Case et al., 2005, “The Amber Biomolecular Simulation Programs,” J. Comput. Chem. 26, 1668-1688) clustered the docking trials. Every time a number of clusters were produced, two clustering metrics (e.g., DBI and percentage of variance (Shao et al., 2007, “Clustering Molecular Dynamics Trajectories: 1. Characterizing the Performance of Different Clustering Algorithms,” J. Chem. Theory and Comput. 3, 2312)) were calculated to assess the quality of clustering. Once acceptable values for these metrics were reached, the clustering protocol extracted the clusters at the predicted cluster counts. The screening protocol then sorted the docking results by the lowest binding energy of the most populated cluster. The objective was to extract the docking solution, for each ligand, that had the largest cluster population and the lowest binding energy from all hERG structures. In this context, for each ligand, the docking results were clustered independently for the individual structures. The clustering results were then compared and top 40 hits were considered for further analysis. AutoDock scoring function (Equation 2) provided a preliminary ranking for the compounds:

$$Δ G = Δ {G}_{vdW} {\sum }_{i , j}^{ } ( \frac{{A}_{ij}}{{r}_{ij}^{12}} - \frac{{B}_{ij}}{{r}_{ij}^{6}} ) + Δ {G}_{hbond} {\sum }_{i , j}^{ } E ( t ) ( \frac{{C}_{ij}}{{r}_{ij}^{12}} - \frac{{D}_{ij}}{{r}_{ij}^{10}} ) + Δ {G}_{elec} {\sum }_{i , j}^{ } \frac{{q}_{i} {q}_{j}}{{ɛ ( {r}_{ij} )}^{2}} + Δ {G}_{tor} {N}_{tor} + Δ {G}_{sol} {\sum }_{i , j}^{ } ( {S}_{i} {V}_{j} ) {e}^{( - {r}_{ij}^{12} / 2 {σ}^{2} )} \qquad ( 2 )$$

Here, the five ΔG terms on the right-hand side are constants. The function includes three in vacua interaction terms, namely a Lennard-Jones 12-6 dispersion/repulsion term, a directional 12-10 hydrogen bonding term, where E(t) is a directional weight based on the angle, t, between the probe and the target atom, and screened Columbic electrostatic potential. In addition, the unfavorable entropy contributions are proportional to the number of rotatable bonds in the ligand and solvation effects are represented by a pairwise volume-based term that is calculated by summing up, for all ligand atoms, the fragmental volumes of their surrounding protein atoms weighted by an exponential function and then multiplied by the atomic solvation parameter of the ligand atom (Sᵢ).

### 7.7 Example 7

### Molecular Dynamics on Selected Complexes

The lowest 40 energy poses for each ligand with their representative hERG1 structures were used as a starting configuration of an MD simulation. The AMBER99SB force field (Hornak et al., 2006, “Comparison of Multiple AMBER Force Fields and Development of Improved Protein Backbone Parameters,” Proteins 65, 712-725) was used for protein parameterization, while the generalized AMBER force field (GAFF) provided parameters for ligands (Wang et al., 2004, “Development and Testing of a General AMBER Force Field,” J. Comput. Chem. 25, 1157-1174). For each ligand, partial charges were calculated with the AM1-BCC method using the Antechamber module of AMBER 10. Protonation states of all ionizable residues were calculated using the program PDB2PQR. All simulations were performed at 300 K and pH 7 using the NAMD program (Kalé et al., 1999, “NAMD2: Greater Scalability for Parallel Molecular Dynamics,” J. Comp. Phys. 151, 283-312). Following parameterization, the protein-ligand complexes were immersed in the center of a cube of TIP3P water molecules. The cube dimensions were chosen to provide at least a 10 Å buffer of water molecules around each system. When required, chloride or sodium counter-ions were added to neutralize the total charge of the complex by replacing water molecules having the highest electrostatic energies on their oxygen atoms. The fully solvated systems were then minimized and subsequently heated to the simulation temperature with heavy restraints placed on all backbone atoms. Following heating, the systems were equilibrated using periodic boundary conditions for 100 ps and energy restraints reduced to zero in successive steps of the MD simulation. The simulations were then continued for 2 ns during which atomic coordinates were saved to the trajectory every 2 ps for subsequent binding energy analysis.

### 7.8 Example 8

### Binding Free Energy Calculation and Rescoring of Top Hits

The molecular mechanics Poisson-Boltzmann surface area (MM-PBSA) technique was used to re-score the preliminary ranked docking hits (Kollman et al., 2000, “Calculating Structures and Free Energies of Complex Molecules: Combining Molecular Mechanics and Continuum Models,” Acc. Chem. Res. 3B, 889-897). This technique combines molecular mechanics with continuum solvation models. The total free energy is estimated as the sum of average molecular mechanical gas-phase energies (E_{MM}), solvation free energies (Gₛₒₗᵥ), and entropy contributions (−TSₛₒₗᵤₜₑ) of the binding reaction:

G=E_{MM}+Gₛₒₗᵥ−TSₛₒₗᵤₜₑ (3)

The molecular mechanical (E_{MM}) energy of each snapshot was calculated using the SANDER module of AMBER10 with all pair-wise interactions included using a dielectric constant (8) of 1.0. The solvation free energy (Gₛₒₗᵥ) was estimated as the sum of electrostatic solvation free energy, calculated by the finite-difference solution of the Poisson-Boltzmann equation in the Adaptive Poisson-Boltzmann Solver (APBS) and non-polar solvation free energy, calculated from the solvent-accessible surface area (SASA) algorithm. The solute entropy was approximated using the normal mode analysis. Applying the thermodynamic cycle for each protein-ligand complex, the binding free energy was calculated using the following equation:

ΔG_{calc}^{o}=G_{gas}^{hERG-ligand}+Gₛₒₗᵥ^{hERG-ligand}−{Gₛₒₗᵥ^{hERG-ligand}+G_{gas}^{hERG-ligand}} (4)

Here, (G_{gas}^{hERG-ligand}) represents the free energy per mole for the non-covalent association of the ligand-protein complex in vacuum (gas phase) at a representative temperature, while (−ΔGₛₒₗᵥ) stands for the work required to transfer a molecule from its solution conformation to the same conformation in vacuum (assuming that the binding conformation of the ligand-protein complex is the same in solution and in vacuum).

The calculated binding energies, ΔG^{o}_{calc}, can be compared directly to the physiologically relevant concentrations. In this regard, the IC₅₀ (concentration at which 50% inhibition is observed) values measured from, for example, in vitro biological assays are converted to the observed free energy change of binding, ΔG_{obs} (cal mol⁻¹) using the equation:

ΔG^{o}_{obs}=RT ln Kᵢ (5)

where R is the gas constant, R=1.987 cal K⁻¹ mol⁻¹, T is the absolute temperature, and Kᵢ is approximated to be the IC₅₀ measured for a particular test compound, i. Accordingly, the calculated binding energies in silico, ΔG^{o}_{calc}, are compared to the observed binding energy in vitro, ΔG_{obs} (e.g., from inhibition studies), and thus, also to the physiologically relevant concentrations (IC₅₀) for each of the combinations of compound and protein, for example, hERG.

The calculated binding energy of a tested compound may also compared to that of a known control (a known hERG blacker from a standardized panel of drugs). The following equation is used:

$$Δ {G}_{1} - Δ {G}_{2 } = RT ln ( \frac{{K}_{i 1}}{{K}_{i 2}} ) \qquad ( 6 )$$

where Kᵢ₁ and Kᵢ₂ are the molar concentrations of the tested compound and the control, respectively.

### 7.9 Example 9

### Classification of Channel Blockage

VMD (Visual MD) (Humphrey et al., 1996, “Visual Molecular Dynamics,” J. Mol. Graphics, 14 (1), 33-38) was used to visually analyze the results of the MD trajectories of the selected complexes for preliminary ranking of the docking hits.

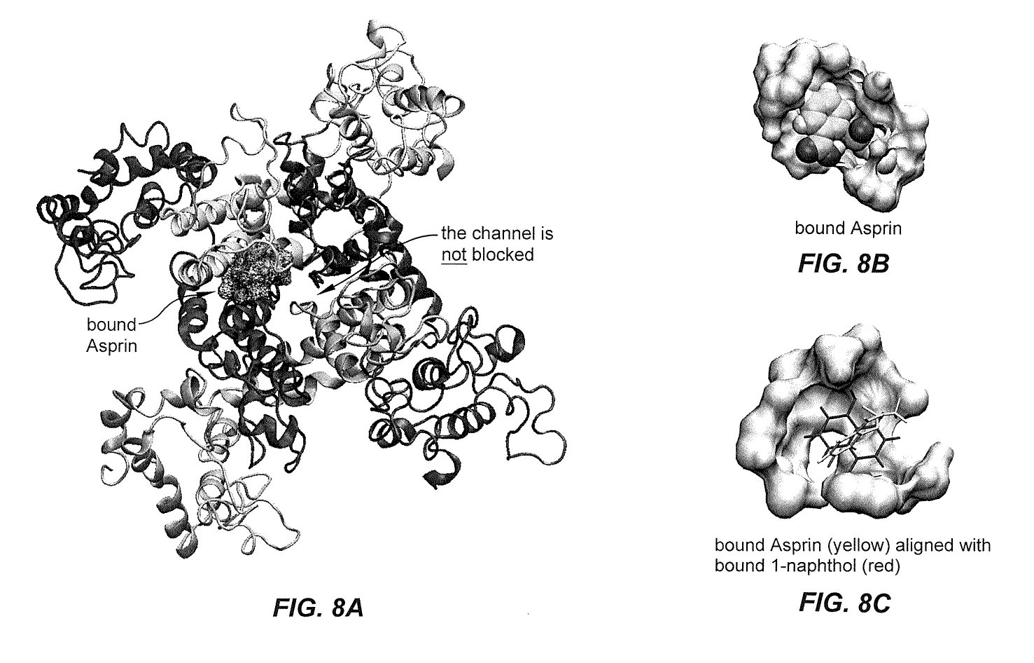

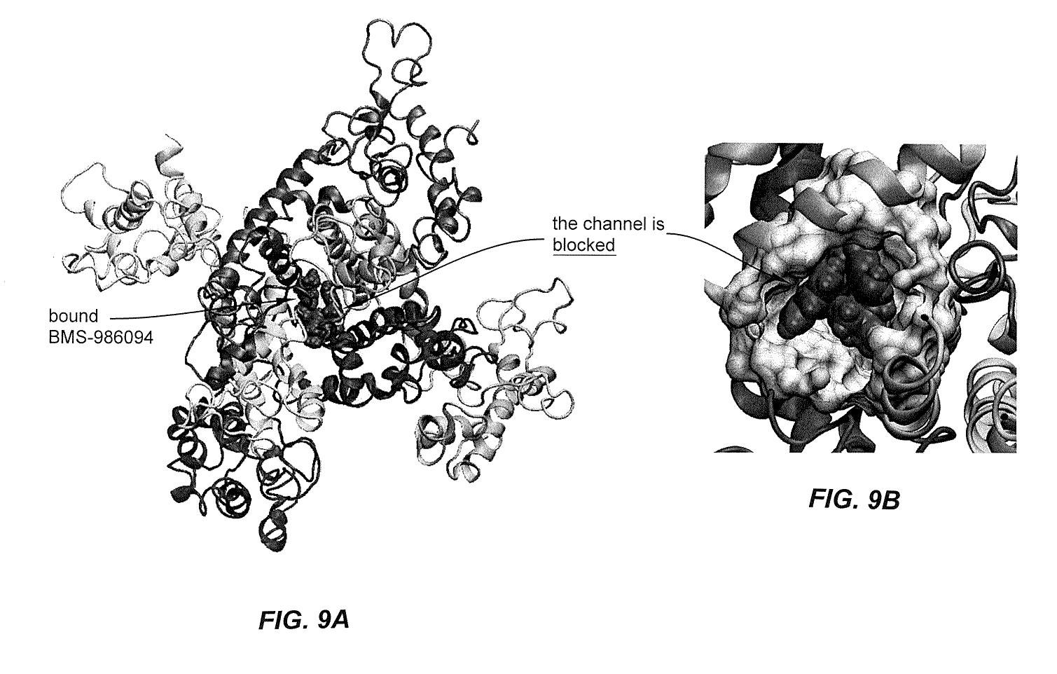

A channel blacker binds within the cavity so that the passage of the potassium ions through the selection filter is blocked. On the other hand, a compound may bind to the channel in a way that it does not interfere with the potassium passage. With that in mind, and by visually inspecting the bound structures, one can classify the tested small molecules as “blockers,” e.g., compounds that blocked the hERG1 ion channel, or as “non-blockers,” e.g., compounds that did not block the hERG1 ion channel. FIGS. 8A-8C present examples of non-blockers—aspirin and 1-naphthol bound to hERG1 tetramer do not block the ion channel. FIGS. 9A and 9B present an example of a blocker—BMS-986094 bound to hERG1 tetramer blocks the ion channel.

### 7.10 Example 10

### Redesign of Compound to be a Non-Blocker

BMS-986094 (“(2R)-neopentyl 2-(((((2R,3R,4R)-5-(2-amino-6-methoxy-9H-purin-9-yl)-3,4-dihydroxy-4-methyltetrahydrofuran-2-yl)methoxy)(naphthalen-1-yloxy)phosphoryl)amino)propanoate) is a nucleotide polymerase (NS5B) inhibitor that was in Phase II development for the treatment of hepatitis. BMS-986094 is an example of a compound that was placed on clinical hold by the FDA, after nine patients in a clinical trial had to be hospitalized and one of them died because of effects on QT interval prolongation. The structure of BMS-986094 is illustrated below, where the highlighted moiety corresponds to an “amino acid based prodrug”:

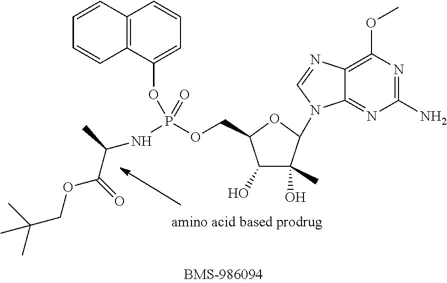 [SMILES: COc1nc(N)nc2c1ncn2C1O[C@H](COP(=O)(N[C@H](C)C(=O)OCC(C)(C)C)Oc2cccc3ccccc23)[C@@H](O)[C@@]1(C)O]

As demonstrated in EXAMPLE 9 and FIGS. 9A and 9B, BMS-986094 is a blocker of the hERG1 channel, a finding which is further confirmed by the results of the in vitro biological assays of EXAMPLES 11 and 12, described below.

According to the preferred binding conformations identified for BMS-986094 from the methods disclosed herein, the part of the BMS compound that blocks the hERG ion channel is the amino acid based prodrug hanging off the left-hand side of the 5-membered sugar. Without being limited by any theory, it is believed that by modifying or, if necessary, removing the prodrug portion of the compound, the modified BMS compound will no longer block the hERG ion channel, but will retain anti-HCV activity.

### 7.11 Example 11

### hERG1 Channel Inhibition Determination) in Mammalian Cells

Mammalian cells expressing the hERG1 potassium channel were dispensed into 384-well planar arrays and hERG tail-currents were measured by whole-cell voltage-clamping. A range of concentrations (TBD) of the test compounds were then added to the cells and a second recording of the hERG current was made. The percent change in hERG current was calculated. IC₅₀ values were derived by fitting a sigmoidal function to concentration-response data, where concentration-dependent inhibition was observed.

The experiments were performed on an IonWorks™ FIT instrument (Molecular Devices Corporation), which automatically performs electrophysiology measurements in 48 single cells simultaneously in a specialised 384-well plate (PatchPlate™). All cell suspensions, buffers and test compound solutions were at room temperature during the experiment.

The cells used were Chinese hamster ovary (CHO) cells stably transfected with hERG (cell-line obtained from Cytomyx, UK). A single-cell suspension was prepared in extracellular solution (Dulbecco's phosphate buffered saline with calcium and magnesium pH 7-7.2) and aliquots were added automatically to each well of a PatchPlate™. The cells were then positioned over a small hole at the bottom of each well by applying a vacuum beneath the plate to form an electrical seal. The vacuum was applied through a single compartment common to all wells which were filled with intracellular solution (buffered to pH 7.2 with HEPES). The resistance of each seal was measured via a common ground-electrode in the intracellular compartment and individual electrodes placed into each of the upper wells.

Electrical access to the cell was then achieved by circulating a perforating agent, amphotericin, underneath the PatchPlate™ and then measuring the pre-compound hERG current. An electrode was positioned in the extracellular compartment and a holding potential of −80 mV for 15 sec was applied. The hERG channels were then activated by applying a depolarising step to +40 mV for 5 sec and then clamped at −50 mV for 4 sec to elicit the hERG tail current, before returning to −80 mV for 0.3 s.

A test compound was then added automatically to the upper wells of the PatchPlate™ from a 96-well microtitre plate containing a range of concentrations of each compound. Solutions were prepared by diluting DMSO solutions of the test compound into extracellular buffer. The test compound was left in contact with the cells for 300 sec before recording currents using the same voltage-step protocol as in the pre-compound scan. Quinidine, an established hERG inhibitor, was included as a positive control and buffer containing 0.25% DMSO was included as a negative control. The results for all compounds on the plate were rejected and the experiment repeated if the IC₅₀ value for quinidine or the negative control results are outside quality-control limits.

Each concentration was tested in 4 replicate wells on the PatchPlate™. However, only cells with a seal resistance greater than 50 MOhm and a pre-compound current of at least 0.1 nA were used to evaluate hERG blockade.

Post-compound currents were then expressed as a percentage of pre-compound currents and plotted against concentration for each compound. Where concentration-dependent inhibition is observed, the data are fitted to the following equation and an IC₅₀ value calculated:

$$Y = \frac{{Y}_{m ax} - {Y}_{m i n}}{1 + ( X / {X}_{50} ) s} + {Y}_{m i n} ; \qquad ( 7 )$$

where Y=(post-compound current/pre-compound current)×100, x=concentration, X₅₀=concentration required to inhibit current by 50% (IC₅₀) and s=slope of the graph.

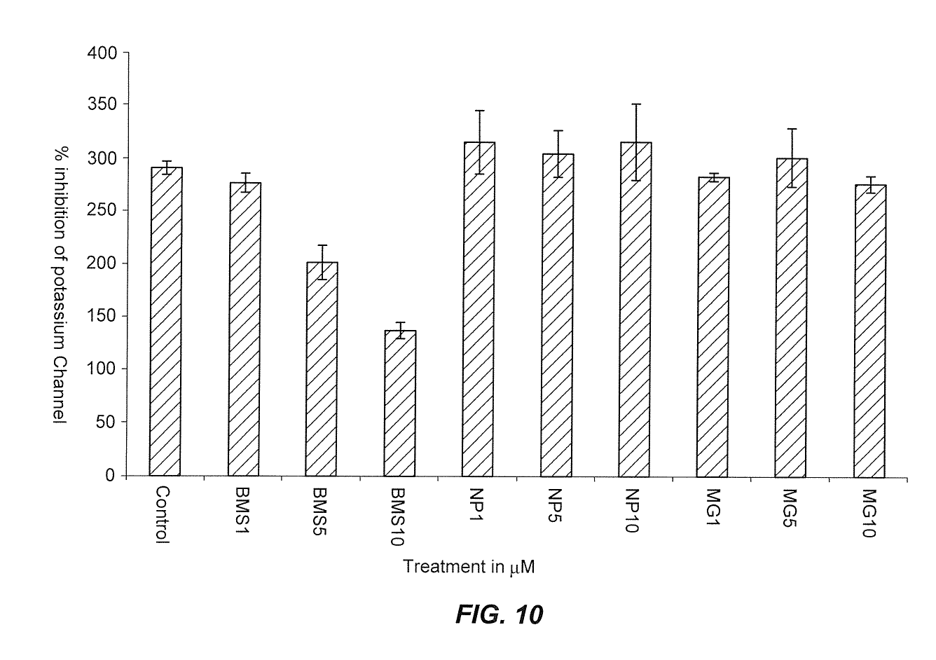

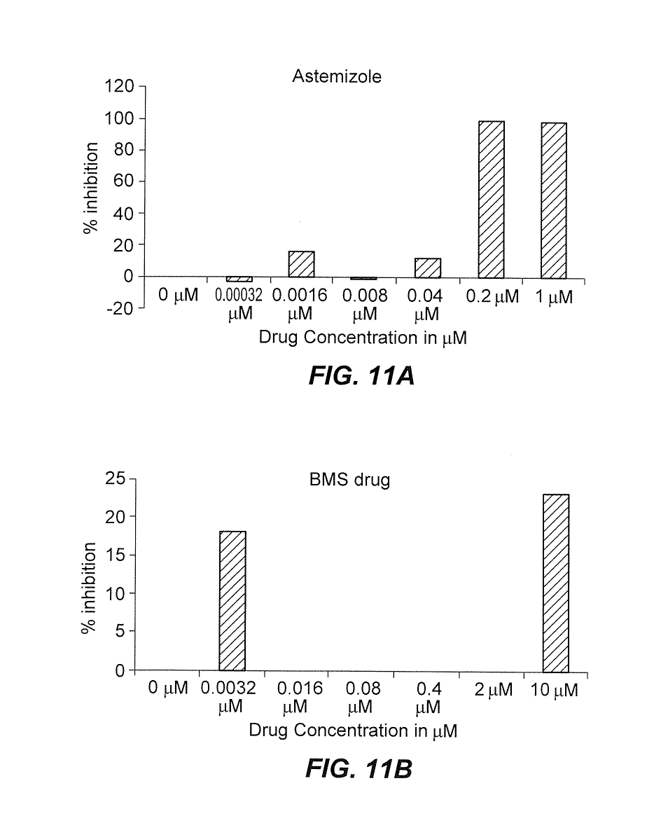

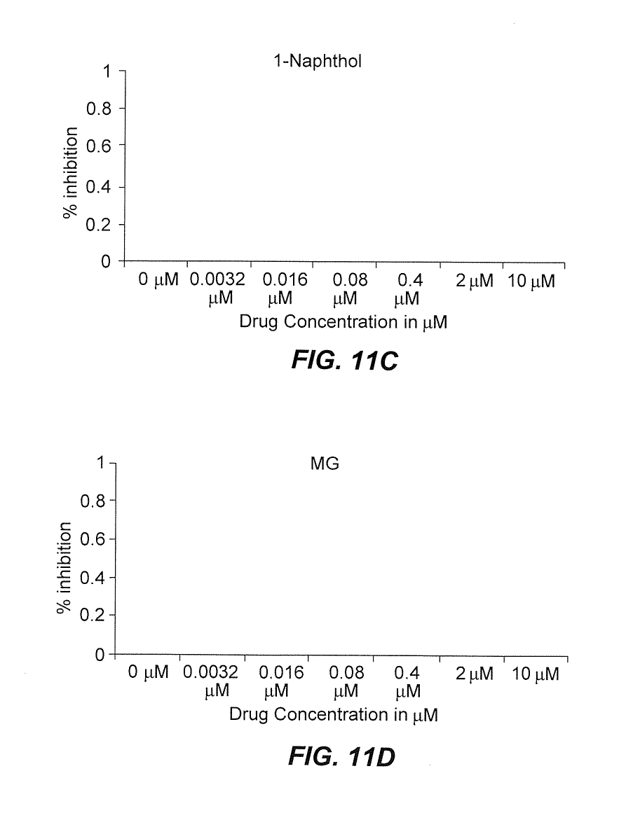

An IC₅₀ was reported if concentration-dependent inhibition is observed. The standard error (SE) of the IC₅₀ model and the number of data-points used to determine IC₅₀ was also reported. Results are presented in TABLE 6, below, and in FIGS. 10 and 11A-11D. According to the data, both astemizole and BMS-986094 inhibit the potassium channel.

TABLE 6
hERG1 Channel Inhibition (IC₅₀ Determination)

| | hERG1 Channel Inhibition (IC50 Determination) | | | | | | | | | | | | |
|---|---|---|---|---|---|---|---|---|---|---|---|---|---|
| | 0 | 0.00032 | 0.0016 | 0.0032 | 0.008 | 0.016 | 0.04 | 0.08 | 0.2 | 0.4 | 1 | 2 | 10 |
| Compound | μM | μM | μM | μM | μM | μM | μM | μM | μM | μM | μM | μM | μM |
| Astemizole | 0 | −3.08 | 15.8 | | −1.45 | | 12.0 | | 99.3 | | 98.7 | | |
| (+ve control) | | | | | | | | | | | | | |
| Pimozide | 0 | 2.29 | 4.56 | | 5.60 | | 25.1 | | 9.44 | | 83.2 | | |
| (+ve control) | | | | | | | | | | | | | |
| BMS-986094 | 0 | | | 18.2 | | −4.94 | | −8.97 | | −5.33 | | n/a | 23.29 |
| 1-naphthol (1-NP) | 0 | | | −14.0 | | −4.91 | | −6.96 | | 0.568 | | −6.35 | −9.67 |
| methoxyguanosine | 0 | | | 4.76 | | 3.14 | | −2.06 | | −2.18 | | −5.36 | −7.56 |
| Apirin | 0 | | | −2.97 | | −3.09 | | −21.0 | | −5.88 | | −3.71 | −0.546 |
| (+ve control) | | | | | | | | | | | | | |
| Guanosine | 0 | | | 0.711 | | 6.12 | | −3.46 | | 26.3 | | 0.453 | 5.54 |
| Sotalol (intermediate | 0 | | | 1.69 | | −0.730 | | 20.4 | | 10.9 | | 1.72 | 0.950 |
| +ve control) | | | | | | | | | | | | | |

### 7.12 Example 12

### Fluxor™ Potassium Channel Assay in Mammalian Cells

The FluxOR™ potassium channel assay was performed on Human Embryonic Kidney 293 cells (HEK 293) cells stably expressing hERG1 or mouse cardiomyocyte cell line HL-1 cells (a gift from Dr. William Claycomb, Louisiana, USA). Briefly, FluxOR™ loading buffer was made from Hank's Balanced Saline Solution (HBSS) buffered with 20 mM HEPES and pH adjusted with NaOH to 7.4. Powerload™ concentrate and water-soluble probenecid were used as directed by the kit to enhance the dye solubility and retention, respectively. Media were removed from the cell plates manually, and 20 of loading buffer containing the FluxOR™ dye mix was applied to each well. Once inside the cell, the nonfluorescent AM ester form of the FluxOR™ dye was cleaved by endogenous esterases into a thallium-sensitive indicator. The dye was loaded for 60 min at room temperature and then removed manually. The cell plates were subsequently washed once with dye-free assay buffer, before adding a final volume of 20 μL assay buffer containing water-soluble probenecid. Cell plates received 2 μL per well of the screening compounds, and were then incubated at room temperature (23-25° C.) for 30 min for HEK 293 cells to allow equilibration of the test compounds in the cultures or at 37° C. for 24 h for HL-1 cells. Prior to injection, stimulation buffer was prepared from the 5× chloride-free buffer, thallium, and potassium sulfate reagents provided in the kit to contain 10 mM free thallium (5 mM Tl₂SO₄) and 50 mM free potassium (25 mM K₂SO₄). These concentrations resulted in final added concentrations of 2 mM free Tl⁺ and 10 mM free K⁺ after 1:5 dilution upon injection of the stimulus buffer into cells that had been loaded with FluxOR™ dye. To each well 20 μL stimulation buffer was added and fluorescence measures were done every 1 sec for a total time of 180 sec. Fluorescence measurement were made using a Perkin Elmer EnSpire Multimode Plate Reader (Massachusetts, USA) using excitation and emission wavelengths of 490/525 nm, respectively.

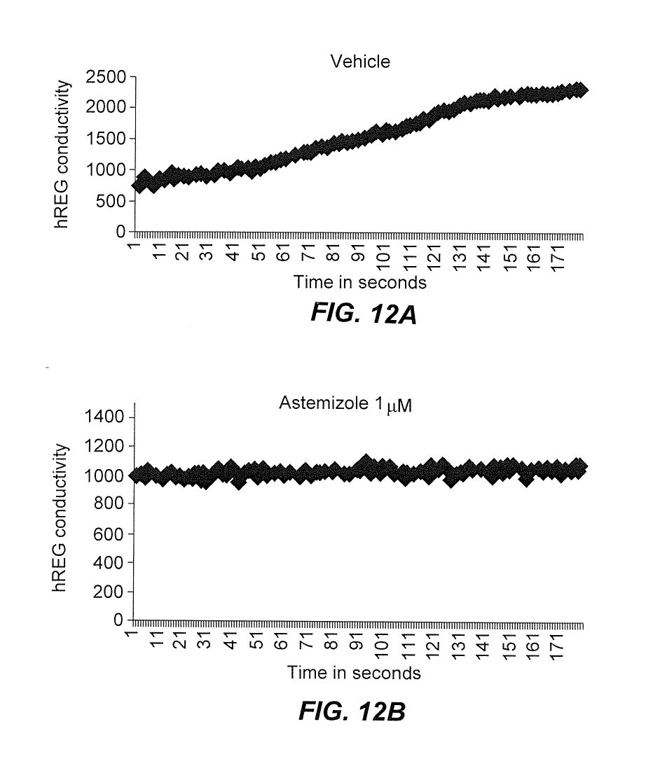

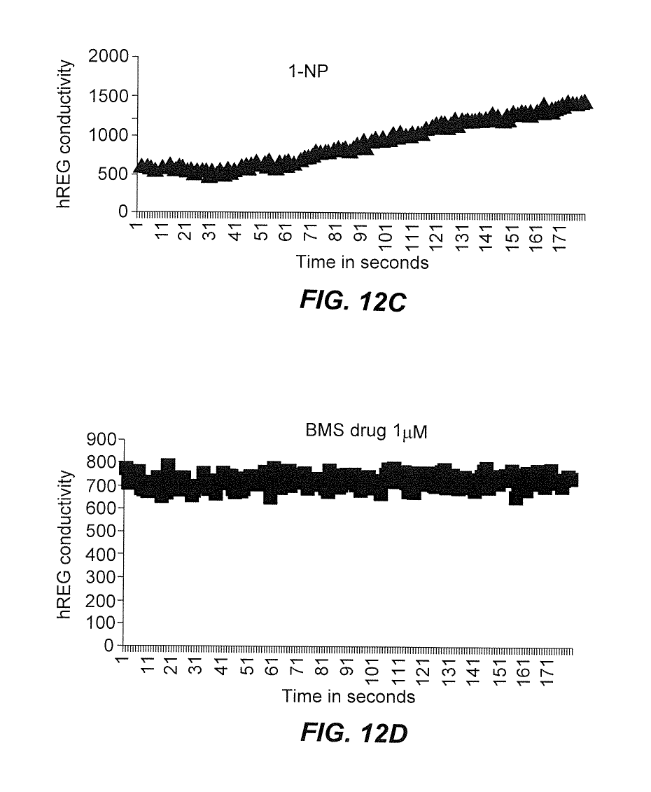

FIGS. 12A-12D present the results of a FluxOR™ potassium channel assay in HEK 293 cells for vehicle (12A), astemizole (12B), 1-naphthol (1-NP) (12C), and BMS-986094 (12D). Both astemizole and BMS-986094 block conductance of the potassium channel.

### 7.13 Example 13

### Electrocardiograpy to Test Anti-Arrhythmic Activity in Transgenic Mice Expressing hERG

Electrocardiograpy to test anti-arrhythmic activity in transgenic mice expressing hERG1 specifically in the heart may be performed using previously published protocols (Royer et al., 2005, “Expression of Human ERG K+Channels in the Mouse Heart Exerts Anti-Arrhythmic Activity,” Cardiovascular Res. 65, 128-137).

### 7.14 Example 14

### Prediction and Validation of hERG Blockage Using Test Panel of Compounds

The computation model and methods disclosed herein were used to identify drug-mediated hERG blocking activity of a test panel of compounds with high sensitivity and specificity. These in silica results were validated using hERG binding assays and patch clamp electrophysiology. As demonstrated in the following Example, the computation models and methods disclosed herein can distinguish between potent, weak, and non-hERG blockers, and enable for the first time high throughput screening and modification of compounds with reduced cardiotoxicity early in the drug development process.

A.1. Molecular Dynamics (MD) Simulations:

A previously published homology structure for the hERG channel in its open state as the initial configuration (Durdagi et al., 2012, “Modeling of Open, Closed, and Open-Inactivated States of the Hergl Channel: Structural Mechanisms of the State-Dependent Drug Binding,” J. Chem. Inform. & Model. 52, 2760-2774) was used. The protein structure was embedded into 416 POPC membrane lipids bilayer, 15 Å-wide buffer of water molecules and a 0.15M of KCl salt concentration using the CHARMM-GUI membrane builder protocol (Barakat et al., 2010, “Ensemble-based Virtual Screening Reveals Dual-Inhibitors for the p53-MDM2IMDMX Interactions,” J. Mol. Graph. & Model. 28, 555-568). Three potassium ions were positioned within the selectivity filter. Two force fields were used, the AMBER99SB force field (Hornak et al., 2006, “Comparison of Multiple Amber Force Fields and Development of Improved Protein Backbone Parameters,” Proteins 65, 712-725) for the protein structure and the amber lipid11 force field (Skjevik et al., 2012, “LIPID11: a Modular Framework for Lipid Simulations using Amber,” J. Phys. Chem. B 116, 11124-11136) for the membrane structure. Overall, 155 MD simulations were carried out using the NAMD program (Homak et al., 2006) at 310K. The initial simulation was carried out for 500 ns on the membrane-bound structure with no ligands within the pocket to explore the conformational dynamics of the hERG cavity and to extract dominant conformations for subsequent docking analyses.

The protocol for the MD simulation employed 200,000 minimization steps with heavy restraints on the protein backbone and lipid molecules, gradual heating for 1 ns over 1000 steps with the same restraints, equilibration for 10 ns with the restrained weakened to one hundred times from that of heating, followed by an additional equilibration phase for 10 ns with a further reduction to one tenth of the restraints used in the previous step, and finally, running the system for the rest of the 500 ns with no restraints. The remaining 154 MD simulations were used to relax the hERG-ligands complexes obtained from docking simulations and generate an ensemble of protein-ligand structures for binding energy analysis. These MD simulations followed the same procedure as those previously described (Jordheim et al., 2013, “Small Molecule Inhibitors of ERCC1-XPF Protein-Protein Interaction Synergize Alkylating Agents in Cancer Cells,” Mol. Pharmacol. 84, 12-24; Barakat et al., 2010, “Ensemble-based Virtual Screening Reveals Dual-Inhibitors for the p53-MDM2/MDMX interactions,” J. Mol. Graph. & Model. 28, 555-568; Barakat et al., 2012, “Virtual Screening and Biological Evaluation of Inhibitors Targeting the XPA-ERCC1 Interaction,” PloS one 7, e51329 (2012)10.1371/journal.pone.0051329)).

For the ligand-bound systems, the ligand parameters were obtained using the generalized amber force field (GAFF) (Wang et al., 2004, “Development and Testing of a General Amber Force Field,” J. Comput. Chem. 25, 1157-1174). For each ligand, partial charges were calculated with the AM1-BCC method using the Antechamber module of AMBER 10. Root-mean-square deviations (RMSD) and B-factors were computed over the duration of the simulation time using the PTRAJ utility. The 1-D electron density profiles were calculated using the density profile tool as implemented in VMD (Barakat et al., 2012, “DNA Repair Inhibitors: the Next Major Step to Improve Cancer Therapy,” Curr. Topics Med. Chem. 12, 1376-1390) for the last 300 ns.

A.2. Clustering Analysis:

The RMSD conformational clustering was performed using the average-linkage algorithm using cluster counts ranging from 5 to 300 clusters. Clustering analysis was performed on the 500 ns MD simulation using residues 623, 624, 651, 652, 653, 654, 655 and 656 from each monomer. Structures were extracted at 10 ps intervals over the entire 500 ns simulation times. All C_{α}-atoms were RMSD fitted to the minimized initial structures in order to remove overall rotation and translation. The clustering quality was anticipated by calculating two clustering metrics, namely, the Davies-Bouldin index (DBI) (Davies et al., 1979, “A Cluster Separation Measure,” IEEE Trans. Pattern Anal. Mach. Intelligence 1, 224) and the “elbow criterion” (Shao et al., 2007, “Clustering Molecular Dynamics Trajectories: 1. Characterizing the Performance of Different Clustering Algorithms,” J. Chem. Theor. & Comp., 2312). A high-quality clustering scheme is expected when DBI experiences a local minimum versus the number of clusters used. On the other hand, using the elbow criterion, the percentage of variance explained by the data is expected to plateau for cluster counts exceeding the optimal number of clusters (Shao et al., 2007). Using these metrics and varying the number of clusters, for adequate clustering, one should expect a local minimum for DBI and a horizontal line for the percentage of variance, which is exhibited by the data (see Results, below).

A.3. Principal Component Analysis:

PCA can transform the original space of correlated variables from a large MD simulation into a reduced space of independent variables comprising the essential dynamics of the system (Barakat et al., 2011, “Relaxed Complex Scheme Suggests Novel Inhibitors for the Lyase Activity of DNA Polymerase Beta,” J. Mol. Graph. & Model. 29, 702-716). For a typical protein, the system's dimensionality is thereby reduced from tens of thousands to fewer than fifty degrees of freedom.

To perform PCA for a subset of N atoms, the entire MD trajectory was RMSD fitted to a reference structure, in order to remove all rotations and translations. The covariance matrix was then be calculated from their Cartesian atomic co-ordinates as:

σᵢⱼ= [symbol] (rᵢ− [symbol] rᵢ [symbol] )(rⱼ− [symbol] rⱼ [symbol] ) [symbol] (8)

where rᵢ represents one the three Cartesian co-ordinates (xᵢ, yᵢ or zᵢ) and the eigenvectors of the covariance matrix constitute the essential vectors of the motion.

A.4. Docking:

The 45 representatives of all clusters were used as rigid targets for the docking simulations. All docking runs were performed using AUTODOCK (Osterberg et al., 2002, “Automated Docking to Multiple Target Structures: Incorporation of Protein Mobility and Structural Water Heterogeneity in Autodock,” Proteins 46, 34-40), version 4.028. For each ligand, an initial docking simulation was performed within the whole cavity against the 45 dominant conformations. Results from this ensemble docking procedure were clustered using RMSD clustering from AUTODOCK with 2 Å cutoff, followed by ranking of the docking binding energies. More comprehensive docking simulations against the 45 dominant conformations were then performed within the preferred halves of the cavity that were selected by the top hits from the initial docking simulation.

For the initial run, the docking box spanned 126 grid points in each direction, with spacing of 0.238 Å between every two-adjacent points, enough to cover twice the whole pocket. For the more focused docking simulations, the box size was confined to 52 82 126 with the same spacing between points, however, the center of the box was moved to be more focused on the residues of the selected half pocket. For all docking simulations, the parameters were similar to those previously described (Barakat et al., 2012, “Virtual Screening and Biological Evaluation of Inhibitors Targeting the XPA-ERCC1 Interaction,” PloS one 7, e51329 (2012)10.1371/journal.pone.0051329); Barakat et al., 2013, “A Computational Model for Overcoming Drug Resistance Using Selective Dual-Inhibitors for Aurora Kinase A and Its T217D Variant,” Mol. Pharm. 10, 4572-4589). In brief, using the Lamarckian Genetic Algorithm (LGA), the docking parameters included an initial population of 350 random individuals; a maximum number of 25,000,000 energy evaluations; 100 trials; 34,000 maximum generations; a mutation rate of 0.02; a crossover rate of 0.80 and the requirement that only one individual can survive into the next generation.

A.5. Calculating the Shortest Distance from the Channel Mouth:

The shortest distance between a tested compound to one of the Thr623 residues at the mouth of the hERG channel was calculated using VMD to construct a table of all contact atoms within 20A for the four-threonine residues and the tested compound. Distances were calculated for each atom pair and all distances were sorted to extract the shortest distance.

A.6. Binding Energy Analysis:

The MM-PBSA technique (Kollman et al., 2000, “Calculating Structures and Free Energies of Complex Molecules: Combining Molecular Mechanics and Continuum Models,” Acc. Chem. Res. 3B, 889-897) was used to predict binding energies. Similar to the work described previously in the literature (Barakat et al., 2010, “Ensemble-Based Virtual Screening Reveals Dual-Inhibitors for the P53-MDM2/MDMX Interactions,” J. Mol. Graph. & Model. 28, 555-568; Barakat et al., 2013, “A Computational Model for Overcoming Drug Resistance Using Selective Dual-Inhibitors for Aurora Kinase A and Its T217D Variant,” Mol. Pharm. 10, 4572-4589; Barakat et al., 2013, “Detailed Computational Study of the Active Site of the Hepatitis C Viral RNA Polymerase to Aid Novel Drug Design,” J. Chem. Inform. & Model. 53, 3031-3043); Friesen et al., 2012, “Discovery of Amall Molecule Inhibitors that Interact with Gamma-Tubulin,” Chem. Biol. & Drug Design 79, 639-652), the total free energy for each system was estimated as the sum of the average molecular mechanical gas-phase energies (E_{MM}), solvation free energies (Gₛₒₗᵥ), and entropy contributions (−TSₛₒₗᵤₜₑ) of the binding reaction:

G=E_{MM}+Gₛₒₗᵥ−TSₛₒₗᵤₜₑ (9)

The molecular mechanical (E_{MM}) energy of each snapshot was calculated using the SANDER module of AMBER10. The solvation free energy (Gₛₒₗᵥ) was estimated as the sum of electrostatic solvation free energy, calculated by the finite-difference solution of the Poisson-Boltzmann equation in the Adaptive Poisson-Boltzmann Solver (APBS) and non-polar solvation free energy, calculated from the solvent-accessible surface area (SASA) algorithm:

ΔG⁰=G_{gas}^{hERG-ligand}+Gₛₒₗᵥ^{hERG-ligand}−{Gₛₒₗᵥ^{hERG-ligand}+G_{gas}^{hERG}} (10)

The parameters used included a dielectric constant for the protein-ligand complex of 1, a dielectric constant for the water of 80, an ionic concentration of 0.15 M, and a surface tension of 0.005 with a zero surface offset to estimate the nonpolar contribution of the solvation energy.

Two-thousand (2000) snapshots from each trajectory were selected to predict the molecular mechanics and solvation contributions; fifty (50) snapshots from each trajectory were selected to predict entropy. Selection of the snapshots' frequency was based on estimating the correlation time similar to the work described by Genheden and Ryde (Genheden and Ryde, 2010, “How to Obtain Statistically Converged MM/GBSA Results,” J. Comput. Chem. 31, 837-846). That is, the delta MM-PBSA energy points from the whole MD trajectory (X) was divided into blocks (Yᵢ) of equal time spaces (τ). The function Φ was then calculated according to the following equation:

$$Φ = \frac{τ \cdot {{σ}^{2} ( Y )}_{τ}}{{σ}^{2} ( X )} \qquad ( 11 )$$

where σ² (X) is the variance of the whole trajectory delta MM-PBSA energy points and σ²(Y) is the variance of the averages of the energy data points within the blocks of length τ (e.g., for each block the average delta energy is calculated then the variance of the n blocks generated is then used in Equation 11 as σ² (Y)_{τ} for a certain τ). The length of the block (τ) is then varied and the values of Φ are expected to be constant when the block averages are statistically independent and at this point the time correlation can be estimated.

A.7. Electrophysiology Buffers and Compounds:

Dulbecco's Phosphate-buffered saline was purchased from Corning. Intracellular (IC) buffer was composed of (mM) ethylene glycol tetraacetic acid EGTA (11), MgCl₂ (2), KCl (30), KF (90), 4-(2-hydroxyethyl)-1-piperazineethane sulfonic acid (HEPES) (10), and K₂-ATP (5), and was pH adjusted with KOH to 7.3. Extracellular (EC) buffer was composed of (mM) CaCl₂, (2), MgCl₂ (1), HEPES (10), KCl (4), NaCl (145), and pH adjusted with NaOH to 7.4. Astemizole, pimozide, cisapride, rofecoxib, celecoxib, haloperidol, terfenadine, quinidine, amiodarone, E-4031, trimethoprim, resveratrol, ranitidine HCl, acetyl salicylic acid, naproxen, ibuprofen, diclofenac Na, acetaminophen, guanosine, and 1-naphtol were obtained from Sigma-Aldrich. 2-amino-6-O-methyl-2′C-methyl guanosine (MG) was purchased from Carbosynth (Berkshire, UK). BMS-986094 was locally synthesized by Syninnova (Edmonton, AB). Compounds were serially diluted in dimethylsulfoxide (DMSO) and then added to the EC buffer at a constant concentration of 0.01% DMSO. A reagent (part No. 910-0049, FLreagent; Fluxion Biosciences) that reduced compound loss due to adhesion/adsorption to the plate was also added to compound solutions (1:100 ratio).

A.8. Predictor™ hERG Fluorescence Polarization Assay:

Compounds that bind to the hERG channel proteins were identified by their ability to displace the tracer (Predictor hERG Tracer Red) and decrease the fluorescence polarization. The Tracer Red ligand was stored in 100% DMSO and diluted to 8 nM in assay buffer (50 mM Tris-HCl, 1 mM MgCl2, 10 mM KCl, 0.05% Pluronic F127, pH 7.4, 4° C.) on the day of the experiment. Test samples and controls were diluted in assay buffer to 16 concentrations with half-log intervals. Cell membranes were removed from the −80° C. freezer and placed on ice after defrosting. Membranes working solution protein concentration was 0.3 mg/mL. The assay was compiled by adding 5 μL of test compound or control buffers, 5 μL of the Tracer Red ligand and 10 μL of cell membranes to a black 384-well plate (Corning, Cat No. 3677). The plates were mixed and then incubated for 6 h prior to reading on a Perkin Elmer EnVision plate reader (Excitation 531/25 nm, Emission 579/25 nm). IC₅₀ values were derived by fitting a sigmoidal function to concentration-response data, where concentration-dependent inhibition was observed. All IC₅₀ data were calculated and analyzed using GraphPad Prism 6 (GraphPad Software).

A.9. Cell Culture and Transfection:

AC10 adult human cardiomyocytes (ATCC Cat. No. PTA-1501) were seeded one day before the transfection in a 6 well plate in complete growth media with 5% fetal bovine serum (FBS) at 37° C. and 5% CO₂. Transfections were carried out according to manufacturer's protocols. Briefly, x μg of lentiviral ORF expression plasmid DNA and y μl of Lenti-Pac HIV mix was first mixed in Opti-MEM I in one tube. In a separate tube, z μl of EndoFectin Lenti was diluted with Opti-MEM I. The diluted EndoFectin Lenti reagents were added drop wise to the DNA containing tube. The mixture was incubated at room temperature to allow the DNA-EndoFectin complex to form. The complex mixture was then directly added to each well and the plate was gently swirled. After incubation at 37° C. and 5% CO₂ for 12-16 h, medium containing the mixtures was gently removed, and fresh growth medium was added. 48 hours post transfection, psedudovirus-containing culture medium was collected in sterile capped tubes and centrifuged. The supernatant was filtered through 0.45 μM low protein-binding filters.

A.10. Transduction of AC10 Cells:

AC10 cells were plated two days before the viral infection into 24-well plate, so that the cells reach to 70-80% confluency at the time of transduction. For each well viral suspension was diluted in complete medium in the presence of Polybrene. Cells were infected with diluted viral suspension containing Polybrene. Cells were incubated at 37° C. in 5% CO₂ overnight. Cells were splitted into 1:5 onto 6-well plate and continued incubating for 48 hours into cell specific medium. The infected target cells were analyzed by transient expression of transgenes by flow cytometry and with a fluorescent microscope. For selecting stably transduced cells, the old media was replaced with fresh selective medium containing the appropriate selection drug every 3-4 days until drug resistance colonies become visible.

A.11. Patch Clamp Cell Culture:

AC10 cells constitutively expressing hERG channels and their corresponding negative control cells were validated in-house on IonFlux 16 (Molecular Devices). The medium was composed of 10% fetal bovine serum, 1% penicillin-streptomycin, and 89% Dulbecco's Modified Eagle Medium (DMEM)/F12 (Invitrogen Corporation). Cells were grown in T175 tissue culture flasks, split at 70%-90% confluency with trypsin/ethylene diamine-tetraacetic acid (0.05%; Invitrogen Corporation), and maintained at 37° C. and 5% CO₂. When designated for experiments, passaged cells were moved to 28° C. for at least 24 h. Harvesting was performed with trypsin/ethylene diamine-tetraacetic acid 0.05% for 4 min, and detached sells were pelleted and resuspended in a solution of 97.5% serum free media (Gibco No. 12052; Invitrogen) and 2.5% HEPES buffer solution (Gibco No. 15630; Invitrogen) for 0.5-2.5 h at 23° C. Immediately before experiments, cells were washed once in EC buffer.

A.12. Automated Patch Clamp IonFlux Software and Experimental Protocols:

Compounds were diluted as described above, and distributed into compound wells (250 μL/well) manually. Cells were distributed to the designated wells and the plate was inserted into the IonFlux system. Plates were primed for 3 min according to the following protocol: (1) traps and compounds at 8 psi for t=0-160 s and 1.6 psi for t=160-175 s, (2) traps but not compounds at 1.6 psi for t=175-180 s, and (3) main channel at 1 psi for t=0-160 s and 0.2 psi for 160-180 s. After cell introduction at 5-8×10⁶ cells/mL, the plates were reprimed: (1) traps and compounds at 5 psi for t=0-15 s and 2 psi for t=15-55 s, (2) traps but not compounds at 2 psi for t=55-60 s, and (3) main channel at 1 psi for t=0-20 s, 0.5 psi for t=20-40 s, and 0.2 psi for t=40-60 s. Then, cells were introduced into the main channel and trapped at lateral trapping sites with a trapping protocol: (1) trapping vacuum of 6 mmHg for t=0-30 s and 4 mmHg for t=30-85 s, (2) main channel pressure of 0.1 psi for t=0-2 s, followed by 15 repeated square pulses of 0-0.2 psi with baseline duration of 4.5 s and pulse duration of 0.5 s, followed by 0.1 psi for 8 s. One to five break protocols were performed and currents were stabilized before compound testing. A negative control (EC buffer with 0.01% DMSO) was tested before compounds which were infused for 5 to 15 min. Finally, cells were washed with EC buffer. Voltage command protocols used in the current study are similar to those employed in conventional patch clamping for hERG current, Vₕ was −80 mV and an initial step to +50 mV for 800 ms inactivated the channels, followed by a 1-s step to −50 mV to elicit the outward tail current that was measured.

A.13. Automated Patch Clamp Data Analysis:

Remaining percentage of current (REM) was calculated by subtracting current level from that of full block (e.g., positive controls), and then dividing by the difference of no block (e.g., negative controls) and full block (negative minus positive controls). The half maximal inhibitory concentration (IC₅₀) and Hill slope (H) for compound concentrations (C) were fit to the following formula for the dps:

REM=I₁₀₀+[(I₀−I₁₀₀)/(1+([C]=IC₅₀̂H))] (12)

where I₀ and I₁₀₀ refer to no block and full block, respectively. IonFlux software (Molecular Devices), GraphPad Prism (GraphPad Software), and Microsoft Excel (Microsoft) were used to analyze and present IC₅₀ values, currents, and seals.

A.14. Patch Clamp Data Inclusion Criteria:

IC₅₀ values were calculated at temperature (33° C.-35° C.) from seven-point concentration-response curves with a minimum of n=6 at each concentration. Data points were accepted if they passed the following inclusion criteria: (1) acceptable current run-up/run-down (<10%) during compound incubation and before the positive control, (2) the negative control associated with the same cell trap did not show current block, and (3) the positive control associated with the same cell trap showed complete current block. The rate of current recovery during washout of compound was monitored, and outliers were excluded to filter out recordings that were lost.

A 500 ns molecular dynamics (MD) simulation was performed using an explicitly solvated membrane-bound hERG channel, an IBM Blue Gene/Q supercomputer, and an automated relaxed complex scheme (RCS) docking algorithm (Barakat et al., 2013, “A Computational Model for Overcoming Drug Resistance Using Selective Dual-Inhibitors for Aurora Kinase A and Its T217D Variant,” Mol. Pharm. 10, 4572-4589). The protocol involved six steps: (1) extracting the dominant (45) conformations of hERG's inner cavity; (2) performing blind docking simulations within the inner cavity against these 45 conformations to identify the highest affinity binding locations; (3) performing focused ligand docking to the top-ranked locations; (4) using all-atom MD simulations with explicit solvent and ions to rescore top hits; (5) calculating the molecular mechanics Poisson-Boltzmann surface area (MM-PBSA) binding energies of the refined complexes; (6) estimating the likelihood of channel blocking based on the ligand's lowest binding energy and shortest distance to the channel's pore. Since most hERG blockers bind within the inner hERG cavity in the channel's open state (Mitcheson et al., 2000, “A Structural Basis for Drug-Induced Long QT Syndrome,” Proc. Natl. Acad. Sci. USA 97, 12329-12333; Spector et al., 1996, “Class III Antiarrhythmic Drugs Block HERG, a Human Cardiac Delayed Rectifier K+ Channel. Open-Channel Block by Methanesulfonanilides,” Circ. Res. 78, 499-503), an open-state model (Durdagi et al., 2012, “Modeling of Open, Closed, and Open-Inactivated States of the Hergl Channel: Structural Mechanisms of the State-Dependent Drug Binding,” J. Chem. Inform. & Model. 52, 2760-2774) was used as an initial configuration for MD simulations prior to extracting representative inner cavity structures for docking.

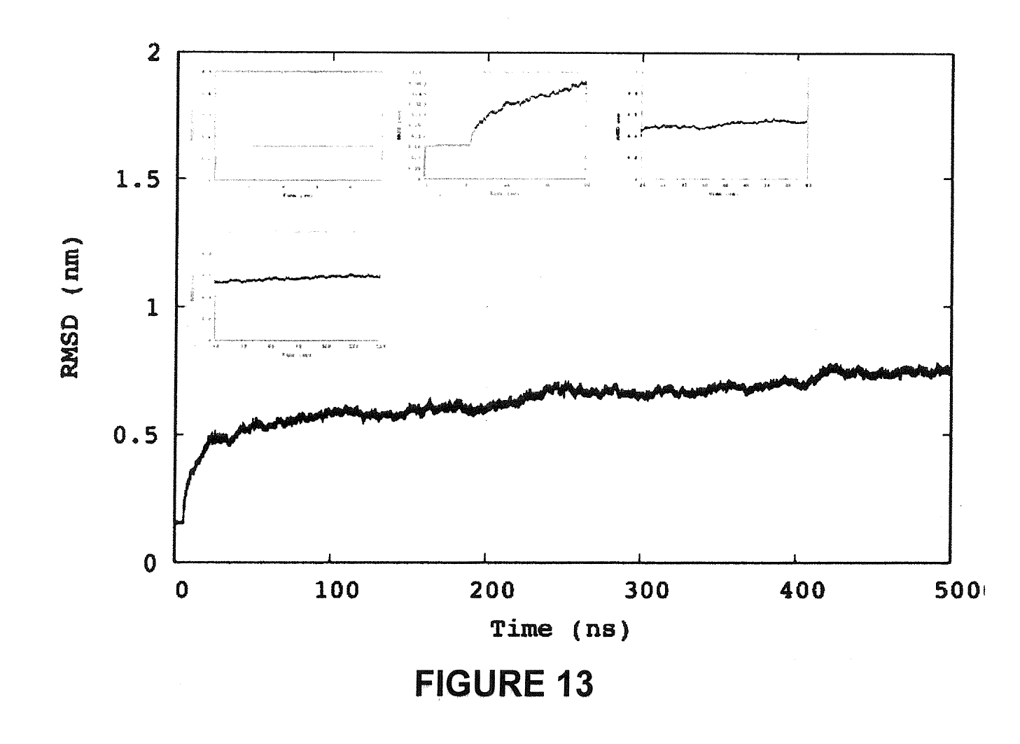

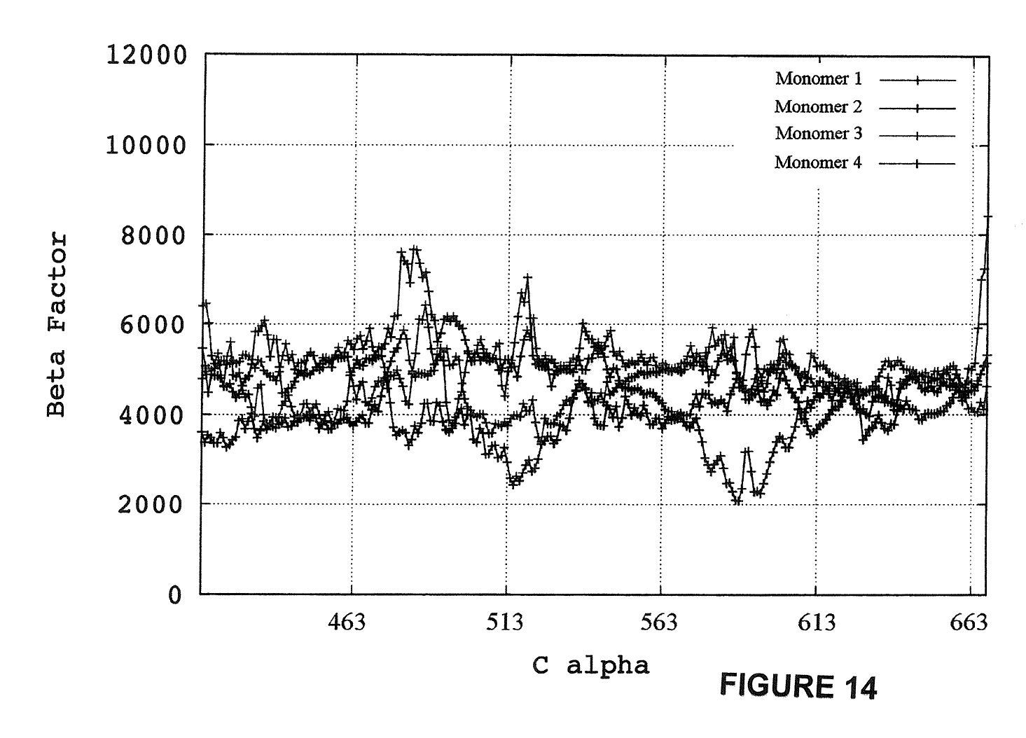

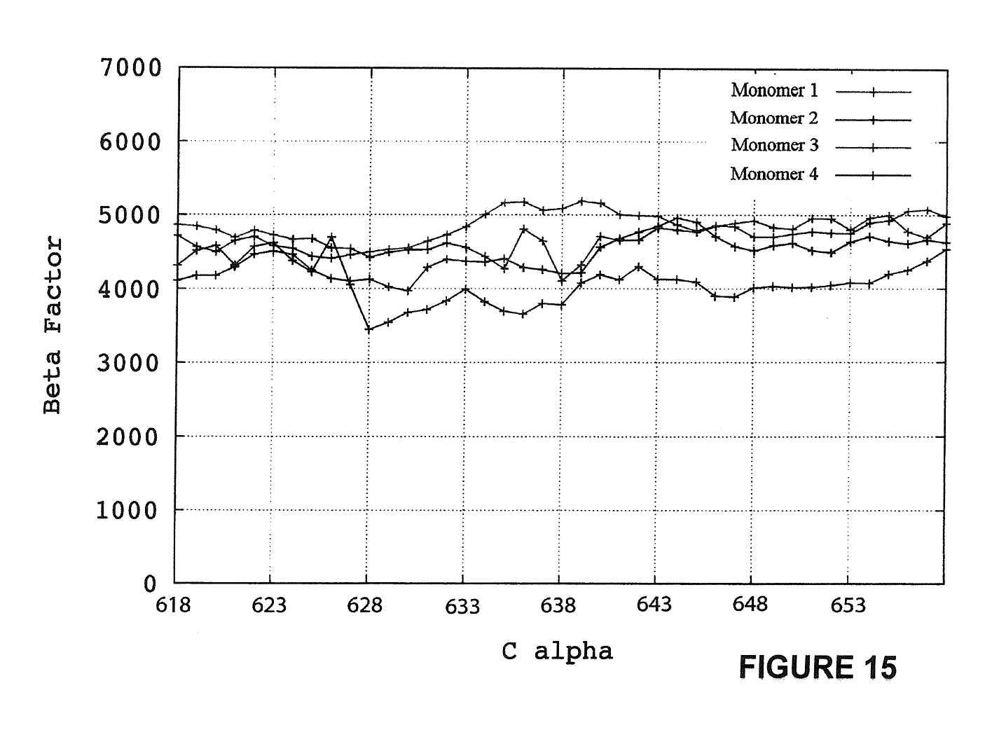

FIG. 13 illustrates the root-mean-square deviation (RMSD) during the simulation. The system started to equilibrate approximately 20 ns after removing the backbone restraints and fluctuated over 7 Å thereafter. B-factor analysis showed hERG channel's thermal fluctuations per residue (see FIG. 14) confirming the reports (Jiang et al., 2005, “Dynamic Conformational Changes of Extracellular S5-P Linkers in the HERG Channel,” J. Physiol. 569, 75-89) that the most flexible regions include the S5-P linker (residues 613-668) and residues 70-140 (located mainly in the S3 and S4 helices), with higher flexibility for monomers 1 and 4 compared to 2 and 3. Conversely, the permeation pore and inner cavity residues (618-658) fluctuated within the same range in all monomers (see FIG. 15).

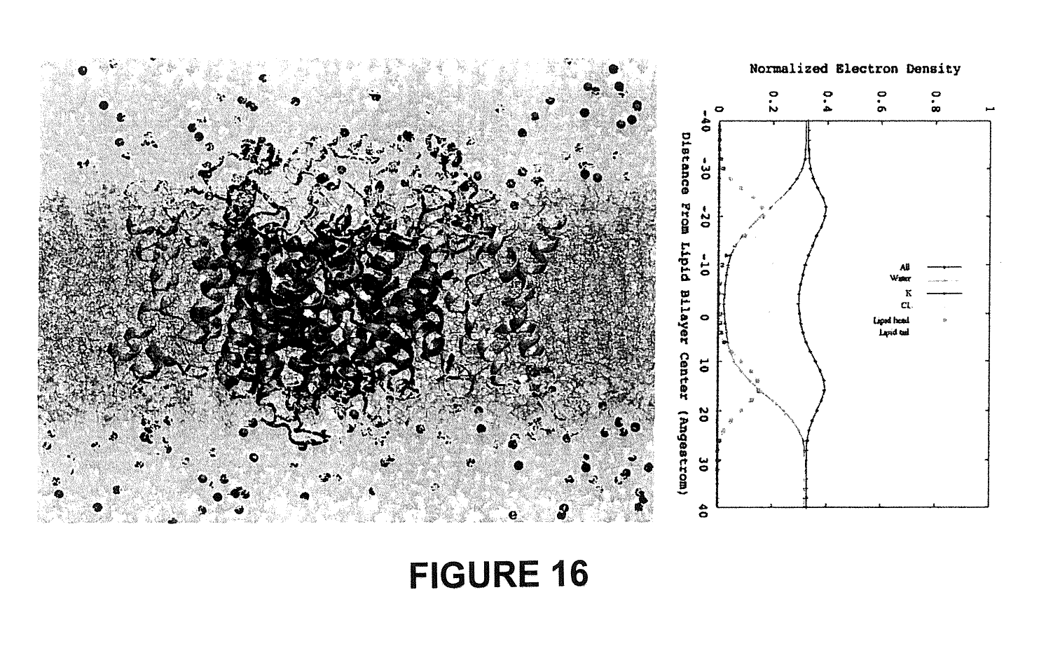

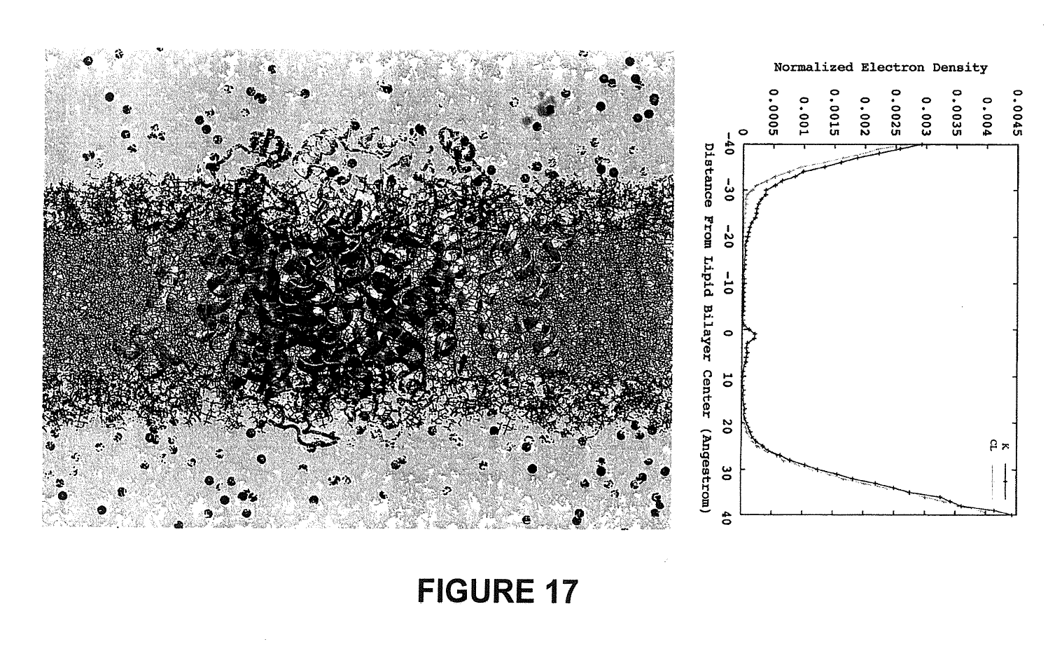

To confirm the model's reproduceability, electron density profiles were calculated for the lipid bilayer's heads and tails, protein, water and ions. The distance between the centroids of average electron density profiles of the lipid head groups determines membrane boundaries illustrating the internal component distributions. As may be seen in FIG. 16, water is mainly concentrated outside the membrane except for a minute fraction within the permeation pore providing ion hydration shells. Although the ionic electron densities are extremely small compared to protein, water or lipid systems, selectivity of the hERG channel for potassium over chlorine is seen by comparing the average electron density profiles for these ions over the last 300 ns of the simulation. A visible potassium density peak within the hERG selectivity filter is compared to chlorine's almost zero density (see FIG. 17).

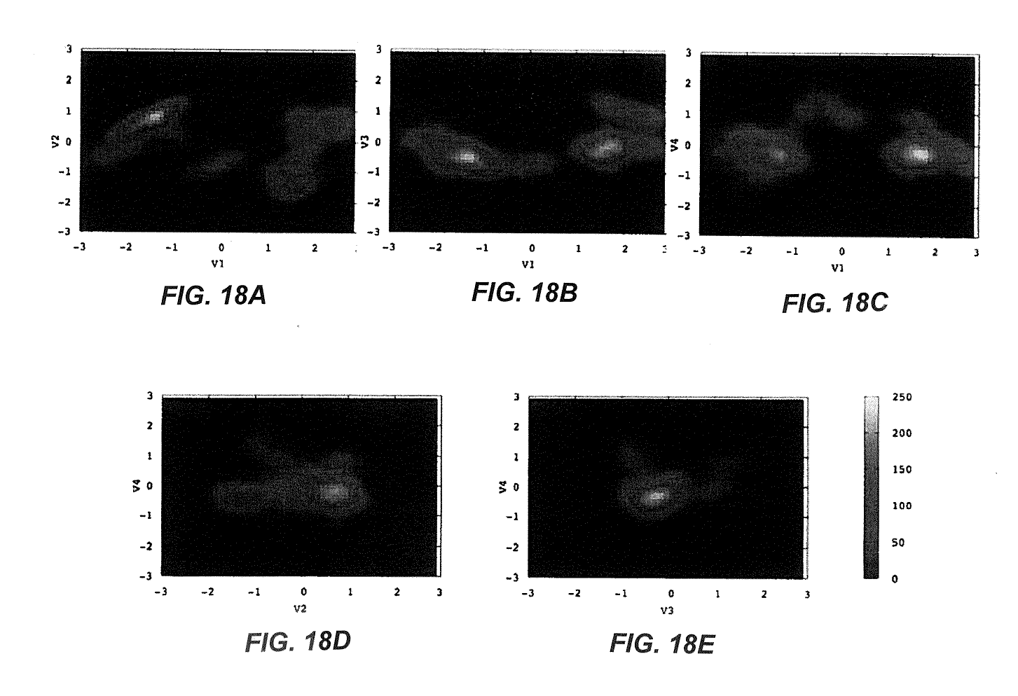

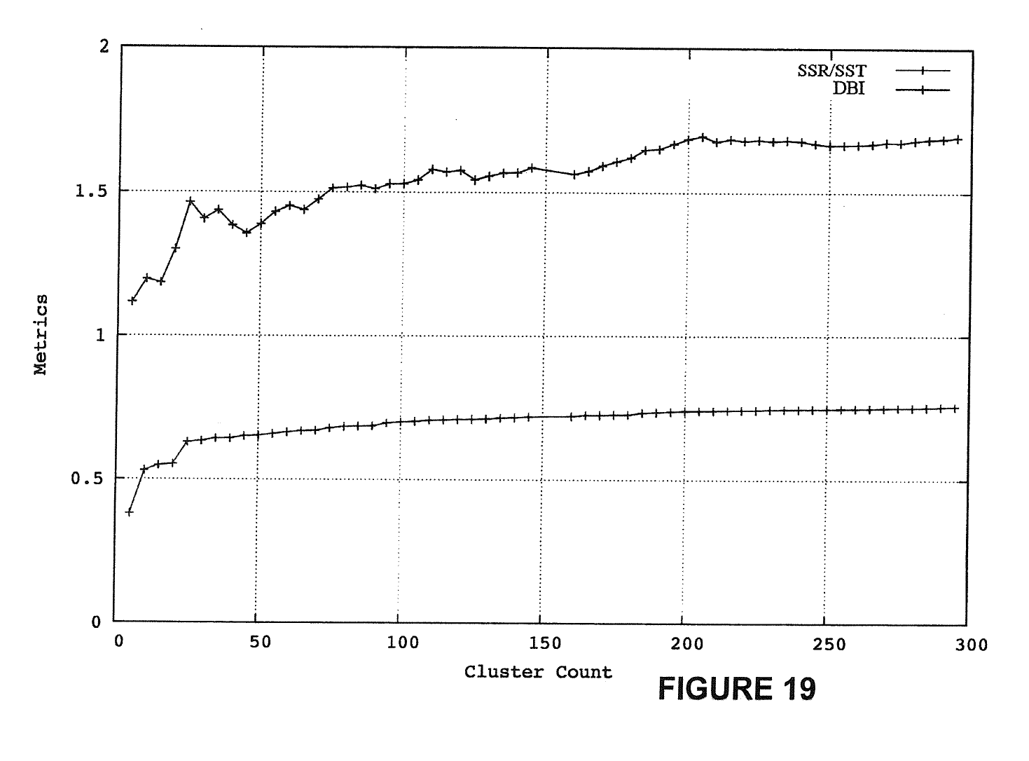

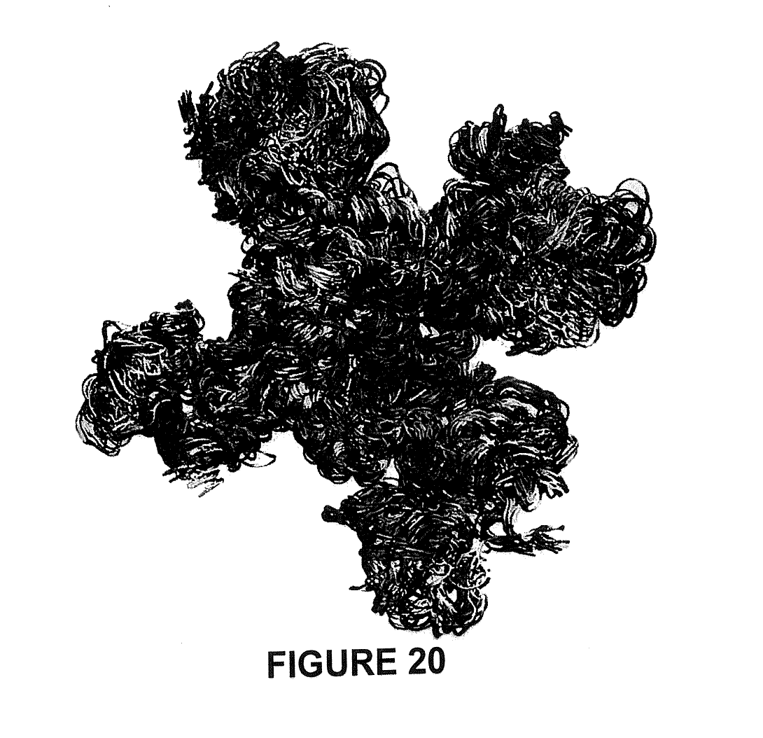

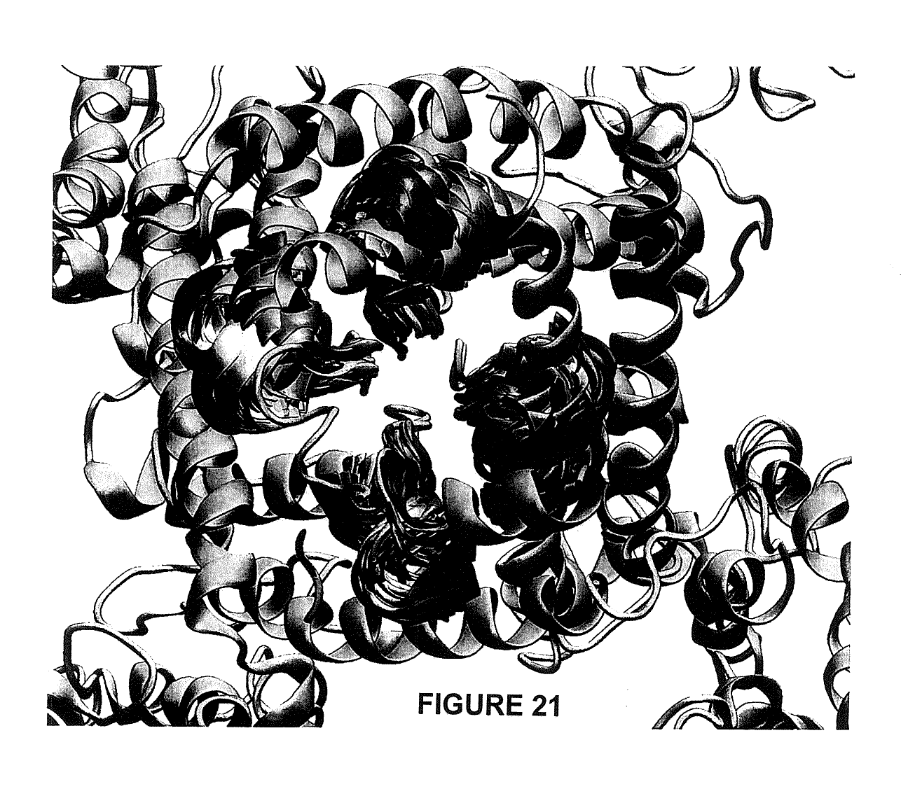

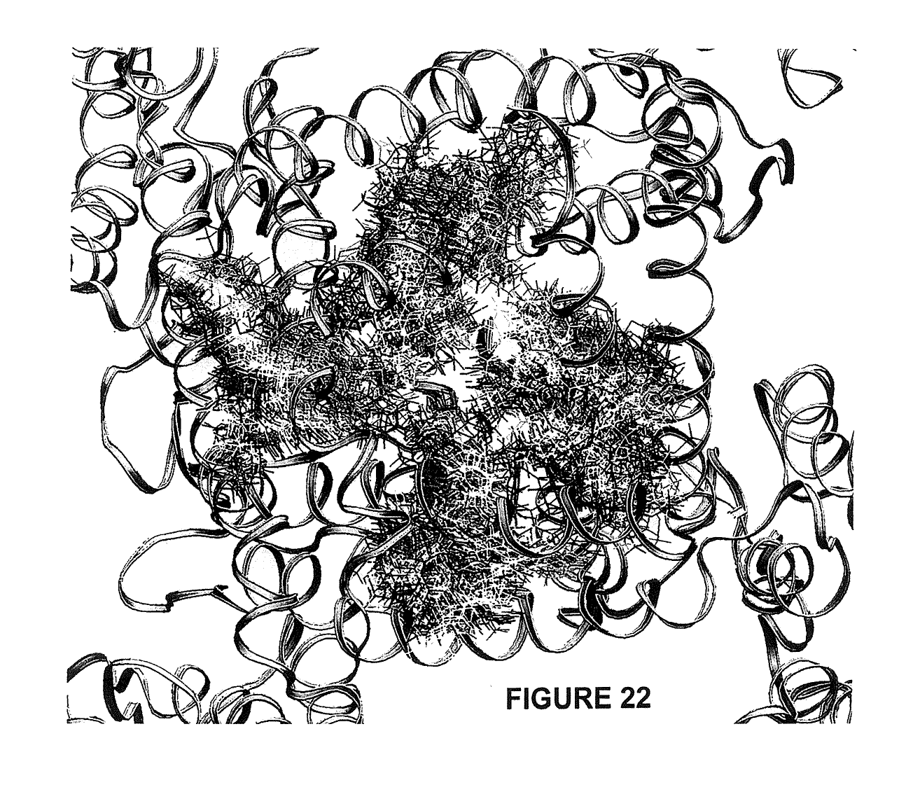

Sampling of the channel's conformational space allowed extracting the dominant hERG conformations for docking. Principal component analysis (PCA) helped reduce the system's dimensionality keeping the essential dynamics (see Methods of Materials, above). The dominant eigenvectors decay exponentially and the largest eigenvalues represent correlated hERG motions with the largest standard deviations along orthogonal directions. FIGS. 18A-18E project the trajectory on the planes spanned by the four dominant principal components of the hERG cavity. The permeation pore residues adopted very few conformations, which align with the atomic fluctuation results (see FIG. 15). The MD trajectory formed a few clusters indicating basins of attraction for favored folded conformations. Forty-five (45) dominant conformations (see FIG. 19) of the hERG's inner cavity were found by clustering MD trajectories using the average linkage algorithm and an optimal number of clusters algorithm (see above), The structures of the 45 dominant conformations reflect the most realistic description of the hERG open state (see FIG. 20). The conformations spanned huge backbone dynamics (see FIG. 21) and significant side chains orientations (see FIG. 22). Ligand docking to the hERG cavity using this ensemble of protein structures precisely accounts for protein flexibility, solving a challenging hERG blockage prediction problem.

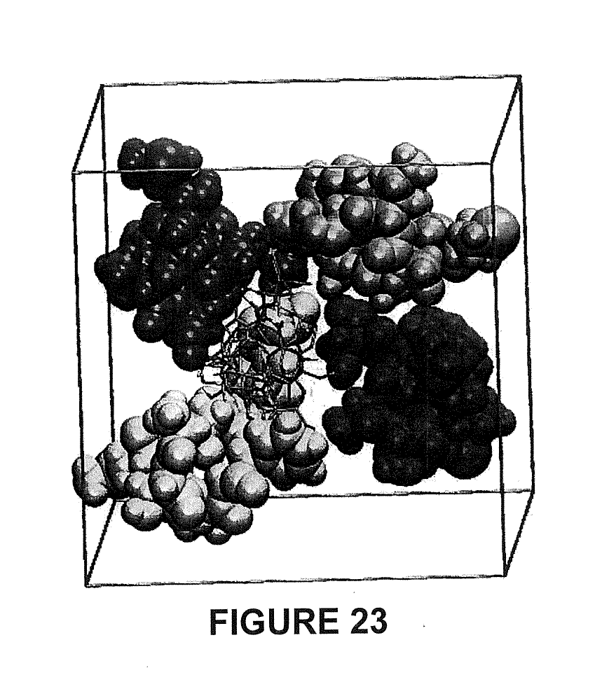

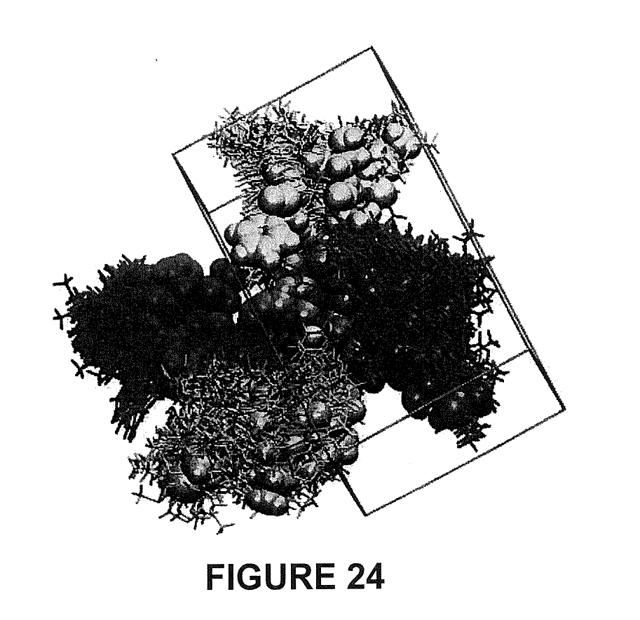

The huge search space and many redundant docking solutions due to hERG symmetry pose additional challenges. Hence, the cavity was divided into four halves for two ensemble-based ligand screening simulations. The first identified preferred ligand binding locations used an ensemble-based blind docking with the 45 dominant conformations, involving the whole cavity (see FIG. 23). Top hits guided the selection towards one half of the cavity, where more accurate docking was performed using all hERG structures (see FIG. 24). hERG-bound ligands generated from focused screening were refined using explicit solvent MD followed by MM-PBSA to determine accurate binding free energies.

Finally, the degree of hERG blockage by ligands was quantified using both the binding energies and distances to the permeation pore. Binding affinity alone yields false positives since a ligand could bind tightly far from the permeation pore leading to a minor effect on the ions' channel passage. Binding weakly close to the permeation pore could be impermanent due to large thermal fluctuations. Hence, using either the binding energy or the shortest distance from the permeation pore alone is insufficient.

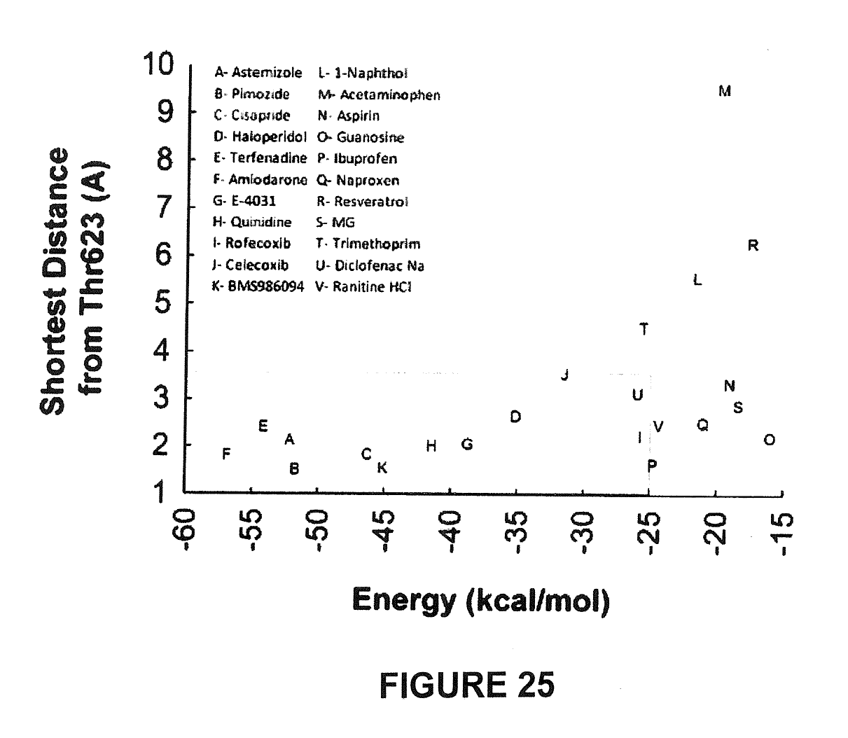

To determine parameter thresholds for hERG blockers, a panel of 22 compounds including hERG blockers and non-blockers (see TABLE 7, below) was used (see also FIG. 25). A hERG blacker was characterized by a binding energy below −30 kcal/mol and a distance less than 3.5 Å to the Thr623 residue, which is adjacent to the selectivity filter's GFG signature motif. Conversely, a compound that either binds further than 3.5 Å or with a binding energy higher than −30 kcal/mol was not characterized as a hERG blocker.

TABLE 7
IC₅₀'s, Binding Energies and Distances to the Permeation
Pore (shortest distance from Thr623) for Panel of 22 Compounds

| | IC50s | IC50s (μM) | | |
|---|---|---|---|---|
| | (μM) | Ionflux | Binding | |
| Compound | Fluxor | patch | Energy | Shortest distnace |
| Name | Binding | clamp | (kcal/mol) | from Thr623 (A) |
| Astemizole | 0.001695 | 0.007195 | −52.1302 | 2.129888766 |
| Pimozide | 0.002832 | 0.003374 | −51.7202 | 1.510191173 |
| Cisapride | 0.002974 | 0.1829 | −46.2901 | 1.822534572 |
| Haloperidol | 0.01212 | 0.1312 | −35.1235 | 2.646003155 |
| Terfenadine | 0.005299 | 0.01779 | −54.1152 | 2.414943014 |
| Amiodarone | 1.186 | 1.977 | −56.8393 | 1.802109438 |
| E-4031 | 0.01212 | 0.1263 | −38.7606 | 2.051596783 |
| Quinidine | 0.7377 | 4.779 | −41.4497 | 2.009906416 |
| Rofecoxib | 5.826 | 15.04 | −25.739 | 2.225615847 |
| Celecoxib | 3.419 | 39.48 | −31.4943 | 3.536723573 |
| BMS986094 | 0.003746 | 0.2663 | −45.1003 | 1.534556744 |
| 1-Naphthol | N/A | N/A | −21.5849 | 5.553319321 |
| Acetaminophen | N/A | N/A | −19.7253 | 9.528936037 |
| Aspirin | N/A | N/A | −19.0503 | 3.32580243 |
| Guanosine | N/A | N/A | −16.0041 | 2.189308251 |
| Ibuprofen | N/A | N/A | −24.7753 | 1.623492703 |
| Naproxen | N/A | N/A | −21.0558 | 2.502857436 |
| Resveratrol | N/A | N/A | −17.4434 | 6.274724519 |
| MG | N/A | N/A | −18.3918 | 2.870620809 |
| Trimethoprim | N/A | N/A | −25.5606 | 4.507126604 |
| Diclofenac Na | N/A | N/A | −25.9478 | 3.122049962 |
| Ranitine HCl | N/A | N/A | −24.3555 | 2.447909915 |

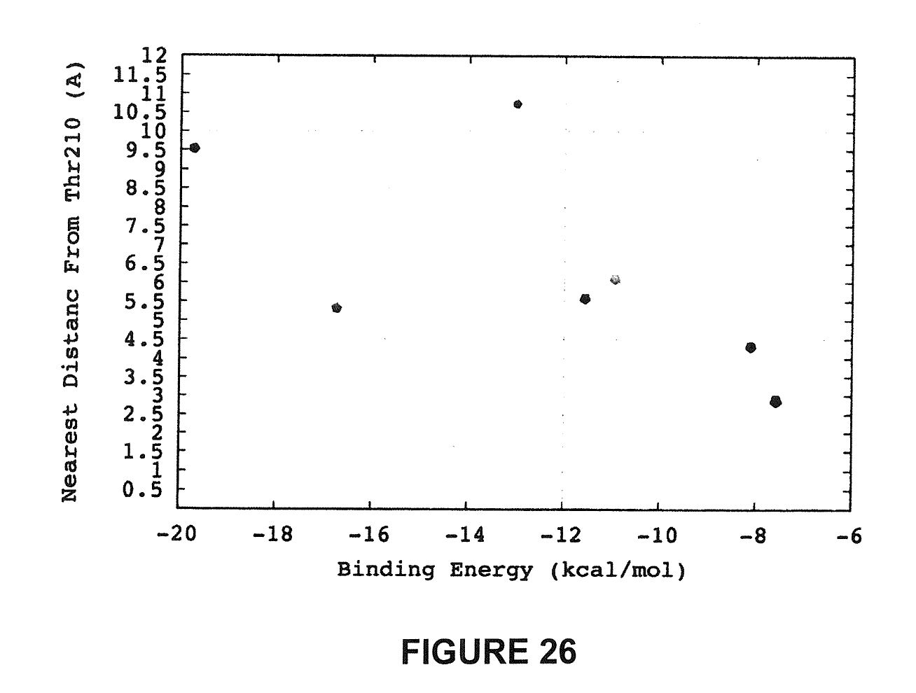

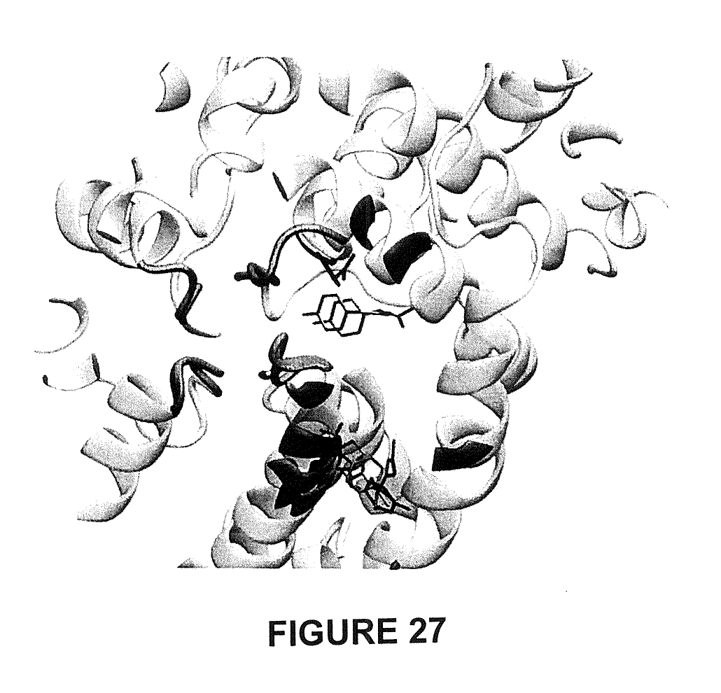

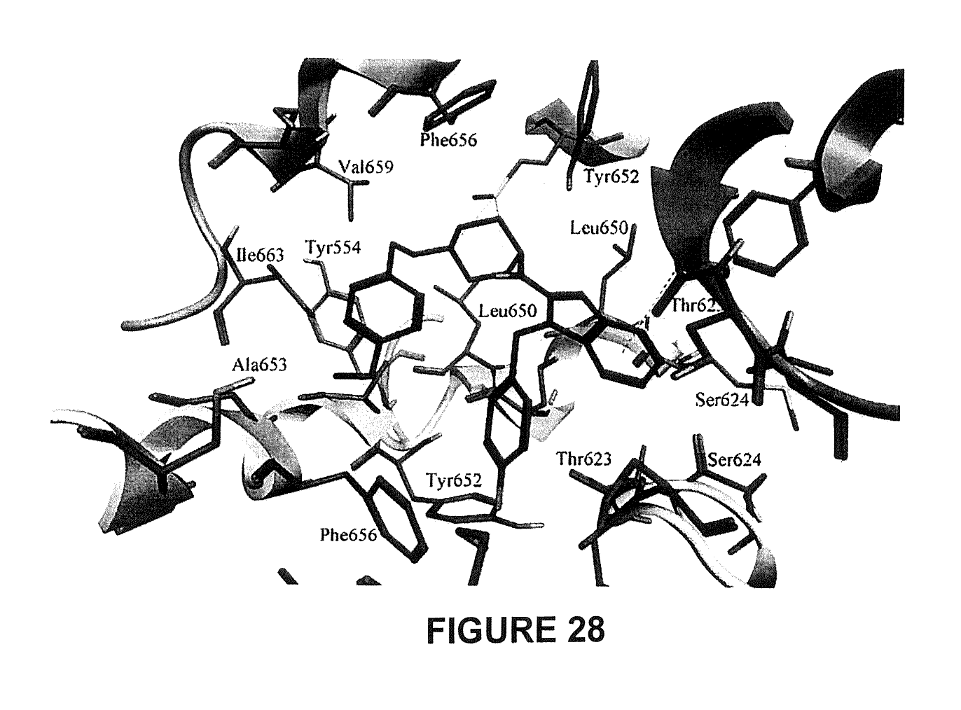

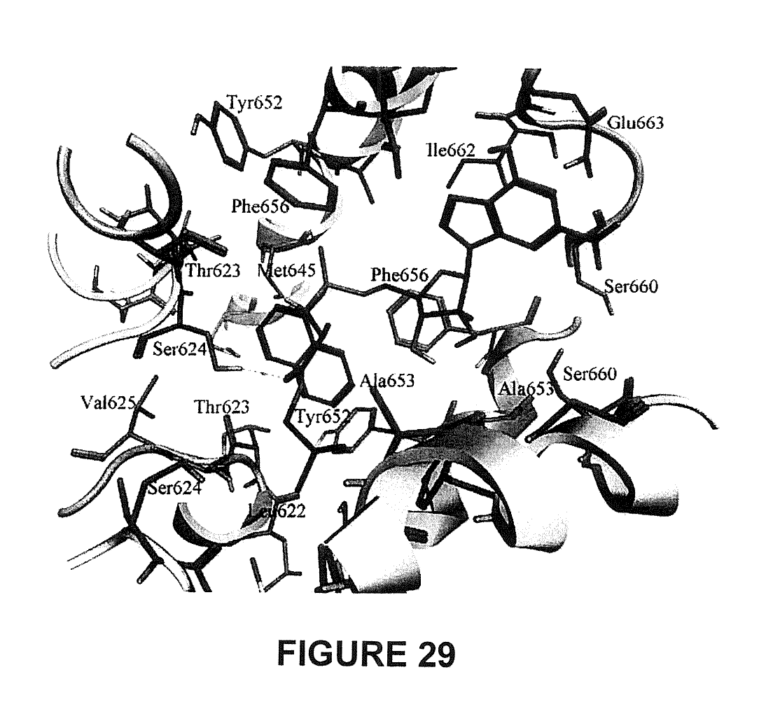

Three examples from TABLE 7 are particularly illustrative: acetaminophen (a non-hERG blocker), astemizole (a potent hERG blocker), and BMS-986094 (a potent HCV replication inhibitor, which caused sudden death and severe cardiotoxicity in patients (Sheridan, 2012, “Calamitous HCV trial casts shadow over nucleoside drugs,” Nat. Biotechnol. 30, 1015-1016). FIG. 26 illustrates the binding locations of acetaminophen within the hERG cavity: the lowest energy binding location (˜−19 kcal/mol) is within ˜10 Å of the nearest Thr623 residue (see FIG. 27), while the closest binding location to any of Thr623 residues (˜3 Å) has a very weak binding energy (˜−7 kcal/mol). Therefore, acetaminophen was identified as a non-hERG blocker. In contrast, astemizole (see FIG. 28) and BMS-986094 (see FIG. 29) have their lowest binding energies (˜−52 and ˜−45 kcal/mol, respectively) within 2 Å of Thr623, and were therefore identified as potent hERG blockers. Similar to astemizole, BMS-986094 interacts with many residues critical for binding of most hERG blockers, including Thr623, Ser624, Val625, Val659, Tyr652 and Phe656.

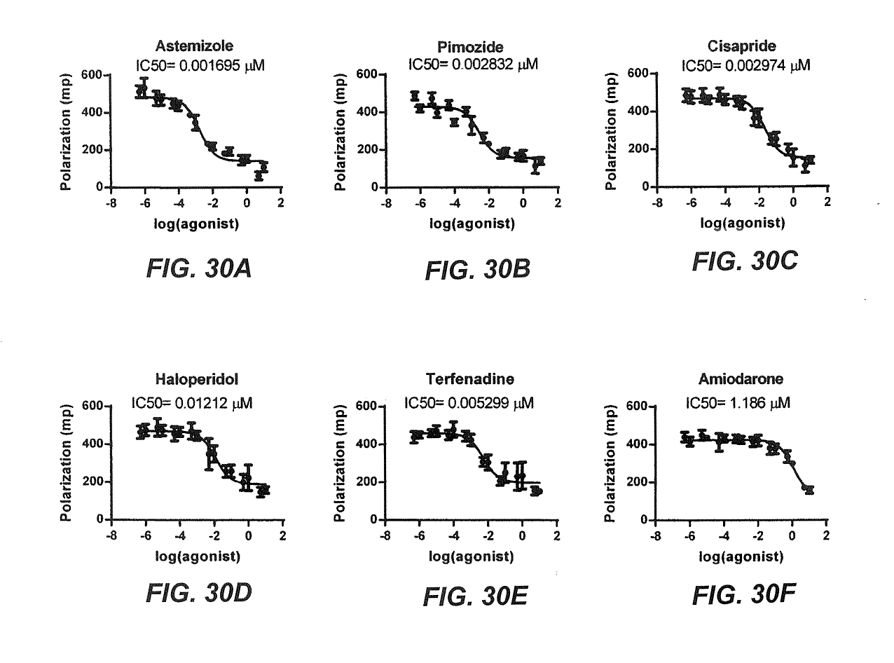

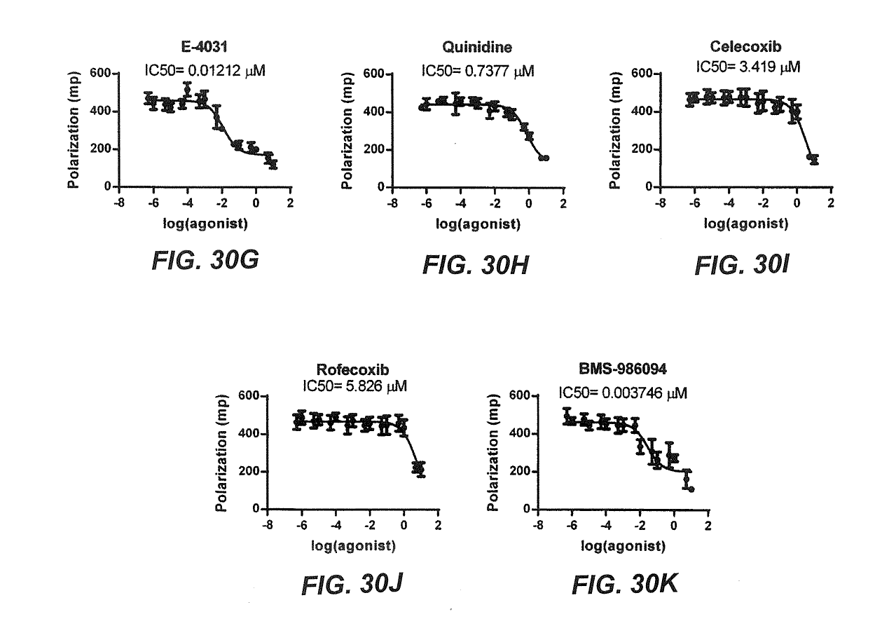

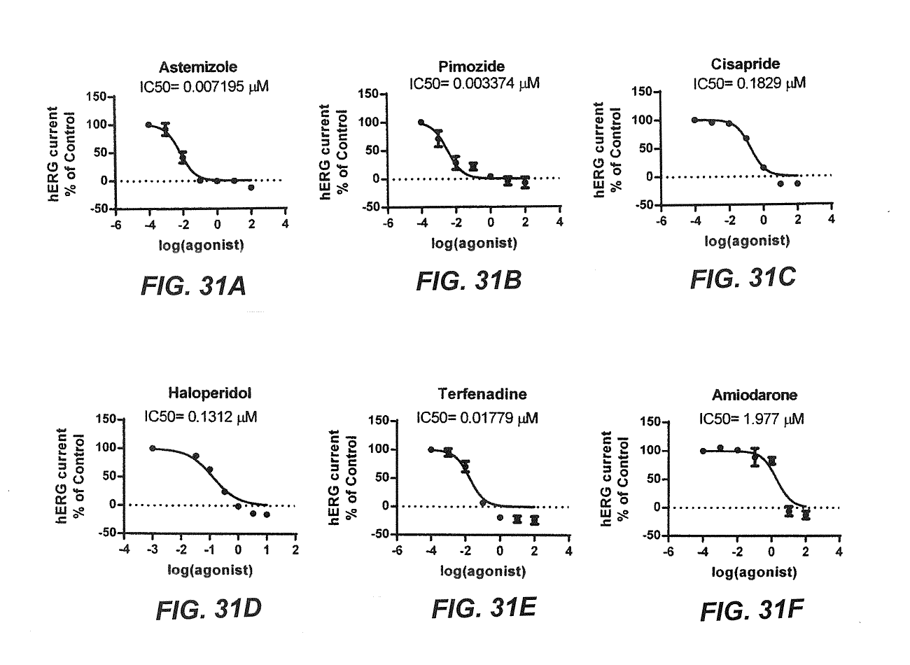

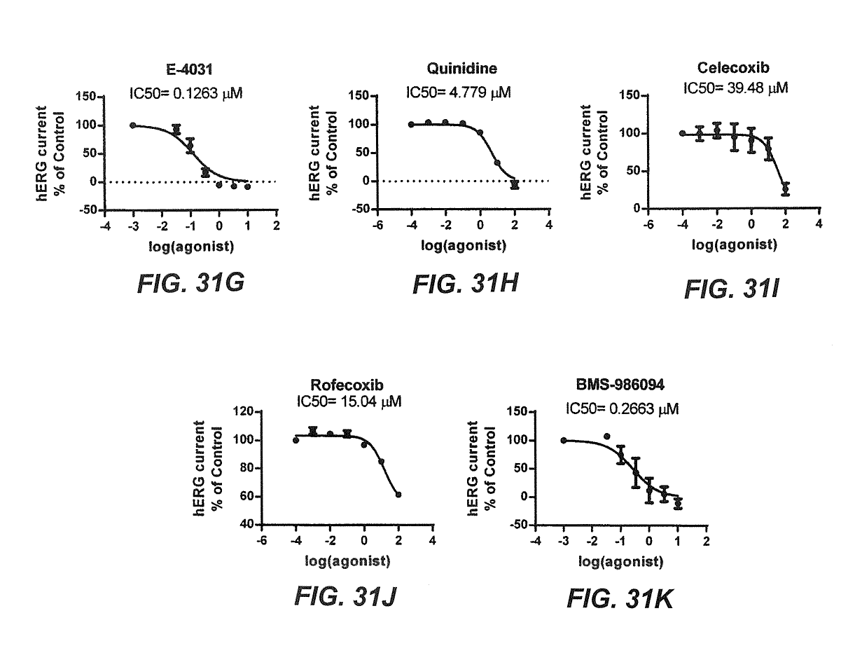

To validate these computational predictions, the 22 compounds were then tested for hERG binding using the Predictor™ assay and patch clamp electrophysiology using AC10 cardiomyocytes stably expressing the hERG channel (see FIGS. 30A-30K and 31A-31K). The Predictor™ assay probes the compound's ability to displace a hERG-bound dye, while patch clamp electrophysiology examines if the compound affects the channel's electrophysiology (see above).

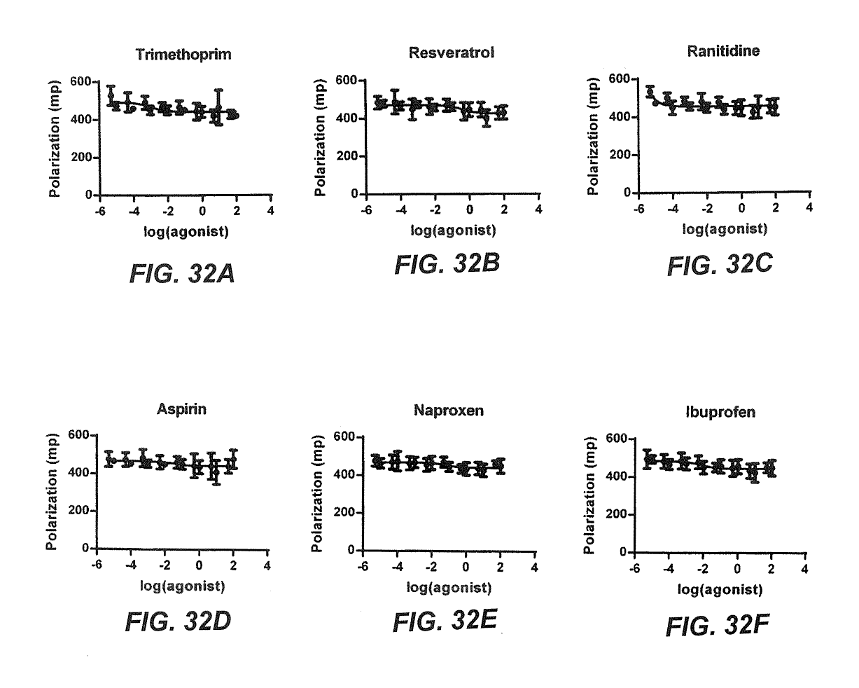

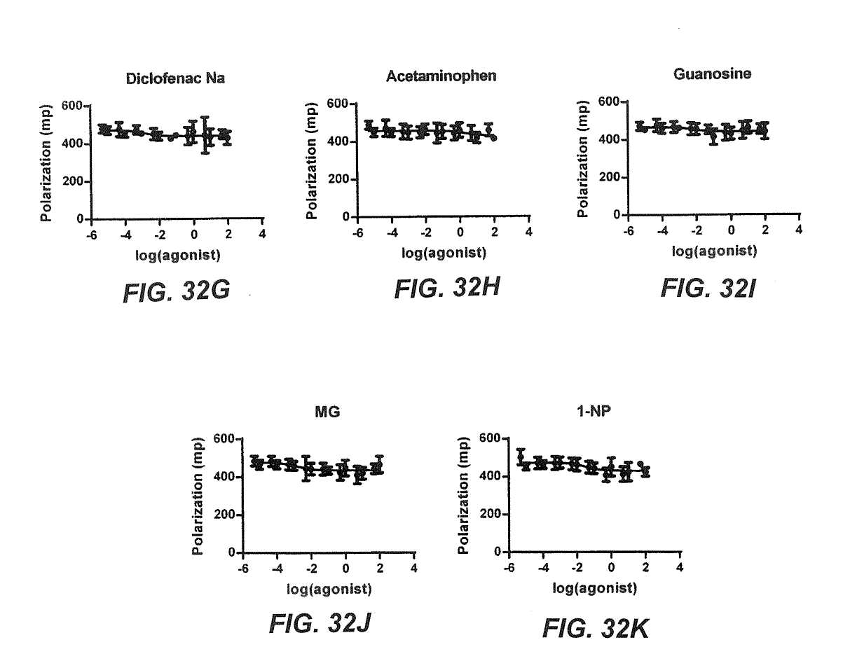

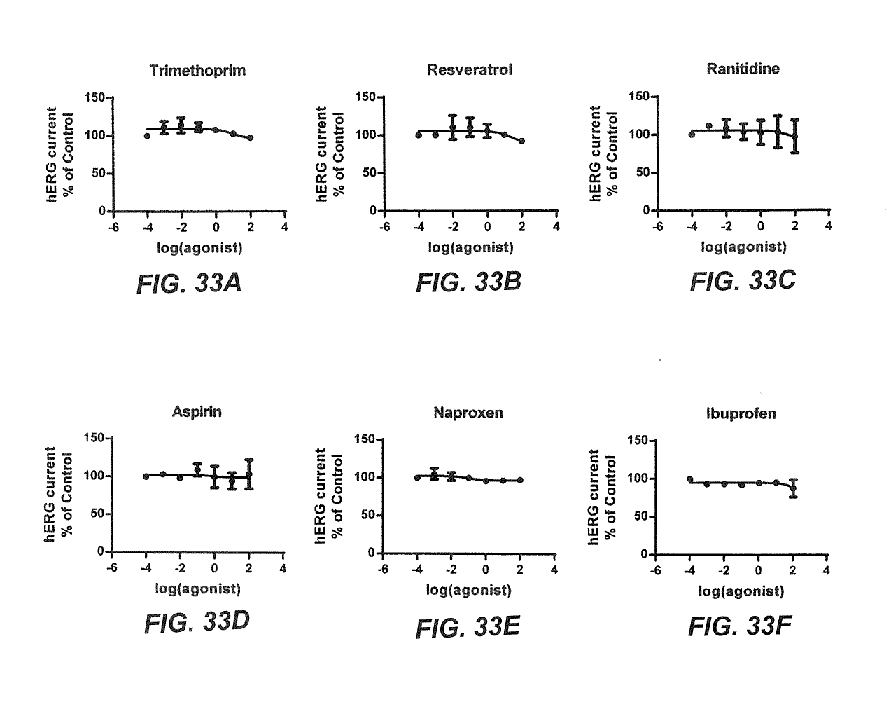

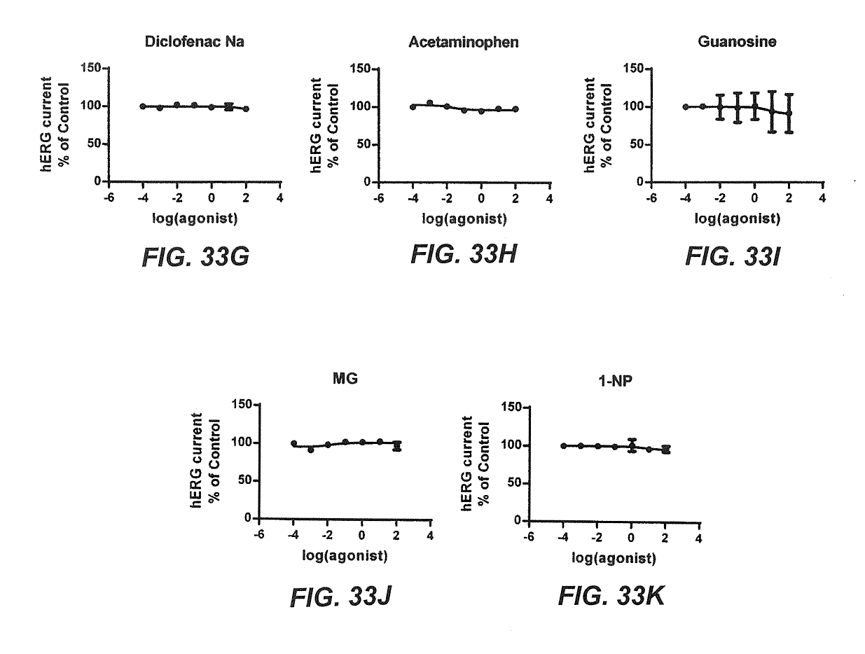

Consistent with the in silico predictions and with previously reported experimental data, the 10 already known hERG blockers in addition to BMS-986094 displaced the hERG-bound dye. For example, these 10 positive controls were reported to block hERG in in vitro electrophysiology and binding assays with similar IC₅₀ values to those obtained here (Wible et al., 2005, “A Novel Comprehensive High-Throughput Screen for Drug-Induced Herg Risk,” J. Pharmacol. Toxicol. Methods 52, 136-145); Deacon et al., 2007, “Early Evaluation of Compound QT Prolongation Effects: A Predictive 384-Well Fluorescence Polarization Binding Assay for Measuring HERG Blockade,” J. Pharmacol. Toxicol. Methods 55, 238-247; Diaz et al., 2004, “The [3H]Dofetilide Binding Assay is a Predictive Screening Tool for HERG Blockade and Proarrhythmia: Comparison of Intact Cell and Membrane Preparations and Effects of Altering [K+]o,” J. Pharmacol. Toxicol. Methods 50, 187-199). In contrast, none of the known non-hERG blockers displaced the dye nor did they affect hERG tail currents implying the negative controls do not bind sufficiently closely to the channel permeation pore to block (see FIGS. 32A-32K and 33A-33K). These results confirm that the computationally identified binding sites for the negative controls do not significantly affect hERG function.

### 7.15 Example 15

### Identification of Herg Blockage of a Test Compound and its Metabolites, and Modification of the Test Compound

The computation models and methods disclosed herein were used to identify drug-mediated hERG blocking activity of BMS-986094 and its metabolites.

BMS-986094 and its metabolites (1-naphthol (1-NP), 2-amino-6-O-methyl-2′C-methyl guanosine (MG) and guanosine) were computationally and experimentally examined according to the methods in the previous example. Consistent with the results of these computational methods and models, experiments showed that BMS-986094 is a potent hERG blocker completely displacing the dye with IC₅₀=0.003 μM (see FIGS. 30A-30K) but its metabolites had no detectable effect on hERG blockage (see FIGS. 32A-32K). To demonstrate that hERG binding of BMS-986094 affects electrophysiology, an automated patch clamp showed agreement with our binding data. BMS-986094 potently blocks hERG tail currents with IC₅₀=0.2663 μM, implying hERG blockade by BMS-986094 is potentially cardiotoxic (see FIGS. 31A-31K). In contrast, none of BMS-986094 metabolites demonstrates either hERG cavity binding or electrophysiology changes (see FIGS. 33A-33K). These results suggest that BMS-986094, but not its metabolites, potently binds to and blocks hERG, and provide a mechanistic explanation of the reported cardiotoxicities. In this regard, accumulating evidence show that BMS-986094 inhibits glucose- and fatty acid-driven mitochondrial respirations that coincide with ATP depletion, apoptosis activation, inhibition of mtRNA polymerase-driven mRNA transcription (POLRMT) in human cardiomyocytes. These toxic events are thought to be attributed to the 2′-C-methylguanosine residue present in BMS-986094. However, according to the preferred binding conformations identified for BMS-986094 from the computational models and methods disclosed herein, the part of BMS-986094 that blocks the hERG ion channel is believed to be the amino acid based prodrug hanging off the left-hand side of the 5-membered sugar, as depicted below:

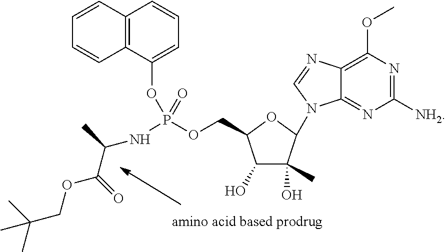 [SMILES: COc1nc(N)nc2c1ncn2C1O[C@H](COP(=O)(N[C@H](C)C(=O)OCC(C)(C)C)Oc2cccc3ccccc23)[C@@H](O)[C@@]1(C)O]

Using the methods described herein, BMS-986094 may be modified as described in EXAMPLE 10. For example, the amino acid based prodrug in the BMS-986094 structure depicted above may be modified to a new prodrug moiety, such as an alkoxyalkyl group (Ciesla et al., 2003, “Esterification of Cidofovir with Alkoxyalkanols Increases Oral Bioavailability and Diminishes Drug Accumulation in Kidney,” Antiviral Res. 59, 163-171; Hostetler, 2009, “Alkoxyalkyl Prodrugs of Acyclic Nucleoside Phosphonates Enhance Oral Antiviral Activity and Reduce Toxicity: Current State of the Art,” Antiviral Res. 82, A84-98), as shown in Examples 15a-d, below:

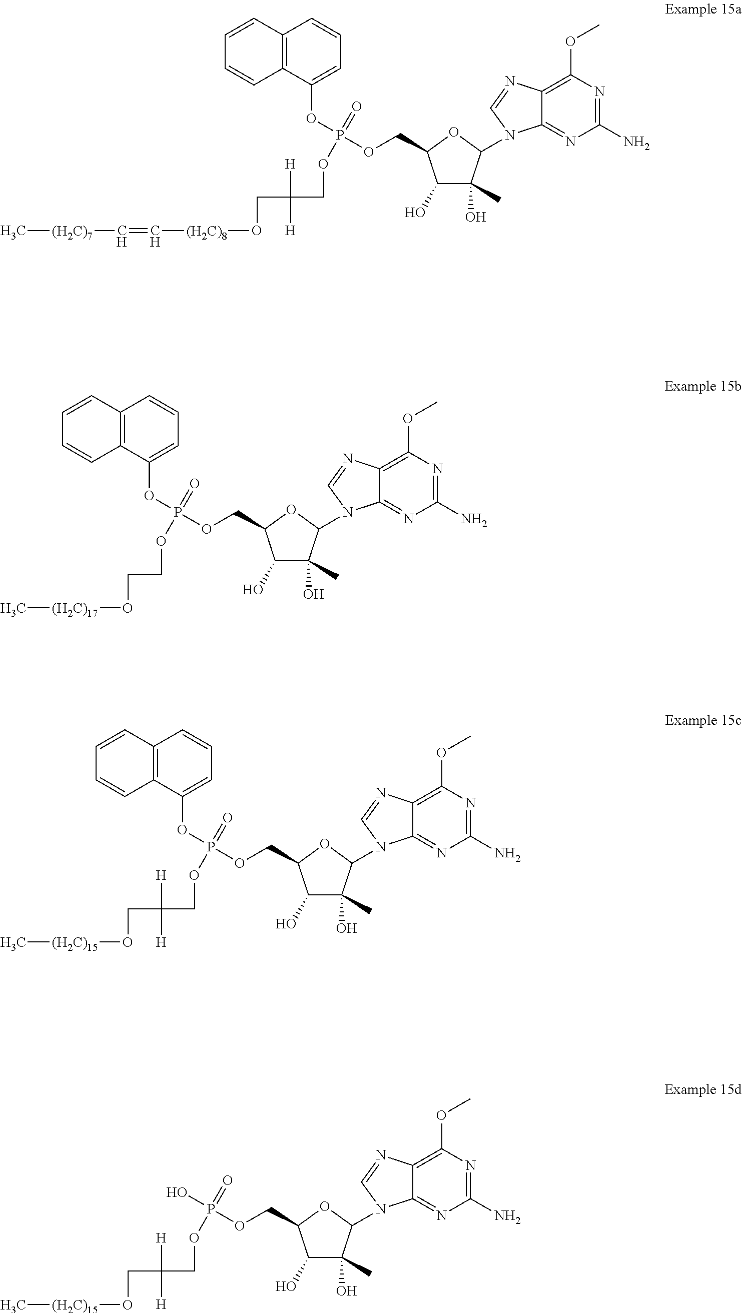

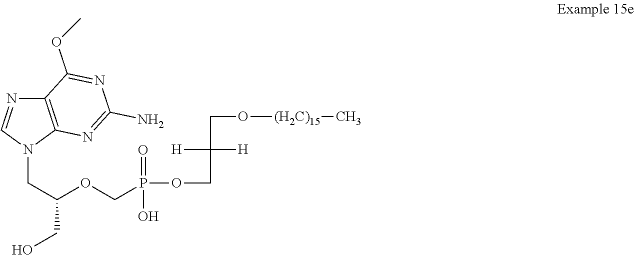

### 7.16 Example 16

### Additional Homology Protein Modeling

The methods disclosed herein as applied to sodium ion channels may be performed as described in Examples 16-19.

Homology protein modeling of the α-subunit of the human Naᵥ1.5 was performed as follows.

The full-length amino acid sequence (2016 amino acid residues) of the α-subunit of the human Naᵥ1.5 (Uniprot accession code: Q14524-1) was downloaded from the Uniprot database (Magrane et al., 2011, “Uniprot Knowledgebase: A Hub of Integrated Protein Data,” Database 2011). Initially, the full Naᵥ1.5 sequence was dissected into nine sub-domains, four trans-membrane domains (TRM1-TRM4) and five cytoplasmic domains (CYT1-CYT5). Dissection was carried out based on the ProtParam tool (Wilkins et al., 1999, “Protein identification and analysis tools in the ExPASy server,” Methods Mol. Biol. 112: 531-552) on the ExPASy bioinformatics resource portal (Artimo et al., 2012, “ExPASy: SIB Bioinformatics Resource Portal,” Nucleic Acids Res 40: W597-603). Following dissection, 10 full models for each sub-domains were separately generated using the I-Tasser bioinformatics software (Roy et al., 2010, “I-TASSER: a unified platform for automated protein structure and function prediction,” Nat. Protoc. 5: 725-738) based on the Na_{y}/NB bacterial sodium channel (Payandeh et al., 2012, “Crystal Structure of a Voltage-Gated Sodium Channel in two Potentially Inactivated States,” Nature 486: 135-139) as the main template for the TRM domains. NaᵥAB crystal structures represent the closed-inactivated states of the channel (PDB codes: 3RVY, 3RVZ, 3RWO and 4EKW) (Payandeh et al., 2011, The Crystal Structure of a Voltage-Gated Sodium Channel,” Nature 475: 353-359). The resolved crystal structures of the two states are very similar with the exception of a very minor shift that is close to the intracellular end of the four S6 helices. These two states of VGSCs are responsible for the binding of common Naᵥ1.5 blockers, including the anti-anginal drug ranolazine (inactivated state) (Sokolov et al., 2013, “Proton-Dependent Inhibition of the Cardiac Sodium Channel Nav1.5 by Ranolazine,” Front Pharmacol 4: 78) and the antiarrhythmic drug mexiletine (closed state) (Undrovinas et al., 2006, Ranolazine Improves Abnormal Repolarization and Contraction in Left Ventricular Myocytes of Dogs with Heart Failure by Inhibiting Late Sodium Current,” J Cardiovasc Electrophysiol, 17 Suppl 1: S169-S177). The open state of the Naᵥ1.5 channel has been shown to bind VGSCs activators (Tikhonov et al., 2005, “Sodium Channel Activators: Model of Binding Inside the Pore and a Possible Mechanism of Action,” FEBS Lett 579: 4207-4212), and rarely blockers, such as the antiarrhythmic flecainide (Ramos et al., 2004, “State-Dependent Trapping of Flecainide in the Cardiac Sodium Channel,” J Physiol 560: 37-49). Flecininde has been shown to bind strongly to the open activated state of the channel (IC₅₀ 7 μM) and only very weakly to the closed/inactivated state (IC₅₀ 345 μM). The amino acid sequences for each sub-domain selected from the main Naᵥ1.5 sequence is given in TABLE 8, below.

TABLE 8
The Amino Acid Sequences for the Nine Sub-Domains
Dissected from the Main Naᵥ1.5 Sequence
Together with the I-Tasser Generated TM
Scores for the Best I-Tasser Identified Models

| Name of the | | TM score | |
|---|---|---|---|
| domain/subdomain | Residues | (I-Tasser) | Notes |
| Full Nav1.5 sequence | 1-2016 | — | Uniprot accession |
| | | | code: Q14524-1 |
| CYT1(N-terminus) | 1-126 | 0.29 | — |
| TRM1 | 127-416 | 0.52 | — |
| CYT2 | 417-709 | 0.43 | Omitted from the |
| | | | final model |
| TRM2 | 710-940 | 0.78 | — |
| CYT3 | 941-1198 | 0.32 | Omitted from the |
| | | | final model |
| TRM3 | 199-1470 | 0.64 | — |
| CYT4 (inactivation gate) | 1471-1523 | 0.50 | — |
| TRM4 | 1524-1772 | 0.68 | — |
| CYT5 (C-terminus) | 1773-2016 | 0.46 | — |

A full homology modeling cycle by iterative threading assembly refinement (I-Tasser) started with a multi-threading procedure using the software LOMET followed by alignment of the query protein on the selected templates from the pool of PDB resolved NMR or X-ray crystal structures. Following this extensive threading and alignment procedures, secondary structures of the query protein domain was predicted using the PSIPRED tool. The correctly predicted domains were then assembled and unaligned regions, such as loops, were predicted through ab initio modeling. Structure assembly was carried out through a modified replica-exchange Monte Carlo simulation. The simulation was guided by statistical as well as energetic potentials. This was followed by final ranking and refinement stages for the generated model. For Naᵥ1.5, final model refinement was carried out using the ModRefiner algorithm of I-Tasser (Xu et al., 2011, “Improving the Physical Realism and Structural Accuracy of Protein Models by a Two-Step Atomic-Level Energy Minimization,” Biophys J 101: 2525-2534). ModRefiner enhanced the overall quality of the generated models, producing models with optimum side chain packing and minimal numbers of steric clashes. TABLE 8 also shows the 1-Tasser calculated TM scores for the best model for each domain and all TRM domains had a high TM score (>0.5) (Zhang et al., 2004, “Scoring Function for Automated Assessment of Protein Structure Template Quality,” Proteins 57: 702-710). The relatively low TM score for TRM1 is believed to be due to the long loop (84 residues, Leu276-Ala359). Before incorporating this loop into the final model, it was first excised and then modeled separately with I-Tasser followed by a structural refinement using a short, all atoms solvated MD simulation (≈1 ns). Finally, the TRM domains were assembled by superposition on the NaᵥAb wild type crystal structure (PDB code: 4EKW) and the final models were again refined with fragment-guided molecular dynamic simulation FG-MD (Zhang et al., 2011, “Atomic-Level Protein Structure Refinement using Fragment-Guided Molecular Dynamics Conformation Sampling,” Structure 19: 1784-1795).

To speed up the simulation, the N (CYT1) and C (CYT5) termini of the channel, the inactivation gate (CYT4) and the four trans-membrane domains (TRM1-TRM4) were included in the final models. The already crystallized small segments for the human Naᵥ1.5 were added to the model without modification. These structures were extracted from the two available X-ray crystal structures for the calmodulin binding motif of the C-terminus (residues: 1773-1940) of Naᵥ1.5. The first structure (PDB code: 4DCK) was resolved at a 2.2 Å resolution (Wang et al., 2012, “Crystal Structure of the Ternary Complex of a Nav C-Terminal Domain, a Fibroblast Growth Factor Homologous Factor, and Calmodulin,” Structure 20: 1167-1176) and the second one (PDB code: 4JQ0) was resolved at 3.84 Å resolution (Wang et al., 2014, “Structural Analyses of Ca(2)(+)/CaM Interaction with NaV Channel C-termini Reveal Mechanisms of Calcium-Dependent Regulation,” Nat Commun 5: 4896). Another crystal structure was available for residues 1491-1522 in the activation gate resolved at an atomic resolution of 1.35 Å (PDB code: 4DJC) (Sarhan et al., 2012, “Crystallographic basis for calcium regulation of sodium channels,” Proc Natl Acad Sci USA 109: 3558-3563). In the final model, 4DCK and 4DJC were included after brief protein refinement using the protein preparation wizard module of the Schrodinger software package. CYT2 (residue 417-709) and CYT3 (941-1198) were omitted from the final model to speed up the simulations and also due the low sequence similarity with other homologous proteins. Thus, the final models of Naᵥ1.5 included 1465 residues that are topologically subdivided into 7 subdomains, 4 transmembrane (TRM1, TRM2, TRM3 and TRM4) sub-domains, and three cytoplasmic domains (CYT1, CYT4 and CYT5).

To achieve the well established four-fold symmetry, the four domains of Naᵥ1.5 were assembled in a clockwise manner based on the resolved NaᵥAb crystal structure. Assembly was carried out by superposing the domains on the 4EKW crystal structure using the Smith-Waterman local alignment (Smith et al., 1981, “Identification of Common Molecular Subsequences,” J Mol Biol 147: 195-197) algorithm with a 90% score for the secondary structure and an iteration threshold of 0.2 Å as implemented in UCSF Chimera (Pettersen et al., 2004, “UCSF Chimera—a Visualization System for Exploratory Research and Analysis,” J. Comput Chem 25: 1605-1612). As a final refinement steps and to remove potential severe steric clashes, the system was finally minimized using the protein preparation wizard in Schrodinger was heavy atoms not allowed to move beyond 0.3 Å.

The coordinates for hNaᵥ1.5 generated from the homology modeling described in EXAMPLE 16, above, are provided in Table B. These coordinates were used as input for the MD simulations, described in EXAMPLE 17 below.

### 7.17 Example 17

### Molecular Dynamics Simulations

The system preparation and setup procedures for the MD simulation were carried out using the CHARMM-GUI routine for building membrane proteins. Ionization states of titratable residues were treated at physiological pH 7.4. The protein was then embedded in a double bilayer of 400 1-palmitoyl-2-oleoyl-sn-glycero-3-phosphocholine (POPC) lipids in each layer. Upper (15 Å thickness from the protein) and lower (20 Å thickness from the protein) water layers of TIP3P waters and an ionic concentration of 150 mM NaCl solution were used. A 12 Å cutoff was used to calculate the short-range electrostatic interactions. The Particle Mesh Ewald summation method was used for calculating long-range electrostatic interactions. The NBFIX correction for sodium ions interaction with charged carboxylates was used.

Multistage heating and equilibration phases were applied for model relaxation and refinement prior to the production simulation. The system was first minimized for 50,000 minimization steps where only lipid tails were free to move and the rest of the system was held fixed. Four additional minimization steps of 25,000 steps were carried out with constrains removed gradually from the rest of the system (protein and lipid heads) and with water molecules and ions freely moving. Constrains were gradually released from 100, 50, 5 and 1 kcal/mol. Dihedral lipid tails were also constrained and the constrains were gradually released from 100, 50, 5 and 1 kcal/mol. The system was then gradually heated to 310 K for 5 ns using a 1 fs integration time step with 1 kcal/mol constrains on the protein backbone, equilibrated for additional 2*10 ns simulation with 1 fs and then 2 fs time step and with weak 0.5 kcal/mol constrains on the protein backbone.

Production simulation was then carried out for 100 ns using 0.1 kcal/mol constrains on the Cα carbons of the TRM subdomains. The Langevin thermostat (Palovcak et al., 2014, “Evolutionary Imprint of Activation: The Design Principles of VSDs,” J Gen Physiol 143: 145-156; Tiwari-Woodruff et al., 2000, “Voltage-Dependent Structural Interactions in the Shaker K(+) Channel,” J Gen Physiol 115: 123-138) and an anisotropic pressure control were used to keep the temperature at 310 K and the pressure at 1 bar, respectively. Total system size was 573,763 atoms. All simulations were carried out using NAMD 2.9 on a Blue Gene\Q supercomputer. Atomic coordinates were saved to the trajectory every 10 ps. Atomic fluctuation (B-factors) and root mean deviations from the reference structures (RMSD) were calculated, according to the methodologies of EXAMPLE 4 above.

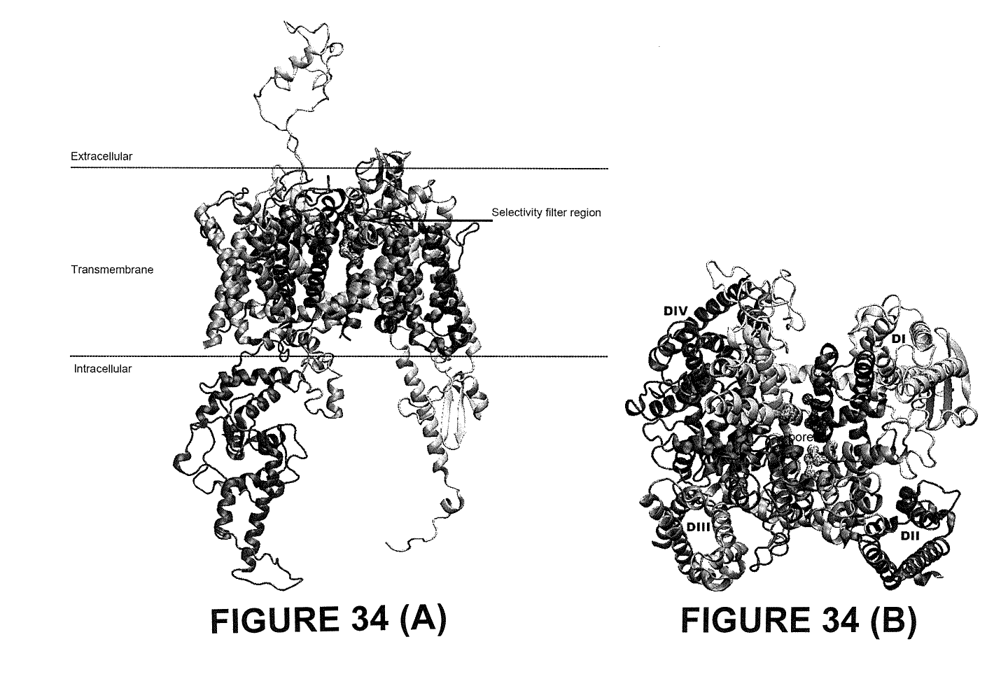

FIGS. 34A and 34B display side and top views for a 3D structure of a relaxed MD snapshot for the generated model of Naᵥ1.5. The figure shows the overall architecture of the channel, comprised of three regions: extracellular, intracellular and trans-membrane. From the intracellular (cytoplasmic) side of the membrane, the trans-membrane sub-domains are connected through the cytoplasmic sub-domains. The four domains are wrapped against the selectivity filter region comprised from the four DEKA sequences that are splayed over the four domains. This DEKA sequence corresponds to the EEEE sequence in the homo-tetrameric bacterial NaᵥAb ion channel template.

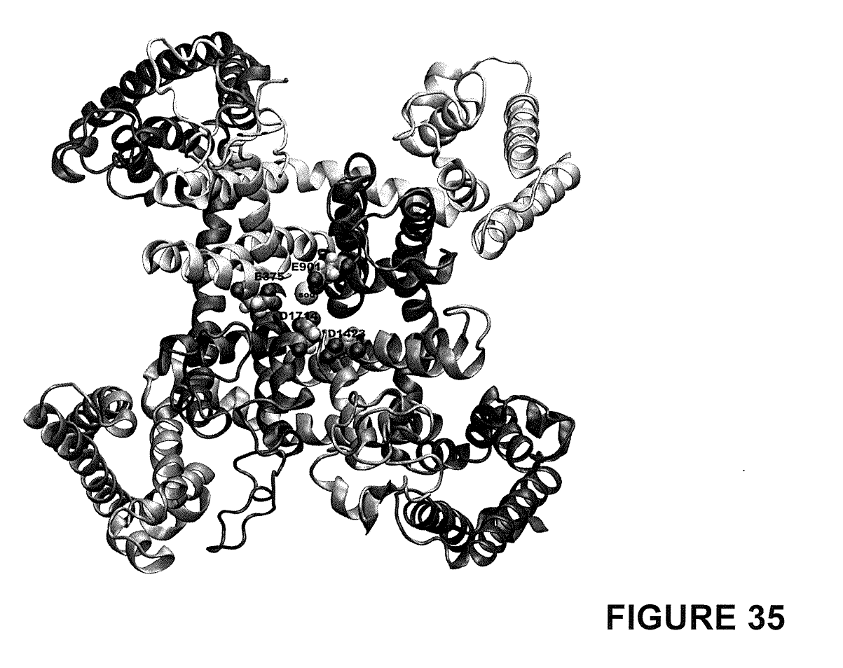

FIG. 35 shows a top view of a 3D structure of a relaxed MD snapshot for the generated model of Naᵥ1.5. As may be seen in this figure, a sodium ion has been trapped within the inner selectivity filter in a region of negative potential (as tested an confirmed by a linearized Poisson-Boltzmann algorithm). A rigorous assessment for the generated model was its ability to incorporate the selectivity filter residues in the correct place, namely; in the short turn region connecting the P1-P2 helices. In this regard, the assembled domains exhibit the characteristic clockwise arrangement of the four selectivity filter residues splayed over the four domains, Asp372 (DI), Glu898 (DII), Lys1419 (DIII) and Ala1711 (DIV).

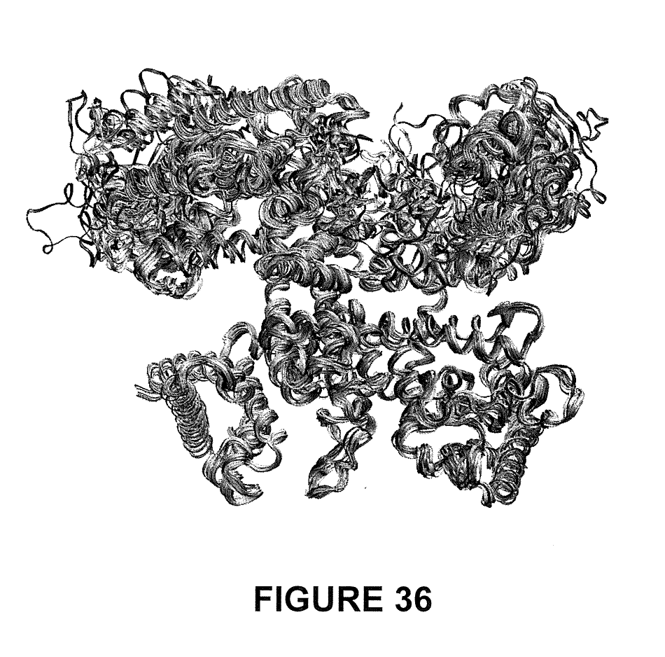

Iterative clustering of the MD trajectory was then performed to extract dominant conformations of Naᵥ1.5, according to the methodologies of EXAMPLE 5 above. Using this methodology, eleven (11) distinct conformations for the intracellular VGSC channel were identified, as shown in FIG. 36.

### 7.18 Example 18

### Docking, Binding Free Energy Calculation, and Rescoring of Top Hits

Docking simulations were next performed. Three marketed cardiovascular drugs were tested: (1) one strong Naᵥ1.5 blacker (Ranolazine, antianginal drug) (Sokolov et al., 2013, “Proton-Dependent Inhibition of the Cardiac Sodium Channel Nav1.5 by Ranolazine,” Front Pharmacol 4: 78) with an IC₅₀ of 5.9 μM; (2) one weak blocker (Dofetilide, antiarrhythmic drug) (Roukoz et al., 2007, “Dofetilide: a New Class III Antiarrhythmic Agent,” Expert Rev Cardiovasc Ther 5: 9-19) with an IC₅₀ of 300 and (3) one known non-blocker for Naᵥ1.5 (Nadolol, anti-hypertensive) (Wang et al., 2010, “Propranolol Blocks Cardiac and Neuronal Voltage-Gated Sodium Channels,” Front Pharmacol 1: 144). The chemical structures of these three compounds are provided below:

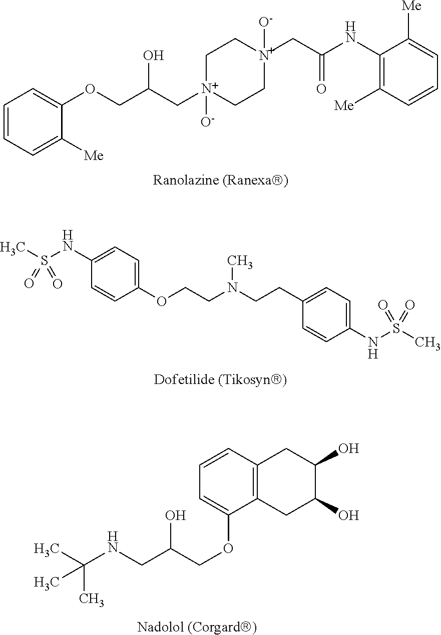

The compounds were docked against the selected eleven (11) dominant conformations. Docking was carried out using the standard precision mode of the Glide docking module of the Schrodinger package (Glide SP). Top ranked poses were re-scored with AMBER-MMGBSA over 60 snapshots produced from three short 200 ps MD simulation for each ligand. Docking and scoring results are given in TABLE 9, below.

TABLE 9
The Docking and Binding Energy Scores from Some Selected
Compounds Against Naᵥ1.5

| | Glide docking score | AMBER/MM-GBSA score | |
|---|---|---|---|
| Compound | (kcal/mol) | (60 snapshots) (kcal/mol) | IC₅₀ (μm) |
| Ranolazine | −6.25 | −40.67 | 5.9 |
| Dofetilide | −5.42 | −27.51 | 300 |
| Nadolol | −6.04 | −15.79 | Non- |
| | | | blocker |

As shown in TABLE 9, the model was able to correctly identify Ranolazine to be the top ranked compound. The AMBER/GBSA over the selected snapshots improved the ranking of the chosen compounds based on their corresponding IC₅₀ values, such that the experimentally observed activity trend is reproduced (Ranolazine>Dofetilide>Nadolol).

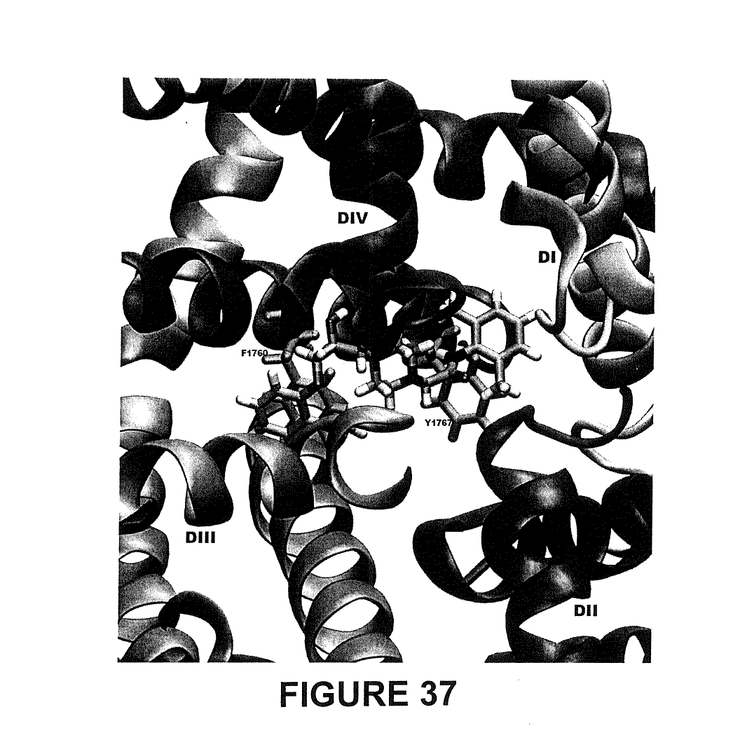

As shown in FIG. 37, Ranolazine binds directly below the selectivity filter of the channel and forms direct interactions with hydrophobic residues in S6 of DIV (F1760, Y1767), which residues has been shown to be very important for binding common Naᵥ1.5 blockers, including Ranolazine (Wang et al., 1998, “A Common Local Anesthetic Receptor for Benzocaine and Etidocaine in Voltage-Gated Mu1 Na+Channels,” Pflugers Arch. 435: 293-302). As shown in FIG. 37, Ranolazine forms a direct, sandwich type π-π stacking interaction with F1760, and tilted T-shaped type π-π stacking interaction with Y1767.

### 7.19 Example 19

### Classification of Channel Blockage and Redesign of Compound to be a Non-Blocker

Classification the compounds as “blockers,” e.g., compounds that block the hNaᵥ1.5 ion channel, or as “non-blockers,” e.g., compounds that do not block the hNaᵥ1.5 ion channel, is performed as described in EXAMPLE 9, above, for the hERG ion channel.

Redesign of a hNaᵥ1.5 ion channel blocker to be a non-blocker is performed as described in EXAMPLE 10, above, for the hERG ion channel.

### 7.20 Example 20

### Additional Homology Protein Modeling

The methods disclosed herein as applied to calcium ion channels may be performed as described in Examples 20-23.

Homology protein modeling of the α-1 subunit of the human Caᵥ1.2 is performed as follows.

The full-length amino acid sequence (2138 amino acid residues) of the α-1 subunit of the human Caᵥ1.2 (Uniprot accession code: Q13936) is downloaded from the Uniprot database (Magrane et al., 2011, “Uniprot Knowledgebase: A Hub of Integrated Protein Data,” Database 2011). Initially, the full Caᵥ1.2 sequence is dissected into sub-domains, trans-membrane domains and cytoplasmic domains. Dissection is carried out based on the ProtParam tool (Wilkins et al., 1999, “Protein identification and analysis tools in the ExPASy server,” Methods Mol. Biol. 112: 531-552) on the ExPASy bioinformatics resource portal (Artimo et al., 2012, “ExPASy: SIB Bioinformatics Resource Portal,” Nucleic Acids Res 40: W597-603). Following dissection, full models for each sub-domains are separately generated using the I-Tasser bioinformatics software (Roy et al., 2010, “I-TASSER: a unified platform for automated protein structure and function prediction,” Nat. Protoc. 5: 725-738) based on the NaᵥAB bacterial sodium channel (Payandeh et al., 2012, “Crystal Structure of a Voltage-Gated Sodium Channel in two Potentially Inactivated States,” Nature 486: 135-139) as the main template for the transmembrane domains. NaᵥAB crystal structures represent the closed-inactivated states of the channel (PDB codes: 3RVY, 3RVZ, 3RWO and 4EKW) (Payandeh et al., 2011, The Crystal Structure of a Voltage-Gated Sodium Channel,” Nature 475: 353-359). The coordinates for the template NaᵥAB crystal structure, used to model Caᵥ1.2 is provided in Table C.

### 7.21 Example 21

### Molecular Dynamics Simulations

MD simulations are performed, as described herein, for example, according to the methodologies of EXAMPLES 3 and 17 above.

Iterative clustering of the MD trajectory is then performed to extract dominant conformations of hCaᵥ1.2, according to the methodologies of EXAMPLE 5 above. Using this methodology, distinct conformations for the intracellular hCaᵥ1.2 channel are identified.

### 7.22 Example 22

### Docking, Binding Free Energy Calculation, and Rescoring of Top Hits

Compounds prepared according to the methodologies of EXAMPLE 2, above, are docked against the selected dominant conformations. Docking is carried out using the standard precision mode of the Glide docking module of the Schrodinger package (Glide SP). Top ranked poses are re-scored with AMBER-MMGBSA.

### 7.23 Example 23

### Classification of Channel Blockage and Redesign of Compound to be a Non-Blocker

Classification the compounds as “blockers,” e.g., compounds that block the hCaᵥ1.2 ion channel, or as “non-blockers,” e.g., compounds that do not block the hCaᵥ1.2 ion channel, is performed as described in EXAMPLE 9, above, for the hERG ion channel.

Redesign of a hCaᵥ1.2 ion channel blocker to be a non-blocker is performed as described in EXAMPLE 10, above, for the hERG ion channel.

### 7.24 Example 24

### Computations for Compound Selection

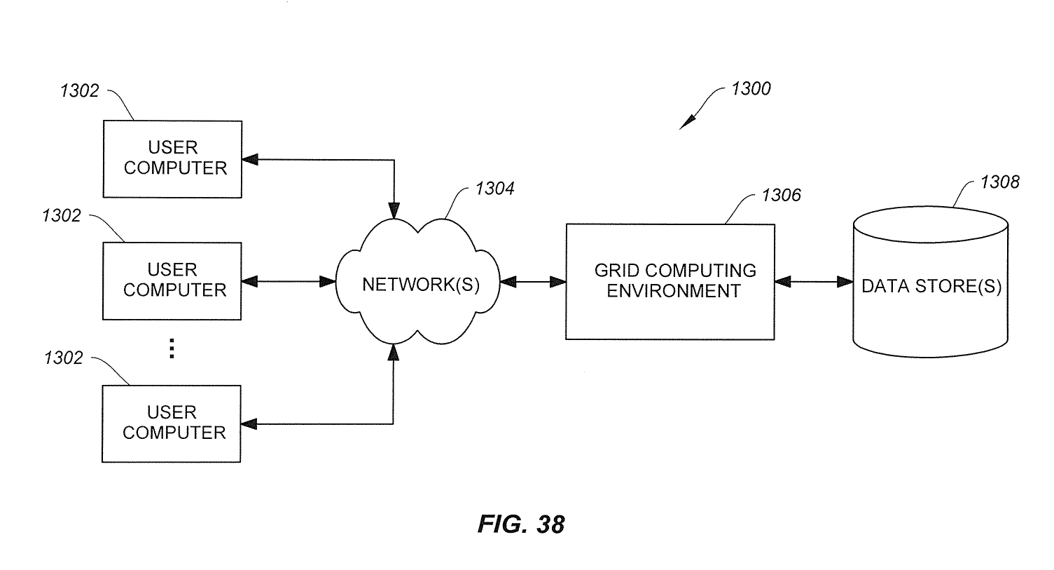

FIG. 38 depicts a grid computing environment for selecting a compound with reduced risk of cardiotoxicity. As shown in FIG. 38, user computers 1302 can interact with the grid computing environment 1306 through a number of ways, such as over one or more networks 1304. The grid computing environment 1306 can assist users to select a compound with reduced risk of cardiotoxicity.

One or more data stores 1308 can store the data to be analyzed by the grid computing environment 1306 as well as any intermediate or final data generated by the grid computing environment. However in certain embodiments, the configuration of the grid computing environment 1306 allows its operations to be performed such that intermediate and final data results can be stored solely in volatile memory (e.g., RAM), without a requirement that intermediate or final data results be stored to non-volatile types of memory (e.g., disk).

This can be useful in certain situations, such as when the grid computing environment 1306 receives ad hoc queries from a user and when responses, which are generated by processing large amounts of data, need to be generated on-the-fly. In this non-limiting situation, the grid computing environment 1306 is configured to retain the processed information within the grid memory so that responses can be generated for the user at different levels of detail as well as allow a user to interactively query against this information.

For example, the grid computing environment 1306 receives structural information describing the structure of the ion channel protein, and performs a molecular dynamics simulation of the protein structure. Then, the grid computing environment 1306 uses a clustering algorithm to identify dominant conformations of the protein structure from the molecular dynamics simulation, and select the dominant conformations of the protein structure identified from the clustering algorithm. In addition, the grid computing environment 1306 receives structural information describing conformers of one or more compounds, and uses a docking algorithm to dock the conformers of the one or more compounds to the dominant conformations. The grid computing environment 1306 further identifies a plurality of preferred binding conformations for each of the combinations of protein and compound, and optimizes the preferred binding conformations using molecular dynamics simulations so as to determine whether the compound blocks the ion channel of the protein in the preferred binding conformations.

Specifically, in response to user inquires about cardiotoxicity of a compound, the grid computing environment 1306, without an OLAP or relational database environment being required, aggregates protein structural information and compound structural information from the data stores 1308. Then the grid computing environment 1306 uses the received protein structural information to perform molecular dynamics simulations for determining configurations of target protein flexibility (e.g., over a simulation length of greater than 50 ns). The molecular dynamics simulations involve the grid computing environment 1306 determining forces acting on an atom based upon an empirical force field that approximates intramolecular forces, where numerical integration is performed to update positions and velocities of atoms. The grid computing environment 1306 clusters molecular dynamic trajectories formed based upon the updated positions and velocities of the atoms into dominant conformations of the protein, and executes a docking algorithm that uses the compound's structural information in order to dock the compound's conformers to the dominant conformations of the protein. Based on information related to the docked compound's conformers, the grid computing environment 1306 identifies a plurality of preferred binding conformations for each of the combinations of protein and compound. If the compound does not block the ion channel of the protein in the preferred binding conformations, the grid computing environment 1306 predicts the compound has reduced risk of cardiotoxicity. Otherwise, the grid computing environment 1306 predicts the compound is cardiotoxic, and redesigns the compound in order to reduce risk of cadiotoxicity.

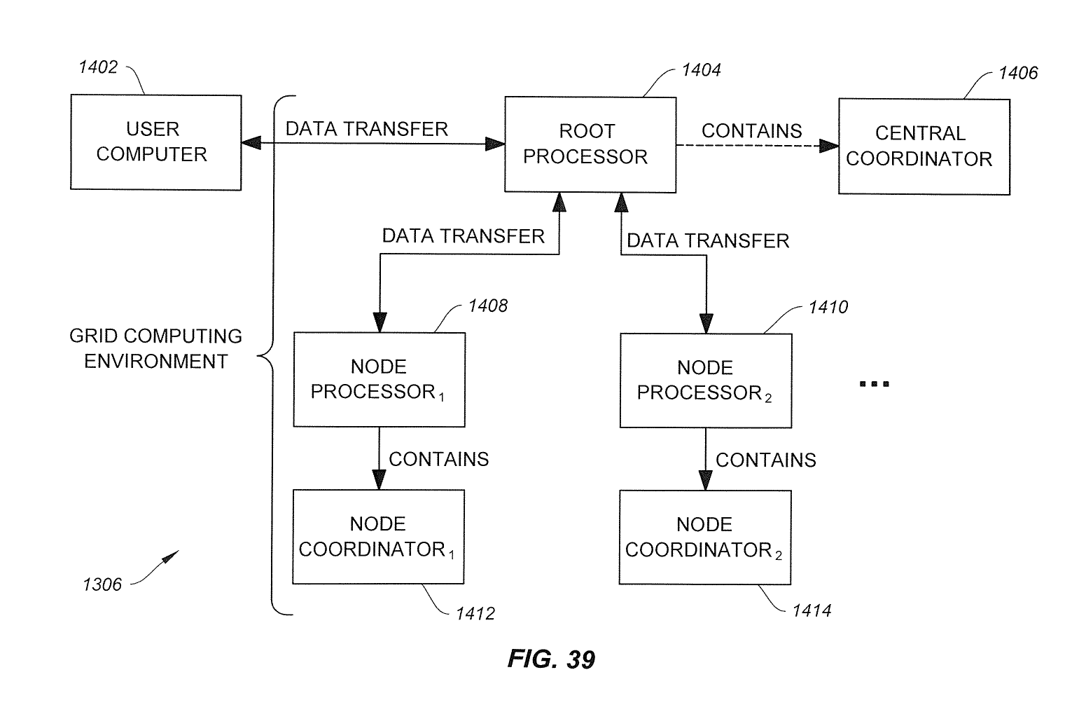

FIG. 39 illustrates hardware and software components for the grid computing environment 1306. As shown in FIG. 39, the grid computing environment 1306 includes a central coordinator software component 1406 which operates on a root data processor 1404. The central coordinator 1406 of the grid computing environment 1306 communicates with a user computer 1402 and with node coordinator software components (1412, 1414) which execute on their own separate data processors (1408, 1410) contained within the grid computing environment 1306.

As an example of an implementation environment, the grid computing environment 1306 can comprise a number of blade servers, and a central coordinator 1406 and the node coordinators (1412, 1414) are associated with their own blade server. In other words, a central coordinator 1406 and the node coordinators (1412, 1414) execute on their own respective blade server. In some embodiments, each blade server contains multiple cores and a thread is associated with and executes on a core belonging to a node processor (e.g., node processor 1408). A network connects each blade server together.

The central coordinator 1406 comprises a node on the grid. For example, there might be 100 nodes, with only 50 nodes specified to be run as node coordinators. The grid computing environment 1306 will run the central coordinator 1406 as a 51st node, and selects the central coordinator node randomly from within the grid. Accordingly, the central coordinator 1406 has the same hardware configuration as a node coordinator.

The central coordinator 1406 may receive information and provide information to a user regarding queries that the user has submitted to the grid. The central coordinator 1406 is also responsible for communicating with the 50 node coordinator nodes, such as by sending those instructions on what to do as well as receiving and processing information from the node coordinators. In one implementation, the central coordinator 1406 is the central point of contact for the client with respect to the grid, and a user never directly communicates with any of the node coordinators.

With respect to data transfers involving the central coordinator 1406, the central coordinator 1406 communicates with the client (or another source) to obtain the input data to be processed. The central coordinator 1406 divides up the input data and sends the correct portion of the input data for routing to the node coordinators. The central coordinator 1406 also may generate random numbers for use by the node coordinators in simulation operations as well as aggregate any processing results from the node coordinators. The central coordinator 1406 manages the node coordinators, and each node coordinator manages the threads which execute on their respective machines.

A node coordinator allocates memory for the threads with which it is associated. Associated threads are those that are in the same physical blade server as the node coordinator. However, it should be understood that other configurations could be used, such as multiple node coordinators being in the same blade server to manage different threads which operate on the server. Similar to a node coordinator managing and controlling operations within a blade server, the central coordinator 1406 manages and controls operations within a chassis.

In certain embodiments, a node processor includes shared memory for use for a node coordinator and its threads. The grid computing environment 1306 is structured to conduct its operations (e.g., matrix operations, etc.) such that as many data transfers as possible occur within a blade server (i.e., between threads via shared memory on their node) versus performing data transfers between threads which operate on different blades. Such data transfers via shared memory are more efficient than a data transfer involving a connection with another blade server.

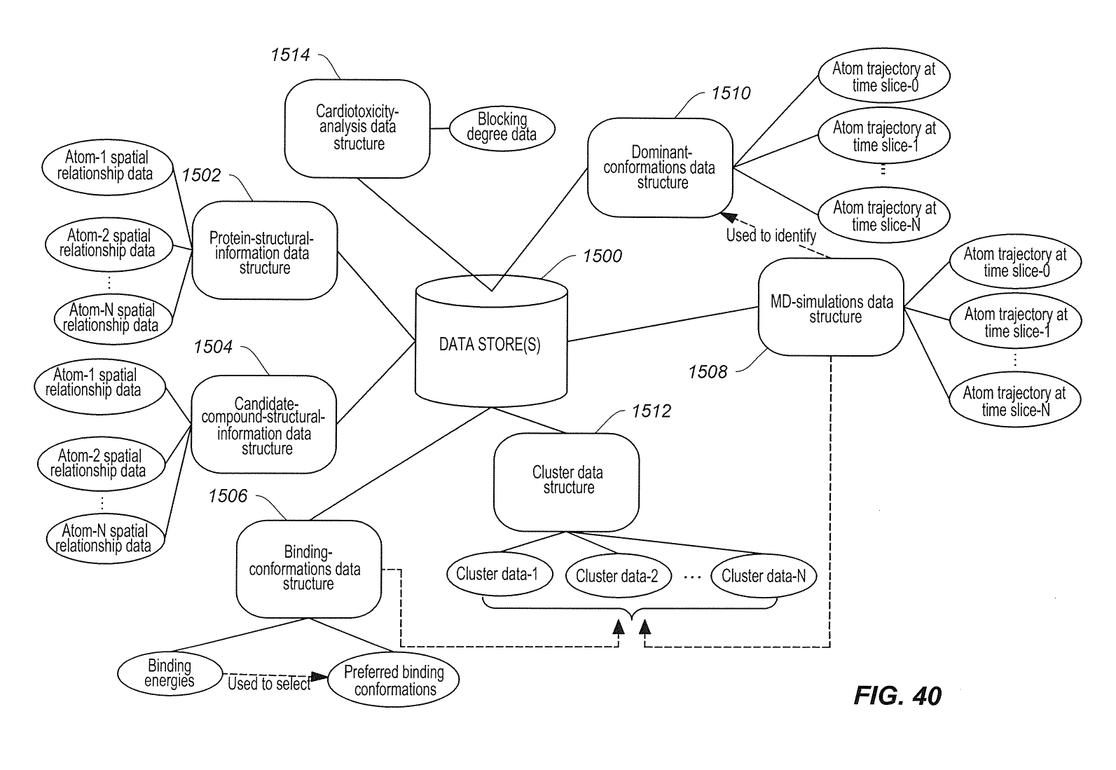

FIG. 40 depicts example schematics of data structures utilized by a compound-selection system. Multiple data structures are stored in a data store 1500, including a protein-structural-information data structure 1502, a candidate-compound-structural-information data structure 1504, a binding-conformations data structure 1506, a molecular-dynamics-simulations data structure 1508, a dominant-conformations data structure 1510, a cluster data structure 1512, and a cardiotoxicity-analysis data structure 1514. These interrelated data structures can be part of the central coordinator 1406 by aggregating data from individual nodes. However, portions of these data structures can be distributed as needed, so that the individual nodes can store the process data. The data store 1500 can be different types of storage devices and programming constructs (e.g., RAM, ROM, Flash memory, flat files, databases, programming data structures, programming variables, IF-THEN (or similar type) statement constructs, etc.). For example, the data store 1500 can be a single relational database or can be databases residing on a server in a distributed network.

Specifically, the protein-structural-information data structure 1502 is configured to store data related to the structure of the potassium ion channel protein, for example, special relationship data between different atoms. The data related to the structure of the potassium ion channel protein may be obtained from a homology model, an NMR solution structure, an X-ray crystal structure, a molecular model, etc. Molecular dynamics simulations can be performed on data stored in the protein-structural-information data structure 1502. For example, the molecular dynamics simulations involve solving the equation of motion according to the laws of physics, e.g., the chemical bonds within proteins being allowed to flex, rotate, bend, or vibrate. Information about the time dependence and magnitude of fluctuations in both positions and velocities of the given molecule/atoms is obtained from the molecular dynamics simulations. For example, data related to coordinates and velocities of molecules/atoms at equal time intervals or sampling intervals are obtained from the molecular dynamics simulations. Atomistic trajectory data (e.g., at different time slices) are formed based on the positions and velocities of molecules/atoms resulted from the molecular dynamics simulations and stored in the molecular-dynamics-simulations data structure 1508. The molecular dynamics simulations can be of any duration. In certain embodiments, the duration of the molecular dynamics simulation is greater than 50 ns, for example, preferably greater than 200 ns.

Data stored in the molecular-dynamics-simulations data structure 1508 are processed using a clustering algorithm, and associated cluster population data are stored in the cluster data structure 1512. Dominant conformations of the potassium ion channel protein are identified based at least in part on the data stored in the molecular-dynamics-simulations data structure 1508 and the associated cluster population data stored in the cluster data structure 1512. Atomistic trajectory data (e.g., at different time slices) related to the identified dominant conformations are stored in the dominant-conformations data structure 1510.

Data stored in the candidate-compound-structure-information data structure 1504 are processed together with data related to the dominant conformations of the potassium ion channel protein stored in the dominant-conformations data structure 1510. The conformers of the one or more compounds are docked to the dominant conformations of the structure of the potassium ion channel protein using a docking algorithm (e.g., DOCK, AutoDock, etc.), so that data related to various combinations of potassium ion channel protein and compound is determined and stored in the binding-conformations data structure 1506. For example, the compound is an antiviral agent (e.g., hepatitis C inhibitor). As an example, the binding-conformations data structure includes data related to binding energies. 2D information of the compound may be translated into a 3D representative structure to be stored in the candidate-compound-structure-information data structure 1504 for docking. Data stored in the binding-conformations data structure 1506 are processed using a clustering algorithm, and associated cluster population data are stored in the cluster data structure 1512. One or more preferred binding conformations are identified based at least in part on the data stored in the binding-conformations data structure 1506 and the associated cluster population data stored in the cluster data structure 1512. For example, the preferred binding conformations include those with a largest cluster population and a lowest binding energy.

The identified preferred binding conformations are optimized using a scalable molecular dynamics simulations (e.g., through a NAMD software, etc.). In certain embodiments, binding energies are calculated (e.g., using salvation models, etc.) for each of the combinations of protein and compound (receptor and ligand) in the corresponding optimized preferred binding conformation(s). The calculated binding energies are output as the predicted binding energies for each of the combinations of protein and compound.

The cardiotoxicity-analysis data structure 1514 includes data related to a blocking degree of one or more compounds, e.g., in the preferred binding conformations. For example, the data stored in the cardiotoxicity-analysis data structure 1514 includes identification of blocking sites and non-blocking sites. The data stored in the cardiotoxicity-analysis data structure 1514 indicates a potential cardiac hazard when (i) a pocket within the hERG channel is classified as a blocking site and (ii) a ligand fits within the pocket and is within a predetermined binding affinity level. The data stored in the cardiotoxicity-analysis data structure 1514 does not indicate a potential cardiac hazard when a ligand binds to a pocket within the hERG channel that is classified as a non-blocking site. In some embodiments, if the compound does not block the ion channel (e.g., the blocking degree being lower than a threshold) in the preferred binding conformation(s), the compound is predicted to have reduced risk of cardiotoxicity, and the compound can be selected. In other embodiments, if the compound blocks the ion channel (e.g., the blocking degree being higher than the threshold) in the preferred binding conformation(s), the compound is predicted to be cardiotoxic. A molecular modeling algorithm can be used to chemically modify or redesign the compound so as to reduce the risk of cardiotoxicity (e.g., to reduce the blocking degree).

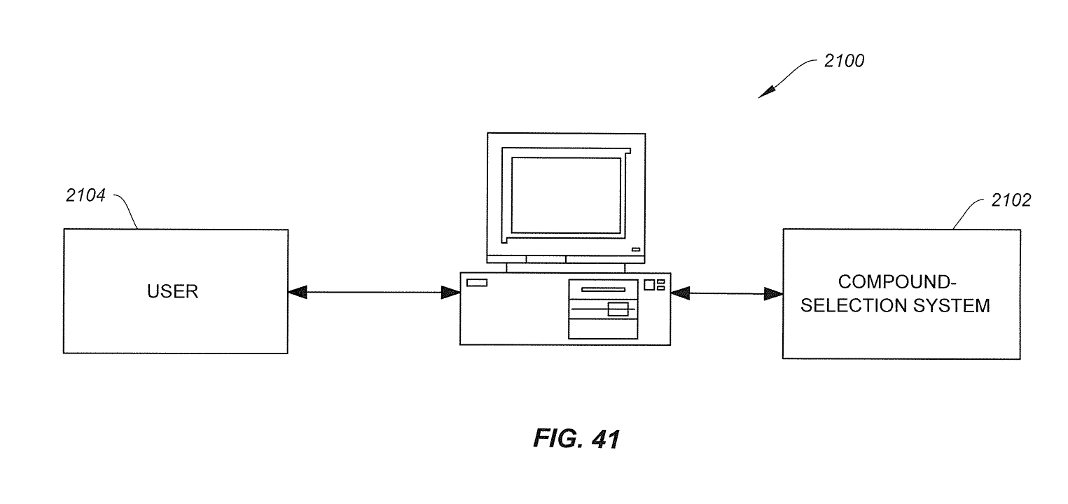

A system can be configured such that a compound-selection system 2102 can be provided on a stand-alone computer for access by a user 2104, such as shown at 2100 in FIG. 41.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims. For example, the actions recited in the claims can be performed in a different order and still achieve desirable results.

All publications and patent applications cited in this specification are herein incorporated by reference as if each individual publication or patent application were specifically and individually indicated to be incorporated by reference. Although the foregoing has been described in some detail by way of illustration and example for purposes of clarity of understanding, it will be readily apparent to those of ordinary skill in the art in light of the teachings of the specification that certain changes and modifications may be made thereto without departing from the spirit or scope of the appended claims.

Lengthy table referenced here
US20150193575A1-20150709-T00001
Please refer to the end of the specification for access instructions.

Lengthy table referenced here
US20150193575A1-20150709-T00002
Please refer to the end of the specification for access instructions.

Lengthy table referenced here
US20150193575A1-20150709-T00003
Please refer to the end of the specification for access instructions.

LENGTHY TABLES
The patent application contains a lengthy table section. A copy of the table is available in electronic form from the USPTO web site (http://seqdata.uspto.gov/?pageRequest=docDetail&DocID=US20150193575A1). An electronic copy of the table will also be available from the USPTO upon request and payment of the fee set forth in 37 CFR 1.19(b)(3).

What is claimed is:

1. A method for selecting a compound with reduced risk of cardiotoxicity, comprising the steps of:
a) using structural information describing the structure of a cardiac ion channel protein;
b) performing a molecular dynamics (MD) simulation of the protein structure;
c) using a clustering algorithm to identify dominant conformations of the protein structure from the MD simulation;
d) selecting the dominant conformations of the protein structure identified from the clustering algorithm;
e) providing structural information describing conformers of one or more compounds;
f) using a docking algorithm to dock the conformers of the one or more compounds of step e) to the dominant conformations of step d);
g) identifying a plurality of preferred binding conformations for each of the combinations of protein and compound;
h) optimizing the preferred binding conformations using scalable MD; and
i) determining if the compound blocks the ion channel of the protein in the preferred binding conformations;
wherein if the compound blocks the ion channel in the preferred binding conformations, the compound is predicted to be cardiotoxic; or
wherein if the compound does not block the ion channel in the preferred binding conformations, the compound is predicted to have reduced risk of cardiotoxicity; and
wherein based on a prediction that the compound has reduced risk of cardiotoxicity, the compound is selected;
wherein said steps a) through i) are executed on one or more processors.

2. The method of claim 1, wherein the cardiac ion channel protein is a membrane-bound protein.

3. The method of claim 1, wherein the cardiac ion channel protein is voltage-gated.

4. The method of claim 1, wherein the cardiac ion channel protein is a sodium, calcium, or potassium ion channel protein.

5. The method of claim 4, wherein the cardiac ion channel protein is a potassium ion channel protein.

6. The method of claim 5, wherein the potassium ion channel protein is hERG1; wherein the hERG1 channel is formed as a tetramer through the association of four monomer subunits.

7. The method of claim 4, wherein the cardiac ion channel protein is a sodium ion channel protein.

8. The method of claim 7, wherein the sodium ion channel protein is hNaᵥ1.5.

9. The method of claim 4, wherein the cardiac ion channel protein is a calcium ion channel protein

10. The method of claim 9, wherein the calcium ion channel protein is hCaᵥ1.2.

11. The method of claim 6, wherein flexibility of the potassium ion channel protein has greater than 100 variable-sized pockets within the monomer subunits or between the interaction sites of the monomers.

12. The method of claim 1, wherein the compound is capable of inhibiting hepatitis C virus (HCV) infection.

13. The method of claim 12, wherein the compound is an inhibitor of HCV NS3/4A protease, an inhibitor of HCV NS5B polymerase, or an inhibitor of HCV NS5a protein.

14. The method of claim 1, wherein the structural information of step a) is a three-dimensional (3D) structure.

15. The method of claim 1, wherein the structural information of step a) is an X-ray crystal structure, an NMR solution structure, or a homology model.

16. The method of claim 1, wherein the structural information of step a) is subjected to energy minimization (EM) prior to performing the MD simulation of step b).

17. The method of claim 1, wherein the MD simulation of step b) incorporates implicit or explicit solvent molecules and ion molecules.

18. The method of claim 1, wherein the MD simulation of step b) incorporates a hydrated lipid bilayer with explicit phospholipid, solvent and ion molecules.

19. The method of claim 1, wherein the MD simulation uses an AMBER force field, a CHARMM force field, or a GROMACS force field.

20. The method of claim 1, wherein the duration of the MD simulation of step b) is greater than 50 ns.

21. The method of claim 1, wherein the duration of the MD simulation of step b) is greater than 200 ns.

22. The method of claim 1, wherein the duration of the MD simulation of step b) is 200 ns.

23. The method of claim 1, wherein the docking algorithm of step is DOCK or AutoDock.

24. The method of claim 1, wherein the scalable MD of step h) uses NAMD software.

25. The method of claim 1, further comprising the step of calculating binding energies for each of the combinations of protein and compound in the corresponding optimized preferred binding conformations.

26. The method of claim 25, further comprising the step of selecting for each of the combinations of protein and compound the lowest calculated binding energy in the optimized preferred binding conformations, and outputting the selected calculated binding energies as the predicted binding energies for each of the combinations of protein and compound.

27. The method of claim 1, wherein if the compound blocks the ion channel in the preferred binding conformations, the method further comprises the step of using a molecular modeling algorithm to chemically modify the compound such that it does not block the ion channel in the preferred binding conformations.

28. The method of claim 27, further comprising repeating steps e) through i) for the modified compound.

29. The method of claim 25, further comprising testing the cardiotoxicity of the compound or modified compound in an in vitro biological assay.

30. The method of claim 29, wherein the in vitro biological assay comprises high throughput screening of potassium ion channel and transporter activities.

31. The method of claim 29, wherein the in vitro biological assay is a hERG1 channel inhibition assay.

32. The method of claim 29, wherein the in vitro biological assay is a FluxOR™ potassium ion channel assay.

33. The method of claim 32, wherein the FluxOR™ potassium channel assay is performed on HEK 293 cells stably expressing hERG1 or mouse cardiomyocyte cell line HL-1 cells.

34. The method of claim 29, wherein the in vitro biological assay comprises electrophysiology measurements in single cells, whereas the electrophysiology measurements comprise patch clamp measurements.

35. The method of claim 34, wherein the single cells are Chinese hamster ovary cells stably transfected with hERG1.

36. The method of claim 34, wherein the in vitro biological assay is a Cloe Screen IC₅₀ hERG1 Safety assay.

37. The method of claim 25, further comprising testing the cardiotoxicity of the compound or modified compound in vivo by measuring ECG in a wild type mouse or a transgenic animal model expressing human hERG1.

38. A processor-implemented system for designing a compound in order to reduce risk of cardiotoxicity, comprising:
one or more computer-readable mediums for storing protein structural information representative of a cardiac ion channel protein and for storing compound structural information describing conformers of the compound;
a grid computing system comprising a plurality of processor-implemented compute nodes and a processor-implemented central coordinator, said grid computing system receiving the stored protein structural information and the stored compound structural information from the one or more computer-readable mediums;
said grid computing system using the received protein structural information to perform molecular dynamics simulations for determining configurations of target protein flexibility over a simulation length of greater than 50 ns;
wherein the molecular dynamics simulations involve each of the compute nodes determining forces acting on an atom based upon an empirical force field that approximates intramolecular forces; wherein numerical integration is performed to update positions and velocities of atoms;
wherein the central coordinator forms molecular dynamic trajectories based upon the updated positions and velocities of the atoms as determined by each of the compute nodes;
said grid computing system configured to:
cluster the molecular dynamic trajectories into dominant conformations of the protein;
execute a docking algorithm that uses the compound's structural information in order to dock the compound's conformers to the dominant conformations of the protein;
identify a plurality of preferred binding conformations for each of the combinations of protein and compound based on information related to the docked compound's conformers;
a data structure stored in memory which includes information about the one or more of the identified plurality of preferred binding conformations blocking the ion channel of the protein;
whereby, based upon the information about blocking the ion channel, the compound is redesigned in order to reduce risk of cardiotoxicity.

39. The system of claim 38, wherein the one or more computer-readable mediums are either locally or remotely situated with respect to the grid computing system; said grid computing system receiving the stored protein structural information and the stored compound structural information directly or indirectly from the one or more computer-readable mediums.

40. The system of claim 39, wherein at least one of the computer readable mediums is locally situated with respect to the grid computing system; wherein at least one of the computer readable mediums is remotely situated with respect to the grid computing system; said grid computing system receiving the stored protein structural information and the stored compound structural information directly or indirectly from the one or more computer-readable mediums.

41. The system of claim 38, wherein the memory is volatile memory, nonvolatile memory, or combinations thereof.

42. The system of claim 38, wherein the compute nodes contain multi-core processors for performing the molecular dynamics simulations.

43. The system of claim 42, wherein the compute nodes manage thread execution on the multi-core processors and include shared memory; wherein a thread executes on a core processor.

44. The system of claim 43, wherein the central coordinator operates on a multi-core processor and provides commands and data to the plurality of compute nodes.

45. The system of claim 38, wherein the protein structural information is a three-dimensional (3D) structure.

46. The system of claim 38, wherein the protein structural information is an X-ray crystal structure, an NMR solution structure, or a homology model.

47. The system of claim 38, wherein the simulation length is greater than 200 ns.

48. The system of claim 38, wherein the information about blocking the ion channel stored in the data structure includes identification of blocking sites and non-blocking sites.

49. The system of claim 48, wherein the identification of blocking sites and non-blocking provide predictive information related to cardiotoxicity.

50. The system of claim 49, wherein if the compound does not block the ion channel in the preferred binding conformations, the compound is predicted to have reduced risk of cardiotoxicity;
wherein if the compound blocks the ion channel in the preferred binding conformations, the compound is predicted to be cardiotoxic.

51. The system of claim 38, wherein the cardiac ion channel protein is a membrane-bound protein.

52. The system of claim 38, wherein the cardiac ion channel protein is voltage-gated.

53. The system of claim 38, wherein the cardiac ion channel protein is a sodium, calcium, or potassium ion channel protein.

54. The system of claim 38, wherein the cardiac ion channel protein is a potassium ion channel protein.

55. The system of claim 54, wherein the potassium ion channel protein is hERG1; wherein the hERG1 channel is formed as a tetramer through the association of four monomer subunits.

56. The method of claim 54, wherein the cardiac ion channel protein is a sodium ion channel protein.

57. The method of claim 56, wherein the sodium ion channel protein is hNaᵥ1.5.

58. The method of claim 54, wherein the cardiac ion channel protein is a calcium ion channel protein

59. The method of claim 58, wherein the calcium ion channel protein is hCaᵥ1.2.

60. The system of claim 54, wherein structure of the potassium ion channel protein encompasses 1020 amino acid residues.

61. The system of claim 54, wherein flexibility of the potassium ion channel protein has greater than 100 variable-sized pockets within the monomer subunits or between the interaction sites of the monomers.

62. The system of claim 55, wherein the information about blocking the ion channel stored in the data structure includes identification of blocking sites and non-blocking sites;
wherein the information in the data structure indicates a potential cardiac hazard when (i) a pocket within the hERG1 channel is classified as a blocking site and (ii) a ligand fits within the pocket and is within a predetermined binding affinity level;
wherein the information in the data structure does not indicate a potential cardiac hazard when a ligand binds to a pocket within the hERG1 channel that is classified as a non-blocking site.

63. The system of claim 38, wherein the information about blocking the ion channel of the protein is generated prior to experimentally synthesizing the compound, thereby saving time and costs associated with drug development involving the compound.

64. A computer-implemented system for selecting a compound with reduced risk of cardiotoxicity, the system comprising:
one or more data processors;
a computer-readable storage medium encoded with instructions for commanding the one or more data processors to execute operations including:
a) using structural information describing the structure of a cardiac ion channel protein;
b) performing a molecular dynamics (MD) simulation of the protein structure;
c) using a clustering algorithm to identify dominant conformations of the protein structure from the MD simulation;
d) selecting the dominant conformations of the protein structure identified from the clustering algorithm;
e) providing structural information describing conformers of one or more compounds;
f) using a docking algorithm to dock the conformers of the one or more compounds of step e) to the dominant conformations of step d);
g) identifying a plurality of preferred binding conformations for each of the combinations of protein and compound;
h) optimizing the preferred binding conformations using scalable MD; and
i) determining if the compound blocks the ion channel of the protein in the preferred binding conformations;
wherein if the compound blocks the ion channel in the preferred binding conformations, the compound is predicted to be cardiotoxic; or
wherein if the compound does not block the ion channel in the preferred binding conformations, the compound is predicted to have reduced risk of cardiotoxicity; and
wherein based on a prediction that the compound is has reduced risk of cardiotoxicity, the compound is selected.

65. A computer-implemented system for selecting a compound with reduced risk of cardiotoxicity, comprising:
one or more computer memories for storing a single computer database having a database schema that contains and interrelates protein-structural-information fields, compound-structural-information fields, and preferred-binding-conformation fields, the protein-structural-information fields being contained within the database schema and being configured to store protein structural information representative of a cardiac ion channel protein, the compound-structural-information fields being contained within the database schema and being configured to store compound structural information describing conformers of one or more compounds, the preferred-binding-conformation fields being contained within the database schema and being configured to store information related to one or more preferred binding conformations for each combination of protein and compound determined based at least in part on information in the protein-structural-information fields and the compound-structural-information fields; and
one or more data processors configured to:
process a database query that operates over data related to the protein-structural-information fields, the compound-structural-information fields, and the preferred-binding-conformation fields; and
determine whether the one or more compounds are cardiotoxic by using information in the preferred-binding-conformation fields.

66. The system of claim 65, wherein the database schema further includes:
protein-conformation fields including information associated with configurations of target protein flexibility determined through molecular dynamics simulations based at least in part on the protein structural information.

67. The system of claim 66, wherein:
the molecular dynamics simulations include determining forces acting on an atom based upon an empirical force field that approximates intramolecular forces;
numerical integration is performed to update positions and velocities of atoms; and
molecular dynamic trajectories are formed based upon the updated positions and velocities of the atoms and stored in the protein-conformation fields.

68. The system of claim 67, wherein the database schema further includes:
dominant-conformation fields including information related to dominant conformations determined by clustering the molecular dynamic trajectories.

69. The system of claim 68, wherein the database schema further includes:
binding-conformation fields including information related to different combinations of protein and compound determined by docking the conformers of the compounds to the dominant conformations of the protein using a docking algorithm.

70. The system of claim 65, wherein information in the preferred-binding-conformation fields is obtained from the binding-conformation fields based at least in part on the compound structural information.

71. The system of claim 65, wherein the one or more preferred binding conformations are optimized using scalable molecular dynamics simulations.

72. The system of claim 65, wherein the one or more data processors are further configured to determine the one or more compounds with reduced risk of cardiotoxicity in response to the one or more compounds not blocking the ion channel in the one or more preferred binding conformations.

73. The system of claim 65, wherein the one or more data processors are further configured to determine the one or more compounds are cardiotoxic in response to the one or more compounds blocking the ion channel in the one or more preferred binding conformations.

74. The system of claim 73, wherein the one or more data processors are further configured to redesign the one or more compounds that are determined to be cardiotoxic in order to reduce risk of cardiotoxicity.

75. A non-transitory computer-readable storage medium for storing data for access by a compound-selection program which is executed on a data processing system, comprising:
a protein-structural-information data structure having access to information stored in a database and including protein structural information representative of a cardiac ion channel protein;
a candidate-compound-structural-information data structure having access to information stored in the database and including compound structural information describing conformers of one or more compounds;
a molecular-dynamics-simulations data structure having access to information stored in the database and including configuration information of target protein flexibility determined by performing molecular dynamics simulations on the protein structural information;
a dominant-conformations data structure having access to information stored in the database and being determined by using a first clustering algorithm based at least in part on the configuration information of target protein flexibility; and
a binding-conformations data structure having access to information stored in the database and including information related to one or more combinations of protein and compound determined by using a docking algorithm based at least in part on the compound structural information and the one or more dominant conformations, one or more preferred binding conformations being determined by using a second clustering algorithm based at least in part on the information related to the one or more combinations of protein and compound;
wherein a compound is selected if the compound has reduced risk of cardiotoxicity in the preferred binding conformations.

76. A non-transitory computer-readable storage medium for storing data for access by a compound-selection program which is executed on a data processing system, comprising:
a protein-structural-information data structure having access to information stored in a database and including protein structural information representative of a cardiac ion channel protein;
a candidate-compound-structural-information data structure having access to information stored in the database and including compound structural information describing conformers of one or more compounds;
a molecular-dynamics-simulations data structure having access to information stored in the database and including configuration information of target protein flexibility determined by performing molecular dynamics simulations on the protein structural information;
a dominant-conformations data structure having access to information stored in the database and being determined by using a first clustering algorithm based at least in part on the configuration information of target protein flexibility; and
a binding-conformations data structure having access to information stored in the database and including information related to one or more combinations of protein and compound determined by using a docking algorithm based at least in part on the compound structural information and the one or more dominant conformations, one or more preferred binding conformations being determined by using a second clustering algorithm based at least in part on the information related to the one or more combinations of protein and compound;
wherein the data processing system is configured to:
process a query that operates over data related to the protein-structural-information data structure, the candidate-compound-structural-information data structure, the molecular-dynamics-simulations data structure, the dominant-conformations data structure and the binding-conformations data structure; and
determine whether the one or more compounds are cardiotoxic in the one or more preferred binding conformations.

77. A method for selecting a compound with reduced risk of cardiotoxicity, comprising the steps of:
a) using the coordinates of Table A describing the structure of a potassium ion channel protein;
b) performing a molecular dynamics (MD) simulation of the structure;
c) using a clustering algorithm to identify dominant conformations of the structure from the MD simulation;
d) selecting the dominant conformations of the structure identified from the clustering algorithm;
e) providing structural information describing conformers of one or more compounds;
f) using a docking algorithm to dock the conformers of the one or more compounds of step e) to the dominant conformations of step d);
g) identifying a plurality of preferred binding conformations for each of the combinations of potassium ion channel protein and compound;
h) optimizing the preferred binding conformations using scalable MD; and
i) determining if the compound blocks the ion channel of the potassium ion channel protein in the preferred binding conformations;
wherein if the compound blocks the ion channel in the preferred binding conformations, the compound is predicted to be cardiotoxic; or
wherein if the compound does not block the ion channel in the preferred binding conformations, the compound is predicted to have reduced risk of cardiotoxicity; and
wherein based on a prediction that the compound has reduced risk of cardiotoxicity, the compound is selected;
wherein said steps a) through i) are executed on one or more processors.

78. The method of claim 77, wherein the the potassium ion channel protein is selected from any one of the members 1-8 of the potassium voltage-gated channel, subfamily H (eag-related), of TABLE 2.

79. The method of claim 77, wherein the potassium ion channel protein is hERG1.

80. A method for selecting a compound with reduced risk of cardiotoxicity, comprising the steps of:
a) using the coordinates of Table B describing the structure of a sodium ion channel protein;
b) performing a molecular dynamics (MD) simulation of the structure;
c) using a clustering algorithm to identify dominant conformations of the structure from the MD simulation;
d) selecting the dominant conformations of the structure identified from the clustering algorithm;
e) providing structural information describing conformers of one or more compounds;
f) using a docking algorithm to dock the conformers of the one or more compounds of step e) to the dominant conformations of step d);
g) identifying a plurality of preferred binding conformations for each of the combinations of sodium ion channel protein and compound;
h) optimizing the preferred binding conformations using scalable MD; and
i) determining if the compound blocks the ion channel of the sodium ion channel protein in the preferred binding conformations;
wherein if the compound blocks the ion channel in the preferred binding conformations, the compound is predicted to be cardiotoxic; or
wherein if the compound does not block the ion channel in the preferred binding conformations, the compound is predicted to have reduced risk of cardiotoxicity; and
wherein based on a prediction that the compound has reduced risk of cardiotoxicity, the compound is selected;
wherein said steps a) through i) are executed on one or more processors.

81. The method of claim 80, wherein the sodium ion channel protein is hNaᵥ1.5.

82. A method for selecting a compound with reduced risk of cardiotoxicity, comprising the steps of:
a) using the coordinates of Table C describing the structure of a calcium ion channel protein;
b) performing a molecular dynamics (MD) simulation of the structure;
c) using a clustering algorithm to identify dominant conformations of the structure from the MD simulation;
d) selecting the dominant conformations of the structure identified from the clustering algorithm;
e) providing structural information describing conformers of one or more compounds;
f) using a docking algorithm to dock the conformers of the one or more compounds of step e) to the dominant conformations of step d);
g) identifying a plurality of preferred binding conformations for each of the combinations of calcium ion channel protein and compound;
h) optimizing the preferred binding conformations using scalable MD; and
i) determining if the compound blocks the ion channel of calcium ion channel protein in the preferred binding conformations;
wherein if the compound blocks the ion channel in the preferred binding conformations, the compound is predicted to be cardiotoxic; or
wherein if the compound does not block the ion channel in the preferred binding conformations, the compound is predicted to have reduced risk of cardiotoxicity; and
wherein based on a prediction that the compound has reduced risk of cardiotoxicity, the compound is selected;
wherein said steps a) through i) are executed on one or more processors.

83. The method of claim 82, wherein the calcium ion channel protein is hCaᵥ1.2.


SEQUENCE LISTING (13 sequences)

SEQ ID NO: 1 - DNA, 3480 bp, Homosapiens
  hERG1 (also known as KCNH2, Kv11.1, HERG1, erg1, LQT2, SQT1)
atgccggtgcggaggggccacgtcgcgccgcagaacaccttcctggacaccatcatccgcaagtttgagggccagagccgtaagttcatcatcgccaacgctcgggtggagaactgcgccgtcatctactgcaacgacggcttctgcgagctgtgcggctactcgcgggccgaggtgatgcagcgaccctgcacctgcgacttcctgcacgggccgcgcacgcagcgccgcgctgccgcgcagatcgcgcaggcactgctgggcgccgaggagcgcaaagtggaaatcgccttctaccggaaagatgggagctgcttcctatgtctggtggatgtggtgcccgtgaagaacgaggatggggctgtcatcatgttcatcctcaatttcgaggtggtgatggagaaggacatggtggggtccccggctcatgacaccaaccaccggggcccccccaccagctggctggccccaggccgcgccaagaccttccgcctgaagctgcccgcgctgctggcgctgacggcccgggagtcgtcggtgcggtcgggcggcgcgggcggcgcgggcgccccgggggccgtggtggtggacgtggacctgacgcccgcggcacccagcagcgagtcgctggccctggacgaagtgacagccatggacaaccacgtggcagggctcgggcccgcggaggagcggcgtgcgctggtgggtcccggctctccgccccgcagcgcgcccggccagctcccatcgccccgggcgcacagcctcaaccccgacgcctcgggctccagctgcagcctggcccggacgcgctcccgagaaagctgcgccagcgtgcgccgcgcctcgtcggccgacgacatcgaggccatgcgcgccggggtgctgcccccgccaccgcgccacgccagcaccggggccatgcacccactgcgcagcggcttgctcaactccacctcggactccgacctcgtgcgctaccgcaccattagcaagattccccaaatcaccctcaactttgtggacctcaagggcgaccccttcttggcttcgcccaccagtgaccgtgagatcatagcacctaagataaaggagcgaacccacaatgtcactgagaaggtcacccaggtcctgtccctgggcgccgacgtgctgcctgagtacaagctgcaggcaccgcgcatccaccgctggaccatcctgcattacagccccttcaaggccgtgtgggactggctcatcctgctgctggtcatctacacggctgtcttcacaccctactcggctgccttcctgctgaaggagacggaagaaggcccgcctgctaccgagtgtggctacgcctgccagccgctggctgtggtggacctcatcgtggacatcatgttcattgtggacatcctcatcaacttccgcaccacctacgtcaatgccaacgaggaggtggtcagccaccccggccgcatcgccgtccactacttcaagggctggttcctcatcgacatggtggccgccatccccttcgacctgctcatcttcggctctggctctgaggagctgatcgggctgctgaagactgcgcggctgctgcggctggtgcgcgtggcgcggaagctggatcgctactcagagtacggcgcggccgtgctgttcttgctcatgtgcacctttgcgctcatcgcgcactggctagcctgcatctggtacgccatcggcaacatggagcagccacacatggactcacgcatcggctggctgcacaacctgggcgaccagataggcaaaccctacaacagcagcggcctgggcggcccctccatcaaggacaagtatgtgacggcgctctacttcaccttcagcagcctcaccagtgtgggcttcggcaacgtctctcccaacaccaactcagagaagatcttctccatctgcgtcatgctcattggctccctcatgtatgctagcatcttcggcaacgtgtcggccatcatccagcggctgtactcgggcacagcccgctaccacacacagatgctgcgggtgcgggagttcatccgcttccaccagatccccaatcccctgcgccagcgcctcgaggagtacttccagcacgcctggtcctacaccaacggcatcgacatgaacgcggtgctgaagggcttccctgagtgcctgcaggctgacatctgcctgcacctgaaccgctcactgctgcagcactgcaaacccttccgaggggccaccaagggctgccttcgggccctggccatgaagttcaagaccacacatgcaccgccaggggacacactggtgcatgctggggacctgctcaccgccctgtacttcatctcccggggctccatcgagatcctgcggggcgacgtcgtcgtggccatcctggggaagaatgacatctttggggagcctctgaacctgtatgcaaggcctggcaagtcgaacggggatgtgcgggccctcacctactgtgacctacacaagatccatcgggacgacctgctggaggtgctggacatgtaccctgagttctccgaccacttctggtccagcctggagatcaccttcaacctgcgagataccaacatgatcccgggctcccccggcagtacggagttagagggtggcttcagtcggcaacgcaagcgcaagttgtccttccgcaggcgcacggacaaggacacggagcagccaggggaggtgtcggccttggggccgggccgggcgggggcagggccgagtagccggggccggccgggggggccgtggggggagagcccgtccagtggcccctccagccctgagagcagtgaggatgagggcccaggccgcagctccagccccctccgcctggtgcccttctccagccccaggccccccggagagccgccgggtggggagcccctgatggaggactgcgagaagagcagcgacacttgcaaccccctgtcaggcgccttctcaggagtgtccaacattttcagcttctggggggacagtcggggccgccagtaccaggagctccctcgatgccccgcccccacccccagcctcctcaacatccccctctccagcccgggtcggcggccccggggcgacgtggagagcaggctggatgccctccagcgccagctcaacaggctggagacccggctgagtgcagacatggccactgtcctgcagctgctacagaggcagatgacgctggtcccgcccgcctacagtgctgtgaccaccccggggcctggccccacttccacatccccgctgttgcccgtcagccccctccccaccctcaccttggactcgctttctcaggtttcccagttcatggcgtgtgaggagctgcccccgggggccccagagcttccccaagaaggccccacacgacgcctctccctaccgggccagctgggggccctcacctcccagcccctgcacagacacggctcggacccgggcagttag

SEQ ID NO: 2 - protein, 1159 aa, Homosapiens
  hERG1 (also known as KCNH2, Kv11.1, HERG1, erg1, LQT2, SQT1)
MPVRRGHVAPQNTFLDTIIRKFEGQSRKFIIANARVENCAVIYCNDGFCELCGYSRAEVMQRPCTCDFLHGPRTQRRAAAQIAQALLGAEERKVEIAFYRKDGSCFLCLVDVVPVKNEDGAVIMFILNFEVVMEKDMVGSPAHDTNHRGPPTSWLAPGRAKTFRLKLPALLALTARESSVRSGGAGGAGAPGAVVVDVDLTPAAPSSESLALDEVTAMDNHVAGLGPAEERRALVGPGSPPRSAPGQLPSPRAHSLNPDASGSSCSLARTRSRESCASVRRASSADDIEAMRAGVLPPPPRHASTGAMHPLRSGLLNSTSDSDLVRYRTISKIPQITLNFVDLKGDPFLASPTSDREIIAPKIKERTHNVTEKVTQVLSLGADVLPEYKLQAPRIHRWTILHYSPFKAVWDWLILLLVIYTAVFTPYSAAFLLKETEEGPPATECGYACQPLAVVDLIVDIMFIVDILINFRTTYVNANEEVVSHPGRIAVHYFKGWFLIDMVAAIPFDLLIFGSGSEELIGLLKTARLLRLVRVARKLDRYSEYGAAVLFLLMCTFALIAHWLACIWYAIGNMEQPHMDSRIGWLHNLGDQIGKPYNSSGLGGPSIKDKYVTALYFTFSSLTSVGFGNVSPNTNSEKIFSICVMLIGSLMYASIFGNVSAIIQRLYSGTARYHTQMLRVREFIRFHQIPNPLRQRLEEYFQHAWSYTNGIDMNAVLKGFPECLQADICLHLNRSLLQHCKPFRGATKGCLRALAMKFKTTHAPPGDTLVHAGDLLTALYFISRGSIEILRGDVVVAILGKNDIFGEPLNLYARPGKSNGDVRALTYCDLHKIHRDDLLEVLDMYPEFSDHFWSSLEITFNLRDTNMIPGSPGSTELEGGFSRQRKRKLSFRRRTDKDTEQPGEVSALGPGRAGAGPSSRGRPGGPWGESPSSGPSSPESSEDEGPGRSSSPLRLVPFSSPRPPGEPPGGEPLMEDCEKSSDTCNPLSGAFSGVSNIFSFWGDSRGRQYQELPRCPAPTPSLLNIPLSSPGRRPRGDVESRLDALQRQLNRLETRLSADMATVLQLLQRQMTLVPPAYSAVTTPGPGPTSTSPLLPVSPLPTLTLDSLSQVSQFMACEELPPGAPELPQEGPTRRLSLPGQLGALTSQPLHRHGSDPGS

SEQ ID NO: 3 - DNA, 6051 bp, Homosapiens
  hNav1.5 (also known as SCN5A)
atggcaaacttcctattacctcggggcaccagcagcttccgcaggttcacacgggagtccctggcagccatcgagaagcgcatggcagagaagcaagcccgcggctcaaccaccttgcaggagagccgagaggggctgcccgaggaggaggctccccggccccagctggacctgcaggcctccaaaaagctgccagatctctatggcaatccaccccaagagctcatcggagagcccctggaggacctggaccccttctatagcacccaaaagactttcatcgtactgaataaaggcaagaccatcttccggttcagtgccaccaacgccttgtatgtcctcagtcccttccaccccatccggagagcggctgtgaagattctggttcactcgctcttcaacatgctcatcatgtgcaccatcctcaccaactgcgtgttcatggcccagcacgaccctccaccctggaccaagtatgtcgagtacaccttcaccgccatttacacctttgagtctctggtcaagattctggctcgaggcttctgcctgcacgcgttcactttccttcgggacccatggaactggctggactttagtgtgattatcatggcgtatgtatcagaaaatataaaactaggcaatttgtcggctcttcgaactttcagagtcctgagagctctaaaaactatttcagttatcccagggctgaagaccatcgtgggggccctgatccagtctgtgaagaagctggctgatgtgatggtcctcacagtcttctgcctcagcgtctttgccctcatcggcctgcagctcttcatgggcaacctaaggcacaagtgcgtgcgcaacttcacagcgctcaacggcaccaacggctccgtggaggccgacggcttggtctgggaatccctggacctttacctcagtgatccagaaaattacctgctcaagaacggcacctctgatgtgttactgtgtgggaacagctctgacgctgggacatgtccggagggctaccggtgcctaaaggcaggcgagaaccccgaccacggctacaccagcttcgattcctttgcctgggcctttcttgcactcttccgcctgatgacgcaggactgctgggagcgcctctatcagcagaccctcaggtccgcagggaagatctacatgatcttcttcatgcttgtcatcttcctggggtccttctacctggtgaacctgatcctggccgtggtcgcaatggcctatgaggagcaaaaccaagccaccatcgctgagaccgaggagaaggaaaagcgcttccaggaggccatggaaatgctcaagaaagaacacgaggccctcaccatcaggggtgtggataccgtgtcccgtagctccttggagatgtcccctttggccccagtaaacagccatgagagaagaagcaagaggagaaaacggatgtcttcaggaactgaggagtgtggggaggacaggctccccaagtctgactcagaagatggtcccagagcaatgaatcatctcagcctcacccgtggcctcagcaggacttctatgaagccacgttccagccgcgggagcattttcacctttcgcaggcgagacctgggttctgaagcagattttgcagatgatgaaaacagcacagcgggggagagcgagagccaccacacatcactgctggtgccctggcccctgcgccggaccagtgcccagggacagcccagtcccggaacctcggctcctggccacgccctccatggcaaaaagaacagcactgtggactgcaatggggtggtctcattactgggggcaggcgacccagaggccacatccccaggaagccacctcctccgccctgtgatgctagagcacccgccagacacgaccacgccatcggaggagccaggcgggccccagatgctgacctcccaggctccgtgtgtagatggcttcgaggagccaggagcacggcagcgggccctcagcgcagtcagcgtcctcaccagcgcactggaagagttagaggagtctcgccacaagtgtccaccatgctggaaccgtctcgcccagcgctacctgatctgggagtgctgcccgctgtggatgtccatcaagcagggagtgaagttggtggtcatggacccgtttactgacctcaccatcactatgtgcatcgtactcaacacactcttcatggcgctggagcactacaacatgacaagtgaattcgaggagatgctgcaggtcggaaacctggtcttcacagggattttcacagcagagatgaccttcaagatcattgccctcgacccctactactacttccaacagggctggaacatcttcgacagcatcatcgtcatccttagcctcatggagctgggcctgtcccgcatgagcaacttgtcggtgctgcgctccttccgcctgctgcgggtcttcaagctggccaaatcatggcccaccctgaacacactcatcaagatcatcgggaactcagtgggggcactggggaacctgacactggtgctagccatcatcgtgttcatctttgctgtggtgggcatgcagctctttggcaagaactactcggagctgagggacagcgactcaggcctgctgcctcgctggcacatgatggacttctttcatgccttcctcatcatcttccgcatcctctgtggagagtggatcgagaccatgtgggactgcatggaggtgtcggggcagtcattatgcctgctggtcttcttgcttgttatggtcattggcaaccttgtggtcctgaatctcttcctggccttgctgctcagctccttcagtgcagacaacctcacagcccctgatgaggacagagagatgaacaacctccagctggccctggcccgcatccagaggggcctgcgctttgtcaagcggaccacctgggatttctgctgtggtctcctgcggcagcggcctcagaagcccgcagcccttgccgcccagggccagctgcccagctgcattgccaccccctactccccgccacccccagagacggagaaggtgcctcccacccgcaaggaaacacggtttgaggaaggcgagcaaccaggccagggcacccccggggatccagagcccgtgtgtgtgcccatcgctgtggccgagtcagacacagatgaccaagaagaagatgaggagaacagcctgggcacggaggaggagtccagcaagcagcaggaatcccagcctgtgtccggtggcccagaggcccctccggattccaggacctggagccaggtgtcagcgactgcctcctctgaggccgaggccagtgcatctcaggccgactggcggcagcagtggaaagcggaaccccaggccccagggtgcggtgagaccccagaggacagttgctccgagggcagcacagcagacatgaccaacaccgctgagctcctggagcagatccctgacctcggccaggatgtcaaggacccagaggactgcttcactgaaggctgtgtccggcgctgtccctgctgtgcggtggacaccacacaggccccagggaaggtctggtggcggttgcgcaagacctgctaccacatcgtggagcacagctggttcgagacattcatcatcttcatgatcctactcagcagtggagcgctggccttcgaggacatctacctagaggagcggaagaccatcaaggttctgcttgagtatgccgacaagatgttcacatatgtcttcgtgctggagatgctgctcaagtgggtggcctacggcttcaagaagtacttcaccaatgcctggtgctggctcgacttcctcatcgtagacgtctctctggtcagcctggtggccaacaccctgggctttgccgagatgggccccatcaagtcactgcggacgctgcgtgcactccgtcctctgagagctctgtcacgatttgagggcatgagggtggtggtcaatgccctggtgggcgccatcccgtccatcatgaacgtcctcctcgtctgcctcatcttctggctcatcttcagcatcatgggcgtgaacctctttgcggggaagtttgggaggtgcatcaaccagacagagggagacttgcctttgaactacaccatcgtgaacaacaagagccagtgtgagtccttgaacttgaccggagaattgtactggaccaaggtgaaagtcaactttgacaacgtgggggccgggtacctggcccttctgcaggtggcaacatttaaaggctggatggacattatgtatgcagctgtggactccagggggtatgaagagcagcctcagtgggaatacaacctctacatgtacatctattttgtcattttcatcatctttgggtctttcttcaccctgaacctctttattggtgtcatcattgacaacttcaaccaacagaagaaaaagttagggggccaggacatcttcatgacagaggagcagaagaagtactacaatgccatgaagaagctgggctccaagaagccccagaagcccatcccacggcccctgaacaagtaccagggcttcatattcgacattgtgaccaagcaggcctttgacgtcaccatcatgtttctgatctgcttgaatatggtgaccatgatggtggagacagatgaccaaagtcctgagaaaatcaacatcttggccaagatcaacctgctctttgtggccatcttcacaggcgagtgtattgtcaagctggctgccctgcgccactactacttcaccaacagctggaatatcttcgacttcgtggttgtcatcctctccatcgtgggcactgtgctctcggacatcatccagaagtacttcttctccccgacgctcttccgagtcatccgcctggcccgaataggccgcatcctcagactgatccgaggggccaaggggatccgcacgctgctctttgccctcatgatgtccctgcctgccctcttcaacatcgggctgctgctcttcctcgtcatgttcatctactccatctttggcatggccaacttcgcttatgtcaagtgggaggctggcatcgacgacatgttcaacttccagaccttcgccaacagcatgctgtgcctcttccagatcaccacgtcggccggctgggatggcctcctcagccccatcctcaacactgggccgccctactgcgaccccactctgcccaacagcaatggctctcggggggactgcgggagcccagccgtgggcatcctcttcttcaccacctacatcatcatctccttcctcatcgtggtcaacatgtacattgccatcatcctggagaacttcagcgtggccacggaggagagcaccgagcccctgagtgaggacgacttcgatatgttctatgagatctgggagaaatttgacccagaggccactcagtttattgagtattcggtcctgtctgactttgccgatgccctgtctgagccactccgtatcgccaagcccaaccagataagcctcatcaacatggacctgcccatggtgagtggggaccgcatccattgcatggacattctctttgccttcaccaaaagggtcctgggggagtctggggagatggacgccctgaagatccagatggaggagaagttcatggcagccaacccatccaagatctcctacgagcccatcaccaccacactccggcgcaagcacgaagaggtgtcggccatggttatccagagagccttccgcaggcacctgctgcaacgctctttgaagcatgcctccttcctcttccgtcagcaggcgggcagcggcctctccgaagaggatgcccctgagcgagagggcctcatcgcctacgtgatgagtgagaacttctcccgaccccttggcccaccctccagctcctccatctcctccacttccttcccaccctcctatgacagtgtcactagagccaccagcgataacctccaggtgcgggggtctgactacagccacagtgaagatctcgccgacttccccccttctccggacagggaccgtgagtccatcgtgtga

SEQ ID NO: 4 - protein, 2016 aa, Homosapiens
  hNav1.5 (also known as SCN5A)
MANFLLPRGTSSFRRFTRESLAAIEKRMAEKQARGSTTLQESREGLPEEEAPRPQLDLQASKKLPDLYGNPPQELIGEPLEDLDPFYSTQKTFIVLNKGKTIFRFSATNALYVLSPFHPIRRAAVKILVHSLFNMLIMCTILTNCVFMAQHDPPPWTKYVEYTFTAIYTFESLVKILARGFCLHAFTFLRDPWNWLDFSVIIMAYVSENIKLGNLSALRTFRVLRALKTISVIPGLKTIVGALIQSVKKLADVMVLTVFCLSVFALIGLQLFMGNLRHKCVRNFTALNGTNGSVEADGLVWESLDLYLSDPENYLLKNGTSDVLLCGNSSDAGTCPEGYRCLKAGENPDHGYTSFDSFAWAFLALFRLMTQDCWERLYQQTLRSAGKIYMIFFMLVIFLGSFYLVNLILAVVAMAYEEQNQATIAETEEKEKRFQEAMEMLKKEHEALTIRGVDTVSRSSLEMSPLAPVNSHERRSKRRKRMSSGTEECGEDRLPKSDSEDGPRAMNHLSLTRGLSRTSMKPRSSRGSIFTFRRRDLGSEADFADDENSTAGESESHHTSLLVPWPLRRTSAQGQPSPGTSAPGHALHGKKNSTVDCNGVVSLLGAGDPEATSPGSHLLRPVMLEHPPDTTTPSEEPGGPQMLTSQAPCVDGFEEPGARQRALSAVSVLTSALEELEESRHKCPPCWNRLAQRYLIWECCPLWMSIKQGVKLVVMDPFTDLTITMCIVLNTLFMALEHYNMTSEFEEMLQVGNLVFTGIFTAEMTFKIIALDPYYYFQQGWNIFDSIIVILSLMELGLSRMSNLSVLRSFRLLRVFKLAKSWPTLNTLIKIIGNSVGALGNLTLVLAIIVFIFAVVGMQLFGKNYSELRDSDSGLLPRWHMMDFFHAFLIIFRILCGEWIETMWDCMEVSGQSLCLLVFLLVMVIGNLVVLNLFLALLLSSFSADNLTAPDEDREMNNLQLALARIQRGLRFVKRTTWDFCCGLLRQRPQKPAALAAQGQLPSCIATPYSPPPPETEKVPPTRKETRFEEGEQPGQGTPGDPEPVCVPIAVAESDTDDQEEDEENSLGTEEESSKQQESQPVSGGPEAPPDSRTWSQVSATASSEAEASASQADWRQQWKAEPQAPGCGETPEDSCSEGSTADMTNTAELLEQIPDLGQDVKDPEDCFTEGCVRRCPCCAVDTTQAPGKVWWRLRKTCYHIVEHSWFETFIIFMILLSSGALAFEDIYLEERKTIKVLLEYADKMFTYVFVLEMLLKWVAYGFKKYFTNAWCWLDFLIVDVSLVSLVANTLGFAEMGPIKSLRTLRALRPLRALSRFEGMRVVVNALVGAIPSIMNVLLVCLIFWLIFSIMGVNLFAGKFGRCINQTEGDLPLNYTIVNNKSQCESLNLTGELYWTKVKVNFDNVGAGYLALLQVATFKGWMDIMYAAVDSRGYEEQPQWEYNLYMYIYFVIFIIFGSFFTLNLFIGVIIDNFNQQKKKLGGQDIFMTEEQKKYYNAMKKLGSKKPQKPIPRPLNKYQGFIFDIVTKQAFDVTIMFLICLNMVTMMVETDDQSPEKINILAKINLLFVAIFTGECIVKLAALRHYYFTNSWNIFDFVVVILSIVGTVLSDIIQKYFFSPTLFRVIRLARIGRILRLIRGAKGIRTLLFALMMSLPALFNIGLLLFLVMFIYSIFGMANFAYVKWEAGIDDMFNFQTFANSMLCLFQITTSAGWDGLLSPILNTGPPYCDPTLPNSNGSRGDCGSPAVGILFFTTYIIISFLIVVNMYIAIILENFSVATEESTEPLSEDDFDMFYEIWEKFDPEATQFIEYSVLSDFADALSEPLRIAKPNQISLINMDLPMVSGDRIHCMDILFAFTKRVLGESGEMDALKIQMEEKFMAANPSKISYEPITTTLRRKHEEVSAMVIQRAFRRHLLQRSLKHASFLFRQQAGSGLSEEDAPEREGLIAYVMSENFSRPLGPPSSSSISSTSFPPSYDSVTRATSDNLQVRGSDYSHSEDLADFPPSPDRDRESIV

SEQ ID NO: 5 - DNA, 6417 bp, Homosapiens
  hCav1.2 (also known as CACNA1C)
atggtcaatgagaatacgaggatgtacattccagaggaaaaccaccaaggttccaactatgggagcccacgccccgcccatgccaacatgaatgccaatgcggcagcggggctggcccctgagcacatccccaccccgggggctgccctgtcgtggcaggcggccatcgacgcagcccggcaggctaagctgatgggcagcgctggcaatgcgaccatctccacagtcagctccacgcagcggaagcggcagcaatatgggaaacccaagaagcagggcagcaccacggccacacgcccgccccgagccctgctctgcctgaccctgaagaaccccatccggagggcctgcatcagcattgtcgaatggaaaccatttgaaataattattttactgactatttttgccaattgtgtggccttagcgatctatattccctttccagaagatgattccaacgccaccaattccaacctggaacgagtggaatatctctttctcataatttttacggtggaagcgtttttaaaagtaatcgcctatggactcctctttcaccccaatgcctacctccgcaacggctggaacctactagattttataattgtggttgtggggctttttagtgcaattttagaacaagcaaccaaagcagatggggcaaacgctctcggagggaaaggggccggatttgatgtgaaggcgctgagggccttccgcgtgctgcgccccctgcggctggtgtccggagtcccaagtctccaggtggtcctgaattccatcatcaaggccatggtccccctgctgcacatcgccctgcttgtgctgtttgtcatcatcatctacgccatcatcggcttggagctcttcatggggaagatgcacaagacctgctacaaccaggagggcatagcagatgttccagcagaagatgacccttccccttgtgcgctggaaacgggccacgggcggcagtgccagaacggcacggtgtgcaagcccggctgggatggtcccaagcacggcatcaccaactttgacaactttgccttcgccatgctcacggtgttccagtgcatcaccatggagggctggacggacgtgctgtactgggtcaatgatgccgtaggaagggactggccctggatctattttgttacactaatcatcatagggtcattttttgtacttaacttggttctcggtgtgcttagcggagagttttccaaagagagggagaaggccaaggcccggggagatttccagaagctgcgggagaagcagcagctagaagaggatctcaaaggctacctggattggatcactcaggccgaagacatcgatcctgagaatgaggacgaaggcatggatgaggagaagccccgaaacatgagcatgcccaccagtgagaccgagtccgtcaacaccgaaaacgtggctggaggtgacatcgagggagaaaactgcggggccaggctggcccaccggatctccaagtcaaagttcagccgctactggcgccggtggaatcggttctgcagaaggaagtgccgcgccgcagtcaagtctaatgtcttctactggctggtgattttcctggtgttcctcaacacgctcaccattgcctctgagcactacaaccagcccaactggctcacagaagtccaagacacggcaaacaaggccctgctggccctgttcacggcagagatgctcctgaagatgtacagcctgggcctgcaggcctacttcgtgtccctcttcaaccgctttgactgcttcgtcgtgtgtggcggcatcctggagaccatcctggtggagaccaagatcatgtccccactgggcatctccgtgctcagatgcgtccggctgctgaggattttcaagatcacgaggtactggaactccttgagcaacctggtggcatccttgctgaactctgtgcgctccatcgcctccctgctccttctcctcttcctcttcatcatcatcttctccctcctggggatgcagctctttggaggaaagttcaactttgatgagatgcagacccggaggagcacattcgataacttcccccagtccctcctcactgtgtttcagatcctgaccggggaggactggaattcggtgatgtatgatgggatcatggcttatggcggcccctcttttccagggatgttagtctgtatttacttcatcatcctcttcatctgtggaaactatatcctactgaatgtgttcttggccattgctgtggacaacctggctgatgctgagagcctcacatctgcccaaaaggaggaggaagaggagaaggagagaaagaagctggccaggactgccagcccagagaagaaacaagagttggtggagaagccggcagtgggggaatccaaggaggagaagattgagctgaaatccatcacggctgacggagagtctccacccgccaccaagatcaacatggatgacctccagcccaatgaaaatgaggataagagcccctaccccaacccagaaactacaggagaagaggatgaggaggagccagagatgcctgtcggccctcgcccacgaccactctctgagcttcaccttaaggaaaaggcagtgcccatgccagaagccagcgcgtttttcatcttcagctctaacaacaggtttcgcctccagtgccaccgcattgtcaatgacacgatcttcaccaacctgatcctcttcttcattctgctcagcagcatttccctggctgctgaggacccggtccagcacacctccttcaggaaccatattctgttttattttgatattgtttttaccaccattttcaccattgaaattgctctgaagatgactgcttatggggctttcttgcacaagggttctttctgccggaactacttcaacatcctggacctgctggtggtcagcgtgtccctcatctcctttggcatccagtccagtgcaatcaatgtcgtgaagatcttgcgagtcctgcgagtactcaggcccctgagggccatcaacagggccaaggggctaaagcatgtggttcagtgtgtgtttgtcgccatccggaccatcgggaacatcgtgattgtcaccaccctgctgcagttcatgtttgcctgcatcggggtccagctcttcaagggaaagctgtacacctgttcagacagttccaagcagacagaggcggaatgcaagggcaactacatcacgtacaaagacggggaggttgaccaccccatcatccaaccccgcagctgggagaacagcaagtttgactttgacaatgttctggcagccatgatggccctcttcaccgtctccaccttcgaagggtggccagagctgctgtaccgctccatcgactcccacacggaagacaagggccccatctacaactaccgtgtggagatctccatcttcttcatcatctacatcatcatcatcgccttcttcatgatgaacatcttcgtgggcttcgtcatcgtcacctttcaggagcagggggagcaggagtacaagaactgtgagctggacaagaaccagcgacagtgcgtggaatacgccctcaaggcccggcccctgcggaggtacatccccaagaaccagcaccagtacaaagtgtggtacgtggtcaactccacctacttcgagtacctgatgttcgtcctcatcctgctcaacaccatctgcctggccatgcagcactacggccagagctgcctgttcaaaatcgccatgaacatcctcaacatgctcttcactggcctcttcaccgtggagatgatcctgaagctcattgccttcaaacccaagcactatttctgtgatgcatggaatacatttgacgccttgattgttgtgggtagcattgttgatatagcaatcaccgaggtaaacccagctgaacatacccaatgctctccctctatgaacgcagaggaaaactcccgcatctccatcaccttcttccgcctgttccgggtcatgcgtctggtgaagctgctgagccgtggggagggcatccggacgctgctgtggaccttcatcaagtccttccaggccctgccctatgtggccctcctgatcgtgatgctgttcttcatctacgcggtgatcgggatgcaggtgtttgggaaaattgccctgaatgataccacagagatcaaccggaacaacaactttcagaccttcccccaggccgtgctgctcctcttcaggtgtgccaccggggaggcctggcaggacatcatgctggcctgcatgccaggcaagaagtgtgccccagagtccgagcccagcaacagcacggagggtgaaacaccctgtggtagcagctttgctgtcttctacttcatcagcttctacatgctctgtgccttcctgatcatcaacctctttgtagctgtcatcatggacaactttgactacctgacaagggactggtccatccttggtccccaccacctggatgagtttaaaagaatctgggcagagtatgaccctgaagccaagggtcgtatcaaacacctggatgtggtgaccctcctccggcggattcagccgccactaggttttgggaagctgtgccctcaccgcgtggcttgcaaacgcctggtctccatgaacatgcctctgaacagcgacgggacagtcatgttcaatgccaccctgtttgccctggtcaggacggccctgaggatcaaaacagaagggaacctagaacaagccaatgaggagctgcgggcgatcatcaagaagatctggaagcggaccagcatgaagctgctggaccaggtggtgccccctgcaggtgatgatgaggtcaccgttggcaagttctacgccacgttcctgatccaggagtacttccggaagttcaagaagcgcaaagagcagggccttgtgggcaagccctcccagaggaacgcgctgtctctgcaggctggcttgcgcacactgcatgacatcgggcctgagatccgacgggccatctctggagatctcaccgctgaggaggagctggacaaggccatgaaggaggctgtgtccgctgcttctgaagatgacatcttcaggagggccggtggcctgttcggcaaccacgtcagctactaccaaagcgacggccggagcgccttcccccagaccttcaccactcagcgcccgctgcacatcaacaaggcgggcagcagccagggcgacactgagtcgccatcccacgagaagctggtggactccaccttcaccccgagcagctactcgtccaccggctccaacgccaacatcaacaacgccaacaacaccgccctgggtcgcctccctcgccccgccggctaccccagcacggtcagcactgtggagggccacgggccccccttgtcccctgccatccgggtgcaggaggtggcgtggaagctcagctccaacaggtgccactcccgggagagccaggcagccatggcgggtcaggaggagacgtctcaggatgagacctatgaagtgaagatgaaccatgacacggaggcctgcagtgagcccagcctgctctccacagagatgctctcctaccaggatgacgaaaatcggcaactgacgctcccagaggaggacaagagggacatccggcaatctccgaagaggggtttcctccgctctgcctcactaggtcgaagggcctccttccacctggaatgtctgaagcgacagaaggaccgagggggagacatctctcagaagacagtcctgcccttgcatctggttcatcatcaggcattggcagtggcaggcctgagccccctcctccagagaagccattcccctgcctcattccctaggccttttgccaccccaccagccacacctggcagccgaggctggcccccacagcccgtccccaccctgcggcttgagggggtcgagtccagtgagaaactcaacagcagcttcccatccatccactgcggctcctgggctgagaccacccccggtggcgggggcagcagcgccgcccggagagtccggcccgtctccctcatggtgcccagccaggctggggccccagggaggcagttccacggcagtgccagcagcctggtggaagcggtcttgatttcagaaggactggggcagtttgctcaagatcccaagttcatcgaggtcaccacccaggagctggccgacgcctgcgacatgaccatagaggagatggagagcgcggccgacaacatcctcagcgggggcgccccacagagccccaatggcgccctcttaccctttgtgaactgcagggacgcggggcaggaccgagccgggggcgaagaggacgcgggctgtgtgcgcgcgcggggtcgaccgagtgaggaggagctccaggacagcagggtctacgtcagcagcctgtag

SEQ ID NO: 6 - protein, 2138 aa, Homosapiens
  hCav1.2 (also known as CACNA1C)
MVNENTRMYIPEENHQGSNYGSPRPAHANMNANAAAGLAPEHIPTPGAALSWQAAIDAARQAKLMGSAGNATISTVSSTQRKRQQYGKPKKQGSTTATRPPRALLCLTLKNPIRRACISIVEWKPFEIIILLTIFANCVALAIYIPFPEDDSNATNSNLERVEYLFLIIFTVEAFLKVIAYGLLFHPNAYLRNGWNLLDFIIVVVGLFSAILEQATKADGANALGGKGAGFDVKALRAFRVLRPLRLVSGVPSLQVVLNSIIKAMVPLLHIALLVLFVIIIYAIIGLELFMGKMHKTCYNQEGIADVPAEDDPSPCALETGHGRQCQNGTVCKPGWDGPKHGITNFDNFAFAMLTVFQCITMEGWTDVLYWVNDAVGRDWPWIYFVTLIIIGSFFVLNLVLGVLSGEFSKEREKAKARGDFQKLREKQQLEEDLKGYLDWITQAEDIDPENEDEGMDEEKPRNMSMPTSETESVNTENVAGGDIEGENCGARLAHRISKSKFSRYWRRWNRFCRRKCRAAVKSNVFYWLVIFLVFLNTLTIASEHYNQPNWLTEVQDTANKALLALFTAEMLLKMYSLGLQAYFVSLFNRFDCFVVCGGILETILVETKIMSPLGISVLRCVRLLRIFKITRYWNSLSNLVASLLNSVRSIASLLLLLFLFIIIFSLLGMQLFGGKFNFDEMQTRRSTFDNFPQSLLTVFQILTGEDWNSVMYDGIMAYGGPSFPGMLVCIYFIILFICGNYILLNVFLAIAVDNLADAESLTSAQKEEEEEKERKKLARTASPEKKQELVEKPAVGESKEEKIELKSITADGESPPATKINMDDLQPNENEDKSPYPNPETTGEEDEEEPEMPVGPRPRPLSELHLKEKAVPMPEASAFFIFSSNNRFRLQCHRIVNDTIFTNLILFFILLSSISLAAEDPVQHTSFRNHILFYFDIVFTTIFTIEIALKMTAYGAFLHKGSFCRNYFNILDLLVVSVSLISFGIQSSAINVVKILRVLRVLRPLRAINRAKGLKHVVQCVFVAIRTIGNIVIVTTLLQFMFACIGVQLFKGKLYTCSDSSKQTEAECKGNYITYKDGEVDHPIIQPRSWENSKFDFDNVLAAMMALFTVSTFEGWPELLYRSIDSHTEDKGPIYNYRVEISIFFIIYIIIIAFFMMNIFVGFVIVTFQEQGEQEYKNCELDKNQRQCVEYALKARPLRRYIPKNQHQYKVWYVVNSTYFEYLMFVLILLNTICLAMQHYGQSCLFKIAMNILNMLFTGLFTVEMILKLIAFKPKHYFCDAWNTFDALIVVGSIVDIAITEVNPAEHTQCSPSMNAEENSRISITFFRLFRVMRLVKLLSRGEGIRTLLWTFIKSFQALPYVALLIVMLFFIYAVIGMQVFGKIALNDTTEINRNNNFQTFPQAVLLLFRCATGEAWQDIMLACMPGKKCAPESEPSNSTEGETPCGSSFAVFYFISFYMLCAFLIINLFVAVIMDNFDYLTRDWSILGPHHLDEFKRIWAEYDPEAKGRIKHLDVVTLLRRIQPPLGFGKLCPHRVACKRLVSMNMPLNSDGTVMFNATLFALVRTALRIKTEGNLEQANEELRAIIKKIWKRTSMKLLDQVVPPAGDDEVTVGKFYATFLIQEYFRKFKKRKEQGLVGKPSQRNALSLQAGLRTLHDIGPEIRRAISGDLTAEEELDKAMKEAVSAASEDDIFRRAGGLFGNHVSYYQSDGRSAFPQTFTTQRPLHINKAGSSQGDTESPSHEKLVDSTFTPSSYSSTGSNANINNANNTALGRLPRPAGYPSTVSTVEGHGPPLSPAIRVQEVAWKLSSNRCHSRESQAAMAGQEETSQDETYEVKMNHDTEACSEPSLLSTEMLSYQDDENRQLTLPEEDKRDIRQSPKRGFLRSASLGRRASFHLECLKRQKDRGGDISQKTVLPLHLVHHQALAVAGLSPLLQRSHSPASFPRPFATPPATPGSRGWPPQPVPTLRLEGVESSEKLNSSFPSIHCGSWAETTPGGGGSSAARRVRPVSLMVPSQAGAPGRQFHGSASSLVEAVLISEGLGQFAQDPKFIEVTTQELADACDMTIEEMESAADNILSGGAPQSPNGALLPFVNCRDAGQDRAGGEEDAGCVRARGRPSEEELQDSRVYVSSL

SEQ ID NO: 7 - protein, 989 aa, Homosapiens
  KCNH1 (also known as Kv10.1, eag, h-eag, eag1)
MTMAGGRRGLVAPQNTFLENIVRRSNDTNFVLGNAQIVDWPIVYSNDGFCKLSGYHRAEVMQKSSTCSFMYGELTDKDTIEKVRQTFENYEMNSFEILMYKKNRTPVWFFVKIAPIRNEQDKVVLFLCTFSDITAFKQPIEDDSCKGWGKFARLTRALTSSRGVLQQLAPSVQKGENVHKHSRLAEVLQLGSDILPQYKQEAPKTPPHIILHYCVFKTTWDWIILILTFYTAILVPYNVSFKTRQNNVAWLVVDSIVDVIFLVDIVLNFHTTFVGPAGEVISDPKLIRMNYLKTWFVIDLLSCLPYDVINAFENVDEVSAFMGDPGKIGFADQIPPPLEGRESQGISSLFSSLKVVRLLRLGRVARKLDHYIEYGAAVLVLLVCVFGLAAHWMACIWYSIGDYEIFDEDTKTIRNNSWLYQLAMDIGTPYQFNGSGSGKWEGGPSKNSVYISSLYFTMTSLTSVGFGNIAPSTDIEKIFAVAIMMIGSLLYATIFGNVTTIFQQMYANTNRYHEMLNSVRDFLKLYQVPKGLSERVMDYIVSTWSMSRGIDTEKVLQICPKDMRADICVHLNRKVFKEHPAFRLASDGCLRALAMEFQTVHCAPGDLIYHAGESVDSLCFVVSGSLEVIQDDEVVAILGKGDVFGDVFWKEATLAQSCANVRALTYCDLHVIKRDALQKVLEFYTAFSHSFSRNLILTYNLRKRIVFRKISDVKREEEERMKRKNEAPLILPPDHPVRRLFQRFRQQKEARLAAERGGRDLDDLDVEKGNVLTEHASANHSLVKASVVTVRESPATPVSFQAASTSGVPDHAKLQAPGSECLGPKGGGGDCAKRKSWARFKDACGKSEDWNKVSKAESMETLPERTKASGEATLKKTDSCDSGITKSDLRLDNVGEARSPQDRSPILAEVKHSFYPIPEQTLQATVLEVRHELKEDIKALNAKMTNIEKQLSEILRILTSRRSSQSPQELFEISRPQSPESERDIFGAS

SEQ ID NO: 8 - protein, 1087 aa, Homosapiens
  KCNH3 (also known as Kv12.2, BEC1, elk2)
MPAMRGLLAPQNTFLDTIATRFDGTHSNFVLGNAQVAGLFPVVYCSDGFCDLTGFSRAEVMQRGCACSFLYGPDTSELVRQQIRKALDEHKEFKAELILYRKSGLPFWCLLDVIPIKNEKGEVALFLVSHKDISETKNRGGPDNWKERGGGRRRYGRAGSKGFNANRRRSRAVLYHLSGHLQKQPKGKHKLNKGVFGEKPNLPEYKVAAIRKSPFILLHCGALRATWDGFILLATLYVAVTVPYSVCVSTAREPSAARGPPSVCDLAVEVLFILDIVLNFRTTFVSKSGQVVFAPKSICLHYVTTWFLLDVIAALPFDLLHAFKVNVYVGAHLLKTVRLLRLLRLLPRLDRYSQYSAVVLTLLMAVFALLAHWVACVWFYIGQQEIENSESELPEIGWLQELARRLETPYYLVSRSPDGGNSSGQSENCSSSGGGSEANGTGLELLGGPSLRSAYITSLYFALSSLTSVGFGNVSANTDTEKIFSICTMLIGALMHAVVFGNVTAIIQRMYARRFLYHSRTRDLRDYIRIHRIPKPLKQRMLEYFQATWAVNNGIDTTELLQSLPDELRADIAMHLHKEVLQLPLFEAASRGCLRALSLALRPAFCTPGEYLIHQGDALQALYFVCSGSMEVLKGGTVLAILGKGDLIGCELPQREQVVKANADVKGLTYCVLQCLQLAGLHESLALYPEFAPRFSRGLRGELSYNLGAGGVSAEVDTSSLSGDNTLMSTLEEKETDGEQGHTISPAPADEPSSPLLSPGCTSSSSAAKLLSPRRTAPRPRLGGRGRPSRAGVLKPEAGPSAHPRTLDGLQLPPMPWNVPPDLSPRVVDGIEDGCGSDQHKFSFRVGQSGPECSSSPSPGTESGLLTVPLVPSEARNTDTLDKLRQAVTELSEQVLQMREGLQSLRQAVQLILVPQGEGQCPRVSGEGPCPATASGLLQPLRVDTGASSYCLQPPAGSVLSGTWPHPRPGHPPPLMAPWPWGPPASQSSPWPRATALWTSTSDSEPPGSGDLCSEPSTPASPPPPEEGARTGTPAPVSQAEATSTGEPPPGSGGRALPWDPHSLEMVLIGCHGPGSVQWTQEEGTGV

SEQ ID NO: 9 - protein, 1017 aa, Homosapiens
  KCNH4 (also known as Kv12.3, elk1)
MPVMKGLLAPQNTFLDTIATRFDGTHSNFLLANAQGTRGFPIVYCSDGFCELTGYGRTEVMQKTCSCRFLYGPETSEPALQRLHKALEGHQEHRAEICFYRKDGSAFWCLLDMMPIKNEMGEVVLFLFSFKDITQSGSPGLGPQGGRGDSNHENSLGRRGATWKFRSARRRSRTVLHRLTGHFGRRGQGGMKANNNVFEPKPSVPEYKVASVGGSRCLLLHYSVSKAIWDGLILLATFYVAVTVPYNVCFSGDDDTPITSRHTLVSDIAVEMLFILDIILNFRTTYVSQSGQVISAPRSIGLHYLATWFFIDLIAALPFDLLYIFNITVTSLVHLLKTVRLLRLLRLLQKLERYSQCSAVVLTLLMSVFALLAHWMACIWYVIGRREMEANDPLLWDIGWLHELGKRLEVPYVNGSVGGPSRRSAYIAALYFTLSSLTSVGFGNVCANTDAEKIFSICTMLIGALMHAVVFGNVTAIIQRMYSRRSLYHSRMKDLKDFIRVHRLPRPLKQRMLEYFQTTWAVNSGIDANELLRDFPDELRADIAMHLNREILQLPLFGAASRGCLRALSLHIKTSFCAPGEYLLRRGDALQAHYYVCSGSLEVLRDNMVLAILGKGDLIGADIPEPGQEPGLGADPNFVLKTSADVKALTYCGLQQLSSRGLAEVLRLYPEYGAAFRAGLPRDLTFNLRQGSDTSGLSRFSRSPRLSQPRSESLGSSSDKTLPSITEAESGAEPGGGPRPRRPLLLPNLSPARPRGSLVSLLGEELPPFSALVSSPSLSPSLSPALAGQGHSASPHGPPRCSAAWKPPQLLIPPLGTFGPPDLSPRIVDGIEDSGSTAEAPSFRFSRRPELPRPRSQAPPTGTRPSPELASEAEEVKEKVCRLNQEISRLNQEVSQLSRELRHIMGLLQARLGPPGHPAGSAWTPDPPCPQLRPPCLSPCASRPPPSLQDTTLAEVHCPASVGTMETGTALLDLRPSILPPYPSEPDPLGPSPVPEASPPTPSLLRHSFQSRSDTFH

SEQ ID NO: 10 - protein, 988 aa, Homosapiens
  KCNH5 (also known as Kv10.2, H-EAG2, eag2)
MPGGKRGLVAPQNTFLENIVRRSSESSFLLGNAQIVDWPVVYSNDGFCKLSGYHRADVMQKSSTCSFMYGELTDKKTIEKVRQTFDNYESNCFEVLLYKKNRTPVWFYMQIAPIRNEHEKVVLFLCTFKDITLFKQPIEDDSTKGWTKFARLTRALTNSRSVLQQLTPMNKTEVVHKHSRLAEVLQLGSDILPQYKQEAPKTPPHIILHYCAFKTTWDWVILILTFYTAIMVPYNVSFKTKQNNIAWLVLDSVVDVIFLVDIVLNFHTTFVGPGGEVISDPKLIRMNYLKTWFVIDLLSCLPYDIINAFENVDEGISSLFSSLKVVRLLRLGRVARKLDHYLEYGAAVLVLLVCVFGLVAHWLACIWYSIGDYEVIDEVTNTIQIDSWLYQLALSIGTPYRYNTSAGIWEGGPSKDSLYVSSLYFTMTSLTTIGFGNIAPTTDVEKMFSVAMMMVGSLLYATIFGNVTTIFQQMYANTNRYHEMLNNVRDFLKLYQVPKGLSERVMDYIVSTWSMSKGIDTEKVLSICPKDMRADICVHLNRKVFNEHPAFRLASDGCLRALAVEFQTIHCAPGDLIYHAGESVDALCFVVSGSLEVIQDDEVVAILGKGDVFGDIFWKETTLAHACANVRALTYCDLHIIKREALLKVLDFYTAFANSFSRNLTLTCNLRKRIIFRKISDVKKEEEERLRQKNEVTLSIPVDHPVRKLFQKFKQQKELRNQGSTQGDPERNQLQVESRSLQNGASITGTSVVTVSQITPIQTSLAYVKTSESLKQNNRDAMELKPNGGADQKCLKVNSPIRMKNGNGKGWLRLKNNMGAHEEKKEDWNNVTKAESMGLLSEDPKSSDSENSVTKNPLRKTDSCDSGITKSDLRLDKAGEARSPLEHSPIQADAKHPFYPIPEQALQTTLQEVKHELKEDIQLLSCRMTALEKQVAEILKILSEKSVPQASSPKSQMPLQVPPQIPCQDIFSVSRPESPESDKDEIHF

SEQ ID NO: 11 - protein, 994 aa, Homosapiens
  KCNH6 (also known as Kv11.2, erg2, HERG2)
MPVRRGHVAPQNTYLDTIIRKFEGQSRKFLIANAQMENCAIIYCNDGFCELFGYSRVEVMQQPCTCDFLTGPNTPSSAVSRLAQALLGAEECKVDILYYRKDASSFRCLVDVVPVKNEDGAVIMFILNFEDLAQLLAKCSSRSLSQRLLSQSFLGSEGSHGRPGGPGPGTGRGKYRTISQIPQFTLNFVEFNLEKHRSSSTTEIEIIAPHKVVERTQNVTEKVTQVLSLGADVLPEYKLQAPRIHRWTILHYSPFKAVWDWLILLLVIYTAVFTPYSAAFLLSDQDESRRGACSYTCSPLTVVDLIVDIMFVVDIVINFRTTYVNTNDEVVSHPRRIAVHYFKGWFLIDMVAAIPFDLLIFRTGSDETTTLIGLLKTARLLRLVRVARKLDRYSEYGAAVLFLLMCTFALIAHWLACIWYAIGNVERPYLEHKIGWLDSLGVQLGKRYNGSDPASGPSVQDKYVTALYFTFSSLTSVGFGNVSPNTNSEKVFSICVMLIGSLMYASIFGNVSAIIQRLYSGTARYHTQMLRVKEFIRFHQIPNPLRQRLEEYFQHAWSYTNGIDMNAVLKGFPECLQADICLHLHRALLQHCPAFSGAGKGCLRALAVKFKTTHAPPGDTLVHLGDVLSTLYFISRGSIEILRDDVVVAILGKNDIFGEPVSLHAQPGKSSADVRALTYCDLHKIQRADLLEVLDMYPAFAESFWSKLEVTFNLRDAAGGLHSSPRQAPGSQDHQGFFLSDNQSGSPHELGPQFPSKGYSLLGPGSQNSMGAGPCAPGHPDAAPPLSISDASGLWPELLQEMPPRHSPQSPQEDPDCWPLKLGSRLEQLQAQMNRLESRVSSDLSRILQLLQKPMPQGHASYILEAPASNDLALVPIASETTSPGPRLPQGFLPPAQTPSYGDLDDCSPKHRNSSPRMPHLAVATDKTLAPSSEQEQPEGLWPPLASPLHPLEVQGLICGPCFSSLPEHLGSVPKQLDFQRHGSDPGFAGSWGH

SEQ ID NO: 12 - protein, 1196 aa, Homosapiens
  KCNH7 (also known as Kv11.3, HERG3, erg3)
MPVRRGHVAPQNTFLGTIIRKFEGQNKKFIIANARVQNCAIIYCNDGFCEMTGFSRPDVMQKPCTCDFLHGPETKRHDIAQIAQALLGSEERKVEVTYYHKNGSTFICNTHIIPVKNQEGVAMMFIINFEYVTDNENAATPERVNPILPIKTVNRKFFGFKFPGLRVLTYRKQSLPQEDPDVVVIDSSKHSDDSVAMKHFKSPTKESCSPSEADDTKALIQPSKCSPLVNISGPLDHSSPKRQWDRLYPDMLQSSSQLSHSRSRESLCSIRRASSVHDIEGFGVHPKNIFRDRHASEDNGRNVKGPFNHIKSSLLGSTSDSNLNKYSTINKIPQLTLNFSEVKTEKKNSSPPSSDKTIIAPKVKDRTHNVTEKVTQVLSLGADVLPEYKLQTPRINKFTILHYSPFKAVWDWLILLLVIYTAIFTPYSAAFLLNDREEQKRRECGYSCSPLNVVDLIVDIMFIIDILINFRTTYVNQNEEVVSDPAKIAIHYFKGWFLIDMVAAIPFDLLIFGSGSDETTTLIGLLKTARLLRLVRVARKLDRYSEYGAAVLMLLMCIFALIAHWLACIWYAIGNVERPYLTDKIGWLDSLGQQIGKRYNDSDSSSGPSIKDKYVTALYFTFSSLTSVGFGNVSPNTNSEKIFSICVMLIGSLMYASIFGNVSAIIQRLYSGTARYHMQMLRVKEFIRFHQIPNPLRQRLEEYFQHAWTYTNGIDMNMVLKGFPECLQADICLHLNQTLLQNCKAFRGASKGCLRALAMKFKTTHAPPGDTLVHCGDVLTALYFLSRGSIEILKDDIVVAILGKNDIFGEMVHLYAKPGKSNADVRALTYCDLHKIQREDLLEVLDMYPEFSDHFLTNLELTFNLRHESAKADLLRSQSMNDSEGDNCKLRRRKLSFESEGEKENSTNDPEDSADTIRHYQSSKRHFEEKKSRSSSFISSIDDEQKPLFSGIVDSSPGIGKASGLDFEETVPTSGRMHIDKRSHSCKDITDMRSWERENAHPQPEDSSPSALQRAAWGISETESDLTYGEVEQRLDLLQEQLNRLESQMTTDIQTILQLLQKQTTVVPPAYSMVTAGSEYQRPIIQLMRTSQPEASIKTDRSFSPSSQCPEFLDLEKSKLKSKESLSSGVHLNTASEDNLTSLLKQDSDLSLELHLRQRKTYVHPIRHPSLPDSSLSTVGIVGLHRHVSDPGLPGK

SEQ ID NO: 13 - protein, 1107 aa, Homosapiens
  KCNH8 (also known as Kv12.1, elk3)
MPVMKGLLAPQNTFLDTIATRFDGTHSNFILANAQVAKGFPIVYCSDGFCELAGFARTEVMQKSCSCKFLFGVETNEQLMLQIEKSLEEKTEFKGEIMFYKKNGSPFWCLLDIVPIKNEKGDVVLFLASFKDITDTKVKITPEDKKEDKVKGRSRAGTHFDSARRRSRAVLYHISGHLQRREKNKLKINNNVFVDKPAFPEYKVSDAKKSKFILLHFSTFKAGWDWLILLATFYVAVTVPYNVCFIGNDDLSTTRSTTVSDIAVEILFIIDIILNFRTTYVSKSGQVIFEARSICIHYVTTWFIIDLIAALPFDLLYAFNVTVVSLVHLLKTVRLLRLLRLLQKLDRYSQHSTIVLTLLMSMFALLAHWMACIWYVIGKMEREDNSLLKWEVGWLHELGKRLESPYYGNNTLGGPSIRSAYIAALYFTLSSLTSVGFGNVSANTDAEKIFSICTMLIGALMHALVFGNVTAIIQRMYSRWSLYHTRTKDLKDFIRVHHLPQQLKQRMLEYFQTTWSVNNGIDSNELLKDFPDELRSDITMHLNKEILQLSLFECASRGCLRSLSLHIKTSFCAPGEYLLRQGDALQAIYFVCSGSMEVLKDSMVLAILGKGDLIGANLSIKDQVIKTNADVKALTYCDLQCIILKGLFEVLDLYPEYAHKFVEDIQHDLTYNLREGHESDVISRLSNKSMVSQSEPKGNGNINKRLPSIVEDEEEEEEGEEEEAVSLSPICTRGSSSRNKKVGSNKAYLGLSLKQLASGTVPFHSPIRVSRSNSPKTKQEIDPPNHNKRKEKNLKLQLSTLNNAGPPDLSPRIVDGIEDGNSSEESQTFDFGSERIRSEPRISPPLGDPEIGAAVLFIKAEETKQQINKLNSEVTTLTQEVSQLGKDMRNVIQLLENVLSPQQPSRFCSLHSTSVCPSRESLQTRTSWSAHQPCLHLQTGGAAYTQAQLCSSNITSDIWSVDPSSVGSSPQRTGAHEQNPADSELYHSPSLDYSPSHYQVVQEGHLQFLRCISPHSDSTLTPLQSISATLSSSVCSSSETSLHLVLPSRSEEGSFSQGTVSSFSLENLPGSWNQEGMASASTKPLENLPLEVVTSTAEVKDNKAINV